(19) United States
(12) Patent Application Publication
(10) Pub. No.: US 2006/0077456 A1
(43) Pub. Date: Apr. 13, 2006

(54) Authentication output system, device using apparatus, network device, output data managing program, output control program, output system, authentication output method, and output method

(76) Inventor: Mikio Aoki, Suwa (JP)

Correspondence Address: HARNESS, DICKEY & PIERCE, P.L.C., P.O. BOX 828, BLOOMFIELD HILLS, MI, 48303, US

(21) Appl. No.: 11/243,387

(22) Filed: Oct. 4, 2005

(30) Foreign Application Priority Data
Oct. 7, 2004 (JP) 2004-294585
Oct. 7, 2004 (JP) 2004-294588
Oct. 7, 2004 (JP) 2004-294589
Jul. 5, 2005 (JP) 2005-196411

(51) Int. Cl. G06F 3/12

(52) U.S. Cl. 358/1.15

(57) ABSTRACT

An authenticator includes: network devices performing output; and an apparatus communicably using the network devices. The apparatus includes: first storage storing the output data; second storage storing tickets specifying whether to permit or restrict output data use; and a utilization manager managing output data use. When the authentication succeeds, the manager supplies output data stored in the first storage to any network device, and prohibits supplying output data until a print completion notice is received. When the print completion notice is received, the manager updates the tickets stored in the second storage, and when the tickets satisfy predetermined conditions, the manager prohibits supplying output data. Each network device includes: a receiver receiving output data; and a controller performing output control based on the output data received by the receiver. The controller transmits the print completion notice to the apparatus when the network device completely outputs the output data.

### RELATED APPLICATIONS

This application claims priority to Japanese Patent Application Nos. 2004-294585 filed Oct. 7, 2004, 2004-294588 filed Oct. 7, 2004, 2004-294589 filed Oct. 7, 2004, and 2005-196411 filed Jul. 5, 2005 which are hereby expressly incorporated by reference herein in their entirety.

### BACKGROUND

1. Technical Field

The present invention relates to a system, a device, an apparatus, and a program that perform an output process through authentication, and more particularly, to an authentication output system, a device using apparatus, a network device, an output data managing program, an output control program, an output system, an authentication output method, and an output method capable of allowing only an authorized user to acquire an output matter and of protecting the secrecy of output contents by preventing the output process from being performed beyond an output permission range.

2. Related Art

When confidential documents are printed by a network printer, serving as a network device, it is preferable to protect the secrecy of a printed matter such that the printed matter is not viewed by unauthorized users. Also, it is preferable to protect literary works, such as documents and images, read over a network.

For example, an image forming apparatus disclosed in JP-A-2002-149385 and a printing control apparatus disclosed in JP-A-2002-189578 have been known as techniques for protecting the secrecy of printed matters.

According to the technique disclosed in JP-A-2002-149385, in a case in which a print job of a confidential print mode is received, when printing is currently inexecutable, the print job is transmitted to another network printer. In this case, only when another network printer, a destination of the print job, which is positioned close to the currently used printer, is in an immediately printable state, the print job is transmitted in a forced print mode. Meanwhile, when the network printer which is a destination of the print job is positioned far away from the currently used printer, or is not in the immediately printable state although it is positioned close thereto, the print job is transmitted again in a confidential print mode. In this way, even when a problem, such as a paper jam, occurs in a network printer receiving a printing request, it is possible to reliably acquire a printed matter by using another network printer.

According to the technique disclosed in JP-A-2002-189578, a print job received from a host terminal, a source of the print job which is serving as a device using apparatus is transmitted to a network printer which is previously set as a destination of the print job. Then, when an NW port of the network printer detects problems, such as a jam of a printing engine unit and the abnormality of a PDL analysis, by communicating with a PDL port, the network printer, which is a destination of the print job, is instructed to start a page analyzing process of the print job. In this way, it is possible to rapidly process the print job in the network printer, which is a destination of the job print, without transmitting the print job to another network printer.

Meanwhile, for example, a document managing method disclosed in JP-A-10-320289 has been known as a technique for protecting a literary work.

The invention disclosed in JP-A-10-320289 includes a copyright management information setting unit, a document storage unit, a copyright management information storage unit, a copyright management information checking unit, and a document generating unit. The copyright management information setting unit sets copyright management information in constituent units of the documents stored in the document storage unit, and associates the set copyright management information with information indicating the constituent units of the set copyright management information to store it in the copyright management information storage unit. When the document generating unit requires using a predetermined portion of another document stored in the document storage unit during the creation of documents, the copyright management information checking unit determines an available portion in the predetermined portion, on the basis of the copyright management information stored in the copyright management information storage unit in the constituent unit that overlaps the predetermined portion.

However, according to the invention disclosed in JP-A-2002-149385, in a case in which the remaining print job exists in a network printer, is a source of the data, capable of reliably acquiring a printed matter, when the network printer gets out of trouble, the same printed matter as that printed in a transmission destination may be printed out.

Further, according to the invention disclosed in JP-A-2002-189578, a plurality of network printers capable of reliably and rapidly acquiring printed matters are simultaneously instructed to start the page analysis process, printed matters larger than a necessary number of copies may be printed.

Therefore, the inventions disclosed in JP-A-2002-149385 and JP-A-2002-189578 have a problem in that unauthorized users may view the contents of a printed matter.

Meanwhile, in the invention disclosed in JP-A-10-320289, when it is necessary to use a predetermined portion of another document, an available portion in the predetermined portion is determined on the basis of the copyright management information in the constituent unit that overlaps the predetermined portion. Therefore, it is possible to restrict the change of documents by using the relationship with other documents, but the document can be relatively freely printed. As a result, literary works may be printed without restriction, and thus the structure disclosed in JP-A-10-320289 has a problem in that the literary works can not be reliably protected.

The problem of the insufficient protection of the literary works may also arise in a case in which a display device, such as a projector or an LCD (liquid crystal display device), is connected to a network to display an image, as well as in the printing process.

### SUMMARY

A first advantage of some aspects of the invention is that it provides an authentication output system, a device using apparatus, a network device, an output data managing program, an output control program, an output system, an authentication output method, and an output method capable of allowing only an authorized user to acquire an output matter and of protecting the secrecy of output contents by preventing an output process from being performed beyond an output permission range. In addition, a second advantage of some aspects of the invention is that it provides an output system, a network device, an output control program, and an output method capable of allowing only an authorized user to acquire an output matter and of protecting literary works and the secrecy of output contents by preventing an output process from being performed beyond an output permission range.

According to a first aspect of the invention, an authentication output system includes a plurality of network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data storage unit that stores the output data; a job ticket storage unit that stores job tickets specifying contents related to whether to permit or restrict the use of the output data; and an output data utilization managing unit that manages the use of the output data. When the authentication succeeds, the output data utilization managing unit supplies the output data stored in the output data storage unit to any one of the plurality of network devices, and prohibits the supply of the output data until a print completion notice is received. When the print completion notice is received, the output data utilization managing unit updates the job tickets stored in the job ticket storage unit. When it is determined that the contents of the job tickets satisfy predetermined conditions, the output data utilization managing unit prohibits the supply of the output data. Each of the network devices includes an output data receiving unit that receives the output data; and an output control unit that performs output control on the basis of the output data received by the output data receiving unit. The output control unit transmits the print completion notice to the device using apparatus when the network device completely outputs the output data.

According to this structure, in the device using apparatus, when the authentication succeeds, the output data utilization managing unit supplies the output data to any one of the plurality of network devices, and then prohibits the supply of the output data until the print completion notice is received.

In the network device, when the output data receiving unit receives the output data, the output control unit performs the output control on the basis of the received output data. Then, when the output of the output data is completed, the print completion notice is transmitted to the device using apparatus.

In the device using apparatus, when the print completion notice is received, the output data utilization managing unit updates the job tickets.

Further, in the device using apparatus, when it is determined that the contents of the job tickets satisfy the predetermined conditions, the output data utilization managing unit prohibits the supply of the output data.

In this way, when the output of the output data is completed, the job tickets are updated. Therefore, even when the output of the output data from the network device is interrupted due to a trouble, it is possible to obtain output contents by using another network device. Thus, only an authorized user can obtain an output matter.

Furthermore, since the output data is supplied to any one of the network devices, it is possible to prevent the same output content from being simultaneously output from the plurality of network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

Moreover, since the output data and the job tickets are collectively managed by the device using apparatus, it is possible to more strictly manage the output data and the job tickets, compared with a case in which the output data and the job tickets are managed by different apparatuses.

Further, when it is determined that the contents of the job tickets satisfy predetermined conditions, the supply of the output data is prohibited. In this case, prohibiting the supply and use of the output data includes, for example, removing the output data, rejecting a request for the supply or use of the output data, rewriting the attribute of the output data into ‘unavailable’, and encoding the output data such that the output data cannot be read. The above is similarly applied to an authentication output system according to a third aspect, device using apparatuses according to sixteenth and eighteenth aspects, a network device according to a twenty-third aspect, output data managing programs according to thirty-fourth and thirty-sixth aspects, an output control program according to a forty-first aspect, and authentication output methods according to fifty-second and fifty-fourth aspects.

Furthermore, the supply of the output data is prohibited until the print completion notice is received. In this case, prohibiting the supply of the output data includes, for example, rejecting a request for the supply of the output data, rewriting the attribute of the output data into ‘unavailable’, and encoding the output data such that the output data cannot be read. The above is similarly applied to the authentication output system according to the third aspect, the device using apparatuses according to the sixteenth and eighteenth aspects, the output data managing programs according to the thirty-fourth and thirty-sixth aspects, and the authentication output methods according to the fifty-second and fifty-fourth aspects.

Further, updating the job tickets includes, for example, prescribing the number of supplies of the output data and decrementing the number of supplies of the output data whenever the supply is performed and incrementing the number of supplies of the output data whenever the supply is performed. The above is similarly applied to an authentication output system according to a fourth aspect, device using apparatuses according to seventeenth and nineteenth aspects, output data managing programs according to thirty-fifth and thirty-seventh aspects, and authentication output methods according to fifty-third and fifty-fifth aspects.

Furthermore, the output control unit has any structure as long as it can perform output control on the basis of the output data. For example, the output control unit may perform the output control on a printing unit that performs a printing process on the basis of print data, a display unit that performs display on the basis of display data, or a voice output unit that outputs a voice on the basis of audio data. For example, a projector or an LCD is used as the display unit. The above is similarly applied to authentication output systems according to fourth, ninth, eleventh, sixty-seventh, sixth-eighth, seventy-third, and seventy-fourth aspects, network devices according to twenty-fourth, twenty-seventh, twenty-ninth, eighty-fifth, eighty-eighth, eighty-ninth, one-hundred twenty-seventh and one-hundred twenty-eighth aspects, and output systems according to one-hundred twenty-first and one-hundred twenty-second aspects.

Moreover, the output data storage unit stores the output data. Alternatively, the output data may be previously stored in the output data storage unit, or the output data may be stored in the output data storage unit by input from the outside during the operation of the present system. This is similarly applied to a case in which the job tickets are stored in the job ticket storage unit. The above is similarly applied to the authentication output systems according to the fourth, ninth, eleventh, sixty-seventh, sixth-eighth, seventy-third, and seventy-fourth aspects, device using apparatuses according to seventeenth, nineteenth, seventy-ninth, and eightieth aspects, the network devices according to the twenty-seventh, twenty-ninth, eighty-fifth, eighty-eighth, eighty-ninth, one-hundred twenty-seventh and one-hundred twenty-eighth aspects, and the output systems according to the one-hundred twenty-first and one-hundred twenty-second aspects.

Further, obtaining authentication includes, for example, obtaining the authentication by an authenticating unit and acquiring authentication result information indicating an authentication result. The authenticating unit may be provided in a network device, a device using apparatus, and other apparatuses connected to the network. The above is similarly applied to the authentication output systems according to the fourth, ninth, eleventh, sixty-seventh, sixth-eighth, seventy-third, and seventy-fourth aspects, the device using apparatuses according to the seventeenth, nineteenth, seventy-ninth, and eightieth aspects, the network devices according to the twenty-seventh, twenty-ninth, eighty-eighth, and eighty-ninth aspects.

Further, using the network device means utilizing the functions of the network device. This is similarly applied to the other aspects.

In addition, utilization restriction includes the output restriction of the output data, the movement restriction of the output data, and copy restriction, and utilization permission includes the output permission of the output data, the movement permission of the output data, and copy permission. Further, specifying the contents related to whether to permit or restrict the use of the output data includes, for example, specifying the number of supplies of the output data. The above is similarly applied to the other aspects.

Furthermore, the management by the output data utilization managing unit includes, for example, the output permission of data, the output restriction of data, and the update of the job tickets. This is similarly applied to the other aspects.

In addition, the supply of the output data includes, for example, transmitting the output data and storing the output data in a storage unit, such as a memory. This is similarly applied to the other aspects.

Further, the predetermined conditions include, for example, a condition for specifying a utilization restriction range and a condition for specifying a utilization permission range. This is similarly applied to the other aspects.

Moreover, the job tickets include, for example, information on content management, such as the number of output permissions (for example, time and the number of times) or the remaining number of output permissions, output permission target information, a place where output is permitted, the number of copies, and output exclusive control information. This is similarly applied to the other aspects.

According to a second aspect of the invention, in the authentication output system of the first aspect, the output data utilization managing unit prohibits the supply of the output data until the print completion notice or a print interruption notice is received. In addition, when the output of the output data from the network devices is interrupted, the output control unit prohibits the use of the output data and transmits the print interruption notice to the device using apparatus.

According to this structure, in the device using apparatus, the supply of the output data is prohibited until the print completion notice or the print interruption notice is received.

In the network device, when the output of the output data is interrupted, the use of the output data is prohibited, and the print interruption notice is transmitted to the device using apparatus.

Here, in the case in which the output is interrupted and the use of the output data is prohibited, prohibiting the supply or use of the output data includes, for example, removing the output data, rejecting a request for the supply or use of the output data, rewriting the attribute of the output data into ‘unavailable’, and encoding the output data such that the output data cannot be read. The above is similarly applied to the authentication output system according to the fourth aspect, the device using apparatuses according to the seventeenth and nineteenth aspects, the network device according to the twenty-fourth aspect, the output data managing programs according to thirty-fifth and thirty-seventh aspects, an output control program according to a forty-second aspect, and authentication output methods according to fifty-third and fifty-fifth aspects.

Further, in the case in which the supply of the output data is prohibited until the print completion notice or a print interruption notice is received, prohibiting the supply of the output data includes, for example, rejecting a request for the supply of the output data, rewriting the attribute of the output data into ‘unavailable’, and encoding the output data such that the output data cannot be read. This is similarly applied to the authentication output system according to the fourth aspect, the device using apparatuses according to the seventeenth and nineteenth aspects, the output data managing programs according to thirty-fifth and thirty-seventh aspects, and the authentication output methods according to the fifty-third and fifty-fifth aspects.

According to a third aspect of the invention, an authentication output system includes a plurality of network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data storage unit that stores the output data; a job ticket storage unit that stores job tickets specifying contents related to whether to permit or restrict the use of the output data; and an output data utilization managing unit that manages the use of the output data. When the authentication succeeds, the output data utilization managing unit supplies the output data stored in the output data storage unit to any one of the plurality of network devices, updates the job tickets stored in the job ticket storage unit, and prohibits the supply of the output data until a print completion notice is received. When it is determined that the contents of the job tickets satisfy predetermined conditions, the output data utilization managing unit prohibits the supply of the output data. Each of the network devices includes an output data receiving unit that receives the output data; and an output control unit that performs output control on the basis of the output data received by the output data receiving unit. The output control unit transmits the print completion notice to the device using apparatus when the network device completely outputs the output data.

According to this structure, in the device using apparatus, when the authentication succeeds, the output data utilization managing unit supplies the output data to any one of the plurality of network devices, and updates the job tickets. Then, the output data utilization managing unit prohibits the supply of the output data until the print completion notice is received.

In the network device, when the output data receiving unit receives the output data, the output control unit performs the output control on the basis of the received output data. Then, when the output of the output data is completed, the print completion notice is transmitted to the device using apparatus.

In the device using apparatus, when it is determined that the contents of the job tickets satisfy the predetermined conditions, the output data utilization managing unit prohibits the supply of the output data.

In this way, when the output of the output data is completed, the job tickets are updated. Therefore, even when the output of the output data from the network device is interrupted due to a trouble, it is possible to obtain output contents by using another network device. Thus, only an authorized user can obtain an output matter.

Furthermore, since the output data is supplied to any one of the network devices, it is possible to prevent the same output content from being simultaneously output from the plurality of network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

Moreover, since the output data and the job tickets are collectively managed by the device using apparatus, it is possible to more strictly manage the output data and the job tickets, compared with a case in which the output data and the job tickets are managed by different apparatuses.

According to a fourth aspect of the invention, in the authentication output system of the third aspect, the output data utilization managing unit prohibits the supply of the output data until the print completion notice or a print interruption notice is received. When the print interruption notice is received, the output data utilization managing unit restores the contents of the job tickets to the original states before the update. When the output of the output data from the network devices is interrupted, the output control unit prohibits the use of the output data and transmits the print interruption notice to the device using apparatus.

According to this structure, in the device using apparatus, the supply of the output data is prohibited until the print completion notice or the print interruption notice is received.

In the network device, when the output of the output data is interrupted, the use of the output data is prohibited, and the print interruption notice is transmitted to the device using apparatus.

In the device using apparatus, when the print interruption notice is received, the output data utilization managing unit restores the contents of the job tickets to the original states before the update.

According to a fifth aspect of the invention, in the authentication output system of the second aspect or the fourth aspect, the device using apparatus further includes an authentication information receiving unit that receives authentication information used for the authentication; and an authenticating unit. Each of the network devices further includes an authentication information acquiring unit that acquires the authentication information; and an authentication information transmitting unit that transmits the authentication information acquired by the authentication information acquiring unit to the device using apparatus. The authenticating unit authenticates the use of the output data on the basis of the authentication information received by the authentication information receiving unit. When it is determined that the use of the output data is authenticated by the authenticating unit, the output data utilization managing unit supplies the output data to one of the plurality of network device, which is a source of the authentication information.

According to this structure, in the network device, when the authentication information acquiring unit acquires the authentication information, the authentication information transmitting unit transmits the acquired authentication information to the device using apparatus.

In the device using apparatus, when the authentication information receiving unit receives the authentication information, the authenticating unit authenticates the use of the output data on the basis of the received authentication information. As a result, when it is determined that the use of the output data is authenticated by the authenticating unit, the output data utilization managing unit supplies the output data to one of the plurality of network device, which is a source of the authentication information.

In this way, when a user inputs proper authentication information to a desired network device, the user can obtain output contents from the network device.

Here, the authentication information acquiring unit has any structure as long as it can acquire the authentication information. For example, the authentication information acquiring unit may receive the authentication information from an input device, or it may acquire or receive the authentication information from, for example, an external terminal. Alternatively, the authentication information acquiring unit reads out the authentication information from, for example, a storage device or a storage media. The storage device and the storage media may be combined with each other, or may be separated from each other. In addition, acquiring includes, for example, at least, input, obtaining, receiving, and reading. The above is similarly applied to authentication output systems according to twelfth, sixty-ninth, and seventy-fifth aspects, network devices according to twenty-fifth, thirtieth, eighty-sixth, eightieth, and one-hundred twenty-ninth aspects, and an output system according to a one-hundred twenty-third aspect.

According to a sixth aspect of the invention, in the authentication output system of the fifth aspect, when it is determined that the use of the output data is authenticated by the authenticating unit and that the job tickets can be updated, the output data utilization managing unit supplies the output data, and prohibits the update of the job tickets until the print interruption notice or the print completion notice is received.

According to this structure, in the device using apparatus, when it is determined that the use of the output data is authenticated by the authenticating unit and that the job tickets can be updated, the output data utilization managing unit supplies the output data. Then, the output data utilization managing unit prohibits the update of the job tickets until the print interruption notice or the print completion notice is received. Therefore, even when the authentication information is received, the output data is not supplied until the print interruption notice or the print completion notice is received.

Here, prohibiting the update includes, for example, prohibiting the update of the job tickets by the request of other network devices. This is similarly applied to the other aspects.

Further, according to a seventh aspect of the invention, in the authentication output system according to any one of the second, fourth to sixth aspects, the device using apparatus further includes a utilization history information generating unit that creates utilization history information indicating a utilization history of the output data, on the basis of the result supplied by the output data utilization managing unit.

According to this structure, in the device using apparatus, the utilization history information generating unit creates utilization history information indicating a utilization history of the output data, on the basis of the result supplied by the output data utilization managing unit.

In this way, it is possible to see how the output data has been used by referring to the utilization history information.

Thus, it is possible to manage a copyright. In addition, it is possible to confirm that a permitted number of copies are output or only an authorized user performs an output process.

Furthermore, according to an eighth aspect of the invention, an authentication output system includes first and second network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data transmitting unit that transmits the output data to the first network device. The first network device includes an output data storage unit; a first output data receiving unit that receives the output data; an output data holding unit that stores the output data received by the first output data receiving unit in the output data storage unit; a job ticket storage unit that stores job tickets specifying contents related to whether to permit or restrict the use of the output data; an output data utilization managing unit that manages the use of the output data; and a first output control unit that performs output control on the basis of the output data stored in the output data storage unit. When the authentication succeeds, the output data utilization managing unit supplies the output data stored in the output data storage unit to the second network device, and prohibits the supply and use of the output data until a print completion notice is received. Alternatively, the output data utilization managing unit requires the first output control unit to output the output data, prohibits the supply of the output data until the output of the output data from the first network device is completed, updates the job tickets stored in the job ticket storage unit when the print completion notice is received or when the output of the output data from the first network device is completed, and prohibits the supply and use of the output data when it is determined that the contents of the job tickets satisfy predetermined conditions. The first output control unit performs the output process on the basis of the output data, according to the output request. The second network device includes a second output data receiving unit that receives the output data; and a second output control unit that performs output control on the basis of the output data received by the second output data receiving unit. When the output of the output data from the second network device is completed, the second output control unit transmits the print completion notice to the first network device.

According to this structure, in the device using apparatus, the output data transmitting unit transmits the output data to the first network device.

In the first network device, when the first output data receiving unit receives the output data, the output data holding unit stores the received output data in the output data storage unit. Then, when the authentication succeeds, the output data utilization managing unit supplies the output data to the second network device, or requests the first network device to output the output data. In the former case, the supply and use of the output data are prohibited until the print completion notice is received.

In the second network device, when the second output data receiving unit receives the output data, the second output control unit performs output control on the basis of the received output data. When the output of the output data is completed, the print completion notice is transmitted to the first network device.

In the first network device, when the print completion notice is received, the output data utilization managing unit updates the job tickets.

Meanwhile, in the first network device, when the output request is performed on the first output control unit, the first output control unit performs the output process on the basis of the output data. Then, the output data utilization managing unit prohibits the supply of the output data until the output of the output data is completed. When the output of the output data is completed, the job tickets are updated.

Further, in the first network device, the output data utilization managing unit prohibits the supply and use of the output data when it is determined that the contents of the job tickets satisfy predetermined conditions.

In this way, when the output of the output data is completed, the job tickets are updated. Therefore, even when the output of the output data from one of the first and second network devices is interrupted due to a trouble, it is possible to obtain output contents from the other network device. In addition, only an authorized user can obtain an output matter.

In addition, the output data is supplied to the second network device, or the output data is used for the first network device. Therefore, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

Moreover, since the output data and the job tickets are collectively managed by the first network device, it is possible to more strictly manage the output data and the job tickets, compared with a case in which the output data and the job tickets are managed by different apparatuses.

Further, when it is determined that the contents of the job tickets satisfy predetermined conditions, the supply of the output data is prohibited. In this case, prohibiting the supply and use of the output data includes, for example, removing the output data, rejecting a request for the supply or use of the output data, rewriting the attribute of the output data into ‘unavailable’, and encoding the output data such that the output data cannot be read. The above is similarly applied to an authentication output system according to a tenth aspect, network devices according to twenty-sixth and twenty-eighth aspects, output control programs according to forty-fourth and forty-sixth aspects, and authentication output methods according to fifty-ninth and sixty-first aspects.

Furthermore, in the case in which the supply and use of the output data are prohibited until the print completion notice is received or the supply of the output data is prohibited until the output of the output data is completed, prohibiting the supply or use of the output data includes, for example, rejecting a request for the supply or use of the output data, rewriting the attribute of the output data into ‘unavailable’, and encoding the output data such that the output data cannot be read. The above is similarly applied to the authentication output system according to the tenth aspect, the network devices according to the twenty-sixth and twenty-eighth aspects, the output control programs according to the forty-fourth and forty-sixth aspects, and the authentication output methods according to the fifty-ninth and sixty-first aspects.

Further, updating the job tickets includes, for example, prescribing the number of supplies or utilizations of the output data, decrementing the number of supplies or utilizations of the output data whenever the supply or utilization is performed, and incrementing the number of supplies or utilizations of the output data whenever the supply or utilization is performed. The above is similarly applied to the authentication output system according to the eleventh, aspect, the network devices according to the twenty-seventh, twenty-ninth, one-hundred twenty-seventh, and one-hundred twenty-eighth aspects, output control programs according to forty-fifth, forty-seventh, one-hundred thirty-third, and one-hundred thirty-fourth aspects, authentication output methods according to sixtieth and sixty-second aspects, the output systems according to one-hundred twenty-first and one-hundred twenty-second aspects, and output method according to one-hundred thirty-ninth and one-hundred fortieth.

Further, according to a ninth aspect of the invention, in the authentication output system of the eighth aspect, the output data utilization managing unit prohibits the supply and use of the output data until the print completion notice or a print interruption notice is received. Alternatively, the output data utilization managing unit prohibits the supply of the output data until the output of the output data from the first network device is interrupted or completed. When the output of the output data from the second network device is interrupted, the second output control unit prohibits the use of the output data and transmits the print interruption notice to the first network device.

According to this structure, in the first network device, when the authentication succeeds, the output data utilization managing unit supplies the output data to the second network device, or requests the first network device to output the output data. In the former case, the supply and use of the output data are prohibited until the print interruption notice or the print completion notice is received.

In the second network device, when the output of the output data is interrupted, the use of the output data is prohibited, and the print interruption notice is transmitted to the first network device.

Meanwhile, in the first network device, the output data utilization managing unit prohibits the supply of the output data until the output of the output data is interrupted or completed.

Here, when the output of the output data is interrupted, the use of the output data is prohibited. In this case, prohibiting the supply and use of the output data includes, for example, removing the output data, rejecting a request for the supply or use of the output data, rewriting the attribute of the output data into ‘unavailable’, and encoding the output data such that the output data cannot be read. This is similarly applied to the authentication output system according to the eleventh, aspect, the network devices according to the twenty-seventh and twenty-ninth aspects, the output control programs according to the forty-fifth and forty-seventh aspects, and the authentication output methods according to the sixtieth and sixty-second aspects.

Further, in the case in which the supply and use of the output data are prohibited until the print interruption notice or the print completion notice is received or the supply of the output data is prohibited until the output of the output data is interrupted or completed, prohibiting the supply or use of the output data includes, for example, rejecting a request for the supply or use of the output data, rewriting the attribute of the output data into ‘unavailable’, and encoding the output data such that the output data cannot be read. This is similarly applied to the authentication output system according to the eleventh aspect, the network devices according to the twenty-seventh, twenty-ninth, one-hundred twenty-seventh, and one-hundred twenty-eighth aspects, the output control programs according to the forty-fifth, forty-seventh, one-hundred thirty-third, and one-hundred thirty-fourth aspects, the authentication output methods according to the sixtieth and sixty-second aspects, the output systems according to the one-hundred twenty-first and one-hundred twenty-second aspects, and the output methods according to the one-hundred thirty-ninth and one-hundred fortieth aspects.

Further, according to a tenth aspect of the invention, an authentication output system includes first and second network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data transmitting unit that transmits the output data to the first network device. The first network device includes an output data storage unit; a first output data receiving unit that receives the output data; an output data holding unit that stores the output data received by the first output data receiving unit in the output data storage unit; a job ticket storage unit that stores job tickets specifying contents related to whether to permit or restrict the use of the output data; an output data utilization managing unit that manages the use of the output data; and a first output control unit that performs output control on the basis of the output data stored in the output data storage unit. When the authentication succeeds, the output data utilization managing unit supplies the output data stored in the output data storage unit to the second network device, updates the job tickets stored in the job ticket storage unit, and prohibits the supply and use of the output data until a print completion notice is received. Alternatively, the output data utilization managing unit requires the first output control unit to output the output data, updates the job tickets stored in the job ticket storage unit, prohibits the supply of the output data until the output of the output data from the first network device is completed, and prohibits the supply and use of the output data when it is determined that the contents of the job tickets satisfy predetermined conditions. The first output control unit performs the output process on the basis of the output data, according to the output request. The second network device includes a second output data receiving unit that receives the output data; and a second output control unit that performs output control on the basis of the output data received by the second output data receiving unit. When the output of the output data from the second network device is completed, the second output control unit transmits the print completion notice to the first network device.

According to this structure, in the device using apparatus, the output data transmitting unit transmits the output data to the first network device.

In the first network device, when the first output data receiving unit receives the output data, the output data holding unit stores the received output data in the output data storage unit. Then, when the authentication succeeds, the output data utilization managing unit supplies the output data to the second network device, or requests the first network device to output the output data. In the former case, the job tickets are updated, and the supply and use of the output data are prohibited until the print completion notice is received.

In the second network device, when the second output data receiving unit receives the output data, the second output control unit performs output control on the basis of the received output data. When the output of the output data is completed, the print completion notice is transmitted to the first network device.

In the first network device, when an output request is performed on the first network device, the output data utilization managing unit updates the job tickets, and the first control unit performs the output process on the basis of the output data. Then, the output data utilization managing unit prohibits the supply of the output data until the output of the output data is completed.

Further, in the first network device, the output data utilization managing unit prohibits the supply and use of the output data when it is determined that the contents of the job tickets satisfy predetermined conditions.

In this way, when the output of the output data is completed, the job tickets are updated. Therefore, even when the output of the output data from one of the first and second network devices is interrupted due to a trouble, it is possible to obtain output contents from the other network device. In addition, only an authorized user can obtain an output matter.

In addition, the output data is supplied to the second network device, or the output data is used for the first network device. Therefore, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

Moreover, since the output data and the job tickets are collectively managed by the first network device, it is possible to more strictly manage the output data and the job tickets, compared with a case in which the output data and the job tickets are managed by different apparatuses.

Further, according to the eleventh aspect of the invention, in the authentication output system of the tenth aspect, the output data utilization managing unit prohibits the supply and use of the output data until the print completion notice or a print interruption notice is received. Alternatively, the output data utilization managing unit prohibits the supply of the output data until the output of the output data from the first network device is interrupted or completed, and restores the contents of the job tickets to the original states before the update when the print interruption notice is received or when the output of the output data from the first network device is interrupted. When the output of the output data from the second network device is interrupted, the second output control unit prohibits the use of the output data and transmits the print interruption notice to the first network device.

According to this structure, in the first network device, when the authentication succeeds, the output data utilization managing unit supplies the output data to the second network device, or requests the first network device to output the output data. In the former case, the job tickets are updated, and the supply and use of the output data are prohibited until the print interruption notice or the print completion notice is received.

In the second network device, when the output of the output data is interrupted, the use of the output data is prohibited, and the print interruption notice is transmitted to the first network device.

In the first network device, when the print interruption notice is received, the output data utilization managing unit restores the contents of the job tickets to the original state before the update.

Meanwhile, in the first network device, the output data utilization managing unit prohibits the supply of the output data until the output of the output data is interrupted or completed. When the output is interrupted, the contents of the job tickets are restored to the state before the update.

According to the twelfth aspect of the invention, in the authentication output system of the ninth aspect or the eleventh aspect, the first network device further includes an authentication information receiving unit that receives authentication information used for the authentication; a first authentication information acquiring unit that acquires the authentication information; and an authenticating unit. The second network device further includes a second authentication information acquiring unit that acquires the authentication information; and an authentication information transmitting unit that transmits the authentication information acquired by the second authentication information acquiring unit to the first network device. The authenticating unit authenticates the use of the output data on the basis of the authentication information received by the authentication information receiving unit and the authentication information acquired by the first authentication information acquiring unit. When it is determined that the use of the output data is authenticated by the authenticating unit, on the basis of the authentication information received by the authentication information receiving unit, the output data utilization managing unit supplies the output data to the second network device. In addition, when it is determined that the use of the output data is authenticated by the authenticating unit on the basis of the authentication information acquired by the first authentication information acquiring unit, the output data utilization managing unit requires the first output control unit to output the output data.

According to this structure, in the second network device, when the authentication information is acquired by the second authentication information acquiring unit, the authentication information transmitting unit transmits the acquired authentication information to the first network device.

In the first network device, when the authentication information is received by the authentication information receiving unit, the use of the output data is authenticated by the authenticating unit on the basis of the received authentication information. As a result, when it is determined that the use of the output data is permitted, the output data utilization managing unit supplies the output data to the second network device.

Further, in the first network device, when the first authentication information acquiring unit acquires the authentication information, the use of the output data is authenticated on the basis of the acquired authentication information. As a result, when the use of the output data is permitted, the output data utilization managing unit requests the first network device to output the output data.

In this way, the same effects as those in the fifth aspect are obtained.

Furthermore, according to a thirteenth aspect of the invention, in the authentication output system of the twelfth aspect, when it is determined that the use of the output data is authenticated by the authenticating unit on the basis of the authentication information received by the authentication information receiving unit and that the job tickets can be updated, the output data utilization managing unit supplies the output data, and prohibits the update of the job tickets until the print interruption notice or the print completion notice is received. In addition, when it is determined that the use of the output data is authenticated by the authenticating unit, on the basis of the authentication information acquired by the first authentication information acquiring unit and that the job tickets can be updated, the output data utilization managing unit performs an output request and prohibits the update of the job tickets until the output of the output data from the first network device is interrupted or completed.

According to this structure, in the first network device, when it is determined that the use of the output data is authenticated by the authenticating unit on the basis of the received authentication information and that the job tickets can be updated, the output data utilization managing unit supplies the output data to the second network device, and prohibits the update of the job tickets until the print interruption notice or the print completion notice is received.

In addition, in the first network device, when it is determined that the use of the output data is authenticated on the basis of the acquired authentication information and that the job tickets can be updated, the output data utilization managing unit requests the first network device to output the output data, and prohibits the update of the job tickets until the output of the output data is interrupted or completed.

Therefore, until the print interruption notice or the print completion notice is received or until the output of the output data is interrupted or completed, the output data is not supplied even though the authentication information is received, and the output of the output data is not performed even though the authentication information is acquired.

Further, according to a fourteenth aspect of the invention, in the authentication output system according to any one of the ninth, eleventh to thirteenth aspects, the first network device further includes a utilization history information generating unit that creates utilization history information indicating a utilization history of the output data, on the basis of a utilization result and a supply result of the output data utilization managing unit.

According to this structure, in the first network device, the utilization history information generating unit creates the utilization history information indicating the utilization history of the output data, on the basis of the utilization result and the supply result of the output data utilization managing unit.

In this way, the same effects as those in the seventh aspect are obtained.

Moreover, according to a fifth aspect of the invention, in the authentication output system according to any one of the second aspect, the fourth to seventh aspects, the ninth aspect, and the eleventh to fourteenth aspects, when it is determined that the contents of the job tickets satisfy the predetermined conditions, the output data utilization managing unit removes the output data and the job tickets.

According to this structure, when it is determined that the contents of the job tickets satisfy the predetermined conditions, the output data utilization managing unit removes the output data and the job tickets.

In this way, it is possible to prevent the output data and the job tickets from being illegally used, and thus to reliably protect the secrecy of the output contents.

According to the sixteenth aspect of the invention, there is provided a device using apparatus that uses a plurality of network devices. The device using apparatus includes an output data storage unit that stores output data; a job ticket storage unit that stores job tickets specifying contents related to whether to permit or restrict the use of the output data; and an output data utilization managing unit that manages the use of the output data. In the device using apparatus, when authentication succeeds, the output data utilization managing unit supplies the output data stored in the output data storage unit to any one of the plurality of network devices, and prohibits the supply of the output data until a print completion notice is received. When the print completion notice is received, the output data utilization managing unit updates the job tickets stored in the job ticket storage unit. When it is determined that the contents of the job tickets satisfy predetermined conditions, the output data utilization managing unit prohibits the supply of the output data.

According to this structure, the same operations as those in the device using apparatus of the authentication output system according to the first aspect are obtained. Thus, the same effects as those in the authentication output system according to the first aspect are obtained.

Further, according to the seventh aspect of the invention, in the device using apparatus of the sixteenth aspect, the output data utilization managing unit prohibits the supply of the output data until the print completion notice or the print interruption notice is received.

According to this structure, the same operations as those in the device using apparatus of the authentication output system according to the second aspect are obtained. Thus, the same effects as those in the authentication output system according to the second aspect are obtained.

Furthermore, according to the eighteenth aspect of the invention, there is provided a device using apparatus that uses a plurality of network devices. The device using apparatus includes an output data storage unit that stores output data; a job ticket storage unit that stores job tickets specifying contents related to whether to permit or restrict the use of the output data; and an output data utilization managing unit that manages the use of the output data. In the device using apparatus, when authentication succeeds, the output data utilization managing unit supplies the output data stored in the output data storage unit to any one of the plurality of network devices, updates the job tickets stored in the job ticket storage unit, and prohibits the supply of the output data until a print completion notice is received. When it is determined that the contents of the job tickets satisfy predetermined conditions, the output data utilization managing unit prohibits the supply of the output data.

According to this structure, the same operations as those in the device using apparatus of the authentication output system according to the third aspect are obtained. Thus, the same effects as those in the authentication output system according to the third aspect are obtained.

Further, according to the nineteenth aspect of the invention, in the device using apparatus of the eighteenth aspect, the output data utilization managing unit prohibits the supply of the output data until the print completion notice or a print interruption notice is received. When the print interruption notice is received, the output data utilization managing unit restores the contents of the job tickets to the original states before the update.

According to this structure, the same operations as those in the device using apparatus of the authentication output system according to the fourth aspect are obtained. Thus, the same effects as those in the authentication output system according to the fourth aspect are obtained.

Moreover, according to a twentieth aspect of the invention, the authentication output system of the seventeenth aspect or the nineteenth aspect further includes an authentication information receiving unit that receives authentication information used for the authentication; and an authenticating unit. The authenticating unit authenticates the use of the output data on the basis of the authentication information received by the authentication information receiving unit. When it is determined that the use of the output data is authenticated by the authenticating unit, the output data utilization managing unit supplies the output data to one of the plurality of network device, which is a source of the authentication information.

According to this structure, the same operations as those in the device using apparatus of the authentication output system according to the fifth aspect are obtained. Thus, the same effects as those in the authentication output system according to the fifth aspect are obtained.

Further, according to a twenty-first aspect of the invention, in the device using apparatus of the twentieth aspect, when it is determined that the use of the output data is authenticated by the authenticating unit and that the job tickets can be updated, the output data utilization managing unit supplies the output data, and prohibits the update of the job tickets until the print interruption notice or the print completion notice is received.

According to this structure, the same operations as those in the device using apparatus of the authentication output system according to the sixth aspect are obtained. Thus, the same effects as those in the authentication output system according to the sixth aspect are obtained.

Furthermore, according to a twenty-second aspect of the invention, the device using apparatus according to any one of the seventeen, nineteenth to twenty-first aspects further includes a utilization history information generating unit that creates utilization history information indicating a utilization history of the output data, on the basis of the result supplied by the output data utilization managing unit.

According to this structure, the same operations as those in the device using apparatus of the authentication output system according to the seventh aspect are obtained. Thus, the same effects as those in the authentication output system according to the seventh aspect are obtained.

Moreover, according to the twenty-third aspect of the invention, there is provided a network device that performs an output process on the basis of output data. The network device includes an output data receiving unit that receives the output data; and an output control unit that performs output control on the basis of the output data received by the output data receiving unit. When the network device completely outputs the output data, the output control unit transmits a print completion notice to a device using apparatus.

According to this structure, the same operations as those in the network device of the authentication output system according to the first aspect are obtained. Thus, the same effects as those in the authentication output system according to the first aspect are obtained.

Furthermore, according to the twenty-fourth aspect of the invention, in the network device of the twenty-third aspect, when the output of the output data from the network devices is interrupted, the output control unit prohibits the use of the output data and transmits the print interruption notice to the device using apparatus.

According to this structure, the same operations as those in the network device of the authentication output system according to the second aspect are obtained. Thus, the same effects as those in the authentication output system according to the second aspect are obtained.

Moreover, according to a twenty-fifth aspect of the invention, the network device of the twenty-fourth aspect includes an authentication information acquiring unit that acquires the authentication information; and an authentication information transmitting unit that transmits the authentication information acquired by the authentication information acquiring unit to the device using apparatus.

According to this structure, the same operations as those in the network device of the authentication output system according to the fifth aspect are obtained. Thus, the same effects as those in the authentication output system according to the fifth aspect are obtained.

Further, according to a twenty-sixth aspect of the invention, there is provided a network device that performs an output process on the basis of output data. The network device includes an output data storage unit; an output data receiving unit that receives the output data; an output data holding unit that stores the output data received by the output data receiving unit in the output data storage unit; a job ticket storage unit that stores job tickets specifying contents related to whether to permit or restrict the use of the output data; an output data utilization managing unit that manages the use of the output data; and an output control unit that performs output control on the basis of the output data stored in the output data storage unit. In the network device, when the authentication succeeds, the output data utilization managing unit supplies the output data stored in the output data storage unit to another network device, and prohibits the supply and use of the output data until a print completion notice is received. Alternatively, the output data utilization managing unit requires the output control unit to output the output data, prohibits the supply of the output data until the output of the output data from the network device is completed, updates the job tickets stored in the job ticket storage unit when the print completion notice is received or when the output of the output data from the network device is completed, and prohibits the supply and use of the output data when it is determined that the contents of the job tickets satisfy predetermined conditions. The output control unit performs the output process on the basis of the output data, according to the output request.

According to this structure, the same operations as those in the first network device of the authentication output system according to the eighth aspect are obtained. Thus, the same effects as those in the authentication output system according to the eighth aspect are obtained.

Further, according to the twenty-seventh aspect of the invention, in the network device of the twenty-sixth aspect, the output data utilization managing unit prohibits the supply and use of the output data until the print completion notice or a print interruption notice is received, or the output data utilization managing unit prohibits the supply of the output data until the output of the output data from the network device is interrupted or completed.

According to this structure, the same operations as those in the first network device of the authentication output system according to the ninth aspect are obtained. Thus, the same effects as those in the authentication output system according to the ninth aspect are obtained.

Furthermore, according to a twenty-eighth aspect of the invention, there is provided a network device that performs an output process on the basis of output data. The network device includes an output data storage unit; an output data receiving unit that receives the output data; an output data holding unit that stores the output data received by the output data receiving unit in the output data storage unit; a job ticket storage unit that stores job tickets specifying contents related to whether to permit or restrict the use of the output data; an output data utilization managing unit that manages the use of the output data; and an output control unit that performs output control on the basis of the output data stored in the output data storage unit. In the network device, when authentication succeeds, the output data utilization managing unit supplies the output data stored in the output data storage unit to another network device, updates the job tickets stored in the job ticket storage unit, and prohibits the supply and use of the output data until a print completion notice is received. Alternatively, the output data utilization managing unit requires the output control unit to output the output data, updates the job tickets stored in the job ticket storage unit, prohibits the supply of the output data until the output of the output data from the first network device is completed, and prohibits the supply and use of the output data when it is determined that the contents of the job tickets satisfy predetermined conditions. The output control unit performs the output process on the basis of the output data, according to the output request.

According to this structure, the same operations as those in the first network device of the authentication output system according to the tenth aspect are obtained. Thus, the same effects as those in the authentication output system according to the tenth aspect are obtained.

Moreover, according to the twenty-ninth aspect of the invention, in the network device of the twenty-eighth aspect, the output data utilization managing unit prohibits the supply and use of the output data until the print completion notice or a print interruption notice is received. Alternatively, the output data utilization managing unit prohibits the supply of the output data until the output of the output data from the network device is interrupted or completed, and restores the contents of the job tickets to the original states before the update when the print interruption notice is received or when the output of the output data from the first network device is interrupted.

According to this structure, the same operations as those in the first network device of the authentication output system according to the eleventh aspect are obtained. Thus, the same effects as those in the authentication output system according to the eleventh aspect are obtained.

Further, according to a thirtieth aspect of the invention, the network device of the twenty-seventh aspect or the twenty-ninth aspect includes an authentication information receiving unit that receives authentication information used for the authentication; an authentication information acquiring unit that acquires the authentication information; and an authenticating unit. The authenticating unit authenticates the use of the output data on the basis of the authentication information received by the authentication information receiving unit and the authentication information acquired by the authentication information acquiring unit. When it is determined that the use of the output data is authenticated by the authenticating unit, on the basis of the authentication information received by the authentication information receiving unit, the output data utilization managing unit supplies the output data to another network device. When it is determined that the use of the output data is authenticated by the authenticating unit on the basis of the authentication information acquired by the authentication information acquiring unit, the output data utilization managing unit requires the output control unit to output the output data.

According to this structure, the same operations as those in the first network device of the authentication output system according to the twelfth aspect are obtained. Thus, the same effects as those in the authentication output system according to the twelfth aspect are obtained.

Furthermore, according to a thirty-first aspect of the invention, in the network device of the thirtieth aspect, when it is determined that the use of the output data is authenticated by the authenticating unit on the basis of the authentication information received by the authentication information receiving unit and that the job tickets can be updated, the output data utilization managing unit supplies the output data, and prohibits the update of the job tickets until the print interruption notice or the print completion notice is received. When it is determined that the use of the output data is authenticated by the authenticating unit, on the basis of the authentication information acquired by the authentication information acquiring unit and that the job tickets can be updated, the output data utilization managing unit performs an output request and prohibits the update of the job tickets until the output of the output data from the network device is interrupted or completed.

According to this structure, the same operations as those in the first network device of the authentication output system according to the thirteenth aspect are obtained. Thus, the same effects as those in the authentication output system according to the thirteenth aspect are obtained.

Moreover, according to a thirty-second aspect of the invention, the network device according to any one of the twenty-seventh, twenty-ninth to thirty-first aspects further includes a utilization history information generating unit that creates utilization history information indicating a utilization history of the output data, on the basis of a utilization result and a supply result of the output data utilization managing unit.

According to this structure, the same operations as those in the first network device of the authentication output system according to the fourteenth aspect are obtained. Thus, the same effects as those in the authentication output system according to the fourteenth aspect are obtained.

Further, according to a thirty-third aspect of the invention, in the network device according to any one of the twenty-fourth, twenty-fifth, twenty-seventh, twenty-ninth to thirty-second aspects, when it is determined that the contents of the job tickets satisfy the predetermined conditions, the output data utilization managing unit removes the output data and the job tickets.

According to this structure, the same operations as those in the first network device of the authentication output system according to the fifteenth aspect are obtained. Thus, the same effects as those in the authentication output system according to the fifteenth aspect are obtained.

Furthermore, according to the thirty-fourth aspect of the invention, there is provided an output data managing program that manages output data used for a plurality of network devices. The output data managing program includes a program that allows a computer to execute a process including an output data utilization managing step of managing the use of the output data. In the output data utilization managing step, when authentication succeeds in an authenticating step, the output data stored in an output data storage unit that stores the output data is supplied to any one of the plurality of network devices, and the supply of the output data is prohibited until a print completion notice is received. When the print completion notice is received, job tickets stored in a job ticket storage unit that stores the job tickets specifying contents related to whether to permit or restrict the use of the output data are updated. When it is determined that the contents of the job tickets satisfy predetermined conditions, the supply of the output data is prohibited.

According to this configuration, when the computer reads out the program to perform the process according to the read program, the same operations and effects as those in the device using apparatus according to the sixteenth aspect are obtained.

Moreover, according to a thirty-fifth aspect of the invention, in the output data managing program of the thirty-fourth aspect, in the output data utilization managing step, the supply of the output data is prohibited until the print completion notice or a print interruption notice is received.

According to this configuration, when the computer reads out the program to perform the process according to the read program, the same operations and effects as those in the device using apparatus according to the seventeenth aspect are obtained.

Further, according to the thirty-sixth aspect of the invention, there is provided an output data managing program that manages output data used for a plurality of network devices. The output data managing program includes a program that allows a computer to execute a process including an output data utilization managing step of managing the use of the output data. In the output data utilization managing step, when authentication succeeds in an authenticating step, the output data stored in an output data storage unit that stores the output data is supplied to any one of the plurality of network devices, job tickets stored in a job ticket storage unit that stores the job tickets specifying contents related to whether to permit or restrict the use of the output data are updated, and the supply of the output data is prohibited until a print completion notice is received. When it is determined that the contents of the job tickets satisfy predetermined conditions, the supply of the output data is prohibited.

According to this configuration, when the computer reads out the program to perform the process according to the read program, the same operations and effects as those in the device using apparatus according to the eighteenth aspect are obtained.

Furthermore, according to the thirty-seventh aspect of the invention, in the output data managing program of the thirty-sixth aspect, in the output data utilization managing step, the supply of the output data is prohibited until a print interruption notice or the print completion notice is received. When the print interruption notice is received, the contents of the job tickets are restored to the original states before the update.

According to this configuration, when the computer reads out the program to perform the process according to the read program, the same operations and effects as those in the device using apparatus according to the nineteenth aspect are obtained.

Moreover, according to a thirty-eighth aspect of the invention, the output data managing program of the thirty-fifth aspect or the thirty-seventh aspect includes a program that allows a computer to execute a process composed of an authentication information receiving step of receiving authentication information used for authentication and the authenticating step. In the authenticating step, the use of the output data is authenticated on the basis of the authentication information received in the authentication information receiving step. In the output data utilization managing step, when it is determined that the use of the output data is authenticated in the authenticating step, the output data is supplied to one of the plurality of network device, which is a source of the authentication information.

According to this configuration, when the computer reads out the program to perform the process according to the read program, the same operations and effects as those in the device using apparatus according to the twentieth aspect are obtained.

Further, according to a thirty-ninth aspect of the invention, in the output data managing program of the thirty-eighth aspect, in the output data utilization managing step, when it is determined that the use of the output data is authenticated in the authenticating step and that the job tickets can be updated, the output data is supplied, and the update of the job tickets is prohibited until the print interruption notice or the print completion notice is received.

According to this configuration, when the computer reads out the program to perform the process according to the read program, the same operations and effects as those in the device using apparatus according to the twenty-first aspect are obtained.

Furthermore, according to a fortieth aspect of the invention, the output data managing program according to any one of the thirty-fifth, thirty-seventh to thirty-ninth aspects further includes a program that allows a computer to execute a process composed of a utilization history information generating step of generating utilization history information indicating a utilization history of the output data, on the basis of the result supplied in the output data utilization managing step.

According to this configuration, when the computer reads out the program to perform the process according to the read program, the same operations and effects as those in the device using apparatus according to the twenty-second aspect are obtained.

Moreover, according to the forty-first aspect of the invention, there is provided an output control program that performs an output process on the basis of output data. The output control program includes a program that allows a computer to execute a process including an output data receiving step of receiving the output data and an output control step of performing output control on the basis of the output data received in the output data receiving step. In the output control step, when the output of the output data is completed, a print completion notice is transmitted to a device using apparatus.

According to this configuration, when the computer reads out the program to perform the process according to the read program, the same operations and effects as those in the network device according to the twenty-third aspect are obtained.

In this configuration, in the output control step, the output control may be performed on the output data, and the output control step includes, for example, performing the output control on a printing unit that performs a printing process on the basis of print data, a display unit that performs display on the basis of display data, or a voice output unit that outputs a voice on the basis of audio data. This is similarly applied to output control programs according to forty-fourth, forty-sixth, hundredth, one-hundred third, one-hundred fourth, one-hundred thirty-third, and one-hundred thirty-fourth aspects, authentication output methods according to fifty-second, fifty-fourth, fifty-ninth, sixty-first, one-hundred ninth, one-hundred tenth, one-hundred fifteenth, and one-hundred sixteenth aspects, and output methods according to one-hundred thirty-ninth and one-hundred fortieth aspects.

Further, according to the forty-second aspect of the invention, in the output control program of the forty-first aspect, in the output control step, when the output of the output data is interrupted, the use of the output data is prohibited, and the print interruption notice is transmitted to the device using apparatus.

According to this configuration, when the computer reads out the program to perform the process according to the read program, the same operations and effects as those in the network device according to the twenty-fourth aspect are obtained.

Furthermore, according to a forty-third aspect of the invention, the output control program of the forty-second aspect further includes a program that allows a computer to execute a process composed of an authentication information acquiring step of acquiring the authentication information; and an authentication information transmitting step of transmitting the authentication information acquired in the authentication information acquiring step to the device using apparatus.

According to this configuration, when the computer reads out the program to perform the process according to the read program, the same operations and effects as those in the network device according to the twenty-fifth aspect are obtained.

Here, the authentication information acquiring step has any configuration as long as the authentication information can be acquired. For example, the authentication information may be input from an input device, or the authentication information may be acquired or received from, for example, an external terminal. Alternatively, the authentication information may be read out from, for example, a storage device or a storage media. The storage device and the storage media may be combined with each other, or may be separated from each other. In addition, acquiring includes, for example, at least, input, obtaining, receiving, and reading. This is similarly applied to output control programs according to forty-eight, one-hundred first, one-hundred fifth, and one-hundred thirty-fifth aspects, authentication output methods according to fifty-sixth, sixty-third, one-hundred eleventh, and one-hundred seventeenth aspects, and an output method according to a one-hundred forty-first aspect.

Moreover, according to a forty-fourth aspect of the invention, there is provided an output control program that performs an output process on the basis of output data. The output control program includes a program that allows a computer to execute a process composed of an output data receiving step of receiving the output data; an output data storing step of storing the output data received in the output data receiving step in an output data storage unit; an output data utilization managing step of managing the use of the output data; and an output control step of performing output control on the basis of the output data stored in the output data storage unit. In the output data utilization managing step, when authentication succeeds in an authenticating step, the output data stored in the output data storage unit is supplied to another network device, and the supply and use of the output data are prohibited until a print completion notice is received. Alternatively, the output of the output data is requested in the output control step, the supply of the output data is prohibited until the output data is completely output, job tickets stored in a job ticket storage unit that stores the job tickets specifying contents related to whether to permit or restrict the use of the output data are updated when the print completion notice is received or when the output data is completely output, and the supply and use of the output data are prohibited when it is determined that the contents of the job tickets satisfy predetermined conditions. In the output control step, the output process is performed on the basis of the output data, according to the output request.

According to this configuration, when the computer reads out the program to perform the process according to the read program, the same operations and effects as those in the network device according to the twenty-sixth aspect are obtained.

Furthermore, according to the forty-fifth aspect of the invention, in the output control program of the forty-fourth aspect, in the output data utilization managing step, the supply and use of the output data are prohibited until the print completion notice or a print interruption notice is received. Alternatively, the supply of the output data is prohibited until the output of the output data is interrupted or completed.

According to this configuration, when the computer reads out the program to perform the process according to the read program, the same operations and effects as those in the network device according to the twenty-seventh aspect are obtained.

Moreover, according to the forty-sixth aspect of the invention, there is provided an output control program that performs an output process on the basis of output data. The output control program includes a program that allows a computer to execute a process composed of an output data receiving step of receiving the output data; an output data storing step of storing the output data received in the output data receiving step in an output data storage unit; an output data utilization managing step of managing the use of the output data; and an output control step of performing output control on the basis of the output data stored in the output data storage unit. In the output data utilization managing step, when authentication succeeds in an authenticating step, the output data stored in the output data storage unit is supplied to another network device, job tickets stored in a job ticket storage unit that stores the job tickets specifying contents related to whether to permit or restrict the use of the output data are updated, and the supply and use of the output data are prohibited until a print completion notice is received. Alternatively, the output of the output data is requested in the output control step, the job tickets stored in the job ticket storage unit are updated, the supply of the output data is prohibited until the output of the output data is completely, and the supply and use of the output data are prohibited when it is determined that the contents of the job tickets satisfy predetermined conditions. In the output control step, the output process is performed on the basis of the output data, according to the output request.

According to this configuration, when the computer reads out the program to perform the process according to the read program, the same operations and effects as those in the network device according to the twenty-eighth aspect are obtained.

Further, according to the forty-seventh aspect of the invention, in the output control program of the forty-sixth aspect, in the output data utilization managing step, the supply and use of the output data are prohibited until the print completion notice or a print interruption notice is received. Alternatively, the supply of the output data is prohibited until the output of the output data is interrupted or completed, and the contents of the job tickets are restored to the original states before the update when the print interruption notice is received or when the output of the output data is interrupted.

According to this configuration, when the computer reads out the program to perform the process according to the read program, the same operations and effects as those in the network device according to the twenty-ninth aspect are obtained.

Furthermore, according to a forty-eighth aspect of the invention, the output control program of the forty-fifth aspect or the forty-seventh aspect further includes a program that allows a computer to execute a process composed of an authentication information receiving step of receiving authentication information used for the authentication; an authentication information acquiring step of acquiring the authentication information; and the authenticating step. In the authenticating step, the use of the output data is authenticated on the basis of the authentication information received in the authentication information receiving step and the authentication information received in the authentication information acquiring step. In the output data utilization managing step, when it is determined that the use of the output data is authenticated in the authenticating step, on the basis of the authentication information received in the authentication information receiving step, the output data is supplied to another network device. When it is determined that the use of the output data is authenticated in the authenticating unit on the basis of the authentication information acquired in the authentication information acquiring step, the output request is performed in the output control step.

According to this configuration, when the computer reads out the program to perform the process according to the read program, the same operations and effects as those in the network device according to the thirtieth aspect are obtained.

Moreover, according to a forty-ninth aspect of the invention, in the output control program of the forty-eighth aspect, in the output data utilization managing step, when it is determined that the use of the output data is authenticated in the authenticating step on the basis of the authentication information received in the authentication information receiving step and that the job tickets can be updated, the output data is supplied, and the update of the job tickets is prohibited until the print interruption notice or the print completion notice is received. When it is determined that the use of the output data is authenticated in the authenticating step, on the basis of the authentication information acquired in the authentication information acquiring step, and that the job tickets can be updated, the output request is performed, and the update of the job tickets is prohibited until the output of the output data is interrupted or completed.

According to this configuration, when the computer reads out the program to perform the process according to the read program, the same operations and effects as those in the network device according to the thirty-first aspect are obtained.

Further, according to a fiftieth aspect of the invention, the output control program according to any one of the forty-fifth, forty-seventh to forty-ninth aspects further includes a program that allows a computer to execute a process composed of a utilization history information generating step of generating utilization history information indicating a utilization history of the output data, on the basis of a utilization result and a supply result of the output data utilization managing unit.

According to this configuration, when the computer reads out the program to perform the process according to the read program, the same operations and effects as those in the network device according to the thirty-second aspect are obtained.

Furthermore, according to a fifty-first aspect of the invention, in the output control program according to any one of the forty-second, forty-third, forty-fifth, forty-seventh to fiftieth aspects, in the output data utilization managing step, when it is determined that the contents of the job tickets satisfy the predetermined conditions, the output data and the job tickets are removed.

According to this configuration, when the computer reads out the program to perform the process according to the read program, the same operations and effects as those in the network device according to the thirty-third aspect are obtained.

Moreover, according to the fifty-second aspect of the invention, there is provided an authentication output method that performs an output process through authentication in a plurality of network devices each of which performs the output process on the basis of output data, the network devices being connected to a device using apparatus that uses the network devices so as to communicate therewith. The method includes, for the device using apparatus, an output data utilization managing step of supplying, when the authentication succeeds in an authenticating step, the output data stored in an output data storage unit that stores the output data to any one of the plurality of network devices, of prohibiting the supply of the output data until a print completion notice is received, of updating, when the print completion notice is received, job tickets stored in a job ticket storage unit that stores the job tickets specifying contents related to whether to permit or restrict the use of the output data, and of prohibiting the supply of the output data when it is determined that the contents of the job tickets satisfy predetermined conditions. The method includes, for the network devices, an output data receiving step of receiving the output data, and an output control step of transmitting the print completion notice to the device using apparatus when the output of the output data from the network devices is completed.

According to this structure, the same effects as those in the authentication output system according to the first aspect are obtained.

Further, according to the fifty-third aspect of the invention, in the authentication output method of the fifty-second aspect, in the output control step, when the output of the output data from the network device is interrupted, the use of the output data received in the output data receiving step, and the print interruption notice is transmitted to the device using apparatus.

According to this structure, the same effects as those in the authentication output system according to the second aspect are obtained.

Furthermore, according to the fifty-fourth aspect of the invention, there is provided an authentication output method that performs an output process through authentication in a plurality of network devices each of which performs the output process on the basis of output data, the network devices being connected to a device using apparatus that uses the network devices so as to communicate therewith. The method includes, for the device using apparatus, an output data utilization managing step of supplying, when the authentication succeeds in an authenticating step, the output data stored in an output data storage unit that stores the output data to any one of the plurality of network devices, of updating job tickets stored in a job ticket storage unit that stores the job tickets specifying contents related to whether to permit or restrict the use of the output data, of prohibiting the supply of the output data until a print completion notice is received, and of prohibiting the supply of the output data when it is determined that the contents of the job tickets satisfy predetermined conditions. In addition, the method includes, for the network devices, an output data receiving step of receiving the output data; and an output control step of transmitting the print completion notice to the device using apparatus when the output of the output data from the network devices is completed.

According to this structure, the same effects as those in the authentication output system according to the third aspect are obtained.

Moreover, according to the fifty-fifth aspect of the invention, in the authentication output method of the fifty-fourth aspect, in the output data utilization managing step, the supply of the output data is prohibited until the print completion notice or a print interruption notice is received. When the print interruption notice is received, the contents of the job tickets are restored to the original states before the update. In the output control step, when the output of the output data from the network device is interrupted, the use of the output data received in the output data receiving step is prohibited, and the print interruption notice is transmitted to the device using apparatus.

According to this structure, the same effects as those in the authentication output system according to the fourth aspect are obtained.

Further, according to a fifty-sixth aspect of the invention, the authentication output method of the fifty-third aspect or the fifth-fifth aspect further includes, for the network device, an authentication information acquiring step of acquiring authentication information used for the authentication; and an authentication information transmitting step of transmitting the authentication information acquired in the authentication information acquiring step to the device using apparatus. In addition, the method further includes, for the device using apparatus, an authentication information receiving unit that receives the authentication information; and the authenticating step. In the authenticating step, the use of the output data is authenticated on the basis of the authentication information received in the authentication information receiving step. In the output data utilization managing step, when it is determined that the use of the output data is authenticated in the authenticating step, the output data is supplied to one of the plurality of network device, which is a source of the authentication information.

According to this structure, the same effects as those in the authentication output system according to the fifth aspect are obtained.

Furthermore, according to a fifty-seventh aspect of the invention, in the authentication output method of the fifty-sixth aspect, in the output data utilization managing step, when it is determined that the use of the output data is authenticated in the authenticating step and that the job tickets can be updated, the output data is supplied, and the update of the job tickets is prohibited until the print interruption notice or the print completion notice is received.

According to this structure, the same effects as those in the authentication output system according to the sixth aspect are obtained.

Moreover, according to a fifty-eighth aspect of the invention, the authentication output method according to the fifty-third, fifty-fifth to fifty-seventh aspects further includes, for the device using apparatus, a utilization history information generating step of generating utilization history information indicating a utilization history of the output data, on the basis of the result supplied in the output data utilization managing step.

According to this structure, the same effects as those in the authentication output system according to the seventh aspect are obtained.

Further, according to the fifty-ninth aspect of the invention, there is provided an authentication output method that performs an output process through authentication in first and second network devices each of which performs the output process on the basis of output data, the first and second network devices being connected to a device using apparatus that uses the network devices so as to communicate therewith. The method includes, for the device using apparatus, an output data transmitting step of transmitting the output data to the first network device. In addition, the method includes, for the first network device, a first output data receiving step of receiving the output data; an output data storing step of storing the output data received in the first output data receiving step in an output data storage unit; an output data utilization managing step of managing the use of the output data; and a first output control step of performing output control on the basis of the output data stored in the output data storage unit. In the output data utilization managing step, when the authentication succeeds in an authenticating step, the output data stored in the output data storage unit is supplied to the second network device, and the supply and use of the output data are prohibited until a print completion notice is received. Alternatively, the output of the output data is requested in the first output control step, the supply of the output data is prohibited until the output of the output data from the first network device is completed, job tickets stored in a job ticket storage unit that stores the job tickets specifying contents related to whether to permit or restrict the use of the output data are updated when the print completion notice is received or when the output of the output data from the first network device is completed, and the supply and use of the output data are prohibited when it is determined that the contents of the job tickets satisfy predetermined conditions. The output process is performed in the first output control step on the basis of the output data, according to the output request. The method includes, for the second network device, a second output data receiving step of receiving the output data; and a second output control step of transmitting the print completion notice to the first network device when the output of the output data from the second network device is completed.

According to this structure, the same effects as those in the authentication output system according to the eighth aspect are obtained.

Furthermore, according to the sixtieth aspect of the invention, in the authentication output method of the fifty-ninth aspect, in the output data utilization managing step, the supply and use of the output data are prohibited until the print completion notice or a print interruption notice is received. Alternatively, the supply of the output data is prohibited until the output of the output data from the first network device is interrupted or completed. In the second output control step, when the output of the output data from the second network device is interrupted, the use of the output data received in the second output data receiving step is prohibited, and the print interruption notice is transmitted to the first network device.

According to this structure, the same effects as those in the authentication output system according to the ninth aspect are obtained.

Moreover, according to the sixty-first aspect of the invention, there is provided an authentication output method that performs an output process through authentication in first and second network devices each of which performs the output process on the basis of output data, the first and second network devices being connected to a device using apparatus that uses the network devices so as to communicate therewith. The method includes, for the device using apparatus, an output data transmitting step of transmitting the output data to the first network device. In addition, the method includes, for the first network device, a first output data receiving step of receiving the output data; an output data storing step of storing the output data received in the first output data receiving step in an output data storage unit; an output data utilization managing step of managing the use of the output data; and a first output control step of performing output control on the basis of the output data stored in the output data storage unit. In the output data utilization managing step, when the authentication succeeds in an authenticating step, the output data stored in the output data storage unit is supplied to the second network device, job tickets stored in a-job ticket storage unit that stores the job tickets specifying contents related to whether to permit or restrict the use of the output data are updated, and the supply and use of the output data are prohibited until a print completion notice is received. Alternatively, the output of the output data is requested in the first output control step, the job tickets stored in the job ticket storage unit are updated, the supply of the output data is prohibited until the output of the output data from the first network device is completed, and the supply and use of the output data are prohibited when it is determined that the contents of the job tickets satisfy predetermined conditions. The output process is performed in the first output control step on the basis of the output data, according to the output request. In addition, the method includes, for the second network device, a second output data receiving step of receiving the output data; and a second output control step of transmitting the print completion notice to the first network device when the output of the output data from the second network device is completed.

According to this structure, the same effects as those in the authentication output system according to the tenth aspect are obtained.

Further, according to the sixty-second aspect of the invention, in the authentication output method of the sixty-first aspect, in the output data utilization managing step, the supply and use of the output data are prohibited until the print completion notice or a print interruption notice is received. Alternatively, the supply of the output data is prohibited until the output of the output data from the first network device is interrupted or completed, and the contents of the job tickets are restored to the original states before the update when the print interruption notice is received or when the output of the output data from the first network device is interrupted. In the second output control step, when the output of the output data from the second network device is interrupted, the use of the output data received in the second output data receiving step is prohibited, and the print interruption notice is transmitted to the first network device.

According to this structure, the same effects as those in the authentication output system according to the eleventh aspect are obtained.

Furthermore, according to a sixty-third aspect of the invention, the authentication output method of the sixtieth aspect or the sixty-second aspect further includes, for the second network device, a second authentication information acquiring step of acquiring authentication information used for the authentication; and an authentication information transmitting step of transmitting the authentication information acquired in the second authentication information acquiring step to the first network device. In addition, the method further includes, for the first network device, an authentication information receiving step of receiving the authentication information; a first authentication information acquiring step of acquiring the authentication information; and the authenticating unit. In the authenticating step, the use of the output data is authenticated on the basis of the authentication information received in the authentication information receiving step and the authentication information received in the first authentication information acquiring step. In the output data utilization managing unit, when it is determined that the use of the output data is authenticated in the authenticating step, on the basis of the authentication information received in the authentication information receiving step, the output data is supplied to the second network device. In addition, when it is determined that the use of the output data is authenticated in the authenticating step on the basis of the authentication information acquired in the first authentication information acquiring step, the output request is performed in the first output control step.

According to this structure, the same effects as those in the authentication output system according to the twelfth aspect are obtained.

Moreover, according to a sixty-fourth aspect of the invention, in the authentication output method of the sixty-third aspect, in the output data utilization managing step, when it is determined that the use of the output data is authenticated in the authenticating step on the basis of the authentication information received in the authentication information receiving step and that the job tickets can be updated, the output data is supplied, and the update of the job tickets is prohibited until the print interruption notice or the print completion notice is received. In the output data utilization managing step, when it is determined that the use of the output data is authenticated in the authenticating step, on the basis of the authentication information acquired in the first authentication information acquiring step, and that the job tickets can be updated, the output request is performed, and the update of the job tickets is prohibited until the output of the output data from the first network device is interrupted or completed.

According to this structure, the same effects as those in the authentication output system according to the thirteenth aspect are obtained.

Further, according to a sixty-fifth aspect of the invention, the authentication output method according to any one of the sixtieth, sixty-second to sixty-fourth aspects further includes a utilization history information generating step of generating utilization history information indicating a utilization history of the output data, on the basis of a utilization result and a supply result of the output data utilization managing step.

According to this structure, the same effects as those in the authentication output system according to the fourteenth aspect are obtained.

Furthermore, according to a sixty-sixth aspect of the invention, in the authentication output method according to the fifty-third, fifty-fifth to fifty-eighth, sixtieth, sixty-second to sixty fifth aspects, in the output data utilization managing step, when it is determined that the contents of the job tickets satisfy the predetermined conditions, the output data and the job tickets are removed.

According to this structure, the same effects as those in the authentication output system according to the fifteenth aspect are obtained.

Moreover, according to the sixty-seventh aspect of the invention, an authentication output system includes a plurality of network devices each of which performs an output process on the basis of output data; and a device using apparatus that uses the network devices, the device using apparatus being connected to the network devices so as to communicate therewith. When authentication succeeds, the network devices perform the output process. The device using apparatus includes: an output data transmitting unit that transmits the output data to the plurality of network devices; a job ticket storage unit that stores job tickets specifying contents related to whether to permit or restrict the use of the output data; and an output data utilization managing unit that manages the use of the output data. When the authentication succeeds, the output data utilization managing unit transmits an output permission notice to any one of the plurality of network devices, and prohibits the transmission of the output permission notice until a print interruption notice or a print completion notice is received. When the print completion notice is received, the output data utilization managing unit updates the job tickets stored in the job ticket storage unit. When it is determined that the contents of the job tickets satisfy predetermined conditions, the output data utilization managing unit transmits a utilization prohibition notice to the plurality of network devices. Each of the network devices includes: an output data storage unit; an output data receiving unit that receives the output data; an output data holding unit that stores the output data received by the output data receiving unit in the output data storage unit; and an output control unit that performs output control on the basis of the output data stored in the output data storage unit. When the output permission notice is received, the output control unit performs the output process on the basis of the output data. When the output of the output data from the network devices is interrupted, the output control unit prohibits the use of the output data and transmits the print interruption notice to the device using apparatus. When the output of the output data from the network devices is completed, the output control unit transmits the print completion notice to the device using apparatus. In addition, when the utilization prohibition notice is received, the output control unit prohibits the use of the output data.

According to this structure, in the device using apparatus, the output data transmitting unit transmits the output data to the respective network devices.

In the network device, when the output data receiving unit receives the output data, the output data holding unit stores the received output data in the output data storage unit.

In the device using apparatus, when the authentication succeeds, the output data utilization managing unit transmits the output permission notice to any one of the plurality of network devices, and prohibits the transmission of the output permission notice until the print interruption notice or the print completion notice is received.

In the network device, when the output permission notice is received, the output control unit performs the output process on the basis of the output data stored in the output data storage unit. When the output of the output data is completed, the print completion notice is transmitted to the device using apparatus. On the other hand, when the output of the output data is interrupted, the output control unit prohibits the use of the output data and transmits the print interruption notice to the device using apparatus.

In the device using apparatus, when the print completion notice is received, the output data utilization managing unit updates the job tickets.

In addition, in the device using apparatus, When it is determined that the contents of the job tickets satisfy predetermined conditions, the output data utilization managing unit transmits the utilization prohibition notice to the respective network devices.

In the network device, when the utilization prohibition notice is received, the output control unit prohibits the use of the output data.

In this way, since the job tickets are updated when the output of the output data is completed, it is possible to obtain output contents from another network device even when the output of the output data from a network device is interrupted due to a trouble. Thus, only an authorized user can obtain an output matter.

Furthermore, since the output permission notice is transmitted to any one of the network devices, it is possible to prevent the same output content from being simultaneously output from the plurality of network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

In addition, the output data is stored in the respective network devices. Therefore, even when the output of the output data from a network device is interrupted due to a trouble, the output can be started by another network device at relatively high speed.

Here, prohibiting the use of the output data includes, for example, removing the output data, rejecting a request for the supply or use of the output data, rewriting the attribute of the output data into ‘unavailable’, and encoding the output data such that the output data cannot be read. This is similarly applied to an authentication output system according to a sixty-eighth aspect, a network device according to an eighty-fifth aspect, an output control program according to the hundredth aspect, and authentication output methods according to one-hundred ninth and one-hundred tenth aspects.

In addition, updating the job tickets includes, for example, prescribing the number of utilizations of the output data, decrementing the number of available times of the output data whenever the output permission notice is transmitted, and decrementing the number of utilizations of the output data whenever the output permission notice is transmitted. This is similarly applied to authentication output systems according to sixty-eighth, seventy-third, and seventy-fourth aspects, device using apparatuses according to seventy-ninth and eightieth aspects, network devices according to eighty-eighth and eighty-ninth aspects, output data managing programs according to ninety-fourth and ninety-fifth aspects, output control program according to one-hundred third and one-hundred fourth aspects, and authentication output methods according to one-hundred ninth, one-hundred tenth, one-hundred fifteenth, and one-hundred sixteenth aspects.

Further, according to the sixty-eighth aspect of the invention, an authentication output system includes a plurality of network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data transmitting unit that transmits the output data to the plurality of network devices; a job ticket storage unit that stores job tickets specifying contents related to whether to permit or restrict the use of the output data; and an output data utilization managing unit that manages the use of the output data. When the authentication succeeds, the output data utilization managing unit transmits an output permission notice to any one of the plurality of network devices, updates the job tickets stored in the job ticket storage unit, and prohibits the transmission of the output permission notice until a print interruption notice or a print completion notice is received. When the print interruption notice is received, the output data utilization managing unit restores the contents of the job tickets to the original states before the update. When it is determined that the contents of the job tickets satisfy predetermined conditions, the output data utilization managing unit transmits a utilization prohibition notice to the plurality of network devices. Each of the network devices includes an output data storage unit; an output data receiving unit that receives the output data; an output data holding unit that stores the output data received by the output data receiving unit in the output data storage unit; and an output control unit that performs output control on the basis of the output data stored in the output data storage unit. When the output permission notice is received, the output control unit performs the output process on the basis of the output data. When the output of the output data from the network devices is interrupted, the output control unit prohibits the use of the output data and transmits the print interruption notice to the device using apparatus. When the output of the output data from the network devices is completed, the output control unit transmits the print completion notice to the device using apparatus. When the utilization prohibition notice is received, the output control unit prohibits the use of the output data.

According to this structure, in the device using apparatus, the output data transmitting unit transmits the output data to the respective network devices.

In the network device, when the output data receiving unit receives the output data, the output data holding unit stores the received output data in the output data storage unit.

In the device using apparatus, when the authentication succeeds, the output data utilization managing unit transmits the output permission notice to any one of the plurality of network devices and updates the job tickets. In addition, the output data utilization managing unit prohibits the transmission of the output permission notice until the print interruption notice or the print completion notice is received.

In the network device, when the output permission notice is received, the output control unit performs the output process on the basis of the output data stored in the output data storage unit. When the output of the output data is completed, the output control unit transmits the print completion notice to the device using apparatus. On the other hand, when the output of the output data is interrupted, the output control unit prohibits the use of the output data and transmits the print interruption notice to the device using apparatus.

In the device using apparatus, when the utilization prohibition notice is received, the output data utilization managing unit restores the contents of the job tickets to the original states before the update.

In addition, in the device using apparatus, when it is determined that the contents of the job tickets satisfy predetermined conditions, the output data utilization managing unit transmits the utilization prohibition notice to the respective network devices.

In the network device, when the utilization prohibition notice is received, the output control unit prohibits the use of the output data.

In this way, when the output of the output data is completed, the job tickets are updated. Therefore, even when the output of the output data from a network device is interrupted due to a trouble, output contents can be obtained from another network device. In addition, only an authorized user can obtain an output matter.

Furthermore, since the output permission notice is transmitted to any one of the network devices, it is possible to prevent the same output content from being simultaneously output from the plurality of network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

In addition, the output data is stored in the respective network devices. Therefore, even when the output of the output data from a network device is interrupted due to a trouble, the output can be started by another network device at relatively high speed.

Furthermore, according to the sixty-ninth aspect of the invention, in the authentication output system of the sixty-seventh aspect or the sixty-eighth aspect, the device using apparatus further includes an authentication information receiving unit that receives authentication information used for the authentication; and an authenticating unit. Each of-the network devices further includes an authentication information acquiring unit that acquires the authentication information; and an authentication information transmitting unit that transmits the authentication information acquired by the authentication information acquiring unit to the device using apparatus. The authenticating unit authenticates the use of the output data on the basis of the authentication information received by the authentication information receiving unit. When it is determined that the use of the output data is authenticated by the authenticating unit, the output data utilization managing unit transmits the output data to one of the plurality of network device, which is a source of the authentication information.

According to this structure, in the network device, when the authentication information acquiring unit acquires the authentication information, the authentication information transmitting unit transmits the acquired authentication information to the device using apparatus.

In the device using apparatus, when the authentication information receiving unit receives authentication information, the authenticating unit authenticates the use of the output data on the basis of the received authentication information. As a result, when it is determined that the use of the output data is permitted, the output data utilization managing unit transmits the output data to one of the plurality of network device, which is a source of the authentication information.

In this way, when a user inputs proper authentication information to a desired network device, the user can obtain output contents from the network device.

Moreover, according to a seventieth aspect of the invention, in the authentication output system of the sixty-ninth aspect, when it is determined that the use of the output data is authenticated by the authenticating unit and that the job tickets can be updated, the output data utilization managing unit transmits the output permission notice, and prohibits the update of the job tickets until the print interruption notice or the print completion notice is received.

According to this structure, in the device using apparatus, when it is determined that the use of the output data is authenticated by the authenticating unit and that the job tickets can be updated, the output data utilization managing unit transmits the output permission notice, and then prohibits the update of the job tickets until the print interruption notice or the print completion notice is received. Therefore, even when the authentication information is received, the output permission notice is not transmitted until the print interruption notice or the print completion notice is received.

Further, according to a seventy-first aspect of the invention, the authentication output system according to any one of the sixty-seventh to seventieth aspects further includes a utilization history information generating unit that creates utilization history information indicating a utilization history of the output data, on the basis of the result supplied by the output data utilization managing unit.

According to this structure, in the device using apparatus, the utilization history information generating unit creates the utilization history information indicating the utilization history of the output data, on the basis of the result supplied by the output data utilization managing unit.

In this way, it is possible to see how the output data has been used by referring to the utilization history information.

Furthermore, according to a seventy-second aspect of the invention, in the authentication output system according to the sixty-seventh to seventy-first aspects, when it is determined that the contents of the job tickets satisfy the predetermined conditions, the output data utilization managing unit transmits the utilization prohibition notice and removes the job tickets. The output control unit removes the output data when the utilization prohibition notice is received.

According to this structure, in the device using apparatus, when it is determined that the contents of the job tickets satisfy the predetermined conditions, the output data utilization managing unit transmits the utilization prohibition notice and removes the job tickets.

In the network device, the output control unit removes the output data when the utilization prohibition notice is received.

In this way, it is possible to prevent the output data and the job tickets from being illegally used, and thus to reliably protect the secrecy of the output contents.

Moreover, according to the seventy-third aspect of the invention, an authentication output system includes first and second network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data transmitting unit that transmits the output data to the first and second network devices. The first network device includes a first output data storage unit; a first output data receiving unit that receives the output data; a first output data holding unit that stores the output data received by the first output data receiving unit in the first output data storage unit; a job ticket storage unit that stores job tickets specifying contents related to whether to permit or restrict the use of the output data; an output data utilization managing unit that manages the use of the output data; and a first output control unit that performs output control on the basis of the output data stored in the first output data storage unit. When the authentication succeeds, the output data utilization managing unit transmits an output permission notice to the second network device, and prohibits the transmission of the output permission notice and the use of the output data until a print interruption notice or a print completion notice is received. Alternatively, the output data utilization managing unit requires the first output control unit to output the output data, prohibits the transmission of the output permission notice until the output of the output data from the first network device is interrupted or completed, updates the job tickets stored in the job ticket storage unit when the print completion notice is received or when the output of the output data from the first network device is completed, and transmits a utilization prohibition notice to the second network device and prohibits the use of the output data when it is determined that the contents of the job tickets satisfy predetermined conditions. The first output control unit performs the output process on the basis of the output data, according to the output request. The second network device includes a second output data storage unit; a second output data receiving unit that receives the output data; a second output data holding unit that stores the output data received by the second output data receiving unit in the second output data storage unit; and a second output control unit that performs output control on the basis of the output data stored in the second output data storage unit. When the output permission notice is received, the second output control unit performs the output process on the basis of the output data. When the output of the output data from the second network device is interrupted, the second output control unit prohibits the use of the output data and transmits the print interruption notice to the first network device. When the output of the output data from the second network device is completed, the second output control unit transmits the print completion notice to the first network device. When the utilization prohibition notice is received, the second output control unit prohibits the use of the output data.

According to this structure, in the device using apparatus, the output data transmitting unit transmits the output data to the first and second network devices.

In the first network device, when the first output data receiving unit receives the output data, the first output data holding unit stores the received output data in the first output data storage unit. Similarly, in the second network device, when the second output data receiving unit receives the output data, the second output data holding unit stores the received output data in the second output data storage unit.

In the first network device, when the authentication succeeds, the output data utilization managing unit transmits the output permission notice to the second network device, or requests the first output control unit to output the output data. In the former case, the transmission of the output permission notice and the use of the output data are prohibited until the print interruption notice or the print completion notice is received.

In the second network unit, when the output permission notice is received, the second output control unit performs the output process on the basis of the output data stored in the second storage unit. When the output of the output data is completed, the second output control unit transmits the print completion notice to the first network device. On the other hand, when the output of the output data is interrupted, the second output control unit prohibits the use of the output data and transmits the print interruption notice to the first network device.

In the first network device, the output data utilization managing unit updates the job tickets when the print completion notice is received.

Meanwhile, in the first network device, when the output request is preformed on the first output control unit, the first output control unit performs the output process on the basis of the output data stored in the first output data storage unit. The output data utilization managing unit prohibits the transmission of the output permission notice until the output of the output data is interrupted or completed. When the output is completed, the job tickets are updated.

In addition, in the first network device, when it is determined that the contents of the job tickets satisfy predetermined conditions, the output data utilization managing unit transmits the utilization prohibition notice to the second network device and prohibits the use of the output data.

In the second network device, when the utilization prohibition notice is received, the second output control unit prohibits the use of the output data.

In this way, when the output of the output data is completed, the job tickets are updated. Therefore, even when the output of the output data from one of the first and second network devices is interrupted due to a trouble, output contents can be obtained from the other network device. In addition, only an authorized user can obtain an output matter.

Furthermore, since the output permission notice is transmitted to the second network device or the output data is used in the first network device, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

In addition, the output data is respectively stored in the first and second network devices. Therefore, even when the output of the output data from one of the first and second network devices is interrupted due to a trouble, the output can be started by the network device at relatively high speed.

In this structure, when it is determined that the contents of the job tickets satisfy the predetermined conditions, the use of the output data is prohibited. When the output of the output data is interrupted, the use of the output data is prohibited. When the utilization prohibition notice is received, the use of the output data is prohibited. In these cases, prohibiting the use of the output data includes, for example, removing the output data, rejecting a request for the supply or use of the output data, rewriting the attribute of the output data into ‘unavailable’, and encoding the output data such that the output data cannot be read. This is similarly applied to the authentication output system according to the seventy-fourth aspect, the network devices according to the eighty-eighth and eighty-ninth aspects, the output control programs according to the one-hundred third and one-hundred fourth aspects, and the authentication output methods according to the one-hundred fifteenth and one-hundred sixteenth aspects.

In addition, in the case in which the use of the output data is prohibited until the print interruption notice or the print completion notice is received, prohibiting the use of the output data includes, for example, rejecting a request for the supply or use of the output data, rewriting the attribute of the output data into ‘unavailable’, and encoding the output data such that the output data cannot be read. This is similarly applied to the authentication output system according to the seventy-fourth aspect, the network devices according to the eighty-eighth and eighty-ninth aspects, the output control programs according to the one-hundred third and one-hundred fourth aspects, and the authentication output methods according to the one-hundred fifteenth and one-hundred sixteenth aspects.

According to the seventy-fourth aspect of the invention, an authentication output system includes first and second network devices each of which performs an output process on the basis of output data; and a device using apparatus that uses the network devices, the device using apparatus being connected to the network devices so as to communicate therewith. When authentication succeeds, the network devices perform the output process. The device using apparatus includes an output data transmitting unit that transmits the output data to the first and second network devices. The first network device includes a first output data storage unit; a first output data receiving unit that receives the output data; a first output data holding unit that stores the output data received by the first output data receiving unit in the first output data storage unit; a job ticket storage unit that stores job tickets specifying contents related to whether to permit or restrict the use of the output data; an output data utilization managing unit that manages the use of the output data; and a first output control unit that performs output control on the basis of the output data stored in the first output data storage unit. When the authentication succeeds, the output data utilization managing unit transmits an output permission notice to the second network device, updates the job tickets stored in the job ticket storage unit, and prohibits the transmission of the output permission notice and the use of the output data until a print interruption notice or a print completion notice is received. Alternatively, the output data utilization managing unit requires the first output control unit to output the output data, updates the job tickets stored in the job ticket storage unit, prohibits the transmission of the output permission notice until the output of the output data from the first network device is interrupted or completed, restores the contents of the job tickets to the original states before the update when the print interruption notice is received or when the output of the output data from the first network device is interrupted, and transmits a utilization prohibition notice to the second network device and prohibits the use of the output data when it is determined that the contents of the job tickets satisfy predetermined conditions. The first output control unit performs the output process on the basis of the output data, according to the output request. The second network device includes a second output data storage unit; a second output data receiving unit that receives the output data; a second output data holding unit that stores the output data received by the second output data receiving unit in the second output data storage unit; and a second output control unit that performs output control on the basis of the output data stored in the second output data storage unit. When the output permission notice is received, the second output control unit performs the output process on the basis of the output data. When the output of the output data from the second network device is interrupted, the second output control unit prohibits the use of the output data and transmits the print interruption notice to the first network device. When the output of the output data from the second network device is completed, the second output control unit transmits the print completion notice to the first network device. When the utilization prohibition notice is received, the second output control unit prohibits the use of the output data.

According to this structure, in the device using apparatus, the output data transmitting unit transmits the output data to the first and second network devices.

In the first network device, when the first output data receiving unit receives the output data, the first output data holding unit stores the received output data in the first output data storage unit. Similarly, in the second network device, when the second output data receiving unit receives the output data, the second output data holding unit stores the received output data in the second output data storage unit.

In the first network device, when the authentication succeeds, the output data utilization managing unit transmits the output permission notice to the second network device, or requests the first output control unit to output the output data. In the former case, the job tickets are updated, and the transmission of the output permission notice and the use of the output data are prohibited until the print interruption notice or the print completion notice is received.

In the second network unit, when the output permission notice is received, the second output control unit performs the output process on the basis of the output data stored in the second output data storage unit. When the output of the output data is completed, the second output control unit transmits the print completion notice to the first network device. On the other hand, when the output of the output data is interrupted, the second output control unit prohibits the use of the output data and transmits the print interruption notice to the first network device.

In the first network device, the output data utilization managing unit restores the contents of the job tickets to the original states before update when the print interruption notice is received.

Meanwhile, in the first network device, when the output request is preformed on the first output control unit, the output data utilization managing unit updates the job tickets, and the first output control unit performs the output process on the basis of the output data stored in the first output data storage unit. Then, the output data utilization managing unit prohibits the transmission of the output permission notice until the output of the output data is interrupted or completed. When the output of the output data is interrupted, the contents of the job tickets are restored to the original states before the update.

In addition, in the first network device, when it is determined that the contents of the job tickets satisfy predetermined conditions, the output data utilization managing unit transmits the utilization prohibition notice to the second network device and prohibits the use of the output data.

In the second network device, when the utilization prohibition notice is received, the second output control unit prohibits the use of the output data.

In this way, when the output of the output data is completed, the job tickets are updated. Therefore, even when the output of the output data from one of the first and second network devices is interrupted due to a trouble, output contents can be obtained from the other network device. In addition, only an authorized user can obtain an output matter.

Furthermore, since the output permission notice is transmitted to the second network device or the output data is used in the first network device, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

In addition, the output data is respectively stored in the first and second network devices. Therefore, even when the output of the output data from one of the first and second network devices is interrupted due to a trouble, the output can be started by the network device at relatively high speed.

Further, according to the seventy-fifth aspect of the invention, in the authentication output system of the seventy-third aspect or the seventy-fourth aspect, the first network device further includes an authentication information receiving unit that receives authentication information used for the authentication; a first authentication information acquiring unit that acquires the authentication information; and an authenticating unit. The second network device further includes: a second authentication information acquiring unit that acquires the authentication information; and an authentication information transmitting unit that transmits the authentication information acquired by the second authentication information acquiring unit to the first network device. The authenticating unit authenticates the use of the output data on the basis of the authentication information received by the authentication information receiving unit and the authentication information received by the first authentication information acquiring unit. When it is determined that the use of the output data is authenticated by the authenticating unit, on the basis of the authentication information received by the authentication information receiving unit, the output data utilization managing unit transmits the output data to the second network device. When it is determined that the use of the output data is authenticated by the authenticating unit on the basis of the authentication information acquired by the first authentication information acquiring unit, the output data utilization managing unit requires the first output control unit to output the output data.

According to this structure, in the second network device, when the second authentication information acquiring unit acquires the authentication information, the authentication information transmitting unit transmits the acquired authentication information to the first network device.

In the first network device, when the authentication information receiving unit receives the authentication information, the authenticating unit authenticates the use of the output data on the basis of the received authentication information. As a result, when it is determined that the use of the output data is permitted, the output data utilization managing unit transmits the output permission notice to the second network device.

In addition, in the first network device, when the authentication information is acquired by the first authentication information acquiring unit, the use of the output data is authenticated by the authenticating unit on the basis of the acquired authentication information. As a result, when it is determined that the use of the output data is permitted, the output data utilization managing unit performs an output request on the first network device.

In this way, the same effects as those in the authentication output system according to the sixty-ninth aspect are obtained.

Furthermore, according to a seventy-sixth aspect of the invention, in the authentication output system of the seventy-fifth aspect, when it is determined that the use of the output data is authenticated by the authenticating unit on the basis of the authentication information received by the authentication information receiving unit and that the job tickets can be updated, the output data utilization managing unit transmits the output permission notice, and prohibits the update of the job tickets until the print interruption notice or the print completion notice is received. In addition, when it is determined that the use of the output data is authenticated by the authenticating unit, on the basis of the authentication information acquired by the first authentication information acquiring unit, and that the job tickets can be updated, the output data utilization managing unit performs the output request and prohibits the update of the job tickets until the output of the output data from the first network device is interrupted or completed.

According to this structure, in the first network device, when it is determined that the use of the output data is authenticated by the authenticating unit on the basis of the received authentication information and that the job tickets can be updated, the output data utilization managing unit transmits the output permission notice to the second network device, and prohibits the update of the job tickets until the print interruption notice or the print completion notice is received. In addition, in the first network device, when it is determined that the use of the output data is authenticated on the basis of the acquired authentication information and that the job tickets can be updated, the output data utilization managing unit requests the first network device to output the output data, and prohibits the update of the job tickets until the output of the output data is interrupted or completed.

Therefore, until the print interruption notice or the print completion notice is received or until the output of the output data is interrupted or completed, the output permission notice is not transmitted even though the authentication information is received, and the output of the output data is not performed even though the authentication information is acquired.

Moreover, according to a seventy-seventh aspect of the invention, in the authentication output system according to any one of the seventy-third to seventy-sixth aspects, the first network device further includes a utilization history information generating unit that creates utilization history information indicating a utilization history of the output data, on the basis of a utilization result and a supply result of the output data utilization managing unit.

According to this structure, in the first network device, the utilization history information generating unit creates the utilization history information indicating the utilization history of the output data, on the basis of the utilization result and the supply result of the output data utilization managing unit.

In this way, the same effects as those in the seventy-first aspect are obtained.

Moreover, according to a seventy-eighth aspect of the invention, in the authentication output system according to any one of the seventy-third to seventy-seventh aspects, when it is determined that the contents of the job tickets satisfy the predetermined conditions, the output data utilization managing unit transmits the utilization prohibition notice and removes the output data and the job tickets. The second output control unit removes the output data when receiving the utilization prohibition notice.

According to this structure, in the first network device, when it is determined that the contents of the job tickets satisfy the predetermined conditions, the output data utilization managing unit transmits the utilization prohibition notice and removes the output data and the job tickets.

In the network device, the second output control unit removes the output data when receiving the utilization prohibition notice.

In this way, it is possible to prevent the output data and the job tickets from being illegally used, and thus to reliably protect the secrecy of the output contents.

Further, according to the seventy-ninth aspect of the invention, there is provided a device using apparatus that uses a plurality of network devices. The device using apparatus includes an output data transmitting unit that transmits the output data to the plurality of network devices; a job ticket storage unit that stores job tickets specifying contents related to whether to permit or restrict the use of the output data; and an output data utilization managing unit that manages the use of the output data. When authentication succeeds, the output data utilization managing unit transmits an output permission notice to any one of the plurality of network devices, and prohibits the transmission of the output permission notice until a print interruption notice or a print completion notice is received. When the print completion notice is received, the output data utilization managing unit updates the job tickets stored in the job ticket storage unit. When it is determined that the contents of the job tickets satisfy predetermined conditions, the output data utilization managing unit transmits a utilization prohibition notice to the plurality of network devices.

According to this structure, the same operations as those in the device using apparatus of the authentication output system according to the sixty-seventh aspect are obtained. Thus, the same effects as those in the authentication output system according to the sixty-seventh aspect are obtained.

Furthermore, according to the eightieth aspect of the invention, there is provided a device using apparatus that uses a plurality of network devices. The device using apparatus includes an output data transmitting unit that transmits the output data to the plurality of network devices; a job ticket storage unit that stores job tickets specifying contents related to whether to permit or restrict the use of the output data; and an output data utilization managing unit that manages the use of the output data. When authentication succeeds, the output data utilization managing unit transmits an output permission notice to any one of the plurality of network devices, updates the job tickets stored in the job ticket storage unit, and prohibits the transmission of the output permission notice until a print interruption notice or a print completion notice is received. When the print interruption notice is received, the output data utilization managing unit updates the job tickets stored in the job ticket storage unit. When it is determined that the contents of the job tickets satisfy predetermined conditions, the output data utilization managing unit transmits a utilization prohibition notice to the plurality of network devices.

According to this structure, the same operations as those in the device using apparatus of the authentication output system according to the sixty-eighth aspect are obtained. Thus, the same effects as those in the authentication output system according to the sixty-eighth aspect are obtained.

Moreover, according to an eighty-first aspect of the invention, the device using apparatus of the seventy-ninth aspect or the eightieth aspect further includes an authentication information receiving unit that receives authentication information used for the authentication; and an authenticating unit. The authenticating unit authenticates the use of the output data on the basis of the authentication information received by the authentication information receiving unit. When it is determined that the use of the output data is authenticated by the authenticating unit, the output data utilization managing unit transmits the output permission notice to one of the plurality of network device, which is a source of the authentication information.

According to this structure, the same operations as those in the device using apparatus of the authentication output system according to the sixty-ninth aspect are obtained. Thus, the same effects as those in the authentication output system according to the sixty-ninth aspect are obtained.

Further, according to an eighty-second aspect of the invention, in the device using apparatus of the eighty-first aspect, when it is determined that the use of the output data is authenticated by the authenticating unit and that the job tickets can be updated, the output data utilization managing unit transmits the output permission notice, and prohibits the update of the job tickets until the print interruption notice or the print completion notice is received.

According to this structure, the same operations as those in the device using apparatus of the authentication output system according to the seventieth aspect are obtained. Thus, the same effects as those in the authentication output system according to the seventieth aspect are obtained.

Furthermore, according to an eighty-third aspect of the invention, the device using apparatus according to any one of the seventy-ninth to eighty-second aspects further includes a utilization history information generating unit that creates utilization history information indicating a utilization history of the output data, on the basis of the result supplied by the output data utilization managing unit.

According to this structure, the same operations as those in the device using apparatus of the authentication output system according to the seventy-first aspect are obtained. Thus, the same effects as those in the authentication output system according to the seventy-first aspect are obtained.

Moreover, according to an eighty-fourth aspect of the invention, in the device using apparatus according to any one of the seventy-ninth to eighty-third aspects, when it is determined that the contents of the job tickets satisfy the predetermined conditions, the output data utilization managing unit transmits the utilization prohibition notice and removes the job tickets. The output control unit removes the output data when the utilization prohibition notice is received.

According to this structure, the same operations as those in the device using apparatus of the authentication output system according to the seventy-second aspect are obtained. Thus, the same effects as those in the authentication output system according to the seventy-second aspect are obtained.

Further, according to the eighty-fifth aspect of the invention, there is provided a network device that performs an output process on the basis of output data. The network device includes an output data storage unit; an output data receiving unit that receives the output data; an output data holding unit that stores the output data received by the output data receiving unit in the output data storage unit; and an output control unit that performs output control on the basis of the output data stored in the output data storage unit. When an output permission notice is received, the output control unit performs the output process on the basis of the output data. When the output of the output data from the network device is interrupted, the output control unit prohibits the use of the output data and transmits a print interruption notice to a device using apparatus. When the output of the output data from the network device is completed, the output control unit transmits a print completion notice to the device using apparatus. When a utilization prohibition notice is received, the output control unit prohibits the use of the output data.

According to this structure, the same operations as those in the network device of the authentication output system according to the sixty-seventh aspect are obtained. Thus, the same effects as those in the authentication output system according to the sixty-seventh aspect are obtained.

Furthermore, according to an eighty-sixth aspect of the invention, the network device of the eighty-fifth aspect further includes an authentication information acquiring unit that acquires the authentication information used for the authentication; and an authentication information transmitting unit that transmits the authentication information acquired by the authentication information acquiring unit to the device using apparatus.

According to this structure, the same operations as those in the network device of the authentication output system according to the sixty-ninth aspect are obtained. Thus, the same effects as those in the authentication output system according to the sixty-ninth aspect are obtained.

Moreover, according to an eighty-seventh aspect of the invention, in the network device of the eighty-fifth aspect or the eighty-sixth aspect, the output control unit removes the output data when the utilization prohibition notice is received.

According to this structure, the same operations as those in the network device of the authentication output system according to the seventy-second aspect are obtained. Thus, the same effects as those in the authentication output system according to the seventy-second aspect are obtained.

Further, according to the eighty-eighth aspect of the invention, there is provided a network device that performs an output process on the basis of output data. The network device includes an output data storage unit; an output data receiving unit that receives the output data; an output data holding unit that stores the output data received by the output data receiving unit in the output data storage unit; a job ticket storage unit that stores job tickets specifying contents related to whether to permit or restrict the use of the output data; an output data utilization managing unit that manages the use of the output data; and an output control unit that performs output control on the basis of the output data stored in the output data storage unit. When authentication succeeds, the output data utilization managing unit transmits an output permission notice to another network device, and prohibits the transmission of the output permission notice and the use of the output data until a print interruption notice or a print completion notice is received. Alternatively, the output data utilization managing unit requires the output control unit to output the output data, prohibits the transmission of the output permission notice until the output of the output data from the network device is interrupted or completed, updates the job tickets stored in the job ticket storage unit when the print completion notice is received or when the output of the output data from the network device is completed, and transmits a utilization prohibition notice to another network device and prohibits the use of the output data when it is determined that the contents of the job tickets satisfy predetermined conditions. The output control unit performs the output process on the basis of the output data, according to the output request.

According to this structure, the same operations as those in the first network device of the authentication output system according to the seventy-third aspect are obtained. Thus, the same effects as those in the authentication output system according to the seventy-third aspect are obtained.

Furthermore, according to the eighty-ninth aspect of the invention, there is provided a network device that performs an output process on the basis of output data. The network device includes an output data storage unit; an output data receiving unit that receives the output data; an output data holding unit that stores the output data received by the output data receiving unit in the output data storage unit; a job ticket storage unit that stores job tickets specifying contents related to whether to permit or restrict the use of the output data; an output data utilization managing unit that manages the use of the output data; and an output control unit that performs output control on the basis of the output data stored in the output data storage unit. When authentication succeeds, the output data utilization managing unit transmits an output permission notice to another network device, updates the job tickets stored in the job ticket storage unit, and prohibits the transmission of the output permission notice and the use of the output data until a print interruption notice or a print completion notice is received. Alternatively, the output data utilization managing unit requires the output control unit to output the output data, updates the job tickets stored in the job ticket storage unit, prohibits the transmission of the output permission notice until the output of the output data from the network device is interrupted or completed, restores the contents of the job tickets to the original states before the update when the print interruption notice is received or when the output of the output data from the first network device is interrupted, and transmits a utilization prohibition notice to another network device and prohibits the use of the output data when it is determined that the contents of the job tickets satisfy predetermined conditions. The output control unit performs the output process on the basis of the output data, according to the output request.

According to this structure, the same operations as those in the first network device of the authentication output system according to the seventy-fourth aspect are obtained. Thus, the same effects as those in the authentication output system according to the seventy-fourth aspect are obtained.

Moreover, according to a ninetieth aspect of the invention, the network device of the eighty-eighth aspect or the eighty-ninth aspect further includes an authentication information receiving unit that receives authentication information used for the authentication; an authentication information acquiring unit that acquires the authentication information; and an authenticating unit. The authenticating unit authenticates the use of the output data on the basis of the authentication information received by the authentication information receiving unit and the authentication information acquired by the authentication information acquiring unit. When it is determined that the use of the output data is authenticated by the authenticating unit, on the basis of the authentication information received by the authentication information receiving unit, the output data utilization managing unit transmits the output permission notice to another network device. When it is determined that the use of the output data is authenticated by the authenticating unit on the basis of the authentication information acquired by the authentication information acquiring unit, the output data utilization managing unit requires the output control unit to output the output data.

According to this structure, the same operations as those in the first network device of the authentication output system according to the seventy-fifth aspect are obtained. Thus, the same effects as those in the authentication output system according to the seventy-fifth aspect are obtained.

Further, according to a ninety-first aspect of the invention, in the network device of the ninetieth aspect, when it is determined that the use of the output data is authenticated by the authenticating unit on the basis of the authentication information received by the authentication information receiving unit and that the job tickets can be updated, the output data utilization managing unit transmits the output permission notice, and prohibits the update of the job tickets until the print interruption notice or the print completion notice is received. In addition, when it is determined that the use of the output data is authenticated by the authenticating unit, on the basis of the authentication information acquired by the authentication information acquiring unit, and that the job tickets can be updated, the output data utilization managing unit performs the output request and prohibits the update of the job tickets until the output of the output data from the network device is interrupted or completed.

According to this structure, the same operations as those in the first network device of the authentication output system according to the seventy-sixth aspect are obtained. Thus, the same effects as those in the authentication output system according to the seventy-sixth aspect are obtained.

Furthermore, according to a ninety-second aspect of the invention, the network device according to any one of the eighty-eighth to ninety-first aspects further includes a utilization history information generating unit that creates utilization history information indicating a utilization history of the output data, on the basis of a utilization result and a transmission result of the output data utilization managing unit.

According to this structure, the same operations as those in the first network device of the authentication output system according to the seventy-seventh aspect are obtained. Thus, the same effects as those in the authentication output system according to the seventy-seventh aspect are obtained.

Moreover, according to a ninety-third aspect of the invention, in the network device according to any one of the eighty-eighth to ninety-second aspects, when it is determined that the contents of the job tickets satisfy the predetermined conditions, the output data utilization managing unit transmits the utilization prohibition notice and removes the output data and the job tickets.

According to this structure, the same operations as those in the first network device of the authentication output system according to the seventy-eighth aspect are obtained. Thus, the same effects as those in the authentication output system according to the seventy-eighth aspect are obtained.

Further, according to a ninety-fourth aspect of the invention, there is provided an output data managing program that manages output data used for a plurality of network devices. The output data managing program includes a program that allows a computer to execute a process including an output data transmitting step of transmitting the output data to the plurality of network devices and an output data utilization managing step of managing the use of the output data. In the output data utilization managing step, when authentication succeeds in an authenticating step, an output permission notice is transmitted to any one of the plurality of network devices, and the transmission of the output permission notice is prohibited until a print interruption notice or a print completion notice is received. When the print completion notice is received, job tickets stored in a job ticket storage unit that stores the job tickets specifying contents related to whether to permit or restrict the use of the output data are updated. When it is determined that the contents of the job tickets satisfy predetermined conditions, the output prohibition notice is transmitted to the plurality of network devices.

According to this configuration, when the computer reads out the program to perform the process according to the read program, the same operations and effects as those in the device using apparatus according to the seventy-ninth aspect are obtained.

Furthermore, according to a ninety-fifth aspect of the invention, there is provided an output data managing program that manages output data used for a plurality of network devices. The output data managing program includes a program that allows a computer to execute a process including an output data transmitting step of transmitting the output data to the plurality of network devices and an output data utilization managing step of managing the use of the output data. In the output data utilization managing step, when authentication succeeds in an authenticating step, an output permission notice is transmitted to any one of the plurality of network devices, and job tickets stored in a job ticket storage unit that stores job tickets specifying contents related to whether to permit or restrict the use of the output data are updated. In addition, the transmission of the output permission notice is prohibited until a print interruption notice or a print completion notice is received. When the print interruption notice is received, the contents of the job tickets are restored to the original states before the update. When it is determined that the contents of the job tickets satisfy predetermined conditions, a utilization prohibition notice is transmitted to the plurality of network devices.

According to this configuration, when the computer reads out the program to perform the process according to the read program, the same operations and effects as those in the device using apparatus according to the eightieth aspect are obtained.

Moreover, according to a ninety-sixth aspect of the invention, the output data managing program of the ninety-fourth aspect or the ninety-fifth aspect further includes a program that allows a computer to execute a process composed of an authentication information receiving step of receiving authentication information used for the authentication; and the authenticating step. In the authenticating step, the use of the output data is authenticated on the basis of the authentication information received in the authentication information receiving step. In the output data utilization managing step, when it is determined that the use of the output data is authenticated in the authenticating step, the output permission notice is transmitted to one of the plurality of network device, which is a source of the authentication information.

According to this configuration, when the computer reads out the program to perform the process according to the read program, the same operations and effects as those in the device using apparatus according to the eighty-first aspect are obtained.

Further, according to a ninety-seventh aspect of the invention, in the output data managing program of the ninety-sixth aspect, in the output data utilization managing step, when it is determined that the use of the output data is authenticated in the authenticating step and that the job tickets can be updated, the output permission notice is transmitted, and the update of the job tickets is prohibited until the print interruption notice or the print completion notice is received.

According to this configuration, when the computer reads out the program to perform the process according to the read program, the same operations and effects as those in the device using apparatus according to the eighty-second aspect are obtained.

Furthermore, according to a ninety-eighty aspect of the invention, the output data managing program according to any one of the ninety-fourth to ninety-seventh aspects further includes a program that allows a computer to execute a process composed of a utilization history information generating step of generating utilization history information indicating a utilization history of the output data, on the basis of the result supplied in the output data utilization managing step.

According to this configuration, when the computer reads out the program to perform the process according to the read program, the same operations and effects as those in the device using apparatus according to the eighty-third aspect are obtained.

Moreover, according to a ninety-ninth aspect of the invention, in the output data managing program according to any one of the ninety-fourth to ninety-eighth aspects, in the output data utilization managing step, when it is determined that the contents of the job tickets satisfy the predetermined conditions, the utilization prohibition notice is transmitted, and the job tickets are removed.

According to this configuration, when the computer reads out the program to perform the process according to the read program, the same operations and effects as those in the device using apparatus according to the eighty-fourth aspect are obtained.

Further, according to the hundredth aspect of the invention, there is provided an output control program that performs an output process on the basis of output data. The output control program includes a program that allows a computer to execute a process including an output data receiving step of receiving the output data; an output data storing step of storing the output data received in the output data receiving step in an output data storage unit; and an output control step of performing output control on the basis of the output data stored in the output data storage unit. In the output control step, when an output permission notice is received, the output process is performed on the basis of the output data. When the output of the output data is interrupted, the use of the output data is prohibited, and a print interruption notice is transmitted to a device using apparatus. When the output of the output data is completed, a print completion notice is transmitted to the device using apparatus. When a utilization prohibition notice is received, the use of the output data is prohibited.

According to this configuration, when the computer reads out the program to perform the process according to the read program, the same operations and effects as those in the network device according to the eighty-fifth aspect are obtained.

Furthermore, according to a one-hundred first aspect of the invention, the output control program of the hundredth aspect further includes a program that allows a computer to execute a process including an authentication information acquiring step of acquiring authentication information used for the authentication; and an authentication information transmitting step of transmitting the authentication information acquired in the authentication information acquiring step to the device using apparatus.

According to this configuration, when the computer reads out the program to perform the process according to the read program, the same operations and effects as those in the network device according to the eighty-sixth aspect are obtained.

Moreover, according to a one-hundred second aspect of the invention, in the output control program of the hundredth aspect or the one-hundred first aspect, in the output control step, when the utilization prohibition notice is received, the output data is removed.

According to this configuration, when the computer reads out the program to perform the process according to the read program, the same operations and effects as those in the network device according to the eighty-seventh aspect are obtained.

Further, according to the one-hundred third aspect of the invention, there is provided an output control program that performs an output process on the basis of output data. The output control program includes a program that allows a computer to execute a process including an output data receiving step of receiving the output data; an output data storing step of storing the output data received in the output data receiving step in an output data storage unit; an output data utilization managing step of managing the use of the output data; and an output control step of performing output control on the basis of the output data stored in the output data storage unit. When authentication succeeds in an authenticating step, in the output data utilization managing step, an output permission notice is transmitted to another network device, and the transmission of the output permission notice and the use of the output data are prohibited until a print interruption notice or a print completion notice is received. Alternatively, an output request is performed in the output control step, the transmission of the output permission notice is prohibited until the output of the output data from the network device is interrupted or completed, and job tickets stored in a job ticket storage unit that stores job tickets specifying contents related to whether to permit or restrict the use of the output data are updated when the print completion notice is received or when the output of the output data is completed. In addition, when it is determined that the contents of the job tickets satisfy predetermined conditions, a utilization prohibition notice is transmitted to another network device, and the use of the output data is prohibited. In the output control step, the output process is performed on the basis of the output data, according to the output request.

According to this configuration, when the computer reads out the program to perform the process according to the read program, the same operations and effects as those in the network device according to the eighty-eighth aspect are obtained.

Furthermore, according to a one-hundred fourth aspect of the invention, there is provided an output control program that performs an output process on the basis of output data. The output control program includes a program that allows a computer to execute a process including an output data receiving step of receiving the output data; an output data storing step of storing the output data received in the output data receiving step in an output data storage unit; an output data utilization managing step of managing the use of the output data; and an output control step of performing output control on the basis of the output data stored in the output data storage unit. In the output data utilization managing step, when authentication succeeds in an authenticating step, an output permission notice is transmitted to another network device, job tickets stored in a job ticket storage unit that stores job tickets specifying contents related to whether to permit or restrict the use of the output data are updated, and the transmission of the output permission notice and the use of the output data are prohibited until a print interruption notice or a print completion notice is received. Alternatively, an output request is performed in the output control step, the job tickets stored in the job ticket storage unit are updated, the transmission of the output permission notice is prohibited until the output of the output data is interrupted or completed, the contents of the job tickets are restored to the original states before the update when the print interruption notice is received or when the output of the output data is interrupted, and a utilization prohibition notice is transmitted to another network device and the use of the output data is prohibited when it is determined that the contents of the job tickets satisfy predetermined conditions. In the output control step, the output process is performed on the basis of the output data, according to the output request.

According to this configuration, when the computer reads out the program to perform the process according to the read program, the same operations and effects as those in the network device according to the eighty-ninth aspect are obtained.

Moreover, according to a one-hundred fifth aspect of the invention, the output control program of the one-hundred third aspect or the one-hundred fourth aspect further includes a program that allows a computer to execute a process including an authentication information receiving step of receiving authentication information used for the authentication; an authentication information acquiring step of acquiring the authentication information; and the authenticating step. In the authenticating step, the use of the output data is authenticated on the basis of the authentication information received in the authentication information receiving step and the authentication information received in the authentication information acquiring step. In the output data utilization managing step, when it is determined that the use of the output data is authenticated in the authenticating step, on the basis of the authentication information received in the authentication information receiving step, the output permission notice is transmitted to another network device. When it is determined that the use of the output data is authenticated in the authenticating step on the basis of the authentication information acquired in the authentication information acquiring step, the output request is performed in the output control step.

According to this configuration, when the computer reads out the program to perform the process according to the read program, the same operations and effects as those in the network device according to the ninetieth aspect are obtained.

Further, according to a one-hundred sixth aspect of the invention, in the output control program of the one-hundred fifth aspect, in the output data utilization managing step, when it is determined that the use of the output data is authenticated in the authenticating step on the basis of the authentication information received in the authentication information receiving step and that the job tickets can be updated, the output permission notice is transmitted, and the update of the job tickets is prohibited until the print interruption notice or the print completion notice is received. In addition, when it is determined that the use of the output data is authenticated in the authenticating step, on the basis of the authentication information acquired in the authentication information acquiring step, and that the job tickets can be updated, the output request is performed, and the update of the job tickets is prohibited until the output of the output data is interrupted or completed.

According to this configuration, when the computer reads out the program to perform the process according to the read program, the same operations and effects as those in the network device according to the ninety-first aspect are obtained.

Furthermore, according to a one-hundred seventh aspect of the invention, the output control program according to any one of the one-hundred third to one-hundred sixth aspects further includes a program that allows a computer to execute a process including a utilization history information generating step of generating utilization history information indicating a utilization history of the output data, on the basis of the transmission result and the utilization result of the output data utilization managing step.

According to this configuration, when the computer reads out the program to perform the process according to the read program, the same operations and effects as those in the device using apparatus according to the ninety-second aspect are obtained.

Moreover, according to a one-hundred eighth aspect of the invention, in the output control program according to any one of the one-hundred third to one-hundred seventh aspects, in the output data utilization managing step, when it is determined that the contents of the job tickets satisfy the predetermined conditions, the utilization prohibition notice is transmitted, and the output data and the job tickets are removed.

According to this configuration, when the computer reads out the program to perform the process according to the read program, the same operations and effects as those in the device using apparatus according to the ninety-third aspect are obtained.

Further, according to the one-hundred ninth aspect of the invention, there is provided an authentication output method that performs an output process through authentication in a plurality of network devices each of which performs the output process on the basis of output data, the network devices being connected to a device using apparatus that uses the network devices so as to communicate therewith. The method includes, for the device using apparatus, an output data transmitting step of transmitting the output data to the plurality of network devices; and an output data utilization managing step of, when authentication succeeds in an authenticating step, transmitting an output permission notice to any one of the plurality of network devices, of prohibits the transmission of the output permission notice until a print interruption notice or a print completion notice is received, of updating job tickets stored in a job ticket storage unit that stores the job tickets specifying contents related to whether to permit or restrict the use of the output data when the print completion notice is received, and of transmitting a utilization prohibition notice to the plurality of network devices when it is determined that the contents of the job tickets satisfy predetermined conditions. The method includes, for the network devices, an output data receiving step of receiving the output data; an output data storing step of storing the output data received in the output data receiving step in an output data storage unit; and an output control step of performing the output process on the basis of the output data stored in the output data storage unit when the output permission notice is received, of prohibiting the use of the output data and transmitting the print interruption notice to the device using apparatus when the output of the output data from the network devices is interrupted, of transmitting the print completion notice to the device using apparatus when the output of the output data from the network devices is completed, and of prohibiting the use of the output data when the utilization prohibition notice is received.

According to this structure, the same effects as those in the authentication output system according to the sixty-seventh aspect are obtained.

Furthermore, according to a one-hundred tenth aspect of the invention, there is provided an authentication output method that performs an output process through authentication in a plurality of network devices each of which performs the output process on the basis of output data, the network devices being connected to a device using apparatus that uses the network devices so as to communicate therewith. The method includes, for the device using apparatus, an output data transmitting step of transmitting the output data to the plurality of network devices; and an output data utilization managing step of, when authentication succeeds in an authenticating step, transmitting an output permission notice to any one of the plurality of network devices, of updating job tickets stored in a job ticket storage unit that stores the job tickets specifying contents related to whether to permit or restrict the use of the output data, of prohibits the transmission of the output permission notice until a print interruption notice or a print completion notice is received, of restoring the contents of the job tickets to the original states before the update when the print interruption notice is received, and of transmitting a utilization prohibition notice to the plurality of network devices when it is determined that the contents of the job tickets satisfy predetermined conditions. In addition, the method includes, for the network devices, an output data receiving step of receiving the output data; an output data storing step of storing the output data received in the output data receiving step in an output data storage unit; and an output control step of performing the output process on the basis of the output data stored in the output data storage unit when the output permission notice is received, of prohibiting the use of the output data and transmitting the print interruption notice to the device using apparatus when the output of the output data from the network devices is interrupted, of transmitting the print completion notice to the device using apparatus when the output of the output data from the network devices is completed, and of prohibiting the use of the output data when the utilization prohibition notice is received.

According to this structure, the same effects as those in the authentication output system according to the sixty-eighth aspect are obtained.

Moreover, according to a one-hundred eleventh aspect of the invention, the authentication output method of the one-hundred ninth aspect or the one-hundred tenth aspect further includes, for the network device, an authentication information acquiring step of acquiring the authentication information; and an authentication information transmitting step of transmitting authentication information acquired in the authentication information acquiring step to the device using apparatus. In addition, the authentication output method further includes, for the device using apparatus, an authentication information receiving step of receiving the authentication information; and an authenticating step. In the authenticating step, the use of the output data is authenticated on the basis of the authentication information received in the authentication information receiving step. In the output data utilization managing step, when it is determined that the use of the output data is authenticated in the authenticating step, the output permission notice is transmitted to one of the plurality of network device, which is a source of the authentication information.

According to this structure, the same effects as those in the authentication output system according to the sixty-ninth aspect are obtained.

Further, according to a one-hundred twelfth aspect of the invention, in the authentication output method of the one-hundred eleventh aspect, in the output data utilization managing step, when it is determined that the use of the output data is authenticated in the authenticating step and that the job tickets can be updated, the output permission notice is transmitted, and the update of the job tickets is prohibited until the print interruption notice or the print completion notice is received.

According to this structure, the same effects as those in the authentication output system according to the seventieth aspect are obtained.

Furthermore, according to a one-hundred thirteenth aspect of the invention, the authentication output method according to any one of the one-hundred ninth to one-hundred twelfth aspects further includes, for the device using apparatus, a utilization history information generating step of generating utilization history information indicating a utilization history of the output data, on the basis of the transmission result of the output data utilization managing step.

According to this structure, the same effects as those in the authentication output system according to the seventy-first aspect are obtained.

Moreover, according to a one-hundred fourteenth aspect of the invention, in the authentication output method according to any one of the one-hundred ninth to one-hundred thirteenth aspects, in the output data utilization managing step, when it is determined that the contents of the job tickets satisfy the predetermined conditions, the utilization prohibition notice is transmitted, and the job tickets are removed. In the output control step, when the utilization prohibition notice is received, the output data is removed.

According to this structure, the same effects as those in the authentication output system according to the seventy-second aspect are obtained.

Further, according to the one-hundred fifteenth aspect of the invention, there is provided an authentication output method that performs an output process through authentication in first and second network devices each of which performs the output process on the basis of output data, the first and second network devices being connected to a device using apparatus that uses the network devices so as to communicate therewith. The method includes, for the device using apparatus, an output data transmitting step of transmitting the output data to the first and second network devices. The method includes, for the first network device, a first output data receiving step of receiving the output data; a first output data storing step of storing the output data received in the first output data receiving step in a first output data storage unit; an output data utilization managing step of managing the use of the output data; and a first output control step of performing output control on the basis of the output data stored in the first output data storage unit. In the output data utilization managing step, when the authentication succeeds in an authenticating step, an output permission notice is transmitted to the second network device, and the transmission of the output permission notice and the use of the output data are prohibited until a print interruption notice or a print completion notice is received. Alternatively, in the output data utilization managing step, the output of the output data is requested in the first output control step, the transmission of the output permission notice is prohibited until the output of the output data from the first network device is interrupted or completed, job tickets stored in a job ticket storage unit that stores the job tickets specifying contents related to whether to permit or restrict the use of the output data are updated when the print completion notice is received or when the output of the output data from the first network device is completed, and a utilization prohibition notice is transmitted to the second network device and the use of the output data is prohibited when it is determined that the contents of the job tickets satisfy predetermined conditions. In the first output control step, the output process is performed on the basis of the output data, according to the output request. The method includes, for the second network device, a second output data receiving step of receiving the output data; a second output data storing step of storing the output data received in the second output data receiving step in a second output data storage unit; and a second output control step of, when the output permission notice is received, performing the output process on the basis of the output data stored in the second output data storage unit, of prohibiting the use of the output data and transmitting the print interruption notice to the first network device when the output of the output data from the second network device is interrupted, of transmitting the print completion notice to the first network device when the output of the output data from the second network device is completed, and of prohibiting the use of the output data when the utilization prohibition notice is received.

According to this structure, the same effects as those in the authentication output system according to the seventy-third aspect are obtained.

Furthermore, according to the one-hundred sixteenth aspect of the invention, there is provided an authentication output method that performs an output process through authentication in first and second network devices each of which performs the output process on the basis of output data, the first and second network devices being connected to a device using apparatus that uses the network devices so as to communicate therewith. The method includes, for the device using apparatus, an output data transmitting step of transmitting the output data to the first and second network devices. The method includes, for the first network device, a first output data receiving step of receiving the output data; a first output data storing step of storing the output data received in the first output data receiving step in a first output data storage unit; an output data utilization managing step of managing the use of the output data; and a first output control step of performing output control on the basis of the output data stored in the first output data storage unit. In the output data utilization managing step, when the authentication succeeds in an authenticating step, an output permission notice is transmitted to the second network device, job tickets stored in a job ticket storage unit that stores the job tickets specifying contents related to whether to permit or restrict the use of the output data are updated, and the transmission of the output permission notice and the use of the output data are prohibited until a print interruption notice or a print completion notice is received. Alternatively, in the output data utilization managing step, the output of the output data is requested in the first output control step, the job tickets stored in the job ticket storage unit are updated, the transmission of the output permission notice is prohibited until the output of the output data from the first network device is interrupted or completed, the contents of the job tickets are restored to the original states before the update when the print interruption notice is received or when the output of the output data from the first network device is interrupted, and a utilization prohibition notice is transmitted to the second network device and the use of the output data is prohibited when it is determined that the contents of the job tickets satisfy predetermined conditions. In the first output control step, the output process is performed on the basis of the output data, according to the output request. In addition, the method includes, for the second network device, a second output data receiving step of receiving the output data; a second output data storing step of storing the output data received in the second output data receiving step in a second output data storage unit; and a second output control step of, when the output permission notice is received, performing the output process on the basis of the output data stored in the second output data storage unit, of prohibiting the use of the output data and transmitting the print interruption notice to the first network device when the output of the output data from the second network device is interrupted, of transmitting the print completion notice to the first network device when the output of the output data from the second network device is completed, and of prohibiting the use of the output data when the utilization prohibition notice is received.

According to this structure, the same effects as those in the authentication output system according to the seventy-fourth aspect are obtained.

Moreover, according to a one-hundred seventeenth aspect of the invention, the authentication output method of the one-hundred fifteenth aspect or the one-hundred sixteenth aspect further includes, for the second network device, a second authentication information acquiring step of acquiring authentication information; and an authentication information transmitting step of transmitting the authentication information acquired by the second authentication information acquiring unit to the first network device. In addition, the authentication output method further includes, for the first network device, an authentication information receiving step of receiving the authentication information; a first authentication information acquiring step of acquiring the authentication information; and the authenticating unit. In the authenticating step, the use of the output data is authenticated on the basis of the authentication information received in the authentication information receiving step and the authentication information acquired in the first authentication information acquiring step. In the output data utilization managing step, when it is determined that the use of the output data is authenticated in the authenticating step, on the basis of the authentication information received in the authentication information receiving step, the output permission notice is transmitted to the second network device. When it is determined that the use of the output data is authenticated in the authenticating unit on the basis of the authentication information acquired in the first authentication information acquiring step, the output request is performed in the first output control step.

According to this structure, the same effects as those in the authentication output system according to the seventy-fifth aspect are obtained.

Further, according to a one-hundred eighteenth aspect of the invention, in the authentication output method of the one-hundred seventeenth aspect, in the output data utilization managing step, when it is determined that the use of the output data is authenticated in the authenticating step on the basis of the authentication information received in the authentication information receiving step and that the job tickets can be updated, the output permission notice is transmitted, and the update of the job tickets is prohibited until the print interruption notice or the print completion notice is received. In addition, when it is determined that the use of the output data is authenticated in the authenticating step, on the basis of the authentication information acquired in the first authentication information acquiring step, and that the job tickets can be updated, the output request is performed, and the update of the job tickets is prohibited until the output of the output data from the first network device is interrupted or completed.

According to this structure, the same effects as those in the authentication output system according to the seventy-sixth aspect are obtained.

Furthermore, according to a one-hundred nineteenth aspect of the invention, the authentication output method according to any one of the one-hundred fifteenth to one-hundred eighteenth aspects further includes, for the first network device, a utilization history information generating step of generating utilization history information indicating a utilization history of the output data, on the basis of a transmission result and a utilization result of the output data utilization managing step.

According to this structure, the same effects as those in the authentication output system according to the seventy-seventh aspect are obtained.

Moreover, according to a one-hundred twentieth aspect of the invention, in the authentication output method according to any one of the one-hundred fifteenth to one-hundred nineteenth aspects, in the output data utilization managing step, when it is determined that the contents of the job tickets satisfy the predetermined conditions, the utilization prohibition notice is transmitted, and the output data and the job tickets are removed. In the second output control step, the output data is removed when the utilization prohibition notice is received.

According to this structure, the same effects as those in the authentication output system according to the seventy-eighth aspect are obtained.

Further, according to the one-hundred twentieth aspect of the invention, an output system includes first and second network devices each of which performs an output process on the basis of output data; and a data managing apparatus that manages the output data, the data managing apparatus being connected to the network devices so as to communicate therewith. The data managing apparatus includes: an output data storage unit that stores the output data; and an output data supplying unit that supplies the output data stored in the output data storage unit to the first network device in response to an acquiring request of the first network device. The first network device includes a job ticket storage unit that stores job tickets specifying contents related to whether to permit or restrict the use of the output data; an output data utilization managing unit that manages the use of the output data; and a first output control unit that performs output control on the basis of the output data. The output data utilization managing unit acquires the output data from the data managing apparatus, supplies the acquired output data to the second network device, and prohibits the supply and use of the output data until a print interruption notice or a print completion notice is received. Alternatively, the output data utilization managing unit outputs the acquired output data to the first output control unit, prohibits the supply of the output data until the output of the output data from the first network device is interrupted or completed, updates the job tickets stored in the job ticket storage unit when the print completion notice is received or when the output of the output data from the first network device is completed, and prohibits the supply and use of the output data when it is determined that the contents of the job tickets satisfy predetermined conditions. The first output control unit performs the output process on the basis of the output data from the output data utilization managing unit. The second network device includes an output data receiving unit that receives the output data; and a second output control unit that performs output control on the basis of the output data received by the output data receiving unit. When the output of the output data from the second network device is interrupted, the second output control unit prohibits the use of the output data and transmits the print interruption notice to the first network device. When the output of the output data from the second network device is completed, the second output control unit transmits the print completion notice to the first network device.

According to this structure, in the first network device, the output data utilization managing unit acquires the output data from the data managing apparatus.

In the data managing unit, the output data supplying unit supplies the output data to the first network device in response to the acquiring request of the first network device.

In the first network device, when the output data is acquired, the output data utilization managing unit supplies the acquired output data to the second network device, or outputs the acquired output data to the first output control unit. In the former case, the supply and use of the output data are prohibited until the print interruption notice or the print completion notice is received.

In the second network device, when the output data receiving unit receives the output data, the second output control unit performs the output control on the basis of the received output data. When the output of the output data is completed, the print completion notice is transmitted to the first network device. On the other hand, when the output of the output data is interrupted, the use of the output data is prohibited, and the print interruption notice is transmitted to the first network device.

In the first network device, when the print completion notice is received, the output data utilization managing unit updates the job tickets.

Further, in the first network device, when the output data is output to the first output control unit, the first output control unit performs the output process on the basis of the output data. Then, the output data utilization managing unit prohibits the supply of the output data until the output of the output data is interrupted or completed. When the output is completed, the job tickets are updated.

In addition, in the first network device, when it is determined that the contents of the job tickets satisfy predetermined conditions, the output data utilization managing unit prohibits the supply and use of the output data.

In this way, when the output of the output data is completed, the job tickets are updated. Therefore, even when the output of the output data from one of the first and second network devices is interrupted due to a trouble, output contents can be obtained from the other network device. In addition, only an authorized user can obtain an output matter.

Furthermore, since the output data is supplied to the second network device or the output data is used in the first network device, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

In this structure, when it is determined that the contents of the job tickets satisfy the predetermined conditions, the supply and use of the output data are prohibited. When the output of the output data is interrupted, the use of the output data is prohibited. In these cases, prohibiting the use of the output data includes, for example, removing the output data, rejecting a request for the supply or use of the output data, transmitting the utilization prohibition notice to the data managing apparatus, rewriting the attribute of the output data into ‘unavailable’, and encoding the output data such that the output data cannot be read. This is similarly applied to an output system according to a one-hundred twenty-second aspect, network devices according to one-hundred twenty-seventh and one-hundred twenty-eighth aspects, output control programs according to one-hundred thirty-third and one-hundred thirty-fourth aspects, and output methods according to one-hundred ninth and one-hundred fortieth aspects.

Further, according to the one-hundred twenty-second aspect of the invention, an output system includes first and second network devices each of which performs an output process on the basis of output data; and a data managing apparatus that manages the output data, the data managing apparatus being connected to the network devices so as to communicate therewith. The data managing apparatus includes an output data storage unit that stores the output data; and an output data supplying unit that supplies the output data stored in the output data storage unit to the first network device in response to an acquiring request of the first network device. The first network device includes a job ticket storage unit that stores job tickets specifying contents related to whether to permit or restrict the use of the output data; an output data utilization managing unit that manages the use of the output data; and a first output control unit that performs output control on the basis of the output data. The output data utilization managing unit acquires the output data from the data managing apparatus, supplies the acquired output data to the second network device, updates the job tickets stored in the job ticket storage unit, and prohibits the supply and use of the output data until a print interruption notice or a print completion notice is received. Alternatively, the output data utilization managing unit outputs the acquired output data to the first output control unit, updates the job tickets stored in the job ticket storage unit, prohibits the supply of the output data until the output of the output data from the first network device is interrupted or completed, restores the contents of the job tickets to the original states before the update when the print interruption notice is received or when the output of the output data from the first network device is interrupted, and prohibits the supply and use of the output data when it is determined that the contents of the job tickets satisfy predetermined conditions. The first output control unit performs the output process on the basis of the output data from the output data utilization managing unit. The second network device includes an output data receiving unit that receives the output data; and a second output control unit that performs output control on the basis of the output data received by the output data receiving unit. When the output of the output data from the second network device is interrupted, the second output control unit prohibits the use of the output data and transmits the print interruption notice to the first network device. When the output of the output data from the second network device is completed, the second output control unit transmits the print completion notice to the first network device.

According to this structure, in the first network device, the output data utilization managing unit acquires the output data from the data managing apparatus.

In the data managing unit, the output data supplying unit supplies the output data to the first network device in response to the acquiring request of the first network device.

In the first network device, when the output data is acquired, the output data utilization managing unit supplies the acquired output data to the second network device, or outputs the acquired output data to the first output control unit. In the former case, the job tickets are updated, and the supply and use of the output data are prohibited until the print interruption notice or the print completion notice is received.

In the second network device, when the output data receiving unit receives the output data, the second output control unit performs the output control on the basis of the received output data. When the output of the output data is completed, the print completion notice is transmitted to the first network device. On the other hand, when the output of the output data is interrupted, the use of the output data is prohibited, and the print interruption notice is transmitted to the first network device.

In the first network device, when the print completion notice is received, the output data utilization managing unit restores the contents of the job tickets to the original states before the update.

Further, in the first network device, when the output data is output to the first output control unit, the output data utilization managing unit updates the job tickets, and the first output control unit performs the output process on the basis of the output data. Then, the output data utilization managing unit prohibits the supply of the output data until the output of the output data is interrupted or completed. When the output is interrupted, the contents of the job tickets are restored to the original states before the update.

In addition, in the first network device, when it is determined that the contents of the job tickets satisfy predetermined conditions, the output data utilization managing unit prohibits the supply and use of the output data.

In this way, when the output of the output data is completed, the job tickets are updated. Therefore, even when the output of the output data from one of the first and second network devices is interrupted due to a trouble, output contents can be obtained from the other network device. In addition, only an authorized user can obtain an output matter.

Furthermore, since the output data is supplied to the second network device or the output data is used in the first network device, it is possible to prevent the same output content from being simultaneously output from the first and second network devices. In addition, even when the network device is restored from a disable state to a normal state, it is possible to prevent the output content from being output from the network device since the use of the output data is prohibited. Further, it is possible to prevent the output process from being performed beyond an output permission range, and thus to more reliably protect the secrecy of the output content.

Further, according to a one-hundred twenty-third aspect of the invention, in the output system of the one-hundred twenty-first aspect or the one-hundred twenty-second aspect, the first network device includes an authentication information receiving unit that receives authentication information used for the authentication; a first authentication information acquiring unit that acquires the authentication information; and an authenticating unit that authenticates the use of the output data on the basis of the authentication information received by the authentication information receiving unit and the authentication information acquired by the first authentication information acquiring unit. The second network device includes a second authentication information acquiring unit that acquires the authentication information; and an authentication information transmitting unit that transmits the authentication information acquired by the second authentication information acquiring unit to the first network device. When it is determined that the use of the output data is authenticated by the authenticating unit, on the basis of the authentication information received by the authentication information receiving unit, the output data utilization managing unit supplies the output data to the second network device. When it is determined that the use of the output data is authenticated by the authenticating unit on the basis of the authentication information acquired by the first authentication information acquiring unit, the output data utilization managing unit requires the first output control unit to output the output data.

According to this structure, in the second network device, when the authentication information is acquired by the second authentication information acquiring unit, the authentication information transmitting unit transmits the acquired authentication information to the first network device.

In the first network device, when the authentication information is received by the authentication information receiving unit, the authenticating unit authenticates the use of the output data on the basis of the received authentication information. As a result, when it is determined that the use of the output data is permitted, the output data utilization managing unit supplies the output data to the second network device.

Further, in the first network device, when the first authentication information acquiring unit acquires the authentication information, the authenticating unit authenticates the use of the output data on the basis of the acquired authentication information. As a result, when the use of the output data is permitted, the output data utilization managing unit requests the first network device to output the output data.

In this way, when a user inputs proper authentication information to a desired network device, the user can obtain output contents from the network device.

Furthermore, according to a one-hundred twenty-fourth aspect of the invention, in the output system of the one-hundred twenty-third aspect, when it is determined that the use of the output data is authenticated by the authenticating unit on the basis of the authentication information received by the authentication information receiving unit and that the job tickets can be updated, the output data utilization managing unit supplies the output data to the second network device, and prohibits the update of the job tickets until the print interruption notice or the print completion notice is received. In addition, when it is determined that the use of the output data is authenticated by the authenticating unit, on the basis of the authentication information acquired by the first authentication information acquiring unit and that the job tickets can be updated, the output data utilization managing unit outputs the output data to the first output control unit and prohibits the update of the job tickets until the output of the output data from the first network device is interrupted or completed.

According to this structure, in the first network device, when it is determined that the use of the output data is authenticated by the authenticating unit on the basis of the received authentication information and that the job tickets can be updated, the output data utilization managing unit supplies the output data to the second network device, and prohibits the update of the job tickets until the print interruption notice or the print completion notice is received.

In addition, in the first network device, when it is determined that the use of the output data is authenticated on the basis of the acquired authentication information and that the job tickets can be updated, the output data utilization managing unit outputs the output data to the first network device, and prohibits the update of the job tickets until the output of the output data is interrupted or completed.

Therefore, until the print interruption notice or the print completion notice is received or until the output of the output data is interrupted or completed, the output data is not supplied even though the authentication information is received, and the output of the output data is not performed even though the authentication information is acquired.

Moreover, according to a one-hundred twenty-fifth aspect of the invention, in the output system according to any one of the one-hundred twenty-first to one-hundred twenty-fourth aspects, the first network device further includes a utilization history information generating unit that creates utilization history information indicating a utilization history of the output data, on the basis of a utilization result and a supply result of the output data utilization managing unit.

According to this structure, in the first network device, the utilization history information generating unit creates the utilization history information indicating the utilization history of the output data, on the basis of the utilization result and the supply result of the output data utilization managing unit.

In this way, it is possible to see how the output data has been used by referring to the utilization history information.

Further, according to a one-hundred twenty-sixth aspect of the invention, in the output system according to the one-hundred twenty-first to one-hundred twenty-fifth aspects, when it is determined that the contents of the job tickets satisfy the predetermined conditions, the output data utilization managing unit removes the job tickets and transmits the utilization prohibition notice to the data managing apparatus. The data managing apparatus includes an output data removing unit that removes the output data when the utilization prohibition notice is received.

According to this structure, in the first network device, when it is determined that the contents of the job tickets satisfy the predetermined conditions, the output data utilization managing unit removes the job tickets and transmits the utilization prohibition notice to the data managing apparatus.

In the data managing apparatus, the output data removing unit removes the output data when the utilization prohibition notice is received.

In this way, it is possible to prevent the output data and the job tickets from being illegally used, and thus to reliably protect the secrecy of the output contents.

Furthermore, according to the one-hundred twenty-seventh aspect, there is provided a network device that performs an output process on the basis of output data. The network device includes a job ticket storage unit that stores job tickets specifying contents related to whether to permit or restrict the use of the output data; an output data utilization managing unit that manages the use of the output data; and an output control unit that performs output control on the basis of the output data. The output data utilization managing unit acquires the output data from a data managing apparatus, supplies the acquired output data to another network device, and prohibits the supply and use of the output data until a print interruption notice or a print completion notice is received. Alternatively, the output data utilization managing unit outputs the acquired output data to the output control unit, prohibits the supply of the output data until the output of the output data from the first network device is interrupted or completed, updates the job tickets stored in the job ticket storage unit when the print completion notice is received or when the output of the output data from the network device is completed, and prohibits the supply and use of the output data when it is determined that the contents of the job tickets satisfy predetermined conditions. The output control unit performs the output process on the basis of the output data from the output data utilization managing unit.

According to this structure, the same operations as those in the first network device of the authentication output system according to the one-hundred twenty-first aspect are obtained. Thus, the same effects as those in the authentication output system according to the one-hundred twenty-first aspect are obtained.

Moreover, according to the one-hundred twenty-eighth aspect of the invention, there is provided a network device that performs an output process on the basis of output data. The network device includes a job ticket storage unit that stores job tickets specifying contents related to whether to permit or restrict the use of the output data; an output data utilization managing unit that manages the use of the output data; and an output control unit that performs output control on the basis of the output data. The output data utilization managing unit acquires the output data from a data managing apparatus, supplies the acquired output data to another network device, updates the job tickets stored in the job ticket storage unit, and prohibits the supply and use of the output data until a print interruption notice or a print completion notice is received. Alternatively, the output data utilization managing unit outputs the acquired output data to the output control unit, updates the job tickets stored in the job ticket storage unit, prohibits the supply of the output data until the output of the output data from the network device is interrupted or completed, restores the contents of the job tickets to the original states before the update when the print interruption notice is received or when the output of the output data from the network device is interrupted, and prohibits the supply and use of the output data when it is determined that the contents of the job tickets satisfy predetermined conditions. The output control unit performs the output process on the basis of the output data from the output data utilization managing unit.

According to this structure, the same operations as those in the first network device of the authentication output system according to the one-hundred twenty-second aspect are obtained. Thus, the same effects as those in the authentication output system according to the one-hundred twenty-second aspect are obtained.

Further, according to a one-hundred twenty-ninth aspect of the invention, the network device of the one-hundred twenty-seventh aspect or the one-hundred twenty-eighth aspect further includes an authentication information receiving unit that receives authentication information used for the authentication; an authentication information acquiring unit that acquires the authentication information; and an authenticating unit that authenticates the use of the output data on the basis of the authentication information received by the authentication information receiving unit and the authentication information acquired by the authentication information acquiring unit. When it is determined that the use of the output data is authenticated by the authenticating unit, on the basis of the authentication information received by the authentication information receiving unit, the output data utilization managing unit supplies the output data to another network device. When it is determined that the use of the output data is authenticated by the authenticating unit on the basis of the authentication information acquired by the authentication information acquiring unit, the output data utilization managing unit outputs the output data to the output control unit.

According to this structure, the same operations as those in the first network device of the authentication output system according to the one-hundred twenty-third aspect are obtained. Thus, the same effects as those in the authentication output system according to the one-hundred twenty-third aspect are obtained.

Furthermore, according to a one-hundred thirtieth aspect of the invention, in the network device of the one-hundred twenty-ninth aspect, when it is determined that the use of the output data is authenticated by the authenticating unit on the basis of the authentication information received by the authentication information receiving unit and that the job tickets can be updated, the output data utilization managing unit supplies the output data to another network device, and prohibits the update of the job tickets until the print interruption notice or the print completion notice is received. In addition, when it is determined that the use of the output data is authenticated by the authenticating unit, on the basis of the authentication information acquired by the authentication information acquiring unit and that the job tickets can be updated, the output data utilization managing unit outputs the output data to the output control unit and prohibits the update of the job tickets until the output of the output data from the network device is interrupted or completed.

According to this structure, the same operations as those in the first network device of the authentication output system according to the one-hundred twenty-fourth aspect are obtained. Thus, the same effects as those in the authentication output system according to the one-hundred twenty-fourth aspect are obtained.

Moreover, according to a one-hundred thirty-first aspect of the invention, the network device according to the one-hundred twenty-seventh to one-hundred thirtieth aspects further includes a utilization history information generating unit that creates utilization history information indicating a utilization history of the output data, on the basis of a utilization result and a supply result of the output data utilization managing unit.

According to this structure, the same operations as those in the first network device of the authentication output system according to the one-hundred twenty-fifth aspect are obtained. Thus, the same effects as those in the authentication output system according to the one-hundred twenty-fifth aspect are obtained.

Further, according to a one-hundred thirty-second aspect of the invention, in the network device according to the one-hundred twenty-seventh to one-hundred thirty-first aspects, when it is determined that the contents of the job tickets satisfy the predetermined conditions, the output data utilization managing unit removes the job tickets and transmits the utilization prohibition notice to the data managing apparatus.

According to this structure, the same operations as those in the first network device of the authentication output system according to the one-hundred twenty-sixth aspect are obtained. Thus, the same effects as those in the authentication output system according to the one-hundred twenty-sixth aspect are obtained.

Furthermore, according to the one-hundred thirty-third aspect of the invention, there is provided an output control program that performs an output process on the basis of output data. The output control program includes a program that allows a computer to execute a process including an output data utilization managing step of managing the use of the output data; and an output control step of performing output control on the basis of the output data. In the output data utilization managing step, the output data is acquired from a data managing apparatus, the acquired output data is supplied to another network device, and the supply and use of the output data are prohibited until a print interruption notice or a print completion notice is received. Alternatively, in the output data utilization managing step, the acquired output data is output to the output control unit, the supply of the output data is prohibited until the output of the output data is interrupted or completed, job tickets stored in a job ticket storage unit that stores job tickets specifying contents related to whether to permit or restrict the use of the output data are updated when the print completion notice is received or when the output of the output data from the network device is completed, and the supply and use of the output data is prohibited when it is determined that the contents of the job tickets satisfy predetermined conditions. In the output control step, the output process is performed on the basis of the output data from the output data utilization managing step.

According to this configuration, when the computer reads out the program to perform the process according to the read program, the same operations and effects as those in the device using apparatus according to the one-hundred twenty-seventh aspect are obtained.

Moreover, according to the one-hundred thirty-fourth aspect of the invention, there is provided an output control program that performs an output process on the basis of output data. The output control program includes a program that allows a computer to execute a process including an output data utilization managing step of managing the use of the output data; and an output control step of performing output control on the basis of the output data. In the output data utilization managing step, the output data is acquired from a data managing apparatus, the acquired output data is supplied to another network device, job tickets stored in a job ticket storage unit that stores job tickets specifying contents related to whether to permit or restrict the use of the output data are updated, and the supply and use of the output data are prohibited until a print interruption notice or a print completion notice is received. Alternatively, in the output data utilization managing step, the acquired output data is output to the output control step, the job tickets stored in the job ticket storage unit are updated, the supply of the output data is prohibited until the output of the output data from the network device is interrupted or completed, the contents of the job tickets are restored to the original states before the update when the print interruption notice is received or when the output of the output data from the network device is interrupted, and the supply and use of the output data are prohibited when it is determined that the contents of the job tickets satisfy predetermined conditions. In the output control step, the output process is performed on the basis of the output data from the output data utilization managing step.

According to this configuration, when the computer reads out the program to perform the process according to the read program, the same operations and effects as those in the device using apparatus according to the one-hundred twenty-eighth aspect are obtained.

Further, according to a one-hundred thirty-fifth aspect of the invention, the output control program of the one-hundred thirty-third aspect or the one-hundred thirty-fourth aspect further includes a program that allows a computer to execute a process including an authentication information receiving step of receiving authentication information used for the authentication; an authentication information acquiring step of acquiring the authentication information; and an authenticating step of authenticating the use of the output data on the basis of the authentication information received in the authentication information receiving step and the authentication information acquired in the authentication information acquiring step. In the output data utilization managing step, when it is determined that the use of the output data is authenticated in the authenticating step, on the basis of the authentication information received in the authentication information receiving step, the output data is supplied to another network device. When it is determined that the use of the output data is authenticated in the authenticating unit on the basis of the authentication information acquired in the authentication information acquiring step, the output data is output to the output control step.

According to this configuration, when the computer reads out the program to perform the process according to the read program, the same operations and effects as those in the device using apparatus according to the one-hundred twenty-ninth aspect are obtained.

Furthermore, according to a one-hundred thirty-sixth aspect of the invention, in the output control program of the one-hundred thirty-fifth aspect, in the output data utilization managing step, when it is determined that the use of the output data is authenticated in the authenticating step on the basis of the authentication information received in the authentication information receiving step and that the job tickets can be updated, the output data is supplied to another network device, and the update of the job tickets is prohibited until the print interruption notice or the print completion notice is received. In addition, in the output data utilization managing step, when it is determined that the use of the output data is authenticated in the authenticating step, on the basis of the authentication information acquired in the authentication information acquiring step, and that the job tickets can be updated, the output data is output to the output control step, and the update of the job tickets is prohibited until the output of the output data from the network device is interrupted or completed.

According to this configuration, when the computer reads out the program to perform the process according to the read program, the same operations and effects as those in the device using apparatus according to the one-hundred thirtieth aspect are obtained.

Moreover, according to a one-hundred thirty-seventh aspect of the invention, the output control program according to any one of the one-hundred thirty-third to one-hundred thirty-sixth aspects further includes a program that allows a computer to execute a process including a utilization history information generating step of generating utilization history information indicating a utilization history of the output data, on the basis of a utilization result and a supply result of the output data utilization managing step.

According to this configuration, when the computer reads out the program to perform the process according to the read program, the same operations and effects as those in the device using apparatus according to the one-hundred thirty-first aspect are obtained.

Further, according to a one-hundred thirty-eighth aspect of the invention, in the output control program according to any one of the one-hundred thirty-third to one-hundred thirty-seventh aspects, in the output data utilization managing step, when it is determined that the contents of the job tickets satisfy the predetermined conditions, the job tickets are removed, and the utilization prohibition notice is transmitted to the data managing apparatus.

According to this configuration, when the computer reads out the program to perform the process according to the read program, the same operations and effects as those in the device using apparatus according to the one-hundred thirty-second aspect are obtained.

Furthermore, according to the one-hundred thirty-ninth aspect of the invention, there is provided an output method used for an output system including first and second network devices each of which performs an output process on the basis of output data and a data managing apparatus that manages the output data, the data managing apparatus being connected to the network devices so as to communicate therewith. The output method includes, for the first network device, an output data utilization managing step of managing the use of the output data; and a first output control step of performing output control on the basis of the output data. In the output data utilization managing step, the output data is acquired from the data managing apparatus, the acquired output data is supplied to the second network device, and the supply and use of the output data are prohibited until a print interruption notice or a print completion notice is received. Alternatively, in the output data utilization managing step, the acquired output data is output to the first output control unit, the supply of the output data is prohibited until the output of the output data from the first network device is interrupted or completed, job tickets stored in a job ticket storage unit that stores job tickets specifying contents related to whether to permit or restrict the use of the output data are updated when the print completion notice is received or when the output of the output data from the first network device is completed, and the supply and use of the output data are prohibited when it is determined that the contents of the job tickets satisfy predetermined conditions. In the first output control step, the output process is performed on the basis of the output data from the output data utilization managing step. In addition, the output method includes, for the data managing apparatus, an output data supplying step of supplying the output data stored in an output data storage unit to the first network device in response to an acquiring request of the first network device. The output method includes, for the second network device, an output data receiving step of receiving the output data; and a second output control step of, when the output of the output data from the second network device is interrupted, prohibiting the use of the output data received in the output data receiving step and transmitting the print interruption notice to the first network device, and of transmitting the print completion notice to the first network device when the output of the output data from the second network device is completed.

According to this structure, the same effects as those in the authentication output system according to the one-hundred twenty-first aspect are obtained.

Moreover, according to the one-hundred fortieth aspect of the invention, there is provided an output method used for an output system including first and second network devices each of which performs an output process on the basis of output data, and a data managing apparatus that manages the output data, the data managing apparatus being connected to the network devices so as to communicate therewith. The output method includes, for the first network device, an output data utilization managing step of managing the use of the output data; and a first output control step of performing output control on the basis of the output data. In the output data utilization managing step, the output data is acquired from the data managing apparatus, the acquired output data is supplied to the second network device, job tickets stored in a job ticket storage unit that stores the job tickets specifying contents related to whether to permit or restrict the use of the output data are updated, and the supply and use of the output data are prohibited until a print interruption notice or a print completion notice is received. Alternatively, in the output data utilization managing step, the acquired output data is output to the first output control unit, the job tickets stored in the job ticket storage unit are updated, the supply of the output data is prohibited until the output of the output data from the first network device is interrupted or completed, the contents of the job tickets are restored to the original states before the update when the print interruption notice is received or when the output of the output data from the first network device is interrupted, and the supply and use of the output data are prohibited when it is determined that the contents of the job tickets satisfy predetermined conditions. In the first output control step, the output process is performed on the basis of the output data from the output data utilization managing step. The output method includes, for the data managing apparatus, an output data supplying step of supplying the output data stored in an output data storage unit to the first network device in response to an acquiring request of the first network device. In addition, the method includes, for the data managing apparatus, an output data receiving step of receiving the output data; and a second output control step of, when the output of the output data from the second network device is interrupted, prohibiting the use of the output data received in the output data receiving step and transmitting the print interruption notice to the first network device, and of transmitting the print completion notice to the first network device when the output of the output data from the second network device is completed.

According to this structure, the same effects as those in the authentication output system according to the one-hundred twenty-second aspect are obtained.

Further, according to a one-hundred forty-first aspect of the invention, in the output method of the one-hundred thirty-ninth aspect or the one-hundred fortieth aspect, the output method further includes, for the second network device, a second authentication information acquiring step of acquiring authentication information; and an authentication information transmitting step of transmitting the authentication information acquired in the second authentication information acquiring step to the first network device. In addition, the output method further includes, for the first network device, an authentication information receiving step of receiving the authentication information; a first authentication information acquiring step of acquiring the authentication information; and an authenticating step of authenticating the use of the output data on the basis of the authentication information received in the authentication information receiving step and the authentication information acquired in the first authentication information acquiring step. In the output data utilization managing step, when it is determined that the use of the output data is authenticated in the authenticating step, on the basis of the authentication information received in the authentication information receiving step, the output data is supplied to the second network device. When it is determined that the use of the output data is authenticated in the authenticating step on the basis of the authentication information acquired in the first authentication information acquiring step, the output data is output to the first output control step.

According to this structure, the same effects as those in the authentication output system according to the one-hundred twenty-third aspect are obtained.

Furthermore, according to a one-hundred forty-second aspect of the invention, in the output method of the one-hundred forty-first aspect, in the output data utilization managing step, when it is determined that the use of the output data is authenticated in the authenticating step, on the basis of the authentication information received in the authentication information receiving step, and that the job tickets can be updated, the output data is supplied to the second network device, and the update of the job tickets are prohibited until the print interruption notice or the print completion notice is received. In addition, in the output data utilization managing step, when it is determined that the use of the output data is authenticated in the authenticating unit, on the basis of the authentication information acquired in the first authentication information acquiring step, and that the job tickets can be updated, the output data is output to the first output control step, and the update of the job tickets is prohibited until the output of the output data from the first network device is interrupted or completed.

According to this structure, the same effects as those in the authentication output system according to the one-hundred twenty-fourth aspect are obtained.

Moreover, according to a one-hundred forty-third aspect of the invention, the output method according to any one of the one-hundred thirty-ninth to one-hundred forty-second aspects further includes, the first network device, a utilization history information generating step of generating utilization history information indicating a utilization history of the output data, on the basis of a utilization result and a supply result of the output data utilization managing step.

According to this structure, the same effects as those in the authentication output system according to the one-hundred twenty-fifth aspect are obtained.

Further, according to a one-hundred forty-fourth aspect of the invention, in the output method according to any one of the one-hundred thirty-ninth to one-hundred forty-third aspects, in the output data utilization managing step, when it is determined that the contents of the job tickets satisfy the predetermined conditions, the job tickets are removed, and the utilization prohibition notice is transmitted to the data managing apparatus. In addition, the output method further includes, for the data managing apparatus, includes an output data removing step of removing the output data when the utilization prohibition notice is received.

According to this structure, the same effects as those in the authentication output system according to the one-hundred twenty-sixth aspect are obtained.

### BRIEF DESCRIPTION OF THE DRAWINGS

The invention will be described with reference to the accompanying drawings, wherein like numbers reference like elements.

FIG. 1 is a functional block diagram illustrating a functional outline of a network device.

FIG. 2 is a block diagram illustrating the hardware configuration of a host terminal.

FIG. 3 is a flowchart illustrating a print data generating process.

FIG. 4 is a view illustrating the data structure of a job ticket.

FIG. 5 is a flowchart illustrating a print request receiving process.

FIG. 6 is a flowchart illustrating a print result receiving process.

FIG. 7 is a block diagram illustrating the hardware configuration of a network printer.

FIG. 8 is a flowchart illustrating a print control process.

FIG. 9 is a flowchart illustrating the print state monitoring process.

FIG. 10 is a functional block diagram illustrating a functional outline of the network system.

FIG. 11 is a flowchart illustrating a print data generating process.

FIG. 12 is a block diagram illustrating the hardware configuration of a network printer.

FIG. 13 is a flowchart illustrating a print data storing process.

FIG. 14 is a flowchart illustrating a print control process.

FIG. 15 is a flowchart illustrating a print state monitoring process.

FIG. 16 is a view illustrating the data structure of the job ticket.

FIG. 17 is a view illustrating the data structure of the job ticket.

FIG. 18 is a flowchart illustrating the job ticket updating process.

FIG. 19 is a functional block diagram illustrating a functional outline of a network device.

FIG. 20 is a block diagram illustrating the hardware configuration of a host terminal.

FIG. 21 is a flowchart illustrating a print data generating process.

FIG. 22 is a view illustrating the data structure of a job ticket.

FIG. 23 is a flowchart illustrating a print request receiving process.

FIG. 24 is a flowchart illustrating a print result receiving process.

FIG. 25 is a block diagram illustrating the hardware configuration of a network printer.

FIG. 26 is a flowchart illustrating a print data storing process.

FIG. 27 is a flowchart illustrating a print control process.

FIG. 28 is a flowchart illustrating a print state monitoring process.

FIG. 29 is a flowchart illustrating a print data deleting process.

FIG. 30 is a functional block diagram illustrating a functional outline of a network device.

FIG. 31 is a flowchart illustrating a print data generating process.

FIG. 32 is a block diagram illustrating the hardware configuration of a network printer.

FIG. 33 is a flowchart illustrating a print data storing process.

FIG. 34 is a flowchart illustrating a print control process.

FIG. 35 is a flowchart illustrating a print state monitoring process.

FIG. 36 is a view illustrating the data structure of a job ticket.

FIG. 37 is a view illustrating the data structure of a job ticket.

FIG. 38 is a flowchart illustrating the job ticket updating process.

FIG. 39 is a functional block diagram illustrating a functional outline of a network device.

FIG. 40 is a block diagram illustrating the hardware configuration of a host terminal.

FIG. 41 is a flowchart illustrating a print data generating process.

FIG. 42 is a view illustrating the data structure of a job ticket.

FIG. 43 is a flowchart illustrating a print data supplying process.

FIG. 44 is a flowchart illustrating a print data deleting process.

FIG. 45 is a block diagram illustrating the hardware configuration of a network printer.

FIG. 46 is a view illustrating a job ticket storing process.

FIG. 47 is a flowchart illustrating a print control process.

FIG. 48 is a flowchart illustrating a print state monitoring process.

FIG. 49 is a flowchart illustrating a print request receiving process.

FIG. 50 is a flowchart illustrating a print result receiving process.

FIG. 51 is a block diagram illustrating the hardware configuration of a network printer.

FIG. 52 is a flowchart illustrating a print control process.

FIG. 53 is a flowchart illustrating a print state monitoring process.

FIG. 54 is a view illustrating the data structure of a job ticket.

FIG. 55 is a view illustrating the data structure of a job ticket.

FIG. 56 is a flowchart illustrating the job ticket updating process.

### DESCRIPTION OF EXEMPLARY EMBODIMENTS

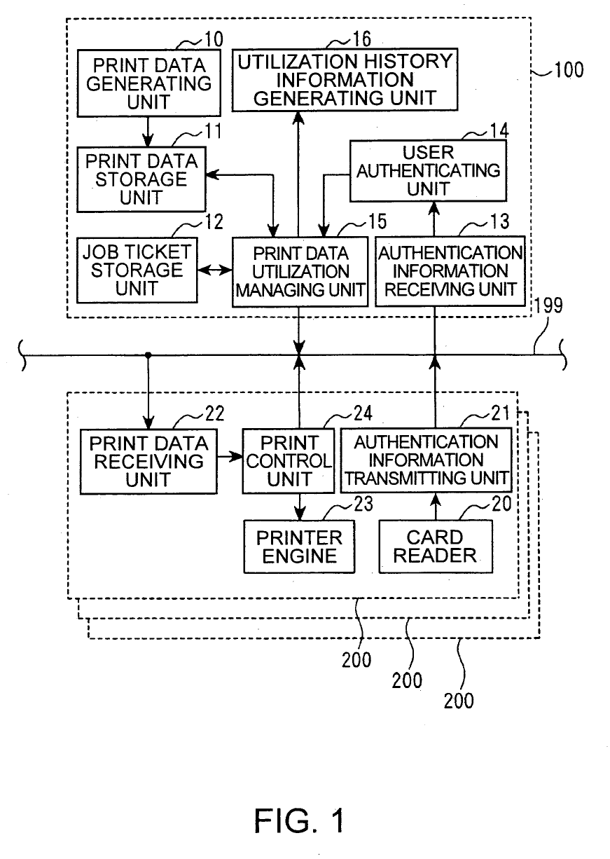

Hereinafter, a first embodiment of the invention will be described with reference to the drawings. FIGS. 1 to 9 are diagrams showing the first embodiment of an authentication output system, a device utilizing apparatus, a network device, an output data management program, an output control program, and an authentication output method according to the invention.

In the present embodiment, as shown in FIG. 1, the authentication output system, the device utilizing apparatus, the network device, the output data management program, the output control program, and the authentication output method according to the invention are applied to a case in which printing is performed by a network printer 200 by using an authentication card.

First, the functional outline of a network system, to which the invention is applied, will be described with reference to FIG. 1.

FIG. 1 is a functional block diagram illustrating the functional outline of the network system.

As shown in FIG. 1, a host terminal 100 and a plurality of network printers 200 are connected to a network 199.

The host terminal 100 has a print data generating unit 10 that generates print data, a print data storage unit 11 that stores print data generated by the print data generating unit 10, a job ticket storage unit 12 that stores a job ticket specifying the number of printable copies, an authentication information receiving unit 13 that receives authentication information, a user authenticating unit 14 that performs user authentication on the basis of the authentication information received by the authentication information receiving unit 13, and a print data utilization managing unit 15 that manages the utilization of print data.

When the user authentication is accomplished by the user authenticating unit 14 and when it is determined that the job ticket of the job ticket storage unit 12 is updatable, the print data utilization managing unit 15 provides print data of the print data storage unit 11 to one of the network printers 200, the one (of the network printers 200) being a source having transmitted the authentication information, and prohibits the update of the job ticket until a print interruption notice or a print completion notice is received. When the print completion notice is received, the number of printable copies of the job ticket is decremented. Then, when it is determined that the number of printable copies is ‘0’, print data and the job ticket are deleted. Hereinafter, prohibiting the update of the job ticket is referred to as ‘freezing the job ticket’.

In addition, the host terminal 100 also has a utilization history information generating unit 16 that generates utilization history information on the basis of the provision result of the print data utilization managing unit 15, the utilization history information indicating the utilization history of print data.

The network printer 200 has a card reader 20 that reads the authentication information from an insert authentication card, an authentication information transmitting unit 21 that transmits the authentication information read by the card reader 20 to the host terminal 100, a print data receiving unit 22 that receives print data, a printer engine 23 that has a print head, a head driving unit, and other mechanisms required for printing, and a print control unit 24 that performs a print control of the printer engine 23 on the basis of print data received by the print data receiving unit 22.

When the printer engine 23 stops printing, the print control unit 24 removes print data being printed and transmits the print interruption notice to the host terminal 100. Further, when printing is completed by the printer engine 23, the print control unit 24 transmits the print completion notice to the host terminal 100.

Next, the configuration of the host terminal 100 will be described.

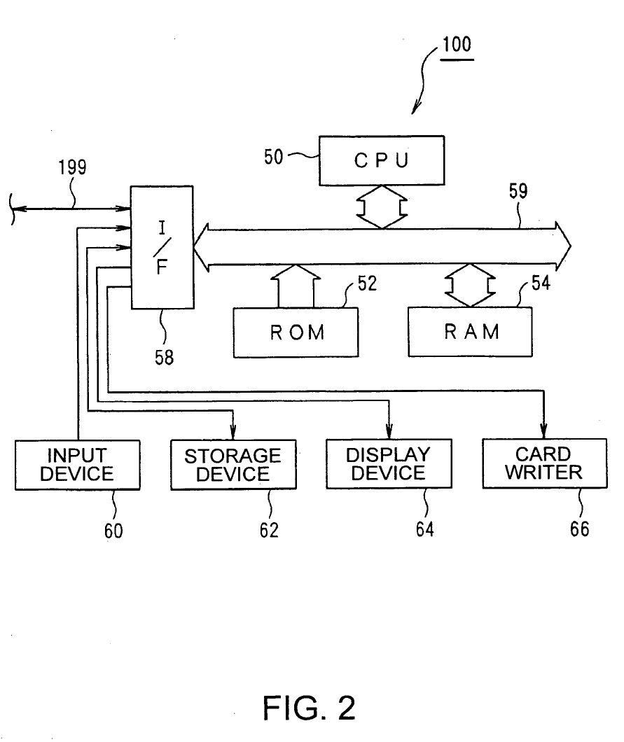

FIG. 2 is a block diagram illustrating the hardware configuration of the host terminal 100.

As shown in FIG. 2, the host terminal 100 has a CPU 50 that performs operations and controls the overall system on the basis of a control program, a ROM 52 that stores the control program of the CPU 50 or the like in a predetermined area in advance, a RAM 54 that stores data read from the ROM 52 or the like and operation results required for the operation process of the CPU 50, and an I/F 58 that intermediates an input/output of data to/from peripheral devices. Those are communicably connected to one another by a bus 59, which serves as a signal line for transmitting data.

To the I/F 58, an input device 60, serving as a human interface, such as a keyboard, a mouse, or the like, through which data can be inputted, a storage device 62 that stores data or tables in files, a display device 64 that displays an image on the basis of an image signal, a card writer 66 that writes the authentication information into an inserted authentication card, all of which are peripheral devices, and signal lines for connection with the network 199 are connected.

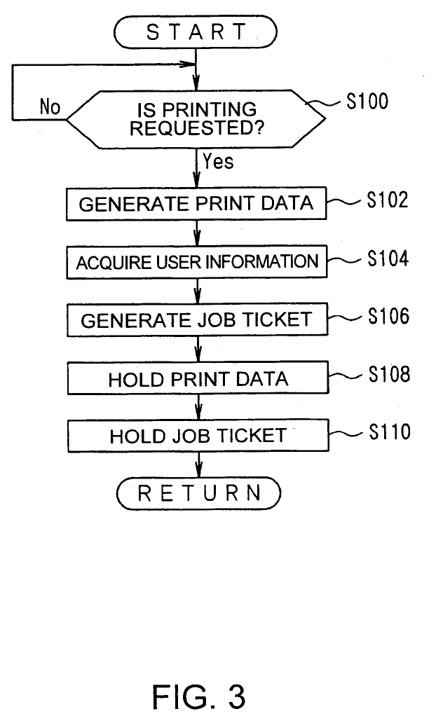

The CPU 50 has a micro processing unit or the like, starts the control program stored in the predetermined area of the ROM 52, and executes a print data generating process, a print request receiving process, and a print result receiving process shown in flowcharts of FIGS. 3, 5 and 6 according to the control program in a time-division manner.

First, the print data generating process will be described in detail with reference to FIG. 3.

FIG. 3 is the flowchart showing the print data generating process.

As shown in FIG. 3, if the print data generating process is executed by the CPU 50, first, the process proceeds to step S100.

In step S100, it is determined whether or not printing is requested from a documentation application or the like. If it is determined that printing is requested (Yes), the process proceeds to step S102. On the other hand, if it is determined that printing is not requested (No), the process is on standby at step S100 until printing is requested.

In step S102, a job ID for uniquely identifying print data is issued, and print data including the issued job ID is generated on the basis of document data edited by the documentation application or the like. Then, the process proceeds to step S104.

In step S104, user information of a user who uses the host terminal 100 at present is acquired, and the process proceeds to step S106. Then, in step S106, a job ticket is generated on the basis of the issued job ID and the acquired user information.

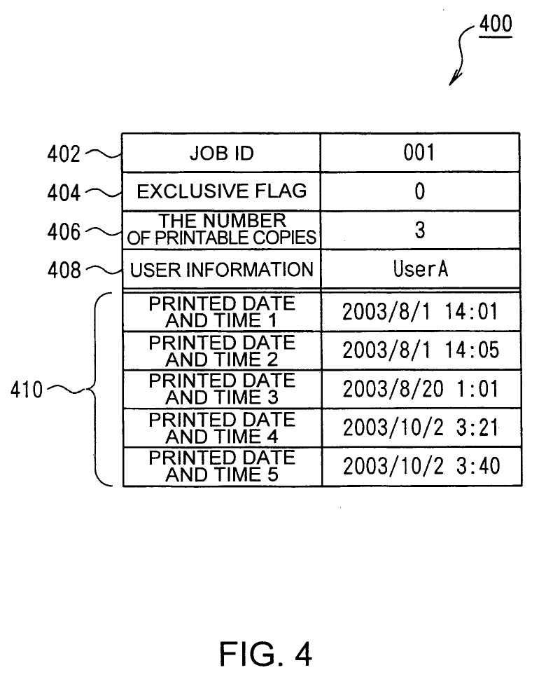

FIG. 4 is a view illustrating the data structure of the job ticket 400.

As shown in FIG. 4, the job ticket 400 includes a field 402 that stores the job ID, a field 404 that stores an exclusive flag indicating whether or not the job ticket 400 is frozen, a field 406 that stores the number of printable copies, and a field 408 that stores the user information. In addition, the job ticket 400 also has a field 410 that stores the utilization history information whenever print data is used.

In the example of FIG. 4, ‘001’, ‘0’, ‘3’, and ‘UserA’ are stored as the job ID, the exclusive flag, the number of printable copies, and the user information, respectively. This indicates that print data of the job ID of ‘001’ can be printed by a user having the user information of ‘UserA’, and the number of printable copies is three. Further, the exclusive flag is reset, which indicates that the job ticket is not frozen at present. Here, the number of printable copies may be optionally specified by the user or may be set to a predetermined value.

Further, five records are stored as the utilization history information. This indicates that print data of the job ID of ‘001’ has been already printed by five copies. In this case, as the utilization history, the printed date and time is shown.

Next, the process proceeds to step S108, and generated print data is stored in the storage device 62. Subsequently, the process proceeds to step S110, the generated job ticket is stored in the storage device 62. After the series of steps are completed, the process returns to the initial step.

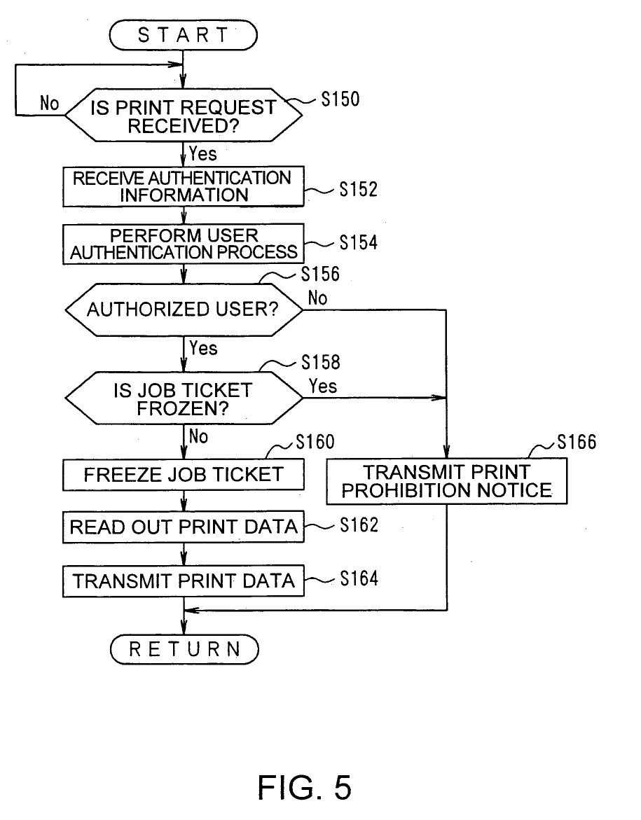

Next, the print request receiving process will be described in detail with reference to FIG. 5.

FIG. 5 is the flowchart showing the print request receiving process.

The print request receiving process is a process of receiving the print request from the network printer 200. As shown in FIG. 5, if the print request receiving process is executed by the CPU 50, first, the process proceeds to step S150.

In step S150, it is determined whether or not the print request is received. If it is determined that the print request is received (Yes), the process proceeds to step S152. On the other hand, if it is determined that the print request is not received (No), the process is on standby at step S150 until the print request is received.

In step S152, the authentication information including the job ID and the user information is received, and the process proceeds to step S154. In step S154, a user authentication process for performing the user authentication on the basis of the received authentication information is executed. In the user authentication process, the job ticket corresponding to the job ID included in the received authentication information is retrieved from the storage device 62. As a result, when the corresponding job ticket is retrieved, it is determined whether or not the user information of the retrieved job ticket corresponds with the user information included in the received authentication information. Then, if it is determined that the user information of the job ticket corresponds with the user information included in the received authentication information, it is determined that the user is eligible to use the print data. On the other hand, when the corresponding job ticket is not retrieved or when the user information of the job ticket does not correspond with the user information included in the authentication information, it is determined that the user is not eligible to use the print data.

Next, the process proceeds to step S156, and the result of the user authentication process is determined. If it is determined that the user is eligible to use the print data (Yes), the process proceeds to step S158. In step S158, it is determined whether or not the exclusive flag of the retrieved job ticket is set. If it is determined that the exclusive flag is not set (No), it is determined that the job ticket is not frozen, and then the process proceeds to step S160.

In step S160, the exclusive flag of the retrieved job ticket is set, and the process proceeds to step S162. In step S162, print data corresponding to the job ID of the retrieved job ticket is read out from the storage device 62 and the process proceeds to step S164. In step S164, print data read from the storage device 62 is transmitted to the network printer 200, which is a source of the print request. After the series of steps are completed, the process returns to the initial step.

In step S158, when it is determined that the exclusive flag of the retrieved job ticket is set (Yes), it is determined that the job ticket is frozen. Next, the process proceeds to step S166, and a print prohibition notice is transmitted to the network printer 200, which is a source of the print request. After the series of steps are completed, the process returns to the initial step.

In step S156, when it is determined that the user is not eligible to use the print data (No), the process proceeds to step S166.

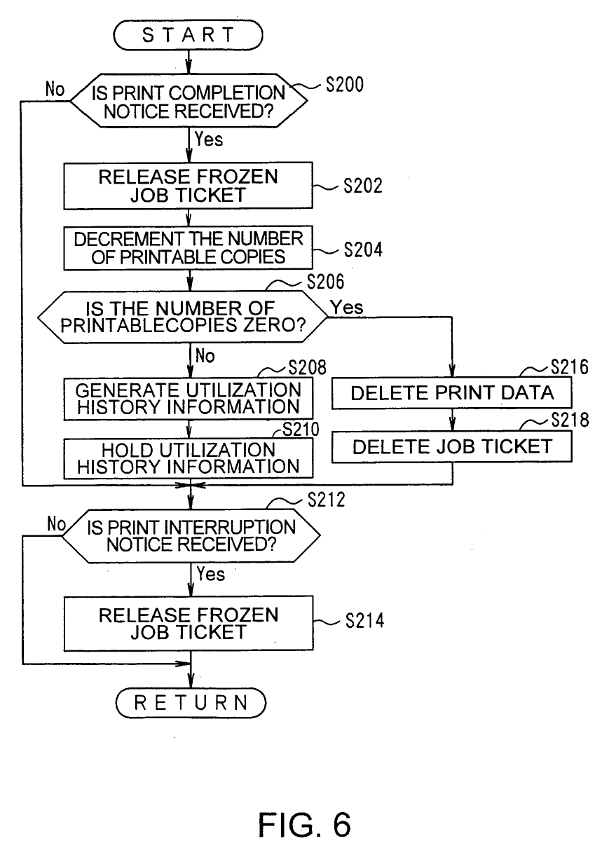

Next, the print result receiving process will be described in detail with reference to FIG. 6.

FIG. 6 is the flowchart showing the print result receiving process.

The print result receiving process is a process of receiving the print result from the network printer 200. As shown in FIG. 6, if the print result receiving process is executed by the CPU 50, first, the process proceeds to step S200.

In step S200, it is determined whether or not the print completion notice including the job ID is received, and when it is determined that the print completion notice is received (Yes), the process proceeds to step S202. In step S202, the job ticket corresponding to the job ID included in the received print completion notice is retrieved from the storage device 62, and the exclusive flag of the retrieved job ticket is reset. Next, the process proceeds to step S204, and the number of printable copies of the retrieved job ticket is decremented by ‘1’. Then, the process proceeds to step S206.

In step S206, it is determined whether or not the number of printable copies is ‘0’, and when it is determined that the number of printable copies is not ‘0’ (No), the process proceeds to step S208. In step S208, the utilization history information including the printed date and time is generated, and the process proceeds to step S210. In step S210, the generated utilization history information is stored in the storage device 62 while being added to the retrieved job ticket, and the process proceeds to step S212.

In step S212, it is determined whether or not the print interruption notice including the job ID is received, and when it is determined that the print interruption notice is received (Yes), the process proceeds to step S214. In step S214, the job ticket corresponding to the job ID included in the received print completion notice is retrieved from the storage device 62 and the exclusive flag of the retrieved job ticket is reset. After the series of steps are completed, the process returns to the initial step.

In step S212, when it is determined that the print interruption notice is not received (No), the series of steps are completed, and then the process returns to the initial step.

In step S206, when it is determined that the number of printable copies is ‘0’ (Yes), the process proceeds to step S216. In step S216, print data corresponding to the job ID included in the received print completion notice is deleted from the storage device 62 and the process proceeds to step S218. In step S218, the job ticket corresponding to the job ID included in the received print completion notice is deleted from the storage device 62, and the process proceeds to step S212.

In step S200, when it is determined that the print completion notice is not received (No), the process proceeds to step S212.

Next, the configuration of the network printer 200 will be described.

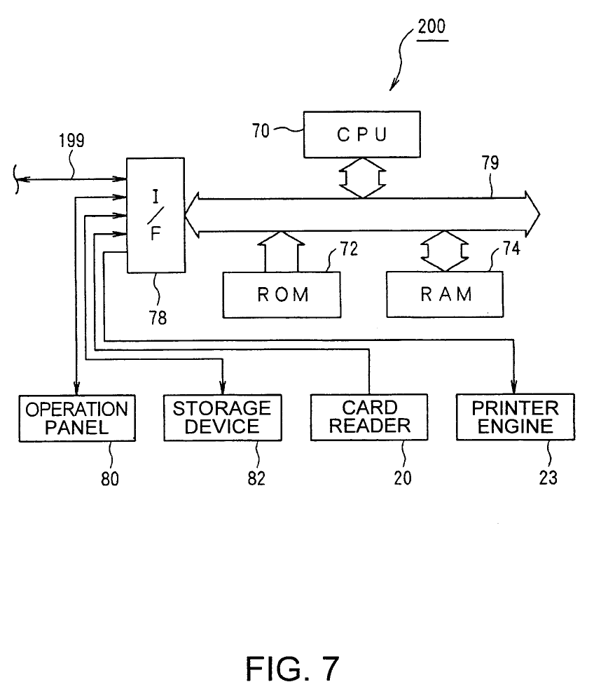

FIG. 7 is a block diagram illustrating the hardware configuration of the network printer 200.

As shown in FIG. 7, the network printer 200 has a CPU 70 that performs operations and controls the overall system on the basis of a control program, a ROM 72 that stores the control program of the CPU 70 or the like in a predetermined area in advance, a RAM 74 that stores data read from the ROM 72 or the like and operation results required for the operation process of the CPU 70, and an I/F 78 that intermediates an input/output of data to/from peripheral devices. Those are communicably connected to one another by a bus 79, which serves as a signal line for transmitting data.

To the I/F 78, an operation panel 80, serving as a human interface, such as a touch panel through which data can be inputted and displayed, a storage device 82 for storing data or tables in files, the card reader 20, the printer engine 23, all of which are peripheral devices, and signal lines for connection with the network 199 are connected.

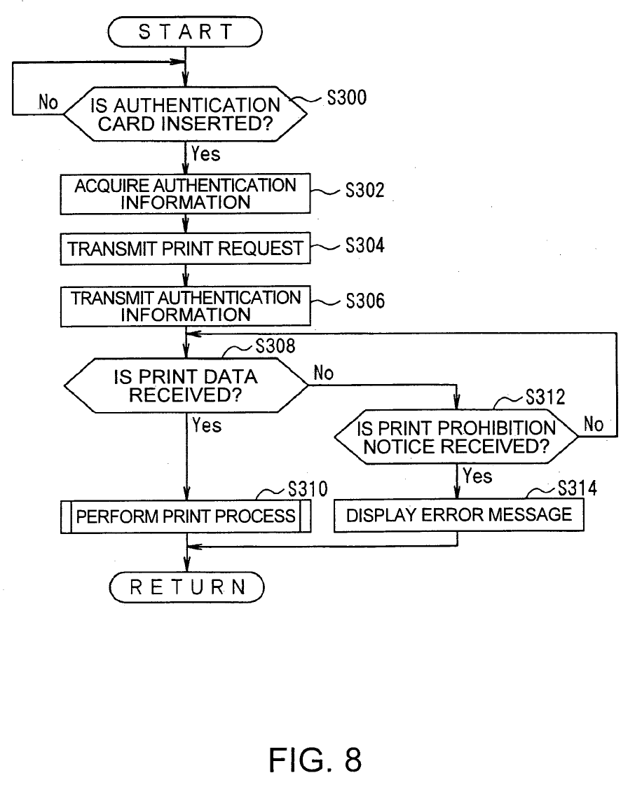

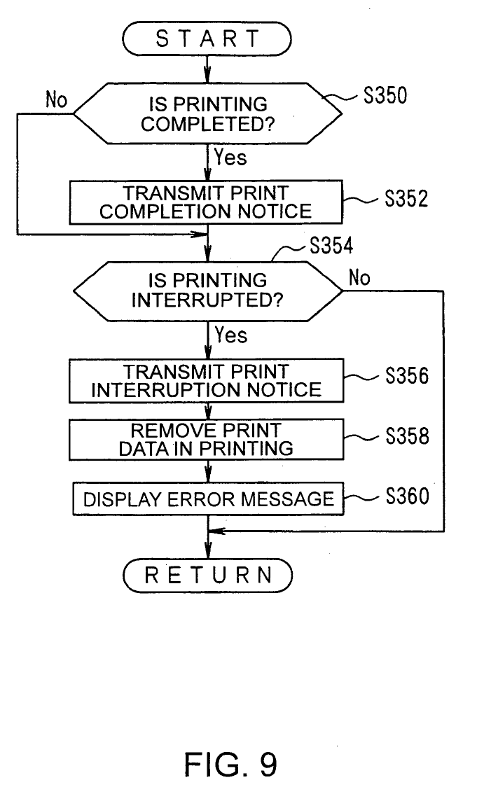

The CPU 70 has a micro processing unit or the like, runs a predetermined program stored in a predetermined area of the ROM 72, and executes a print control process and a print state monitoring process shown in flowcharts of FIGS. 8 and 9 according to the program in a time-division manner.

First, the print control process will be described in detail with reference to FIG. 8.

FIG. 8 is the flowchart showing the print control process.

The print control process is a process of performing the print control of the printer engine 23. As shown in FIG. 8, if the print control process is executed by the CPU 70, first, the process proceeds to step S300.

In step S300, it is determined whether or not the authentication card is inserted into the card reader 20, and when it is determined that the authentication card is inserted (Yes), the process proceeds to step S302. If it is determined that the authentication card is not inserted (No), the process is on standby at step S300 until the authentication card is inserted.

In step S302, the authentication information is read from the authentication card by the card reader 20, and the process proceeds to step S304. In step S304, the print request is transmitted to the host terminal 100, and the process proceeds to step S306. In step S306, the authentication information read from the authentication card is transmitted to the host terminal 100, and the process proceeds to step S308.

In step S308, it is determined whether or not print data is received, and when it is determined that print data is received (Yes), the process proceeds to step S310. In step S310, a print process for performing the print control of the printer engine 23 is executed on the basis of received print data. After the series of steps are completed, the process returns to the initial step.

In step S308, when it is determined that print data is not received (No), the process proceeds to step S312. In step S312, it is determined whether or not the print prohibition notice is received, and when it is determined that the print prohibition notice is received (Yes), the process proceeds to step S314. In step S314, an error message is displayed on the operation panel 80. After the series of steps are completed, the process returns to the initial step.

In step S312, when it is determined that the print prohibition notice is not received (No), the process proceeds to step S308.

Next, the print state monitoring process will be described in detail with reference to FIG. 9.

FIG. 9 is the flowchart showing the print state monitoring process.

The print state monitoring process is a process of monitoring a printing state of the printer engine 23. As shown in FIG. 9, if the print state monitoring process is executed by the CPU 70, first, the process proceeds to step S350.

In step S350, it is determined whether or not printing is completed by the printer engine 23, and when it is determined that printing is completed (Yes), the process proceeds to step S352. In step S352, the print completion notice including the job ID of the print-completed print data is transmitted to the host terminal 100 and the process proceeds to step S354.

In step S354, it is determined whether or not the printer engine 23 has stopped printing, and when it is determined that the printer engine 23 has stopped printing (Yes), the process proceeds to step S356. In step S356, the print interruption notice including the job ID of the print-interrupted print data is transmitted to the host terminal 100 and the process proceeds to step S358. In step S358, print data being printed is removed and the process proceeds to step S360. In step S360, an error message is displayed on the operation panel 80. After the series of steps are completed, the process returns to the initial step.

In step S354, when it is determined that the printer engine 23 has not stopped printing (No), the series of steps are completed, and then the process returns to the initial step.

In step S350, when it is determined that printing is not completed by the printer engine 23 (No), the process proceeds to step S354.

Next, the operation of the present embodiment will be described.

In the host terminal 100, the user edits document data by using the documentation application or the like and requests to print it.

In the host terminal 100, if printing is requested, print data and the job ticket are generated and print data and the job ticket generated are stored in the storage device 62 through steps to S102 S110.

Next, in the host terminal 100, the user inserts the authentication card into the card writer 66 so as to allow the job ID and the user information of his own to be written into the authentication card by the card writer 66. Then, the user goes to one of the network printers 200 and inserts the authentication card into the card reader 20.

In the network printer 200, if the authentication card is inserted, the authentication information is read from the authentication card by the card reader 20, and the read authentication information and the print request are transmitted to the host terminal 100 through steps S302 to S306.

In the host terminal 100, if the authentication information and the print request are received, the user authentication is performed on the basis of the received authentication information in step S154. As a result, if the user authentication is accomplished, through steps S160 to S164, the job ticket is frozen, print data is read out from the storage device 62, and print data read from the storage device 62 is transmitted to the network printer 200, which is a source of the print request.

In the network printer 200, if print data is received, through step S310, the print control is performed on the basis of received print data. Then, if printing is completed, through step S352, the print completion notice is transmitted to the host terminal 100.

In the host terminal 100, if the print completion notice is received, through steps S202 and S204, the job ticket is not frozen (e.g., released) and the number of printable copies of the job ticket is decremented. As a result, if the number of printable copies becomes ‘0’, through steps S208 and S210, the utilization history information is generated and the generated utilization history information is stored in the storage device 62 while being added to the job ticket.

Next, a case in which printing is interrupted will be described.

In the network printer 200, if printing is interrupted due to a trouble, such as a paper jam or the like, through steps S356 to S360, the print interruption notice is transmitted to the host terminal 100, print data being printed is removed, and the error message is displayed.

In the host terminal 100, if the print interruption notice is received, through step S214, the job ticket is not frozen.

Next, the user removes the authentication card from the card reader 20 in the network printer 200, in which printing is interrupted. Then, the user goes to another network printer 200 and inserts the authentication card into the card reader 20. Hereinafter, in another network printer 200 and the host terminal 100, the same operation as described above is performed, and printing is performed by another network printer 200. The number of printable copies is not decremented even when printing is interrupted. When printing is completed by another network printer 200, the number of printable copies is decremented.

Next, a case will be described in which the authentication card is removed for the purpose of insertion into the card reader 20 of another network printer 200 while one of the network printers 200 is in a printing operation.

In the network printer 200, if the authentication card is inserted, the authentication information is read from the authentication card by the card reader 20, and the read authentication information and the print request are transmitted to the host terminal 100.

In the host terminal 100, if the authentication information and the print request are received, the user authentication is performed on the basis of the received authentication information. As a result, even when the user authentication is accomplished, since the job ticket is frozen during the print process, through step S166, the print prohibition notice is transmitted to the network printer 200, which is a source of the print request.

In the network printer 200, if the print prohibition notice is received, through step S314, the error message is displayed. That is, printing is not performed.

Moreover, when an authentication card in which incorrect authentication information is stored is used, in the host terminal 100, the user authentication is not accomplished, and thus the print prohibition notice is transmitted to the network printer 200, which is a source of the print request.

Further, when the number of printable copies becomes ‘0’, in the host terminal 100, through steps S216 and S218, print data and the job ticket are deleted.

In the present embodiment, in such a manner, when the user authentication is accomplished and it is determined that the job ticket is not frozen, the host terminal 100 provides print data to one of the plurality of network printers 200, and freezes the job ticket until the print interruption notice or the print completion notice is received. When receiving the print completion notice, the host terminal 100 decrements the number of printable copies of the job ticket. Then, when it is determined that the number of printable copies is ‘0’, the host terminal 100 deletes print data and the job ticket. Further, the network printer 200 receives print data and performs the print control on the basis of received print data. When printing is interrupted, the network printer 200 removes print data being printed, and at the same time, transmits the print interruption notice to the host terminal 100. When printing is completed, the network printer 200 transmits the print completion notice to the host terminal 100.

In such a manner, when printing is completed, the number of printable copies is decremented, and thus, even when the network printer 200 stops printing due to a trouble, such as a paper jam or the like, the printed contents can be obtained from another network printer 200. Therefore, only an authorized user can acquire the printed matter.

Further, since print data is provided to one of the network printers 200, the possibility that the same printed contents are printed with the plurality of network printers 200 at one time can be reduced. In addition, even when the network printer 200, in which printing is interrupted, is recovered, since print data being printed is removed, the possibility that the printed contents are printed with the recovered network printer 200 can be reduced. Therefore, the possibility that printing is performed in excess of the number of printable copies can be reduced, and thus secrecy of the printed contents can be protected, as compared with the related art.

In addition, since print data and the job ticket are unitarily managed by the host terminal 100, the management of print data and the job ticket can be strictly performed, as compared with the case in which print data and the job ticket are managed by different apparatuses or the like.

In addition, in the present embodiment, when the user authentication is accomplished on the basis of the received authentication information and it is determined that the job ticket is not frozen, the host terminal 100 provides print data to one of the plurality of network printers 200, the one being a source having transmitted the authentication information.

In such a manner, when the authentication card with correct authentication information is given to the network printer 200 in which printing is to be performed, the user can obtain the printed contents with the network printer 200.

In addition, in the present embodiment, the host terminal 100 generates the utilization history information whenever print data is used.

In such a manner, it is possible to see how the print data has been used by referring to the utilization history information.

In addition, in the present embodiment, when it is determined that the number of printable copies is ‘0’, the host terminal 100 deletes print data and the job ticket.

In such a manner, the possibility that print data and the job ticket are incorrectly used can be reduced, and thus secrecy of the printed contents can be reliably protected.

In the first embodiment described above, the host terminal 100 corresponds to the device utilization apparatuses according to the first, second, fifth, seventh, sixteenth, seventeenth, twentieth to twenty-fifth, forty-first to forty-third, fifty-second, fifty-third, fifty-sixth, and fifty-eighth aspects, and the print data storage unit 11 and the storage device 62 correspond to the output data storage units according to the first, sixteenth, thirty-fourth, and fifty-second aspects. Further, the job ticket storage unit 12 and the storage device 62 correspond to the job ticket storage units according to the first, sixteenth, thirty-fourth, and fifty-second aspects, and the authentication information receiving unit 13, the I/F 58, and step S152 correspond to the authentication information receiving unit of the fifth or twentieth aspect. In addition, step S152 corresponds to the authentication information receiving step of the thirty-eighth or fifty-sixth aspect.

Further, in the first embodiment described above, the user authenticating unit 14 and step S154 correspond to the authenticating units according to the fifth, sixth, twentieth, and twenty-first aspects, step S154 corresponds to the authenticating steps according to the thirty-fourth, thirty-eighth, thirty-ninth, forty-second, forty-sixth, and forty-seventh aspects, and the print data utilization managing unit 15, the I/F 58, and steps S156 to S164, S200 to S206, and S212 to S218 correspond to the output data utilization managing units according to the first, second, fifth to seventh, fifteenth to seventeenth, twentieth to twenty-second, and thirty-third aspects. Further, steps S156 to S164, S200 to S206, and S212 to S218 correspond to the output data utilization managing steps according to the thirty-fourth, thirty-fifth, thirty-eighth to fortieth, fifty-first to fifty-third, fifty-sixth to fifty-eighth, and sixty-sixth aspects, and the utilization history information generating unit 16 and step S208 correspond to the utilization history information generating unit of the seventh or twenty-second aspect.

Further, in the first embodiment described above, step S208 corresponds to the utilization history information generating step of the fortieth or fifty-eighth aspect, and the network printer 200 corresponds to the network devices according to the first, second, fifth, sixteenth, twentieth, twenty-third to twenty-fifth, thirty-third, thirty-fourth, thirty-eighth, fifty-second, fifty-third, and fifty-sixth aspects. Further, the card reader 20 and step S302 correspond to the authentication information acquiring unit of the fifth or twenty-fifth aspect, and step S302 corresponds to the authentication information acquiring step of the forty-third or fifty-sixth aspect. In addition, the authentication information transmitting unit 21, the I/F 78, and step S306 correspond to the authentication information transmitting unit of the fifth or twenty-fifth aspect.

Further, in the first embodiment described above, step S306 corresponds to the authentication information transmitting step of the forty-third or fifty-sixth aspect, and the print data receiving unit 22, the I/F 78, and step S308 correspond to the first or twenty-third aspect. Further, step S308 corresponds to the output data receiving steps according to the forty-first, fifty-second, and fifty-third aspects. In addition, the print control unit 24, the I/F 78, and step S310 correspond to the output control units according to the first, second, twenty-third, and twenty-fourth aspects, step S310 corresponds to the output control steps according to the forty-first, forty-second, fifty-second, and fifty-third aspects, and print data corresponds to output data according to the first, second, fifth to seventh, fifteenth to seventeenth, twentieth to twenty-fourth, thirty-third to thirty-fifth, thirty-eighth to forty-second, fifty-first to fifty-third, fifty-sixth to or fifty-eighth, and sixty-sixth aspects.

Further, in the first embodiment described above, the print interruption notice corresponds to the output interruption notice according to the second, sixth, seventeenth, twenty-first, twenty-fourth, thirty-fifth, thirty-ninth, forty-second, fifty-third, and fifty-seventh aspects, and the print completion notice corresponds to the output completion notice according to the first, second, sixth, sixteenth, seventeenth, twenty-first, twenty-third, thirty-fourth, thirty-fifth, thirty-ninth, forty-first, fifty-second, fifty-third, and fifty-seventh aspects.

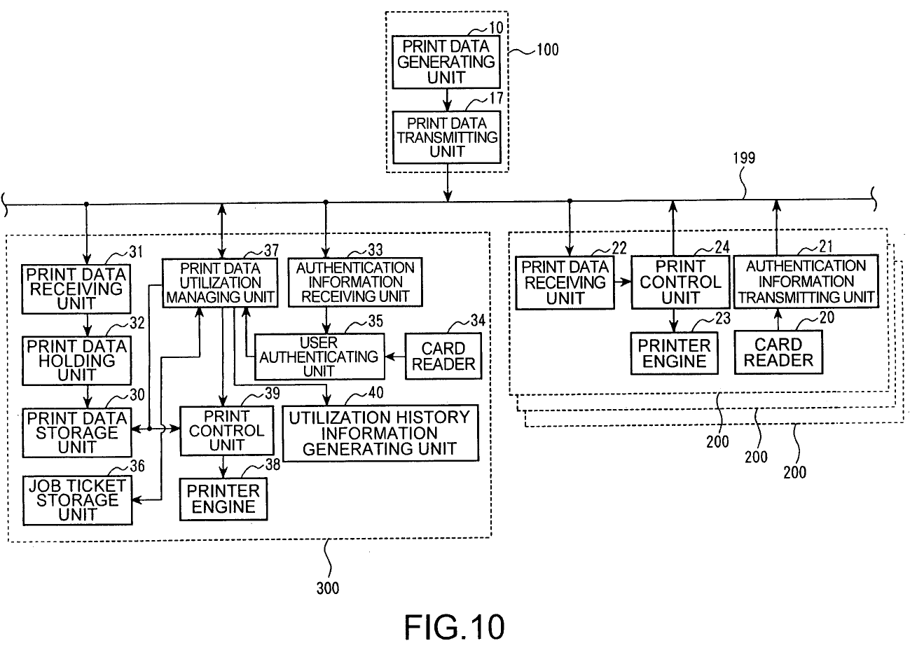

Hereinafter, a second embodiment of the invention will be described with reference to the drawings. FIGS. 10 to 15 are diagrams showing the second embodiment of an authentication output system, a device utilizing apparatus, a network device, an output data management program, an output control program, and an authentication output method according to the invention.

In the present embodiment, as shown in FIG. 10, the authentication output system, the device utilizing apparatus, the network device, the output data management program, the output control program, and the authentication output method according to the invention are applied to a case in which printing is performed by a network printer 200 or 300 by using an authentication card. The present embodiment is different from the first embodiment in that print data and a job ticket are managed by the network printer 300, not the host terminal 100. Moreover, hereinafter, only different parts from the first embodiment will be described. The same parts as those in the first embodiment are represented by the same reference numerals and the descriptions thereof will be omitted.

First, the functional outline of a network system, to which the invention is applied, will be described with reference to FIG. 10.

FIG. 10 is a functional block diagram illustrating the functional outline of the network system.

As shown in FIG. 10, a host terminal 100, a plurality of network printers 200, and a network printer 300 that manages print data and the job ticket are connected to a network 199.

The host terminal 100 has a print data generating unit 10, and a print data transmitting unit 17 that transmits print data generated by the print data generating unit 10 to the network printer 300.

The network printer 300 has a print data storage unit 30, a print data receiving unit 31 that receives print data, a print data storage unit 32 that stores print data received by the print data receiving unit 31 in the print data storage unit 30, an authentication information receiving unit 33 that receives authentication information, a card reader 34 that reads authentication information from an inserted authentication card, and a user authenticating unit 35 that performs user authentication on the basis of the authentication information received by the authentication information receiving unit 33 and the authentication information read by the card reader 34.

In addition, the network printer 300 also has a job ticket storage unit 36 that stores the job ticket, a print data utilization managing unit 37 that manages the utilization of print data, a printer engine 38 that has a print head, a head driving unit, and other mechanisms required for printing, and a print control unit 39 that performs a print control of the printer engine 38 on the basis of print data of the print data storage unit 30.

When the user authentication is accomplished by the user authenticating unit 35 on the basis of the authentication information received by the authentication information receiving unit 33 and when it is determined that the job ticket of the job ticket storage unit 36 is not frozen, the print data utilization managing unit 37 provides print data of the print data storage unit 30 to one of the plurality of network printers 200, the one being a source having transmitted the authentication information, and freezes the job ticket until the print interruption notice or the print completion notice is received. Further, when the user authentication is accomplished by the user authenticating unit 35 on the basis of the authentication information read by the card reader 34 and when it is determined that the job ticket of the job ticket storage unit 36 is not frozen, the print data utilization managing unit 37 requests the print control unit 39 for printing and freezes until the printer engine 38 stops or completes the printing. Then, when the print completion notice is received or when printing is completed by the printer engine 38, the number of printable copies of the job ticket is decremented, and when it is determined that the number of printable copies is ‘0’, the print data and the job ticket are deleted.

The print control unit 39 performs printing on the basis of print data of the print data storage unit 30 according to the print request from the print data utilization managing unit 37.

In addition, the network printer 300 has a utilization history information generating unit 40 that generates utilization history information on the basis of the provision result of the print data utilization managing unit 37 and the utilization result.

The present embodiment is different from the first embodiment in that the network printer 200 communicates with the network printer 300, not the host terminal 100.

Next, the configuration of the host terminal 100 will be described.

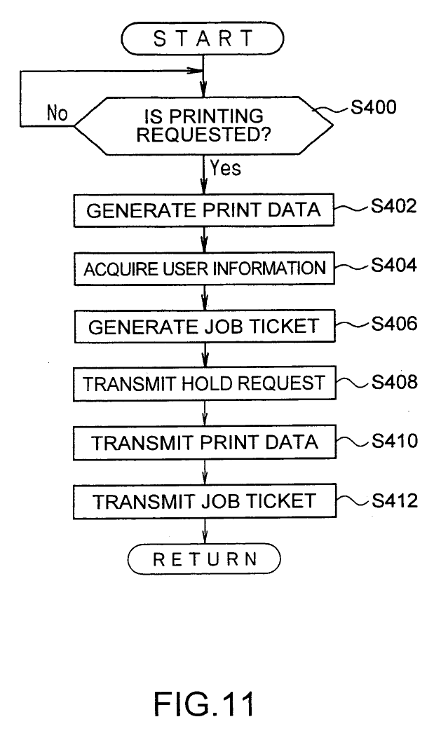

The CPU 50 runs a predetermined program stored in a predetermined area of the ROM 52 and executes a print data generating process shown in a flowchart of FIG. 11, instead of the print data generating process, the print request receiving process, and the print result receiving process shown in the flowcharts of FIGS. 3, 5 and 6, according to the program.

FIG. 11 is the flowchart showing the print data generating process.

As shown in FIG. 11, if the print data generating process is executed by the CPU 50, first, the process proceeds to step S400.

In step S400, it is determined whether or not printing is requested from a documentation application or the like. If it is determined that printing is requested (Yes), the process proceeds to step S402. On the other hand, if it is determined that printing is not requested (No), the process is on standby at step S400 until printing is requested.

In step S402, a job ID is issued, and print data including the issued job ID is generated on the basis of document data edited by the documentation application or the like. Then, the process proceeds to step S404. In step S404, user information of a user who uses the host terminal 100 at present is acquired, and the process proceeds to step S406. Then, in step S406, a job ticket is generated on the basis of the issued job ID and the acquired user information, and the process proceeds to step S408.

In step S408, a storage request is transmitted to the network printer 300, and the process proceeds to step S410. In step S410, generated print data is transmitted to the network printer 300, and the process proceeds to step S412. In step S412, the generated job ticket is transmitted to the network printer 300. After the series of steps are completed, the process returns to the initial step.

Next, the configuration of the network printer 300 will be described.

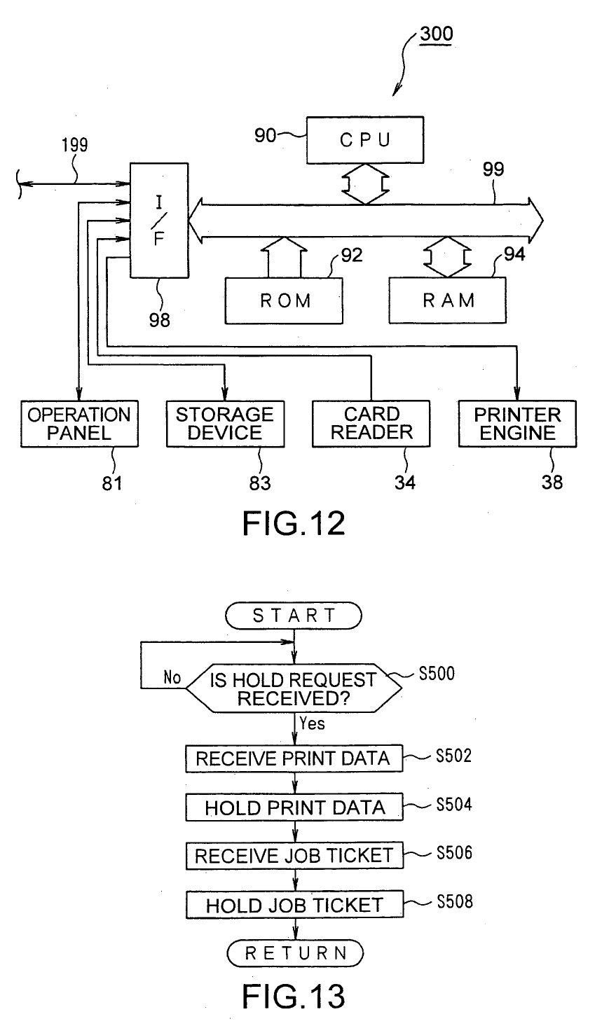

FIG. 12 is a block diagram illustrating the hardware configuration of the network printer 300.

As shown in FIG. 12, the network printer 300 has a CPU 90 that performs operations and controls the overall system on the basis of a control program, a ROM 92 that stores the control program of the CPU 90 or the like in a predetermined area in advance, a RAM 94 that stores data read from the ROM 92 or the like and operation results required for the operation process of the CPU 90, and an I/F 98 that intermediates an input/output of data to/from peripheral devices. Those are communicably connected to one another by a bus 99, which serves as a signal line for transmitting data.

To the I/F 98, an operation panel 81, serving as a human interface, such as a touch panel or the like, through which data can be inputted and displayed, a storage device 83 for storing data or tables in files, the card reader 34, the printer engine 38, all of which are peripheral devices, and signal lines for connection with the network 199 are connected.

The CPU 90 has a micro processing unit or the like, runs a predetermined program stored in a predetermined area of the ROM 92, and executes a print data storing process, a print control process, and a print state monitoring process shown in flowcharts of FIGS. 13 to 15 according to the program in a time-division manner. Besides, the CPU 90 executes the same processes as the print request receiving process and the print result receiving process shown in the flowcharts of FIGS. 5 and 6 in a time-division manner.

First, the print data storing process will be described in detail with reference to FIG. 13.

FIG. 13 is the flowchart showing the print data storing process.

The print data storing process is a process of storing print data from the host terminal 100. As shown in FIG. 13, if the print data storing process is executed by the CPU 90, first, the process proceeds to step S500.

In step S500, it is determined whether or not a storage request is received, and when it is determined that the storage request is received (Yes), the process proceeds to step S502. On the other hand, when it is determined that the storage request is not received (No), the process is on standby at step S500 until the storage request is received.

In step S502, print data is received, and the process proceeds to step S504. In step S504, received print data is stored in the storage device 83, and the process proceeds to step S506. In step S506, the job ticket is received, and the process proceeds to step S508. In step S508, the received job ticket is stored in the storage device 83. After the series of steps are completed, the process returns to the initial step.

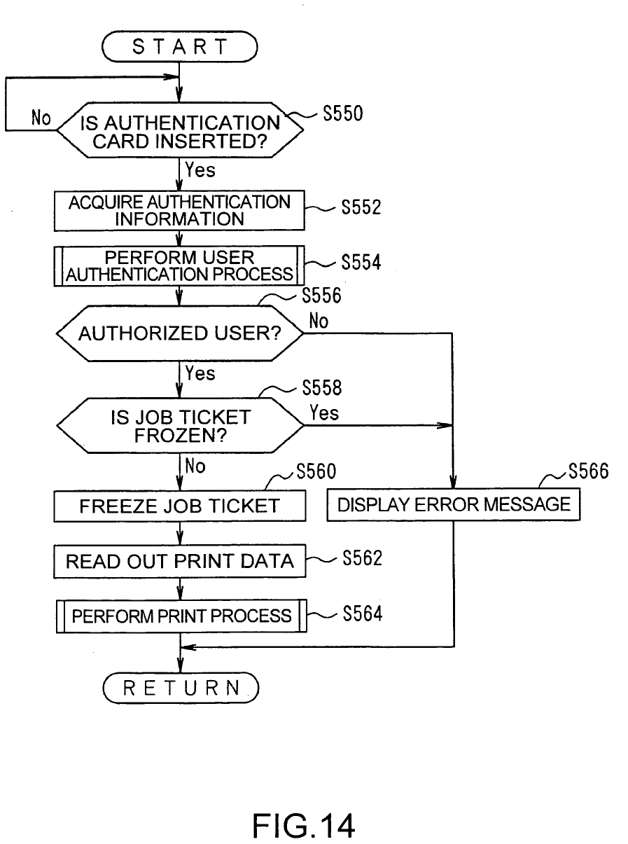

Next, the print control process will be described in detail with reference to FIG. 14.

FIG. 14 is the flowchart showing the print control process.

The print control process is a process of performing the print control of the printer engine 38. As shown in FIG. 14, if the print control process is executed by the CPU 90, first, the process proceeds to step S550.

In step S550, it is determined whether or not the authentication card is inserted into the card reader 34, and when it is determined that the authentication card is inserted (Yes), the process proceeds to step S552. On the other hand, when it is determined that the authentication card is not inserted (No), the process is on standby at step S550 until the authentication card is inserted.

In step S552, the authentication information is read from the authentication card by the card reader 34, and the process proceeds to step S554. In step S554, a user authentication process for performing the user authentication is executed on the basis of the read authentication information. In the user authentication process, the job ticket corresponding to the job ID included in the read authentication information is retrieved from the storage device 83. As a result, when the corresponding job ticket is retrieved, it is determined whether or not the user information of the retrieved job ticket and the user information included in the read authentication information correspond with each other. When it is determined that the user information of the job ticket and the user information included in the authentication information correspond with each other, it is determined that the user is eligible to use the print data. On the other hand, when the corresponding job ticket is not retrieved or when the user information of the job ticket and the user information included in the authentication information correspond with each other, it is determined that the user is not eligible to use the print data.

Next, the process proceeds to step S556, the result of the user authentication process is determined. At this time, when it is determined that the user is eligible to use the print data (Yes), the process proceeds to step S558, and it is determined whether or not the exclusive flag of the retrieved job ticket is set. When it is determined that the exclusive flag is not set (No), it is determined that the job ticket is not frozen, and the process proceeds to step S560.

In step S560, the exclusive flag of the retrieved job ticket is set, and the process proceeds to step S562. In step S562, print data corresponding to the job ID of the retrieved job ticket is read out from the storage device 83, and the process proceeds to step S564. In step S564, a print process for performing the print control of the printer engine 38 is executed on the basis of print data read out from the storage device 83. After the series of steps are completed, the process returns to the initial step.

In step S558, when it is determined that the exclusive flag of the retrieved job ticket is set (Yes), it is determined that the job ticket is frozen, and the process proceeds to step S566. In step S566, an error message is displayed on the operation panel 81. After the series of steps are completed, the process returns to the initial step.

In step S556, when it is determined that the user is not eligible to use the print data (No), the process proceeds to step S566.

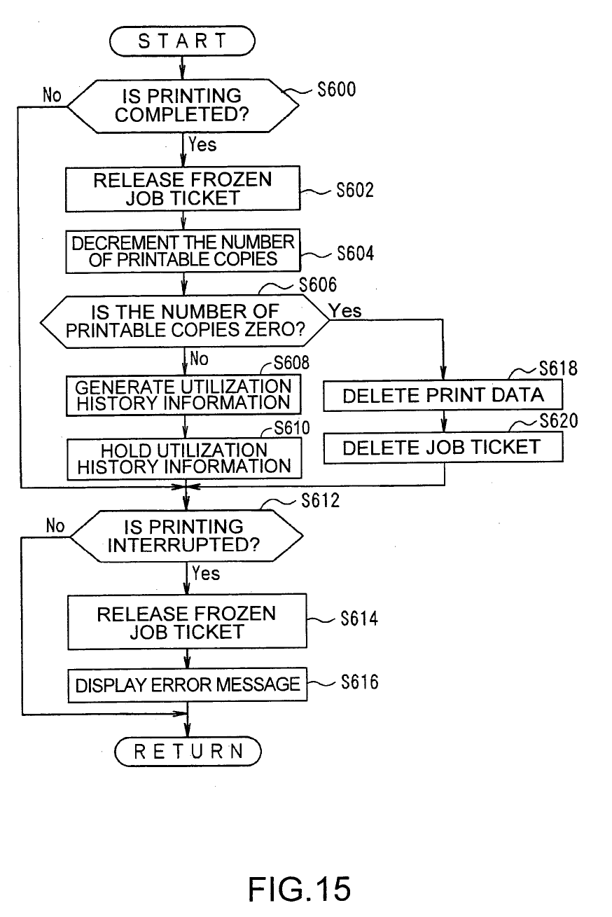

Next, the print state monitoring process will be described in detail with reference to FIG. 15.

FIG. 15 is the flowchart showing the print state monitoring process.

The print state monitoring process is a process of monitoring the print situation of the printer engine 38. As shown in FIG. 15, if the print state monitoring process is executed by the CPU 90, first, the process proceeds to step S600.

In step S600, it is determined whether or not printing is completed by the printer engine 38, and when it is determined that printing is completed (Yes), the process proceeds to step S602. In step S602, the job ticket corresponding to the job ID of the print-completed print data is retrieved from the storage device 83, the exclusive flag of the retrieved job ticket is reset, and the process proceeds to step S604. In step S604, the number of printable copies of the retrieved job ticket is decremented by ‘1’, and the process proceeds to step S606.

In step S606, it is determined whether or not the number of printable copies is ‘0’, and when it is determined that the number of printable copies is not ‘0’ (No), the process proceeds to step S608. In step S608, the utilization history information including the printed date and time is generated, and the process proceeds to step S610. In step S610, the generated utilization history information is stored in the storage device 83 while being added to the retrieved job ticket, and the process proceeds to step S612.

In step S612, it is determined whether or not the printer engine 38 has stopped printing, and when it is determined that the printer engine 38 has stopped printing (Yes), the process proceeds to step S614. In step S614, the job ticket corresponding to the job ID of the print-interrupted print data is retrieved from the storage device 83, the exclusive flag of the retrieved job ticket is reset, and the process proceeds to step S616. In step S616, an error message is displayed on the operation panel 81. After the series of steps are completed, the process returns to the initial step.

In step S612, when it is determined that the printer engine 38 has not stopped printing (No), the series of steps are completed, and then the process returns to the initial step.

In step S606, when it is determined that the number of printable copies is ‘0’ (Yes), the process proceeds to step S618. In step S618, print data corresponding to the job ID of the print-completed print data is deleted from the storage device 83, and the process proceeds to step S620. In step S620, the job ticket corresponding to the job ID of the print-completed print data is deleted from the storage device 83, and the process proceeds to step S612.

In step S600, when it is determined that printing is not completed by the printer engine 38 (No), the process proceeds to step S612.

Next, the operation of the present embodiment will be described.

In the host terminal 100, the user edits document data by using the documentation application or the like and requests to print it.

In the host terminal 100, if printing is requested, through steps S402 to S412, print data and the job ticket are generated and print data and the job ticket generated are transmitted to the network printer 300, together with the storage request.

In the network printer 300, when print data and the job ticket and the storage request are received, through steps S504 and S506, print data and the job ticket received are stored in the storage device 83.

First, a case in which printing is performed by the network printer 200 will be described.

The user goes to one of the network printers 200 and inserts the authentication card into the card reader 20.

In the network printer 200, if the authentication card is inserted, through steps S302 to S306, the authentication information is read from the authentication card by the card reader 20, and the read authentication information and the print request are transmitted to the network printer 300.

In the network printer 300, if the authentication information and the print request are received, through step S154, the user authentication is performed on the basis of the received authentication information. As a result, if the user authentication is accomplished, through steps S160 to S164, the job ticket is frozen, print data is read out from the storage device 83, and print data read from the storage device 83 is transmitted to the network printer 200, which is a source of the print request.

In the network printer 200, if print data is received, through step S310, the print control is performed on the basis of received print data. Then, if printing is completed, through step S352, the print completion notice is transmitted to the network printer 300.

In the network printer 300, if the print completion notice is received, through steps S202 and S204, the job ticket is not frozen (e.g., released) and the number of printable copies is decremented. As a result, if the number of printable copies becomes ‘0’, through steps S208 and S210, the utilization history information is generated and the generated utilization history information is stored in the storage device 83 while being added to the job ticket.

Next, a case in which printing is performed by the network printer 300 will be described.

The user goes to the network printer 300 and inserts the authentication card into the card reader 34.

In the network printer 300, if the authentication card is inserted, through steps S552 and S554, the authentication information is read from the authentication card by the card reader 34, and the user authentication is performed on the basis of the read authentication information. As a result, if the user authentication is accomplished, through steps S560 to S564, the job ticket is frozen, print data is read out from the storage device 83, and the print control is performed on the basis of read print data. Then, if printing is completed, through steps S602 and S604, the job ticket is not frozen (e.g., released) and the number of printable copies of the job ticket is decremented. As a result, if the number of printable copies becomes ‘0’, through steps S608 and S610, the utilization history information is generated and the generated utilization history information is stored in the storage device 83 while being added to the job ticket.

Next, a case in which the network printer 200 stops printing will be described.

In the network printer 200, if printing is interrupted due to a trouble, such as a paper jam or the like, through steps S356 to S360, the print interruption notice is transmitted to the network printer 300, print data being printed is removed, and the error message is displayed.

In the network printer 300, if the print interruption notice is received, through step S214, the job ticket is not frozen.

Next, the user removes the authentication card from the card reader 20 in the network printer 200, in which printing has been interrupted. Then, the user goes to another network printer 200 and inserts the authentication card into the card reader 20. Hereinafter, in another network printer 200 and the network printer 300, the same operation as described above is performed, and printing is performed by another network printer 200. The number of printable copies is not decremented even when printing is interrupted. When printing is completed by another network printer 200, the number of printable copies is decremented.

Next, a case in which the network printer 300 stops printing will be described.

In the network printer 300, if printing is interrupted due to a trouble, such as a paper jam or the like, through steps S614 and S616, the job ticket is not frozen, and the error message is displayed.

Next, the user removes the authentication card from the card reader 34 in the network printer 300. Then, the user goes to another network printer 200 and inserts the authentication card into the card reader 20. Hereinafter, in another network printer 200 and the network printer 300, the same operation as described above is performed, and printing is performed by another network printer 200. The number of printable copies is not decremented even when printing is interrupted. When printing is completed by another network printer 200, the number of printable copies is decremented.

Next, a case, in which while one of the network printers 200 or the network printer 300 is in a printing operation, the authentication card is removed to be inserted into the card reader 20 of another network printer 200, will be described.

In the network printer 200, if the authentication card is inserted, the authentication information is read from the authentication card by the card reader 20, and the read authentication information and the print request are transmitted to the network printer 300.

In the network printer 300, if the authentication information and the print request are received, the user authentication is performed on the basis of the received authentication information. As a result, even when the user authentication is accomplished, since the job ticket is frozen during the print process, through step S166, the print prohibition notice is transmitted to the network printer 200, which is a source of the print request.

In the network printer 200, if the print prohibition notice is received, through step S314, the error message is displayed. That is, printing is not performed.

Next, a case, in which while one of the network printers 200 is in a printing operation, the authentication card is removed to be inserted into the card reader 34 of the network printer 300, will be described.

In the network printer 300, if the authentication card is inserted, the authentication information is read from the authentication card by the card reader 34, and the user authentication is performed on the basis of the read authentication information. As a result, even when the user authentication is accomplished, since the job ticket is frozen during the print process, through step S566, the error message is displayed. That is, printing is not performed.

Moreover, when an authentication card in which incorrect authentication information is stored is used, in the network printer 300, the user authentication is not accomplished, and thus the print prohibition notice is transmitted to the network printer 200, which is a source of the print request, or the error message is displayed.

Further, when the number of printable copies becomes ‘0’, in the network printer 300, through steps S216 and S218 or steps S618 and S620, print data and the job ticket are deleted.

In the present embodiment, in such a manner, the host terminal 100 generates print data and transmits generated print data to the network printer 300, and the network printer 300 receives print data and stores received print data in the storage device 83. When the user authentication is accomplished and it is determined that the job ticket is not frozen, the network printer 300 provides print data to one of the plurality of network printers 200, and freezes the job ticket until the print interruption notice or the print completion notice is received. Further, the network printer 300 performs the print control on the basis of print data of the storage device 83, freezes the job ticket until printing is interrupted or completed, and when the print completion notice is received or when printing is completed, decrements the number of printable copies of the job ticket. Then, when it is determined that the number of printable copies is ‘0’, the network printer 200 deletes print data and the job ticket. Further, the network printer 200 receives print data and performs the print control on the basis of received print data. When printing is interrupted, the network printer 200 removes print data being printed, and at the same time, transmits the print interruption notice to the network printer 300. When printing is completed, the network printer 200 transmits the print completion notice to the network printer 300.

In such a manner, when printing is completed, the number of printable copies is decremented, and thus, even when any one of the network printers 200 and 300 stops printing due to the trouble, such as a paper jam or the like, the printed contents can be obtained from one of the other network printers 200 and 300. Therefore, only an authorized user can obtain the printed matter.

Further, since print data is provided to the network printer 200 or print data is used by the network printer 300, the possibility that the same printed contents are printed with the network printers 200 and 300 at one time can be reduced. In addition, even when the network printer 200 or 300, in which printing is interrupted, is recovered, since print data being printed is removed, the possibility that the printed contents are printed with the recovered network printer 200 or 300 can be reduced. Therefore, the possibility that printing is performed in excess of the number of printable copies can be reduced, and thus secrecy of the printed contents can be protected, as compared with the related art.

In addition, since print data and the job ticket are unitarily managed by the network printer 300, the management of print data and the job ticket can be strictly performed, as compared with the case in which print data and the job ticket are managed by different apparatuses or the like.

In addition, in the present embodiment, when the user authentication is accomplished on the basis of the received authentication information and when it is determined that the job ticket is not frozen, the network printer 300 provides print data to one of the plurality of network printers 200, the one being a source having transmitted the authentication information. Further, when the user authentication is accomplished on the basis of the read authentication information and it is determined that the job ticket is not frozen, the network printer 300 performs the print control on the basis of print data of the storage device 83.

In such a manner, when giving the authentication card with the correct authentication information recorded therein to the network printer 200 or 300 in which printing is to be performed, the user can obtain the printed contents with the network printer 200 or 300.

In addition, in the present embodiment, the network printer 300 generates the utilization history information whenever print data is used.

In such a manner, it is possible to see how the print data has been used by referring to the utilization history information.

In addition, in the present embodiment, when it is determined that the number of printable copies is ‘0’, the network printer 300 deletes print data and the job ticket.

In such a manner, the possibility that print data and the job ticket are incorrectly used can be reduced, and thus secrecy of the printed contents can be protected more reliably.

In the second embodiment described above, the host terminal 100 corresponds to the device utilization apparatus of the eighth or fifty-ninth aspect, and the print data transmitting unit 17, the I/F 58, and step S410 correspond to the output data transmitting unit of the eighth aspect. Further, step S410 corresponds to the output data transmitting step of the fifty-ninth aspect. In addition, the network printer 300 corresponds to the first network devices according to the eighth, ninth, twelfth to fourteenth, fifty-ninth, sixtieth, and sixty-third to sixty-fifth aspects, and the print data storage unit 30 and the storage device 83 correspond to the output data storage units according to the eighth, twenty-sixth, forty-fourth, and fifty-ninth aspects.

Further, in the second embodiment described above, the job ticket storage unit 36 and the storage device 83 correspond to the job ticket storage units according to eighth, twenty-sixth, forty-fourth, and fifty-ninth aspects, and the print data receiving unit 31, the I/F 98, and step S502 correspond to the first output data receiving unit of the eighth aspect or the output data receiving unit of the twenty-sixth aspect. Further, step S502 corresponds to the first output data receiving step of the fifty-ninth aspect or the output data receiving step of the forty-fourth aspect, the print data storage unit 32 and step S504 correspond to the output data holding unit of the eighth or twenty-sixth aspect, and step S504 corresponds to the output data storing step of the forty-fourth or fifty-ninth aspect.

Further, in the second embodiment described above, the authentication information receiving unit 33, the I/F 98, and step S152 correspond to the authentication information receiving units according to the twelfth, thirteenth, thirtieth, and thirty-first aspects, step S152 corresponds to the authentication information receiving steps according to the forty-eighth, forty-ninth, sixty-third, and the sixty-fourth aspects, and the card reader 34 and step S552 correspond to the first authentication information acquiring unit of the twelfth or thirteenth aspect, or the authentication information acquiring unit of the thirtieth or thirty-first aspect. Further, step S552 corresponds to the first authentication information acquiring step of the sixty-third or sixty-fourth aspect or corresponds to the authentication information acquiring step of the forty eighth or forty-ninth aspect, and the user authenticating unit 35 and steps S154 and S554 correspond to the authenticating units according to the twelfth, thirteenth, thirtieth, and thirty-first aspects.

Further, in the second embodiment described above, steps S154 and S554 correspond to the authenticating steps according to the forty-fourth, forty-eighth, forty-ninth, fifty-ninth, sixty-third, and sixty-fourth aspects, and the print data utilization managing unit 37, the I/F 98, and steps S156 to S164, S200 to S206, S212 to S218, S556 to S562, S600 to S606, and S612 to S620 correspond to the output data utilization managing units according to eighth, ninth, twelfth to fifteenth, twenty-sixth, twenty-seventh, and thirtieth to thirty-third aspects. Further, steps S156 to S164, S200 to S206, S212 to S218, S556 to S562, S600 to S606, and S612 to S620 correspond to the output data utilization managing steps according to the forty-fourth, forty-fifth, forty-eighth to fifty-first, fifty-ninth, sixtieth, sixty-third to sixty-sixth aspects.

Further, in the second embodiment described above, the print control unit 39 and step S564 correspond to the first output control unit of the eighth or twelfth aspect or the output control unit of the twenty-sixth or thirtieth aspect, and step S564 corresponds to the first output control step of the fifty-ninth or sixty-third aspect or the output control step of the forty-fourth or forty-eighth aspect. Further, the utilization history information generating unit 40 and steps S208 and S608 correspond to the utilization history information generating unit of the fourteenth or thirty-second aspect, steps S208 and S608 correspond to the utilization history information generating step of the fiftieth or sixty-fifth aspect, and the network printer 200 corresponds to the second network devices according to the eighth, ninth, twelfth, fifty-ninth, sixtieth, and sixty-third aspects.

Further, in the second embodiment described above, the card reader 20 and step S302 correspond to the second authentication information acquiring unit of the twelfth aspect, step S302 corresponds to the second authentication information acquiring step of the sixty-third aspect, and the authentication information transmitting unit 21, the I/F 78, and step S306 correspond to the authentication information transmitting unit of the twelfth aspect. Further, step S306 corresponds to the authentication information transmitting step of the sixty-third aspect, the print data receiving unit 22, the I/F 78, and step S308 correspond to the second output data receiving unit of the eighth aspect, and step S308 corresponds to the second output data receiving step of the forty-ninth or sixtieth aspect.

Further, in the second embodiment described above, the print control unit 24, the I/F 78, and step S310 correspond to the second output control unit of the eighth or ninth aspect, step S310 corresponds to the second output control step of the fifty-ninth or sixtieth aspect, and print data corresponds to output data according to eighth, ninth, twelfth to fifteenth, twenty-sixth, twenty-seventh, thirtieth to thirty-third, forty-fourth, forty-fifth, forty-eighth to fifty-first, fifty-ninth, sixtieth, sixty-third to sixty-sixth aspects. Further, the print interruption notice corresponds to the output interruption notice according to the ninth, thirteenth, twenty-seventh, thirty-first, forty-fifth, fifty-ninth, sixtieth, and sixty-fourth aspects, and the print completion notice corresponds to the output completion notice according to eighth, ninth, thirteenth, twenty-sixth, twenty-seventh, thirty-first, forty-fourth, forty-fifth, forty-ninth, fifty-ninth, sixtieth, and sixty-fourth aspects.

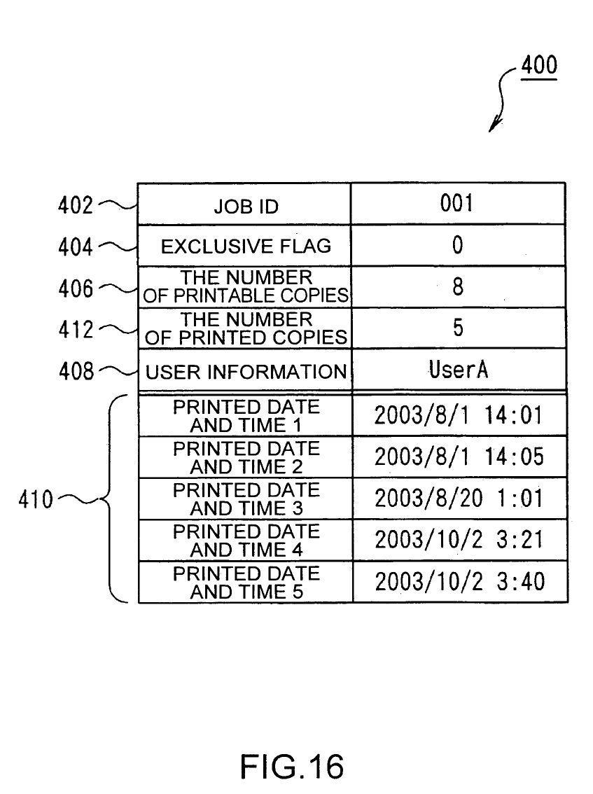

Moreover, in the first and second embodiments described above, the number of printable copies of the job ticket is decremented, and when the number of printable copies becomes ‘0’, print data and the job ticket are deleted. However, the invention is not limited thereto. For example, the number of printable copies and the number of printed copies may be specified in the job ticket, the number of printed copies of the job ticket may be incremented, and when the number of printed copies reaches the number of printable copies, print data and the job ticket may be deleted. Specifically, the job ticket is constituted as shown in FIG. 16.

FIG. 16 is a view illustrating the data structure of the job ticket 400.

As shown in FIG. 16, the job ticket 400 includes a field 402 that stores a job ID, a field 404 that stores an exclusive flag, a field 406 that stores the number of printable copies, a field 412 that stores the number of printed copies, and a field 408 that stores user information.

In the example of FIG. 16, ‘8’ and ‘5’ are stored as the number of printable copies and the number of printed copies, respectively. This indicates that the number of printable copies is eight and print data of the job ID of ‘001’ has been already printed by five copies.

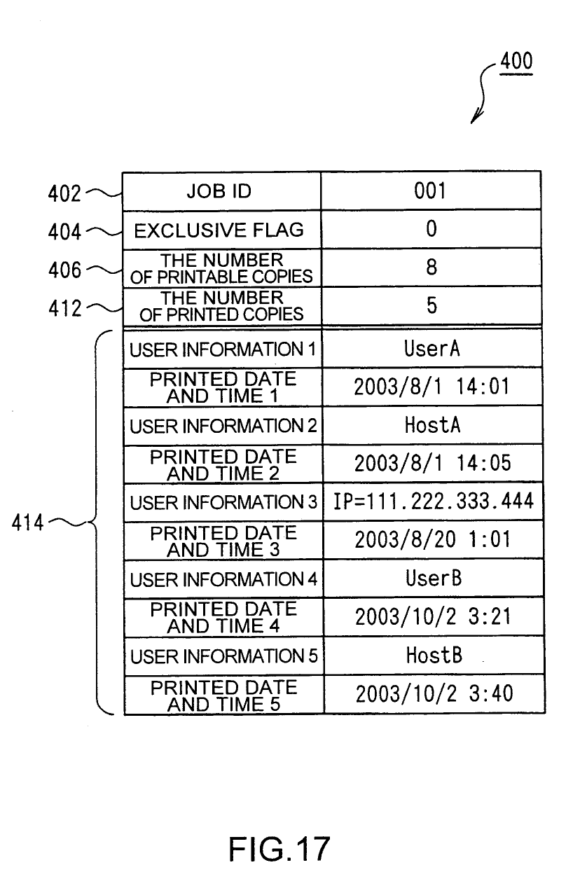

Further, in the first and second embodiments described above, the user information is specified in the job ticket and the user authentication is performed on the basis of the authentication information and the job ticket. However, the invention is not limited thereto. For example, any user may print, without the user authentication. In this case, the user information and the printed date and time as the utilization history information are preferably recorded. Specifically, the job ticket is constituted as shown in FIG. 17.

FIG. 17 is a view illustrating the data structure of the job ticket 400.

As shown in FIG. 17, the job ticket 400 includes a field 402 that stores a job ID, a field 404 that stores an exclusive flag, a field 406 that stores the number of printable copies, and a field 412 that stores the number of printed copies. In addition, the job ticket 400 also includes a field 414 that stores the utilization history information whenever print data is used.

In the example of FIG. 17, five records are stored as the utilization history information. This indicates that print data of the job ID of ‘001’ has been already printed by five copies. In this case, as the utilization history, the user information and the printed date and time are shown. Here, as the user information, for example, a host ID of the host terminal 100 and an IP address may be set, in addition to the user ID.

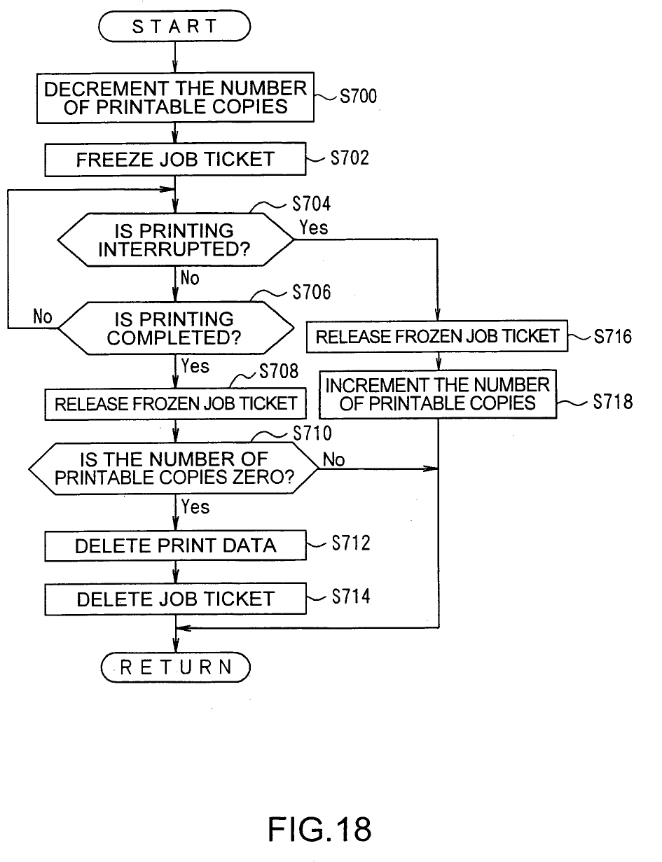

Further, in the first and second embodiments described above, after printing is interrupted or completed, the number of printable copies of the job ticket is decremented. However, the invention is not limited thereto. For example, before the job ticket is frozen, the number of printable copies of the job ticket may be decremented. Specifically, a job ticket updating process shown in a flowchart of FIG. 18 is executed.

FIG. 18 is the flowchart of the job ticket updating process.

As shown in FIG. 18, if the job ticket updating process is executed by the CPU 50 or 90, first, the process proceeds to step S700.

In step S700, the number of printable copies of the job ticket is decremented by ‘1’, and the process proceeds to step S702. In step S702, the job ticket is frozen, and the process proceeds to step S704. In step S704, it is determined whether or not printing has been interrupted, and when it is determined that the printing has been interrupted (No), the process proceeds to step S706.

In step S706, it is determined whether or not printing is completed, and when it is determined that printing is completed (Yes), the process proceeds to step S708. In step S708, the job ticket is not frozen, and the process proceeds to step S710. In step S710, it is determined whether or not the number of printable copies is ‘0’, and when it is determined that the number of printable copies is not ‘0’ (No), the series of steps are completed and then the process returns to the initial step.

In step S710, when it is determined that the number of printable copies is ‘0’ (Yes), the process proceeds to step S712. In step S712, print data is deleted, and the process proceeds to step S714. In step S714, the job ticket is deleted. After the series of steps are completed, the process returns to the initial step.

In step S706, when it is determined that printing is not completed (No), the process proceeds to step S704.

In step S704, when it is determined that printing has been interrupted (Yes), the process proceeds to step S716. In step S716, the job ticket is not frozen (i.e., released), and the process proceeds to step S718. In step S718, the number of printable copies of the job ticket is incremented by ‘1’. After the series of steps are completed, the process returns to the initial step.

In this case, steps S700 to S718 correspond to the output data utilization managing units according to third, fourth, tenth, eleventh, eighteenth, nineteenth, twenty-eighth, and twenty-ninth aspects or the output data utilization managing steps according to the thirty-sixth, thirty-seventh, forty-sixth, forty-seventh, fifty-fourth, fifty-fifth, sixty-first, and sixty-second aspects.

Further, in the first and second embodiments described above, the number of printable copies is specified in the job ticket. However, the invention is not limited thereto. For example, the number of printable pages may be specified in the job ticket and the number of printed pages may be restricted.

Further, in the first and second embodiments described above, the host terminal 100 is used, but the invention is not limited thereto. For example, instead of the host terminal 100, a printer server may be used.

Further, in the first and second embodiments described above, the authentication information is read from the authentication card by the card reader 20 or 34, but the invention is not limited thereto. For example, the authentication information may be inputted from the operation panel 80 or 81. In this case, the card reader 20 or 34 does not need to be provided.

Further, in the first and second embodiments described above, the card reader 20 or 34 is integrally provided in the network printer 200 or 300, but the invention is not limited thereto. For example, the card reader 20 or 34 may be separately provided from the network printer 200 or 300. Specifically, a user authenticating device having the card reader 20 or 34 is communicably connected to the network printer 200 or 300, and the network printer 200 or 300 inputs the authentication information by receiving the authentication information from the user authenticating device.

Further, in the first and second embodiments described above, in order to execute each of the processes shown in the flowcharts of FIGS. 3, 5, 6, 8, 9, 11, 13 to 15, and 18, the control program stored in the ROM 52, 72, or 92 in advance is executed, but the invention is not limited thereto. For example, programs indicating these procedures may be stored in a storage medium. Then, each program may be read in the RAM 54, 74, or 94 to be executed.

Here, as the storage medium, a semiconductor storage medium, such as the RAM, the ROM, or the like, a magnetic recordable storage medium, such as the FD, the HD, or the like, an optical readable storage medium, such as the CD, the CDV, the LC, the DVD, or the like, and a magnetic recordable/optical readable storage medium, such as the MO or the like may be used. Specifically, any storage media may be used as long as it is a computer readable storage medium, regardless of reading methods such as electronic, magnetic, or optical.

Further, in the first and second embodiments described above, the authentication output system, the device utilizing apparatus, the network device, the output data management program, the output control program, and the authentication output method according to the invention are applied to the case in which printing is performed by the network printer 200 or 300 by using the authentication card. However, the invention is not limited thereto, and, for example, the invention can be applied to other cases without departing from the subject matter of the invention. Instead of the network printer 200 or 300, for example, the invention can be applied to a projector, a home gateway, a personal computer, a PDA (personal digital assistant), a network storage, an audio apparatus, a mobile phone, PHS (Registered Trademark) (personal handyphone system), a watch-type PDA, an STB (set top box), a POS (point of sale) terminal, a facsimile machine, a phone (including an IP phone or the like), and other output devices.

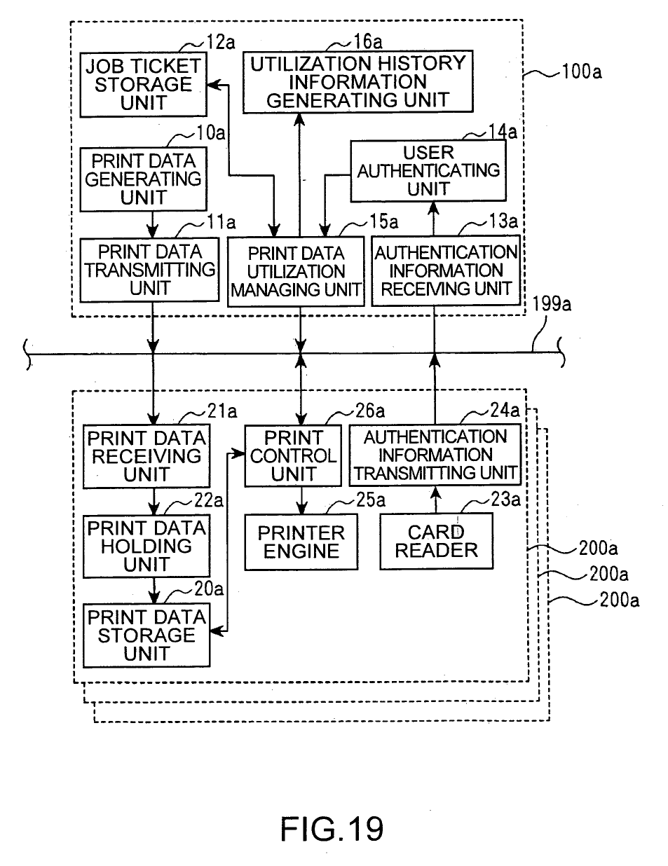

Next, a third embodiment of the invention will be described with reference to the drawings. FIGS. 19 to 29 are diagrams showing the third embodiment of an authentication output system, a device utilizing apparatus, a network device, an output data management program, an output control program, and an authentication output method according to the invention.

In the present embodiment, as shown in FIG. 19, the authentication output system, the device utilizing apparatus, the network device, the output data management program, the output control program, and the authentication output method according to the invention are applied to a case in which printing is performed by a network printer 200a by using an authentication card.

First, the functional outline of a network system, to which the invention is applied, will be described with reference to FIG. 19.

FIG. 19 is a functional block diagram illustrating the functional outline of the network system.

As shown in FIG. 19, a host terminal 100a and a plurality of network printers 200a are connected to a network 1999.

The host terminal 100a has a print data generating unit 10a that generates print data, a print data transmitting unit 11a that transmits print data generated by the print data generating unit 10a to all the network printers 200a, a job ticket storage unit 12a that stores a job ticket specifying the number of printable copies, an authentication information receiving unit 13a that receives authentication information, a user authenticating unit 14a that performs user authentication on the basis of the authentication information received by the authentication information receiving unit 13a, and a print data utilization managing unit 15a that manages the utilization of print data.

When the user authentication is accomplished by the user authenticating unit 14a and when it is determined that the job ticket of the job ticket storage unit 12a is updatable, the print data utilization managing unit 15a transmits a print enablement notice to one of the plurality of network printers 200a, the one being a source having transmitted the authentication information, and prohibits the update of the job ticket until a print interruption notice or a print completion notice is received. When the print completion notice is received, the number of printable copies of the job ticket is decremented. Then, when it is determined that the number of printable copies is ‘0’, the print data utilization managing unit 15a transmits a to all the network printers 200a and simultaneously deletes the job ticket.

In addition, the host terminal 100a also has a utilization history information generating unit 16a that generates utilization history information on the basis of the transmission result of the print data utilization managing unit 15a, the utilization history information indicating the utilization history of print data.

The network printer 200a has a print data storage unit 20a, a print data receiving unit 21a that receives print data, a print data storage unit 22a that stores print data received by the print data receiving unit 21a in the print data storage unit 20a, a card reader 23a that reads the authentication information from an inserted authentication card, an authentication information transmitting unit 24a that transmits the authentication information read by the card reader 23a to the host terminal 100a, a printer engine 25a that has a print head, a head driving unit, and other mechanisms required for printing, and a print control unit 26a that performs a print control of the printer engine 25a on the basis of print data of the print data storage unit 20a.

When the print enablement notice is received, the print control unit 26a performs printing on the basis of print data of the print data storage unit 20a. Further, when the printer engine 25a stops printing, the print control unit 26a removes print data being printed and transmits the print interruption notice to the host terminal 100a. Further, when printing is completed by the printer engine 25a, the print control unit 26a transmits the print completion notice to the host terminal 100a, and when the data deletion notice is received, the print control unit 26a deletes the print data.

Next, the configuration of the host terminal 100a will be described.

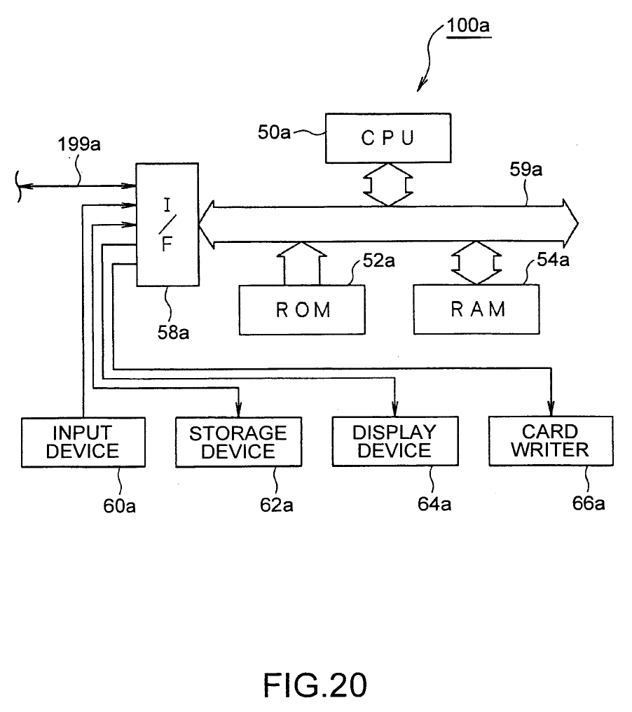

FIG. 20 is a block diagram illustrating the hardware configuration of the host terminal 100a.

As shown in FIG. 20, the host terminal 100a has a CPU 50a that performs operations and controls the overall system on the basis of a control program, a ROM 52a that stores the control program of the CPU 50a or the like in a predetermined area in advance, a RAM 54a that stores data read from the ROM 52a or the like and operation results required for the operation process of the CPU 50a, and an I/F 58a that intermediates an input/output of data to/from peripheral devices. Those are communicably connected to one another by a bus 59a, which serves as a signal line for transmitting data.

To the I/F 58a, an input device 60a, serving as a human interface, such as a keyboard, a mouse, or the like, through which data can be inputted, a storage device 62a that stores data or tables in files, a display device 64a that displays an image on the basis of an image signal, a card writer 66a that writes the authentication information into an inserted authentication card, all of which are peripheral devices, and signal line for connections with the network 199a are connected.

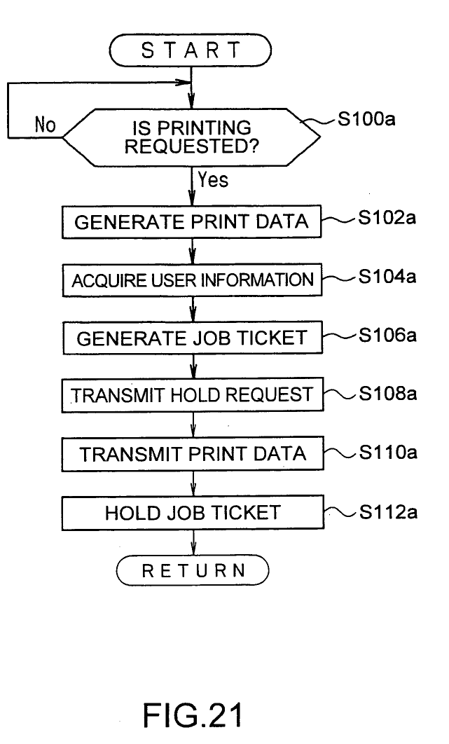

The CPU 50a has a micro processing unit or the like, runs a predetermined program stored in a predetermined area of the ROM 52a, and executes a print data generating process, a print request receiving process, and a print result receiving process shown in flowcharts of FIGS. 21, 23 and 24 according to the program in a time-division manner.

First, the print data generating process will be described in detail with reference to FIG. 21.

FIG. 21 is the flowchart showing the print data generating process.

As shown in FIG. 21, if the print data generating process is executed by the CPU 50a, first, the process proceeds to step S100a.

In step S100a, it is determined whether or not printing is requested from a documentation application or the like. If it is determined that printing is requested (Yes), the process proceeds to step S102a. On the other hand, if it is determined that printing is not requested (No), the process is on standby at step S100a until printing is requested.

In step S102a, a job ID for uniquely identifying print data is issued, and print data including the issued job ID is generated on the basis of document data edited by the documentation application or the like. Then, the process proceeds to step S104a.

In step S104a, user information of a user who uses the host terminal 100a at present is acquired, and the process proceeds to step S106a. Then, in step S106a, a job ticket is generated on the basis of the issued job ID and the acquired user information.

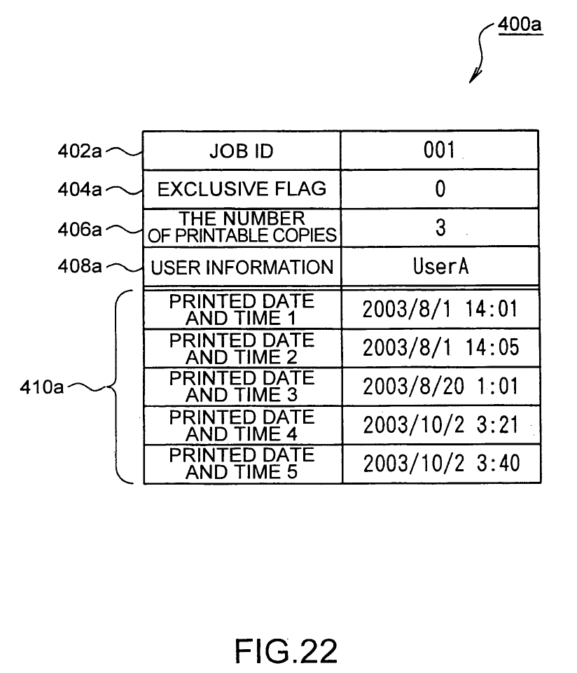

FIG. 22 is a view illustrating the data structure of the job ticket 400a.

As shown in FIG. 22, the job ticket 400a includes a field 402a that stores the job ID, a field 404a that stores an exclusive flag indicating whether or not the job ticket 400a is frozen, a field 406a that stores the number of printable copies, and a field 408a that stores the user information. In addition, the job ticket 400a also has a field 410a that stores the utilization history information whenever print data is used.

In the example of FIG. 22, ‘001’, 101, ‘3’, and ‘UserA’ are stored as the job ID, the exclusive flag, the number of printable copies, and the user information, respectively. This indicates that print data of the job ID of ‘001’ can be printed by a user of the user information of ‘UserA’, and the number of printable copies is three. Further, the exclusive flag is reset, which indicates that the job ticket is not frozen at present. Here, the number of printable copies may be optionally specified by the user or may be set to a predetermined value.

Further, five records are stored as the utilization history information. This indicates that print data of the job ID of ‘001’ has been already printed by five copies. In this case, as the utilization history, the printed date and time is shown.

Next, the process proceeds to step S108a, a storage request is transmitted to all the network printers 200a, and the process proceeds to step S110a. In step S110a, generated print data is transmitted to all the network printers 200a, and the process proceeds to step S112a. In step S112a, the generated job ticket is stored in the storage device 62a. After the series of steps are completed, the process returns to the initial step.

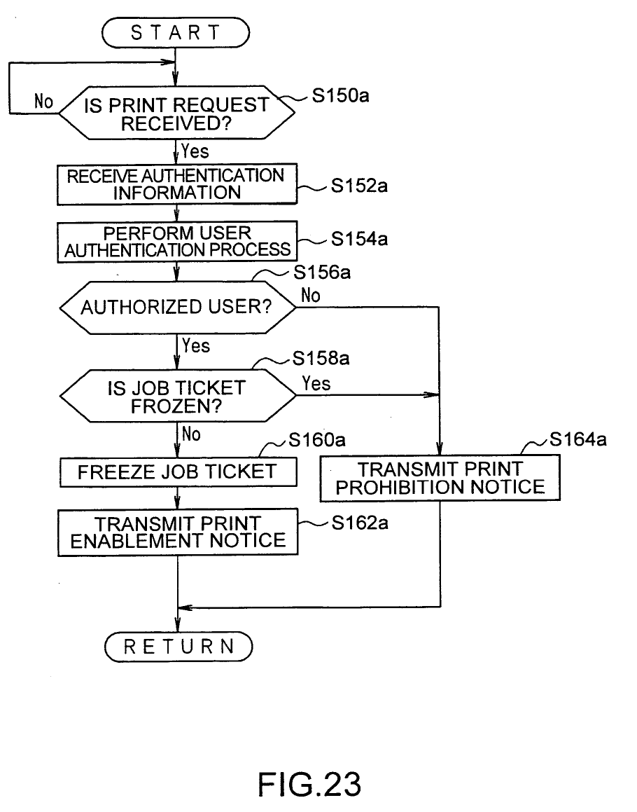

Next, the print request receiving process will be described in detail with reference to FIG. 23.

FIG. 23 is the flowchart showing the print request receiving process.

The print request receiving process is a process of receiving the print request from the network printer 200a. As shown in FIG. 23, if the print request receiving process is executed by the CPU 50a, first, the process proceeds to step S150a.

In step S150a, it is determined whether or not the print request is received. If it is determined that the print request is received (Yes), the process proceeds to step S152a. On the other hand, if it is determined that the print request is not received (No), the process is on standby at step S150a until the print request is received.

In step S152a, the authentication information including the job ID and the user information is received, and the process proceeds to step S154a. In step S154a, a user authentication process for performing the user authentication on the basis of the received authentication information is executed. In the user authentication process, the job ticket corresponding to the job ID included in the received authentication information is retrieved from the storage device 62a. As a result, when the corresponding job ticket is retrieved, it is determined whether or not the user information of the retrieved job ticket corresponds with the user information included in the received authentication information. Then, if it is determined that the user information of the job ticket corresponds with the user information included in the received authentication information, it is determined that the user is eligible to use the print data. On the other hand, when the corresponding job ticket is not retrieved or when it is determined that the user information of the job ticket does not correspond with the user information included in the authentication information, it is determined that the user is not eligible to use the print data.

Next, the process proceeds to step S156a, and the result of the user authentication process is determined. If it is determined that the user is eligible to use the print data (Yes), the process proceeds to step S158a. In step S158a, it is determined whether or not the exclusive flag of the retrieved jot ticket is set. If it is determined that the exclusive flag is not set (No), it is determined that the job ticket is not frozen, and then the process proceeds to step S160a.

In step S160a, the exclusive flag of the retrieved job ticket is set, and the process proceeds to step S162a. In step S162a, the print enablement notice is transmitted to the network printer 200a which is a source of the print request. After the series of steps are completed, the process returns to the initial step.

In step S158a, when it is determined that the exclusive flag of the retrieved job ticket is set (Yes), it is determined that the job ticket is frozen. Next, the process proceeds to step S164a, and the print prohibition notice is transmitted to the network printer 200a, which is a source of the print request. After the series of steps are completed, the process returns to the initial step.

In step S156a, when it is determined that the user is not eligible to use the print data (No), the process proceeds to step S164a.

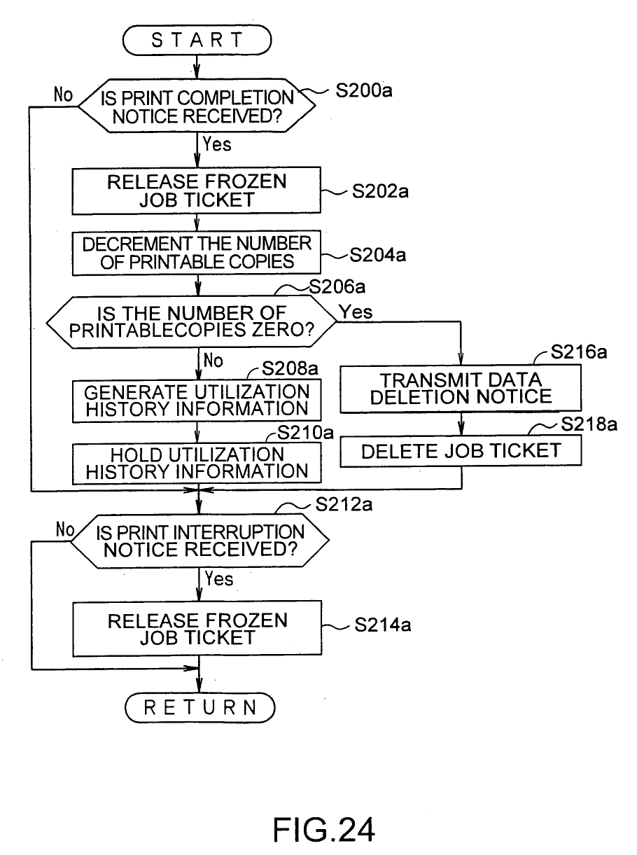

Next, the print result receiving process will be described in detail with reference to FIG. 24.

FIG. 24 is the flowchart showing the print result receiving process.

The print result receiving process is a process of receiving the print result from the network printer 200a. As shown in FIG. 24, if the print result receiving process is executed by the CPU 50a, first, the process proceeds to step S200a.

In step S200a, it is determined whether or not the print completion notice including the job ID is received, and when it is determined that the print completion notice is received (Yes), the process proceeds to step S202a. In step S202a, the job ticket corresponding to the job ID included in the received print completion notice is retrieved from the storage device 62a, and the exclusive flag of the retrieved job ticket is reset. Next, the process proceeds to step S204a, and the number of printable copies of the retrieved job ticket is decremented by ‘1’. Then, the process proceeds to step S206a.

In step S206a, it is determined whether or not the number of printable copies is ‘0’, and when it is determined that the number of printable copies is not ‘0’ (No), the process proceeds to step S208a. In step S208a, the utilization history information including the printed date and time is generated, and the process proceeds to step S210a. In step S210a, the generated utilization history information is stored in the storage device 62a while being added to the retrieved job ticket, and the process proceeds to step S212a.

In step S212a, it is determined whether or not the print interruption notice including the job ID is received, and when it is determined that the print interruption notice is received (Yes), the process proceeds to step S214a. In step S214a, the job ticket corresponding to the job ID included in the received print completion notice is retrieved from the storage device 62a and the exclusive flag of the retrieved job ticket is reset. After the series of steps are completed, the process returns to the initial step.

In step S212a, when it is determined that the print interruption notice is not received (No), the series of steps are completed, and then the process returns to the initial step.

In step S206a, when it is determined that the number of printable copies is ‘0’ (Yes), the process proceeds to step S216a. In step S216a, the data deletion notice including the job ID included in the received print completion notice is transmitted to all the network printers 200a, and the process proceeds to step S218a. In step S218a, the job ticket corresponding to the job ID included in the received print completion notice is deleted from the storage device 62a, and the process proceeds to step S212a.

In step S200a, when it is determined that the print completion notice is not received (No), the process proceeds to step S212a.

Next, the configuration of the network printer 200a will be described.

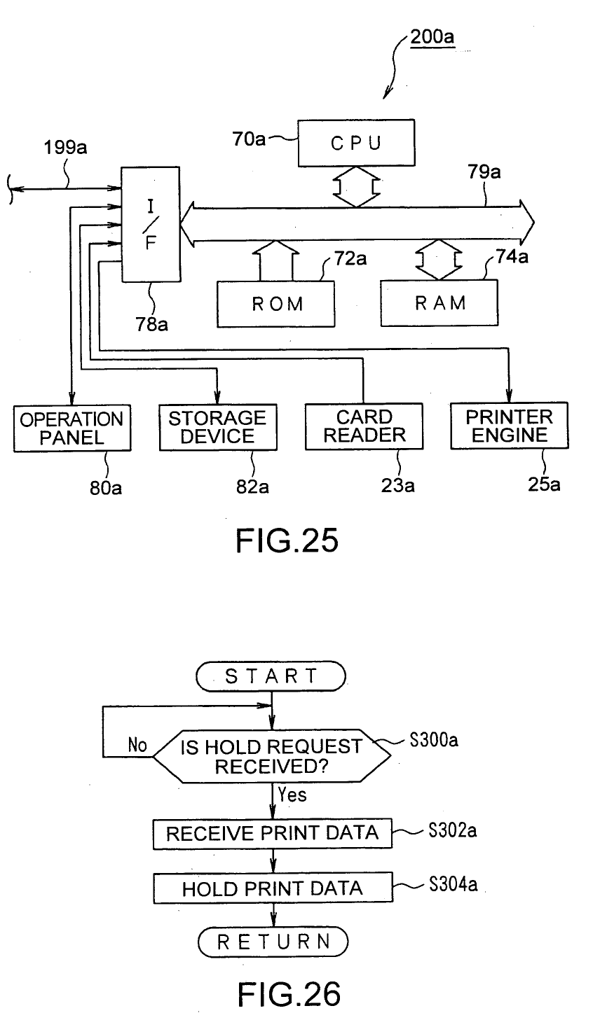

FIG. 25 is a block diagram illustrating the hardware configuration of the network printer 200a.

As shown in FIG. 25, the network printer 200a has a CPU 70a that performs operations and controls the overall system on the basis of a control program, a ROM 72a that stores the control program of the CPU 70a or the like in a predetermined area in advance, a RAM 74a that stores data read from the ROM 72a or the like and operation results required for the operation process of the CPU 70a, and an I/F 78a that intermediates an input/output of data to/from peripheral devices. Those are communicably connected to one another by a bus 79a, which serves as a signal line for transmitting data.

To the I/F 78a, an operation panel 80a, serving as a human interface, such as a touch panel or the like, through which data can be inputted and displayed, a storage device 82a for storing data or tables in files, the card reader 23a, the printer engine 25a, all of which are peripheral devices, and signal lines for connection with the network 199a are connected.

The CPU 70a has a micro processing unit or the like, runs a predetermined program stored in a predetermined area of the ROM 72a, and executes a data storage process, a print control process, a print state monitoring process, and a print data deletion process shown in flowcharts of FIGS. 26 to 29 according to the program in a time-division manner.

First, the print data storing process will be described in detail with reference to FIG. 26.

FIG. 26 is the flowchart showing the print data storing process.

The print data storing process is a process of storing print data from the host terminal 100a. As shown in FIG. 26, if the print data storing process is executed by the CPU 70a, first, the process proceeds to step S300a.

In step S300a, it is determined whether or not the storage request is received, and when it is determined that the storage request is received (Yes), the process proceeds to step S302a. On the other hand, when it is determined that the storage request is not received (No), the process is on standby at step S300a until the storage request is received.

In step S302a, print data is received, and the process proceeds to step S304a. In step S304a, received print data is stored in the storage device 82a. After the series of steps are completed, the process returns to the initial step.

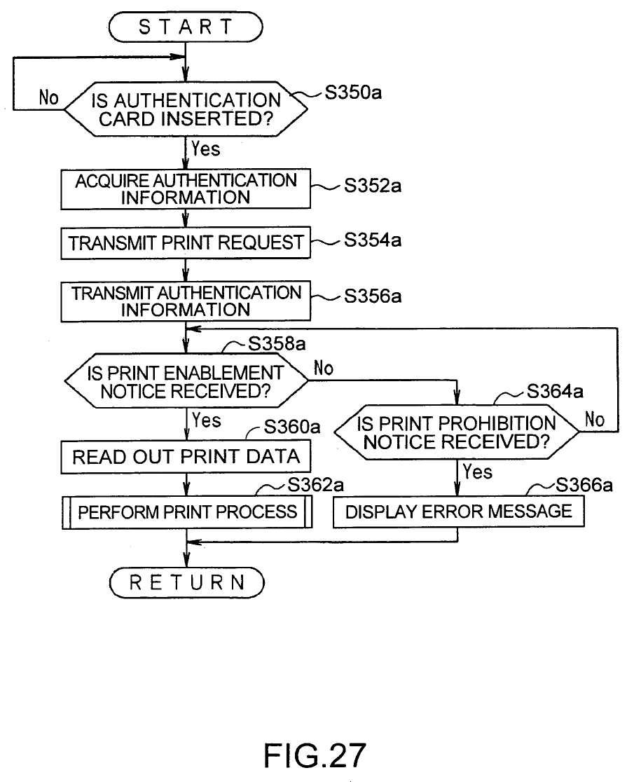

Next, the print control process will be described in detail with reference to FIG. 27.

FIG. 27 is the flowchart showing the print control process.

The print control process is a process of performing the print control of the printer engine 25a. As shown in FIG. 27, if the print control process is executed by the CPU 70a, first, the process proceeds to step S350a.

In step S350a, it is determined whether or not the authentication card is inserted into the card reader 23a, and when it is determined that the authentication card is inserted (Yes), the process proceeds to step S352a. If it is determined that the authentication card is not inserted (No), the process in on standby at step S350a until the authentication card is inserted.

In step S352a, the authentication information is read from the authentication card by the card reader 23a, and the process proceeds to step S354a. In step S354a, the print request is transmitted to the host terminal 100a, and the process proceeds to step S356a. In step S356a, the read authentication information is transmitted to the host terminal 100a, and the process proceeds to step S358a.

In step S358a, it is determined whether or not the print enablement notice is received, and when it is determined that the print enablement notice is received (Yes), the process proceeds to step S360a. In step S360a, print data corresponding to the job ID included in the read authentication information is read out from the storage device 82a, and the process proceeds to step S362a. In step S362a, a print process for performing the print control of the printer engine 25a is executed on the basis of read print data. After the series of steps are completed, the process returns to the initial step.

In step S358a, when it is determined that the print enablement notice is not received (No), the process proceeds to step S364a. In step S364a, it is determined whether or not the print prohibition notice is received, and when it is determined that the print prohibition notice is received (Yes), the process proceeds to step S366a. In step S366a, an error message is displayed on the operation panel 80a. After the series of steps are completed, the process returns to the initial step.

In step S364a, when it is determined that the print prohibition notice is not received (No), the process proceeds to step S358a.

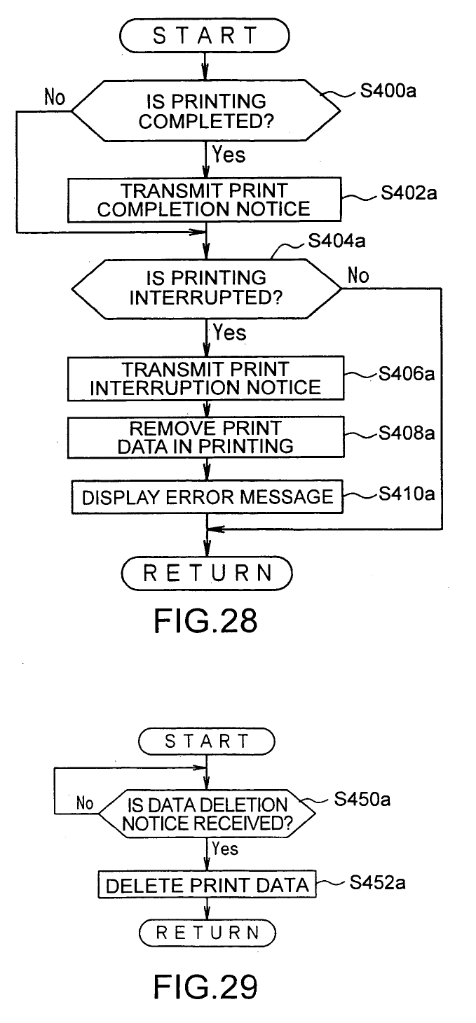

Next, the print state monitoring process will be described in detail with reference to FIG. 28.

FIG. 28 is the flowchart showing the print state monitoring process.

The print state monitoring process is a process of monitoring the print situation of the printer engine 25a. As shown in FIG. 28, if the print state monitoring process is executed by the CPU 70a, first, the process proceeds to step S400a.

In step S400a, it is determined whether or not printing is completed by the printer engine 25a, and when it is determined that printing is completed (Yes), the process proceeds to step S402a. In step S402a, the print completion notice including the job ID of the print-completed print data is transmitted to the host terminal 100a, and the process proceeds to step S404a.

In step S404a, it is determined whether or not the printer engine 25a printing has been interrupted, and when it is determined that the printing has been interrupted (Yes), the process proceeds to step S406a. In step S406a, the print interruption notice including the job ID of the print-interrupted print data is transmitted to the host terminal 100a, and the process proceeds to step S408a. In step S408a, print data being printed is removed and the process proceeds to step S410a. In step S410a, an error message is displayed on the operation panel 80a. After the series of steps are completed, the process returns to the initial step.

In step S404a, when it is determined that the printer engine 25a has not stopped printing (No), the series of steps are completed, and then the process returns to the initial step.

In step S400a, when it is determined that printing is not completed by the printer engine 25a (No), the process proceeds to step S404a.

Next, the print data deletion process will be described in detail with reference to FIG. 29.

FIG. 29 is the flowchart showing the print data deletion process.

As shown in FIG. 29, if the print data deletion process is executed by the CPU 70a, first, the process proceeds to step S450a.

In step S450a, it is determined whether or not the data deletion notice is received, and when it is determined that the data deletion notice is received (Yes), the process proceeds to step S452a. On the other hand, if it is determined that the data deletion notice is not received (No), the process is on standby at step S450a until the data deletion notice is received.

In step S452a, print data corresponding to the job ID included in the received data deletion notice is deleted from the storage device 82a. After the series of steps are completed, the process returns to the initial step.

Next, the operation of the present embodiment will be described.

In the host terminal 100a, the user edits document data by using the documentation application or the like and requests to print it.

In the host terminal 100a, if printing is requested, through steps S102a to S110a, print data and the job ticket are generated, and generated print data is requested to store and simultaneously is transmitted to all the network printers 200a. Further, through step S112a, the generated job ticket is stored in the storage device 62a.

When print data and the storage request are received in the network printer 200a, through step S304a, received print data is stored in the storage device 82a.

Next, in the host terminal 100a, the user inserts the authentication card into the card writer 66a so as to allow the job ID and the user information of his own to be written into the authentication card by the card writer 66a. Then, the user goes to one of the network printers 200a and inserts the authentication card into the card reader 23a.

In the network printer 200a, if the authentication card is inserted, through steps S352a to S356a, the authentication information is read from the authentication card by the card reader 23a, and the read authentication information and the print request are transmitted to the host terminal 100a.

In the host terminal 100a, if the authentication information and the print request are received, through step S154a, the user authentication is performed on the basis of the received authentication information. As a result, if the user authentication is accomplished, through steps S160a to S162a, the job ticket is frozen, the print enablement notice is transmitted to the network printer 200a, which is a source of the print request.

In the network printer 200a, if the print enablement notice is received, through steps S360a and S362a, print data is read out from the storage device 82a, and the print control is performed on the basis of read print data. Then, if printing is completed, through step S402a, the print completion notice is transmitted to the host terminal 100a.

In the host terminal 100a, if the print completion notice is received, through steps S202a and S204a, the job ticket is not frozen (e.g., released) and the number of printable copies of the job ticket is decremented. As a result, if the number of printable copies becomes ‘0’, through steps S208a and S210a, the utilization history information is generated and the generated utilization history information is stored in the storage device 62a while being added to the job ticket.

Next, a case in which printing is interrupted will be described.

In the network printer 200a, if printing is interrupted due to a trouble, such as a paper jam or the like, through steps S406a to S410a, the print interruption notice is transmitted to the host terminal 100a, print data being printed is removed, and the error message is displayed.

In the host terminal 100a, if the print interruption notice is received, through step S214a, the job ticket is not frozen.

Next, the user removes the authentication card from the card reader 23a in the network printer 200a, in which printing has been interrupted. Then, the user goes to another network printer 200a and inserts the authentication card into the card reader 23a. Hereinafter, in another network printer 200a and the host terminal 100a, the same operation as described above is performed, and printing is performed by another network printer 200a. The number of printable copies is not decremented even when printing is interrupted. When printing is completed by another network printer 200a, the number of printable copies is decremented.

Next, a case, in which while one of the network printers 200a is in a printing operation, the authentication card is removed to be inserted into the card reader 23a of another network printer 200a, will be described.

In the network printer 200a, if the authentication card is inserted, the authentication information is read from the authentication card by the card reader 23a, and the read authentication information and the print request are transmitted to the host terminal 100a.

In the host terminal 100a, if the authentication information and the print request are received, the user authentication is performed on the basis of the received authentication information. In this case, even when the user authentication is accomplished, since the job ticket is frozen during the print process, through step S164a, the print prohibition notice is transmitted to the network printer 200a, which is a source of the print request.

In the network printer 200a, if the print prohibition notice is received, through step S366a, the error message is displayed. That is, printing is not performed.

Moreover, when an authentication card in which incorrect authentication information is stored is used, in the host terminal 100a, the user authentication is not accomplished, and thus the print prohibition notice is transmitted to the network printer 200a, which is a source of the print request.

Further, when the number of printable copies becomes ‘0’, in the host terminal 100a, through steps S216a and S218a, the data deletion notice is transmitted to all the network printers 200a, and the job ticket is deleted.

In the network printer 200a, if the data deletion notice is received, through step S452a, print data is deleted.

In the present embodiment, in such a manner, when print data is transmitted to all the network printers 200a, the user authentication is accomplished, and it is determined that the job ticket is not frozen, the host terminal 100a transmits the print enablement notice to one of the plurality of network printers 200a, and freezes the job ticket until the print interruption notice or the print completion notice is received. When receiving the print completion notice, the host terminal 100a decrements the number of printable copies of the job ticket. Then, when it is determined that the number of printable copies is ‘0’, the host terminal 100a transmits the data deletion notice to all the network printers 200a and deletes the job ticket. Further, the network printer 200a receives print data and stores received print data in the storage device 82a. When receiving the print enablement notice, the network printer 200a performs printing on the basis of print data of the storage device 82a. When printing is interrupted, the network printer 200a removes print data being printed and simultaneously transmits the print interruption notice to the host terminal 100a. When printing is completed, the network printer 200a transmits the print completion notice to the host terminal 100a. Further, when receiving the data deletion notice, the network printer 200a deletes print data.

In such a manner, when printing is completed, the number of printable copies is decremented, and thus, even when the network printer 200a stops printing due to the trouble, such as the paper jam or the like, the printed contents can be obtained from another network printer 200a. Therefore, only an authorized user can obtain the printed matter.

Further, since the print enablement notice is transmitted to one of the network printers 200a, the possibility that the same printed contents are printed with the plurality of network printers 200a at one time can be reduced. In addition, even when the network printer 200a, in which printing is interrupted, is recovered, since print data being printed is removed, the possibility that the printed contents are printed with the recovered network printer 200a can be reduced. Therefore, the possibility that printing is performed in excess of the number of printable copies can be reduced, and thus secrecy of the printed contents can be protected, as compared with the related art.

In addition, since print data is stored in the respective network printers 200a, even when the network printer 200a stops printing due to a trouble, such as a paper jam or the like, printing can start with another network printer 200a at relatively high speed.

In addition, in the present embodiment, when the user authentication is accomplished on the basis of the received authentication information and when it is determined that the job ticket is not frozen, the host terminal 100a transmits the print enablement notice to one of the plurality of network printers 200a, the one being a source having transmitted the authentication information.

In such a manner, when giving the authentication card with the correct authentication information recorded therein to the network printer 200a in which printing is to be performed, the user can obtain the printed contents with that network printer 200a.

In addition, in the present embodiment, the host terminal 100a generates the utilization history information whenever print data is used.

In such a manner, it is possible to see how the print data has been used by referring to the utilization history information.

In addition, in the present embodiment, when it is determined that the number of printable copies is ‘0’, the host terminal 100a transmits the data deletion notice to all the network printers 200a and simultaneously deletes the job ticket. Further, when receiving the data deletion notice, the network printer 200a deletes print data.

In such a manner, the possibility that print data and the job ticket are incorrectly used can be reduced, and thus secrecy of the printed contents can be protected more reliably.

In the third embodiment described above, the host terminal 100a corresponds to the device utilization apparatuses according to the sixty-seventh, sixty-ninth, seventy-first, seventy-ninth, eighty-first to eighty-sixth, one-hundredth, one-hundred first, one-hundred ninth, one-hundred eleventh, and one-hundred thirteenth aspects, and the job ticket storage unit 12a and the storage device 62a correspond to the job ticket storage units according to sixty-seventh, seventy-ninth, ninety-fourth, and one-hundred ninth aspects. Further, the print data transmitting unit 11a, the I/F 58a, and step S110a correspond to the output data transmitting unit of the sixty-seventh or seventy-ninth aspect, and step S110a corresponds to the output data transmitting step of the ninety-fourth or one-hundred ninth aspect. In addition, the authentication information receiving unit 13a, the I/F 58a, and step S152a correspond to the authentication information receiving unit of the sixty-ninth or eighty-first aspect.

Further, in the third embodiment described above, step 152a corresponds to the authentication information receiving step of the ninety-sixth or one-hundred eleventh aspect, the user authenticating unit 14a and step S154a correspond to the authenticating units according to the sixty-ninth, seventieth, eighty-first, and eighty-second aspects, and step S154a corresponds to the authenticating steps according to the ninety-fourth, ninety-sixth, ninety-seventh, one-hundred ninth, one-hundred eleventh, and one-hundred twelfth aspects. Further, the print data utilization managing unit 15a, the I/F 58a, and steps S156a to S162a, S200a to S206a, and S212a to S218a correspond to the output data utilization managing units according to the sixty-seventh, sixty-ninth to seventy-second, seventy-ninth, eighty-first to eighty-fourth aspects, and steps S156a to S162a, S200a to S206a, and S212a to S218a correspond to the output data utilization managing steps according to the ninety-fourth, ninety-sixth to ninety-ninth, one-hundred ninth, and one-hundred eleventh to one-hundred fourteenth aspects.

Further, in the third embodiment described above, the utilization history information generating unit 16a and step S208a correspond to the utilization history information generating unit of the seventy-first or eighty-third aspect, step S208a corresponds to the utilization history information generating step of the ninety-eighth or one-hundred thirteenth aspect, and the network printer 200a corresponds to the network devices according to the sixty-seventh, sixty-ninth, seventy-ninth, eighty-first, eighty-fifth to eighty-seventh, ninety-fourth, ninety-sixth, one-hundred ninth and one-hundred eleventh aspects. Further, the print data storage unit 20a and the storage device 82a correspond to the output data storage units according to sixty-seventh, eighty-fifth, one-hundredth, and one-hundred ninth aspects, and the print data receiving unit 21a, the I/F 78a, and step S302a corresponds to the output data receiving step of the sixty-seventh or eighty-fifth aspect.

Further, in the third embodiment described above, step S302a corresponds to the output data receiving step of the one-hundredth or one-hundred ninth aspect, the print data storage unit 22a and step S304a correspond to the output data holding unit of the sixty-seventh or eighty-fifth aspect, and step S304a corresponds to the output data storing step of the one-hundredth or one-hundred ninth aspect. Further, the card reader 23a and step S352a correspond to the authentication information acquiring unit of the sixty-ninth or eighty-sixth aspect, step S352a corresponds to the authentication information acquiring step of the one-hundred first or one-hundred eleventh aspect, and the authentication information transmitting unit 24a, the I/F 78a, and step S356a corresponds to the authentication information transmitting unit of the sixty-ninth or eighty-sixth aspect.

Further, in the third embodiment described above, step S356a corresponds to the authentication information transmitting step of the one-hundred first or one-hundred eleventh aspect, the print control unit 26a, the I/F 78a, and steps S360a and S362a correspond to the output control units according to the sixty-seventh, seventy-second, eighty-seventh, and the eighty-fifth aspects, and steps S360a and S362a correspond to the output control steps according to the one-hundredth, one-hundred second, one-hundred ninth, and one-hundred fourteenth aspects. Further, print data corresponds to output data according to the sixty-seventh, sixty-ninth to seventy-second, seventy-ninth, eighty-first to eighty-third, eighty-fifth, eighty-seventh, ninety-fourth, ninety-sixth to ninety-eighth, one-hundredth, one-hundred second, one-hundred ninth, and one-hundred eleventh to one-hundred fourteenth aspects, and the print interruption notice corresponds to the output interruption notice according to the sixty-seventh, seventieth, seventy-ninth, eighty-second, eighty-fifth, ninety-fourth, ninety-seventh, one-hundredth, one-hundred ninth, and one-hundred twelfth aspects.

Further, in the third embodiment described above, the print completion notice corresponds to the output completion notice according to the sixty-seventh, seventieth, seventy-ninth, eighty-second, eighty-fifth, ninety-fourth, ninety-seventh, one-hundredth, one-hundred ninth, one-hundred twelfth aspects, and the print enablement notice corresponds to the output enablement notice according to the sixty-seventh, sixty-ninth, seventieth, seventy-ninth, eighty-first, eighty-second, eighty-fifth, ninety-fourth, ninety-sixth, ninety-seventh, one-hundredth, one-hundred ninth, one-hundred eleventh, and one-hundred twelfth aspects. Further, the data deletion notice corresponds to the utilization prohibition notice according to the sixty-seventh, seventy-second, seventy-ninth, eighty-fourth, eighty-fifth, eighty-seventh, ninety-fourth, ninety-ninth, one-hundredth, one-hundred second, one-hundred ninth, and one-hundred fourteenth aspects.

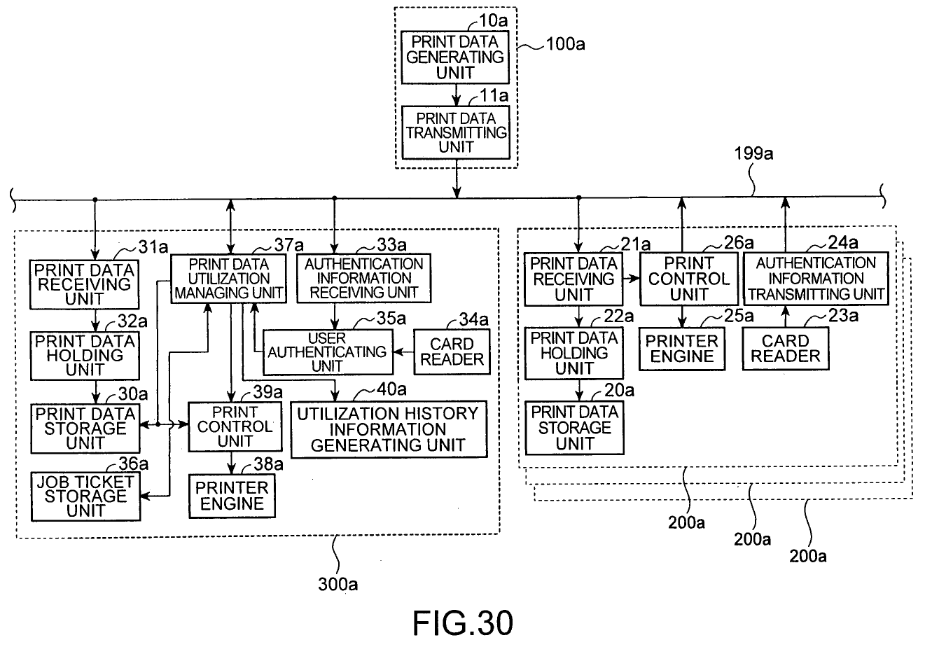

Next, a fourth embodiment of the invention will be described with reference to the drawings. FIGS. 30 to 35 are diagrams showing the fourth embodiment of an authentication output system, a device utilizing apparatus, a network device, an output data management program, an output control program, and an authentication output method according to the invention.

In the present embodiment, as shown in FIG. 30, the authentication output system, the device utilizing apparatus, the network device, the output data management program, the output control program, and the authentication output method according to the invention are applied to a case in which printing is performed by a network printer 200a or 300a by using an authentication card. The present embodiment is different from the third embodiment in that a job ticket is managed by the network printer 300a, not the host terminal 100a. Moreover, hereinafter, only different parts from the third embodiment will be described. The same parts as those in the third embodiment are represented by the same reference numerals and the descriptions thereof will be omitted.

First, the functional outline of a network system, to which the invention is applied, will be described with reference to FIG. 30.

FIG. 30 is a functional block diagram illustrating the functional outline of the network system.

As shown in FIG. 30, the host terminal 100a, a plurality of network printers 200a, and the network printer 300a that manages the job ticket are connected to a network 199a.

The host terminal 100a has a print data generating unit 10a and a print data transmitting unit 11a.

The network printer 300a has a print data storage unit 30a, a print data receiving unit 31a that receives print data, a print data storage unit 32a that stores print data received by the print data receiving unit 31a in the print data storage unit 30a, an authentication information receiving unit 33a that receives authentication information, a card reader 34a that reads authentication information from an inserted authentication card, and a user authenticating unit 35a that performs user authentication on the basis of the authentication information received by the authentication information receiving unit 33a and the authentication information read by the card reader 34a.

In addition, the network printer 300a also has a job ticket storage unit 36a that stores the job ticket, a print data utilization managing unit 37a that manages the utilization of print data, a printer engine 38a that has a print head, a head driving unit, and other mechanisms required for printing, and a print control unit 39a that performs a print control of the printer engine 38a on the basis of print data of the print data storage unit 30a.

When the user authentication is accomplished by the user authenticating unit 35a on the basis of the authentication information received by the authentication information receiving unit 33a and when it is determined that the job ticket of the job ticket storage unit 36a is not frozen, the print data utilization managing unit 37a transmits the print enablement notice to one of the plurality of network printers 200a, the one being a source having transmitted the authentication information, and freezes the job ticket until the print interruption notice or the print completion notice is received. Further, when the user authentication is accomplished by the user authenticating unit 35a on the basis of the authentication information read by the card reader 34a and when it is determined that the job ticket of the job ticket storage unit 36a is not frozen, the print data utilization managing unit 37a requests the print control unit 39a for printing and freezes the job ticket until the printer engine 38a stops or completes the printing. Then, when the print completion notice is received or when printing is completed by the printer engine 38a, the print data utilization managing unit 37a decrements the number of printable copies of the job ticket. Then, when it is determined that the number of printable copies is ‘0’, the print data utilization managing unit 37a transmits the data deletion notice to all the network printers 200a and deletes the print data and the job ticket.

The print control unit 39a performs printing on the basis of print data of the print data storage unit 30a according to the print request from the print data utilization managing unit 37a.

The network printer 300a also has a utilization history information generating unit 40a that generates utilization history information on the basis of the transmission result and the utilization result of the print data utilization managing unit 37a.

The present embodiment is different from the third embodiment in that the network printer 200a communicates with the network printer 300a, not the host terminal 100a.

Next, the configuration of the host terminal 100a will be described.

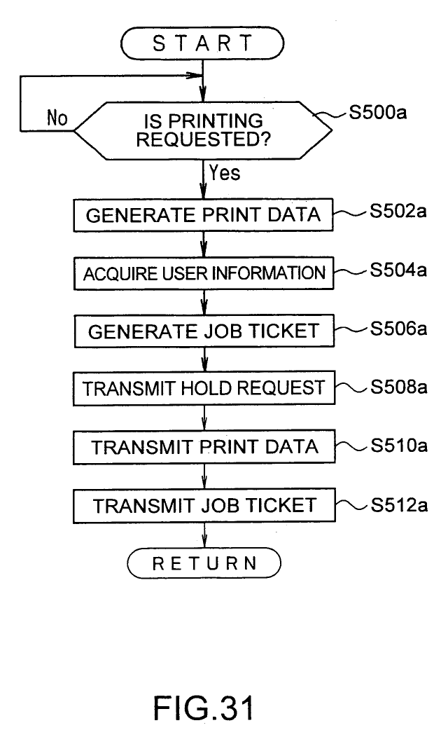

The CPU 50a runs a predetermined program stored in a predetermined area of the ROM 52a and executes a print data generating process shown in a flowchart of FIG. 31, instead of the print data generating process, the print request receiving process, and the print result receiving process shown in the flowcharts of FIGS. 21, 23 and 24, according to the program.

FIG. 31 is the flowchart showing the print data generating process.

As shown in FIG. 31, if the print data generating process is executed by the CPU 50a, first, the process proceeds to step S500a.

In step S500a, it is determined whether or not printing is requested from a documentation application or the like. If it is determined that printing is requested (Yes), the process proceeds to step S502a. On the other hand, if it is determined that printing is not requested (No), the process is on standby at step S500a until printing is requested.

In step S502a, a job ID is issued, and print data including the issued job ID is generated on the basis of document data edited by the documentation application or the like. Then, the process proceeds to step S504a. In step S504a, user information of a user who uses the host terminal 100a at present is acquired, and the process proceeds to step S506a. Then, in step S506a, a job ticket is generated on the basis of the issued job ID and the acquired user information, and the process proceeds to step S508a.

In step S508a, a storage request is transmitted to all the network printers 200a and the network printer 300a, and the process proceeds to step S510a. In step S510a, generated print data is transmitted to all the network printers 200a and the network printer 300a, and the process proceeds to step S512a. In step S512a, the generated job ticket is transmitted to the network printer 300a. After the series of steps are completed, the process returns to the initial step.

Next, the configuration of the network printer 300a will be described.

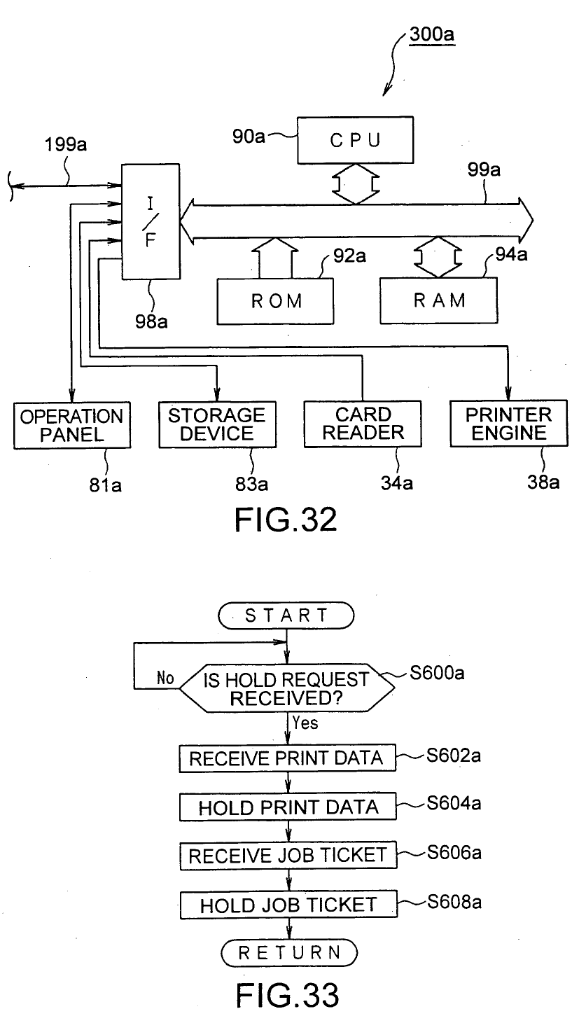

FIG. 32 is a block diagram illustrating the hardware configuration of the network printer 300a.

As shown in FIG. 32, the network printer 300a has a CPU 90a that performs operations and controls the overall system on the basis of a control program, a ROM 92a that stores the control program of the CPU 90a or the like in a predetermined area in advance, a RAM 94a that stores data read from the ROM 92a or the like and operation results required for the operation process of the CPU 90a, and an I/F 98a that intermediates an input/output of data to/from peripheral devices. Those are communicably connected to one another by a bus 99a, which serves as a signal line for transmitting data.

To the I/F 98a, an operation panel 81a, serving as a human interface, such as a touch panel or the like, through which data can be inputted and displayed, a storage device 83a for storing data or tables in files, the card reader 34a, the printer engine 38a, all of which are peripheral devices, and signal lines for connection with the network 199a are connected.

The CPU 90a has a micro processing unit or the like, runs a predetermined program stored in a predetermined area of the ROM 92a, and executes a print data storing process, a print control process, and a print state monitoring process shown in flowcharts of FIGS. 33 to 35 according to the program in a time-division manner. Besides, the CPU 90a executes the same processes as the print request receiving process and the print result receiving process shown in the flowcharts of FIGS. 23 and 24 in a time-division manner. However, in the print result receiving process, the step corresponding to step S218a becomes the step of deleting print data and the job ticket corresponding to the job ID included in the received print completion notice from the storage device 83a.

First, the print data storing process will be described in detail with reference to FIG. 33.

FIG. 33 is the flowchart showing the print data storing process.

The print data storing process is a process of storing print data from the host terminal 100a. As shown in FIG. 33, if the print data storing process is executed by the CPU 90a, first, the process proceeds to step S600a.

In step S600a, it is determined whether or not the storage request is received, and when it is determined that the storage request is received (Yes), the process proceeds to step S602a. On the other hand, when it is determined that the storage request is not received (No), the process is on standby at step S600a until the storage request is received.

In step S602a, print data is received, and the process proceeds to step S604a. In step S604a, received print data is stored in the storage device 83a, and the process proceeds to step S606a. In step S606a, the job ticket is received, and the process proceeds to step S608a. In step S608a, the received job ticket is stored in the storage device 83a. After the series of steps are completed, the process returns to the initial step.

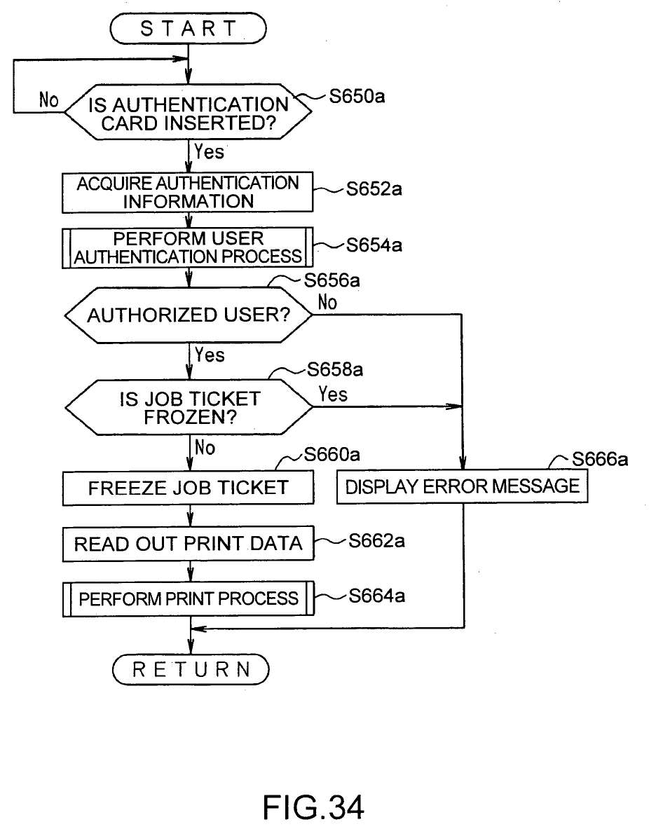

Next, the print control process will be described in detail with reference to FIG. 34.

FIG. 34 is the flowchart showing the print control process.

The print control process is a process of performing the print control of the printer engine 38a. As shown in FIG. 34, if the print control process is executed by the CPU 90a, first, the process proceeds to step S650a.

In step S650a, it is determined whether or not the authentication card is inserted into the card reader 34a, and when it is determined that the authentication card is inserted (Yes), the process proceeds to step S652a. On the other hand, when it is determined that the authentication card is not inserted (No), the process is on standby at step S650a until the authentication card is inserted.

In step S652a, the authentication information is read from the authentication card by the card reader 34a, and the process proceeds to step S654a. In step S654a, a user authentication process for performing the user authentication is executed on the basis of the read authentication information. In the user authentication process, the job ticket corresponding to the job ID included in the read authentication information is retrieved from the storage device 83a. As a result, when the corresponding job ticket is retrieved, it is determined whether or not the user information of the retrieved job ticket and the user information included in the read authentication information correspond with each other. When it is determined that the user information of the job ticket and the user information included in the authentication information correspond with each other, it is determined that the user is eligible to use the print data. On the other hand, when the corresponding job ticket is not retrieved or when the user information of the job ticket and the user information included in the authentication information correspond with each other, it is determined that the user is not eligible to use the print data.

Next, the process proceeds to step S656a, the result of the user authentication process is determined. At this time, when it is determined that the user is eligible to use the print data (Yes), the process proceeds to step S658a, and it is determined whether or not the exclusive flag of the retrieved job ticket is set. When it is determined that the exclusive flag is not set (No), it is determined that the job ticket is not frozen, and the process proceeds to step S660a.

In step S660a, the exclusive flag of the retrieved job ticket is set, and the process proceeds to step S662a. In step S662a, print data corresponding to the job ID of the retrieved job ticket is read out from the storage device 83a, and the process proceeds to step S664a. In step S664a, a print process for performing the print control of the printer engine 38a is executed on the basis of print data read out from the storage device 83a. After the series of steps are completed, the process returns to the initial step.

In step S658a, when it is determined that the exclusive flag of the retrieved job ticket is set (Yes), it is determined that the job ticket is frozen, and the process proceeds to step S666a. In step S666a, an error message is displayed on the operation panel 81a. After the series of steps are completed, the process returns to the initial step.

In step S656a, when it is determined that the user is not eligible to use the print data (No), the process proceeds to step S666a.

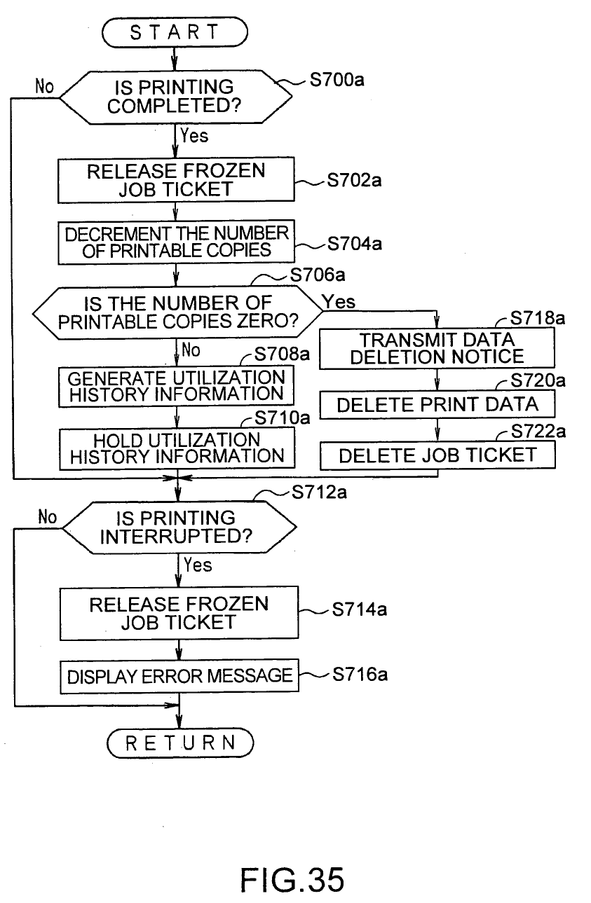

Next, the print state monitoring process will be described in detail with reference to FIG. 35.

FIG. 35 is the flowchart showing the print state monitoring process.

The print state monitoring process is a process of monitoring the print situation of the printer engine 38a. As shown in FIG. 35, if the print state monitoring process is executed by the CPU 90a, first, the process proceeds to step S700a.

In step S700a, it is determined whether or not printing is completed by the printer engine 38a, and when it is determined that printing is completed (Yes), the process proceeds to step S702a. In step S702a, the job ticket corresponding to the job ID of the print-completed print data is retrieved from the storage device 83a, the exclusive flag of the retrieved job ticket is reset, and the process proceeds to step S704a. In step S704a, the number of printable copies of the retrieved job ticket is decremented by ‘1’, and the process proceeds to step S706a.

In step S706a, it is determined whether or not the number of printable copies is ‘0’, and when it is determined that the number of printable copies is not ‘0’ (No), the process proceeds to step S708a. In step S708a, the utilization history information including the printed date and time is generated, and the process proceeds to step S710a. In step S710a, the generated utilization history information is stored in the storage device 83a while being added to the retrieved job ticket, and the process proceeds to step S712a.

In step S712a, it is determined whether or not the printer engine 38a has stopped printing, and when it is determined that the printer engine 38a has stopped printing (Yes), the process proceeds to step S714a. In step S714a, the job ticket corresponding to the job ID of the print-interrupted print data is retrieved from the storage device 83a, the exclusive flag of the retrieved job ticket is reset, and the process proceeds to step S716a. In step S716a, an error message is displayed on the operation panel 81a. After the series of steps are completed, the process returns to the initial step.

In step S712a, when it is determined that the printer engine 38a has not stopped printing (No), the series of steps are completed, and then the process returns to the initial step.

In step S706a, when it is determined that the number of printable copies is ‘0’ (Yes), the process proceeds to step S718a. In step S718a, the data deletion notice including the job ID of the print-completed print data is transmitted to all the network printers 200a, and the process proceeds to step S720a. In step S720a, print data corresponding to the job ID of the, print-completed print data is deleted from the storage device 83a, and the process proceeds to step S712a.

In step S700a, when it is determined that printing is not completed by the printer engine 38a (No), the process proceeds to step S712a.

Next, the operation of the present embodiment will be described.

In the host terminal 100a, the user edits document data by using the documentation application or the like and requests to print it.

In the host terminal 100a, if printing is requested, through steps S502a to S512a, print data and the job ticket are generated and generated print data and the storage request are transmitted to all the network printers 200a, and simultaneously print data and the job ticket generated are transmitted to the network printer 300a, together with the storage request.

In the network printer 200a, when print data and the storage request are received, through step S304a, received print data is stored in the storage device 82a.

In the network printer 300a, when print data and the job ticket and the storage request are received, through steps S604a and S606a, print data and the job ticket received are stored in the storage device 83a.

First, a case in which printing is performed by the network printer 200a will be described.

The user goes to one of the network printers 200a and inserts the authentication card into the card reader 23a.

In the network printer 200a, if the authentication card is inserted, through steps S352a to S356a, the authentication information is read from the authentication card by the card reader 23a, and the read authentication information and the print request are transmitted to the network printer 300a.

In the network printer 300a, if the authentication information and the print request are received, through step S154a, the user authentication is performed on the basis of the received authentication information. As a result, if the user authentication is accomplished, through steps S160a and S162a, the job ticket is frozen and the print enablement notice is transmitted to the network printer 200a, which is a source of the print request.

In the network printer 200a, if the print enablement notice is received, through steps S360a and S362a, print data is read out from the storage device 82a and the print control is performed on the basis of read print data. Then, if printing is completed, through step S402a, the print completion notice is transmitted to the network printer 300a.

In the network printer 300a, if the print completion notice is received, through steps S202a and S204a, the job ticket is not frozen (e.g., released) and the number of printable copies is decremented. As a result, if the number of printable copies of the job ticket becomes ‘0’, through steps S208a and S210a, the utilization history information is generated and the generated utilization history information is stored in the storage device 83a while being added to the job ticket.

Next, a case in which printing is performed by the network printer 300a will be described.

The user goes to the network printer 300a and inserts the authentication card into the card reader 34a.

In the network printer 300a, if the authentication card is inserted, through steps S652a and S654a, the authentication information is read from the authentication card by the card reader 34a, and the user authentication is performed on the basis of the read authentication information. As a result, if the user authentication is accomplished, through steps S660a to S664a, the job ticket is frozen, print data is read out from the storage device 83a, and the print control is performed on the basis of read print data. Then, if printing is completed, through steps S702a and S704a, the job ticket is not frozen and the number of printable copies of the job ticket is decremented. As a result, if the number of printable copies becomes ‘0’, through steps S708a and S710a, the utilization history information is generated and the generated utilization history information is stored in the storage device 83a while being added to the job ticket.

Next, a case in which the network printer 200a stops printing will be described.

In the network printer 200a, if printing is interrupted due to a trouble, such as a paper jam or the like, through steps S406a to S410a, the print interruption notice is transmitted to the network printer 300a, print data being printed is removed, and the error message is displayed.

In the network printer 300a, if the print interruption notice is received, through step S214a, the job ticket is not frozen (e.g., released).

Next, the user removes the authentication card from the card reader 23a in the network printer 200a, in which printing has been interrupted. Then, the user goes to another network printer 200a and inserts the authentication card into the card reader 23a. Hereinafter, in another network printer 200a and the network printer 300a, the same operation as described above is performed, and printing is performed by another network printer 200a. The number of printable copies is not decremented even when printing is interrupted. When printing is completed by another network printer 200a, the number of printable copies is decremented.

Next, a case in which the network printer 300a stops printing will be described.

In the network printer 300a, if printing is interrupted due to a trouble, such as a paper jam or the like, through steps S714a and S716a, the job ticket is not frozen (e.g., released) to display an error message.

Next, the user removes the authentication card from the card reader 34a in the network printer 300a. Then, the user goes to another network printer 200a and inserts the authentication card into the card reader 23a. Hereinafter, in another network printer 200a and the network printer 300a, the same operation as described above is performed, and printing is performed by another network printer 200a. The number of printable copies is not decremented even when printing is interrupted. When printing is completed by another network printer 200a, the number of printable copies is decremented.

Next, a case, in which while one of the network printers 200a or the network printer 300a is in a printing operation, the authentication card is removed to be inserted into the card reader 23a of another network printer 200a, will be described.

In the network printer 200a, if the authentication card is inserted, the authentication information is read from the authentication card by the card reader 23a, and the read authentication information and the print request are transmitted to the network printer 300a.

In the network printer 300a, if the authentication information and the print request are received, the user authentication is performed on the basis of the received authentication information. In this case, even when the user authentication is accomplished, since the job ticket is frozen during the print process, through step S164a, the print prohibition notice is transmitted to the network printer 200a, which is a source of the print request.

In the network printer 200a, if the print prohibition notice is received, through step S366a, the error message is displayed. That is, printing is not performed.

Next, a case, in which while one of the network printers 200a is in a printing operation, the authentication card is removed to be inserted into the card reader 34a of the network printer 300a, will be described.

In the network printer 300a, if the authentication card is inserted, the authentication information is read from the authentication card by the card reader 34a, and the user authentication is performed on the basis of the read authentication information. In this case, even when the user authentication is accomplished, since the job ticket is frozen during the print process, through step S666a, the error message is displayed. That is, printing is not performed.

Moreover, when an authentication card in which incorrect authentication information is stored is used, in the network printer 300a, the user authentication is not accomplished, and thus the print prohibition notice is transmitted to the network printer 200a, which is a source of the print request, or the error message is displayed.

Further, when the number of printable copies becomes ‘0’, in the network printer 300a, through steps S216a and S218a or steps S718a to S722a, the data deletion notice is transmitted to all the network printers 200a, and print data and the job ticket are deleted.

In the network printer 200a, if the data deletion notice is received, through step S452a, print data is deleted.

In the present embodiment, in such a manner, the host terminal 100a generates print data and transmits generated print data to all the network printers 200a and the network printer 300a, and the network printer 300a receives print data and stores received print data in the storage device 83a. When the user authentication is accomplished and it is determined that the job ticket is not frozen, the network printer 300a transmits the print enablement notice to one of the plurality of network printers 200a, and freezes the job ticket until the print interruption notice or the print completion notice is received. Further, the network printer 300a performs the print control on the basis of print data of the storage device 83a, freezes the job ticket until printing is interrupted or completed, and when the print completion notice is received or when printing is completed, decrements the number of printable copies of the job ticket. Then, when it is determined that the number of printable copies is ‘0’, the network printer 300a transmits the data deletion notice to all the network printers 200a and simultaneously deletes print data and the job ticket. Further, the network printer 200a receives print data and stores received print data in the storage device 82a. Then, when receiving the print enablement notice, the network printer 200a performs printing on the basis of print data of the storage device 82a. When printing is interrupted, the network printer 200a removes print data being printed and simultaneously transmits the print interruption notice to the network printer 300a. When printing is completed, the network printer 200a transmits the print completion notice to the network printer 300a. In addition, when receiving the data deletion notice, the network printer 200a deletes print data.

In such a manner, when printing is completed, the number of printable copies is decremented, and thus, even when any one of the network printers 200a and 300a stops printing due to a trouble, such as a paper jam or the like, the printed contents can be obtained from the other of the network printers 200a and 300a. Therefore, only an authorized user can acquire the printed matter.

Further, since the print enablement notice is transmitted to the network printer 200a or print data is used by the network printer 300a, the possibility that the same printed contents are printed with the network printers 200a and 300a at one time can be reduced. In addition, even when the network printer 200a or 300a, in which printing has been interrupted, is recovered, since print data being printed is removed, the possibility that the printed contents are printed with the recovered network printer 200a or 300a can be reduced. Therefore, the possibility that printing is performed in excess of the number of printable copies can be reduced, and thus secrecy of the printed contents can be protected, as compared with the related art.

In addition, since print data is stored in the respective network printers 200a and the network printer 300a, even when one of the network printers 200a and 300a stops printing due to a trouble, such as a paper jam or the like, printing can start with the other of the network printers 200a and 300a at relatively high speed.

In addition, in the present embodiment, when the user authentication is accomplished on the basis of the received authentication information and when it is determined that the job ticket is not frozen, the network printer 300a transmits the print enablement notice to one of the plurality of network printers 200a, the one being a source having transmitted the authentication information. Further, when the user authentication is accomplished on the basis of the read authentication information and it is determined that the job ticket is not frozen, the network printer 300a performs the print control on the basis of print data of the storage device 83a.

In such a manner, when giving the authentication card with the correct authentication information recorded therein to the network printer 200a or 300a in which printing is to be performed, the user can obtain the printed contents with the network printer 200a or 300a.

In addition, in the present embodiment, the network printer 300a generates the utilization history information whenever print data is used.

In such a manner, it is possible to see how the print data has been used by referring to the utilization history information.

In addition, in the present embodiment, when it is determined that the number of printable copies is ‘0’, the network printer 300a transmits the data deletion notice to all the network printers 200a and simultaneously deletes print data and the job ticket. Further, when receiving the data deletion notice, the network printer 200a deletes print data.

In such a manner, the possibility that print data and the job ticket are incorrectly used can be reduced, and thus secrecy of the printed contents can be protected more reliably.

In the fourth embodiment described above, the host terminal 100a corresponds to the device utilization apparatus of the seventy-third or one-hundred fifteenth aspect, the print data transmitting unit 11a, the I/F 58a, and step S510a correspond to the output data transmitting unit of the seventy-third aspect, and step S510a corresponds to the output data transmitting step of the one-hundred fifteenth aspect. Further, the network printer 300a corresponds to the first network devices according to the seventy-third, seventy-fifth to seventy-seventh, one-hundred fifteenth, and one-hundred seventeenth to one-hundred nineteenth aspects, and the print data storage unit 30a and the storage device 83a correspond to the first output data storage unit of the seventy-third or one-hundred fifteenth aspect or the output data storage units according to the eighty-eighth or one-hundred third aspect.

Further, in the fourth embodiment described above, the job ticket storage unit 36a and the storage device 83a correspond to the job ticket storage units according to the seventy-third, eighty-eighth, one-hundred third, and one-hundred fifteenth aspects, and the print data receiving unit 31a, the I/F 98a, and step S602a correspond to the first output data receiving unit of the seventy-third aspect or the output data receiving unit of the eighty-eighth aspect. Further, step S602a corresponds to the first output data receiving step of the one-hundred fifteenth aspect or the output data receiving step of the one-hundred third aspect, the print data holding unit 32a and step S604a correspond to the first output data holding unit of the seventy-third aspect, or the output data holding unit of the eighty-eighth aspect.

Further, in the fourth embodiment described above, and step S604a corresponds to the first output data storing step of the one-hundred fifteenth aspect or the output data storing step of the one-hundred third aspect, and the authentication information receiving unit 33a, the I/F 98a, and step S152a correspond to the authentication information receiving units according to the seventy-fifth, seventy-sixth, ninetieth, and ninety-first aspects. Further, step S152a corresponds to the authentication information receiving steps according to the one-hundred fifth, one-hundred sixth, one-hundred seventeenth, and one-hundred eighteenth aspects, and the card reader 34a and step S652a correspond to the first authentication information acquiring unit of the seventy-fifth or seventy-sixth aspect, or the authentication information acquiring unit of the ninetieth or ninety-first aspect.

Further, in the fourth embodiment described above, step S652a corresponds to the first authentication information acquiring step of the one-hundred seventeenth or one-hundred eighteenth aspect, or the authentication information acquiring step of the one-hundred fifth or one-hundred sixth aspect, and the user authenticating unit 35a and steps S154a and S654a correspond to the authenticating units according to the seventy-fifth, seventy-sixth, ninetieth, and ninety-first aspects. Further, steps S154a and S654a correspond to the authenticating steps according to the one-hundred third, one-hundred fifth, one-hundred sixth, one-hundred fifteenth, one-hundred seventeenth, and one-hundred eighteenth aspects, the print data utilization managing unit 37a, the I/F 98a, and steps S156a to S162a, S200a to S206a, S212a to S218a, S656a to S660a, S700a to S706a, and S712a to S722a correspond to the output data utilization managing units according to the seventy-third, seventy-fifth to seventy-eighth, eighty-eighth, and ninetieth to ninety-third aspects.

Further, in the fourth embodiment described above, steps S156a to S162a, S200a to S206a, S212a to S218a, S656a to S660a, S700a to S706a, and S712a to S722a correspond to the output data utilization managing steps according to the one-hundred third, one-hundred fifth to one-hundred eighth, one-hundred fifteenth, and one-hundred seventeenth to one-hundred twentieth aspects. Further, the print control unit 39a and steps S662a and S664a correspond to the first output control unit of the seventy-third or seventy-fifth aspect, or the output control unit of the eighty-eighth or ninetieth aspect, and steps S662a and S664a corresponds to the first output control step of the one-hundred fifteenth or one-hundred seventeenth aspect or the output control step of the one-hundred third or one-hundred fifth aspect.

Further, in the fourth embodiment described above, the utilization history information generating unit 40a and steps S208a and S708a correspond to the utilization history information generating unit of the seventy-seventh or ninety-second aspect, steps S208a and S708a correspond to the utilization history information generating step of the one-hundred seventh or one-hundred nineteenth aspect, and the network printer 200a corresponds to the second network devices according to the seventy-third, seventy-fifth, one-hundred fifteenth, and one-hundred seventeenth aspects. Further, the print data storage unit 20a and the storage device 82a correspond to the second output data storage unit of the seventy-third or one-hundred fifteenth aspect, the print data receiving unit 21a, the I/F 78a, and step S302a correspond to the second output data receiving unit of the seventy-third aspect, and step 302a corresponds to the second output data receiving step of the one-hundred fifteenth aspect.

Further, in the fourth embodiment described above, the print data storage unit 22a and step S304a correspond to the second output data holding unit of the seventy-third aspect, step S304a corresponds to the second output data storing step of the one-hundred fifteenth aspect, and the card reader 23a and step S352a correspond to the second authentication information acquiring unit of the seventy-fifth aspect. Further, step S352a corresponds to the second authentication information acquiring step of the one-hundred seventeenth aspect, the authentication information transmitting unit 24a, the I/F 78a, and step S356a correspond to the authentication information transmitting unit of the seventy-fifth aspect, and step S356a corresponds to the authentication information transmitting step of the one-hundred seventeenth aspect.

Further, in the fourth embodiment described above, the print control unit 26a, the I/F 78a, and steps S360a and S362a correspond to the second output control unit of the seventy-third or seventy-eighth aspect, steps S360a and S362a correspond to the second output control step of the one-hundred fifteenth or one-hundred twentieth aspect, and print data corresponds to output data according to the seventy-third, seventy-fifth to seventy-eighth, eighty-eighth, ninetieth to ninety-third, one-hundred third, one-hundred fifth to one-hundred eighth, one-hundred fifteenth, and one-hundred seventeenth to one-hundred twentieth aspects. Further, the print interruption notice corresponds to the output interruption notice according to the seventy-third, seventy-sixth, eighty-eighth, ninety-first, one-hundred third, one-hundred sixth, one-hundred fifteenth, and one-hundred eighteenth aspects, the print completion notice corresponds to the output completion notice according to the seventy-third, seventy-sixth, eighty-eighth, ninety-first, one-hundred third, one-hundred sixth, one-hundred fifteenth, and one-hundred eighteenth aspects, and the print enablement notice corresponds to the output enablement notice according to the seventy-third, seventy-fifth, seventy-sixth, eighty-eighth, ninetieth, ninety-first, one-hundred third, one-hundred fifth, one-hundred sixth, one-hundred fifteenth, one-hundred seventeenth, and one-hundred eighteenth aspects.

Further, in the fourth embodiment described above, the data deletion notice corresponds to the utilization prohibition notice according to the seventy-third, seventy-eighth, eighty-eighth, ninety-third, one-hundred third, one-hundred eighth, one-hundred fifteenth, and one-hundred twentieth aspects.

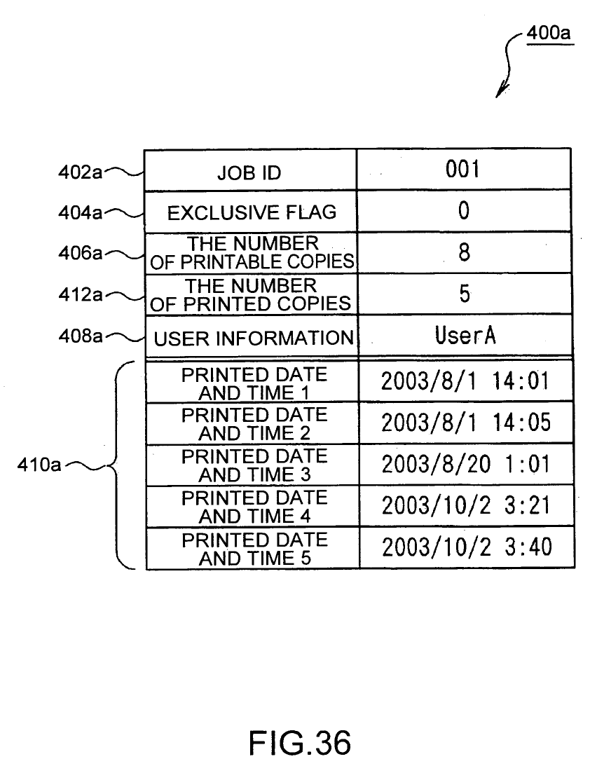

Moreover, in the third and fourth embodiments described above, the number of printable copies of the job ticket is decremented, and when the number of printable copies becomes ‘0’, print data and the job ticket are deleted. However, the invention is not limited thereto. For example, the number of printable copies and the number of printed copies may be specified in the job ticket, the number of printed copies of the job ticket may be incremented, and when the number of printed copies reaches the number of printable copies, print data and the job ticket may be deleted. Specifically, the job ticket is constituted as shown in FIG. 36.

FIG. 36 is a view illustrating the data structure of the job ticket 400a.

As shown in FIG. 36, the job ticket 400a includes a field 402a that stores the job ID, a field 404a that stores the exclusive flag, a field 406a that stores the number of printable copies, a field 412a that stores the number of printed copies, and a field 408a that stores the user information.

In the example of FIG. 36, ‘8’ and ‘5’ are stored as the number of printable copies and the number of printed copies, respectively. This indicates that the number of printable copies is eight and print data of the job ID of ‘001’ has been already printed by five copies.

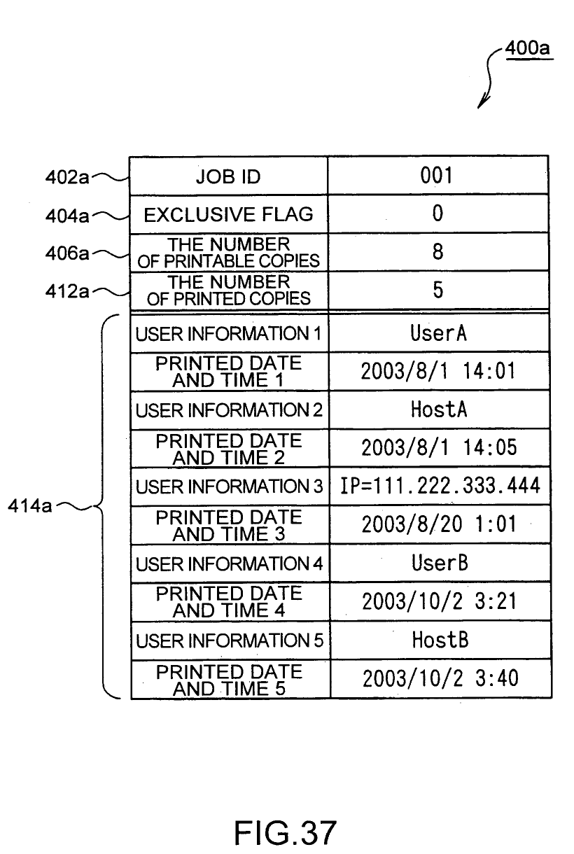

Further, in the third and fourth embodiments described above, the user information is specified in the job ticket and the user authentication is performed on the basis of the authentication information and the job ticket. However, the invention is not limited thereto. For example, any user may print, without performing the user authentication. In this case, the user information and the printed date and time as the utilization history information are preferably recorded. Specifically, the job ticket is constituted as shown in FIG. 37.

FIG. 37 is a view illustrating the data structure of the job ticket 400a.

As shown in FIG. 37, the job ticket 400a includes the field 402a that stores the job ID, the field 404a that stores the exclusive flag, the field 406a that stores the number of printable copies, and the field 412a that stores the number of printed copies. In addition, the job ticket 400a also includes a field 414a that stores the utilization history information whenever print data is used.

In the example of FIG. 37, five records are stored as the utilization history information. This indicates that print data of the job ID of ‘001’ has been already printed by five copies. In this case, as the utilization history, the user information and the printed date and time are shown. Here, as the user information, for example, a host ID of the host terminal 100a and an IP address may be set, in addition to the user ID.

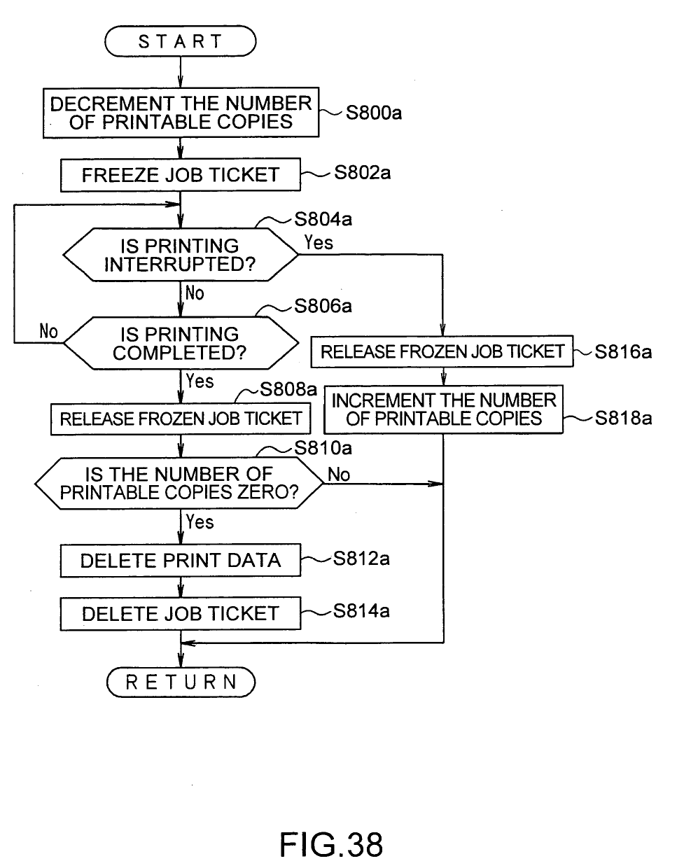

Further, in the third and fourth embodiments described above, after printing is interrupted or completed, the number of printable copies of the job ticket is decremented. However, the invention is not limited thereto. For example, before the job ticket is frozen, the number of printable copies of the job ticket may be decremented. Specifically, a job ticket updating process shown in a flowchart of FIG. 38 is executed.

FIG. 38 is the flowchart of the job ticket updating process.

As shown in FIG. 38, if the job ticket updating process is executed by the CPU 50a or 90a, first, the process proceeds to step S800a.

In step S800a, the number of printable copies of the job ticket is decremented by ‘1’, and the process proceeds to step S802a. In step S802a, the job ticket is frozen, and the process proceeds to step S804a. In step S804a, it is determined whether or not printing has been interrupted, and when it is determined that the printing has not been interrupted (No), the process proceeds to step S806a.

In step S806a, it is determined whether or not printing is completed, and when it is determined that printing is completed (Yes), the process proceeds to step S808a. In step S808a, the job ticket is not frozen (e.g., released), and the process proceeds to step S810a. In step S810a, it is determined whether or not the number of printable copies is ‘0’, and when it is determined that the number of printable copies is not ‘0’ (No), the series of steps are completed and then the process returns to the initial step.

In step S810a, when it is determined that the number of printable copies is ‘0’ (Yes), the process proceeds to step S812a. In step S812a, print data is deleted, and the process proceeds to step S814a. In step S814a, the job ticket is deleted. After the series of steps are completed, the process returns to the initial step.

In step S806a, when it is determined that printing is not completed (No), the process proceeds to step S804a.

In step S804a, when it is determined that printing has been interrupted (Yes), the process proceeds to step S816a. In step S816a, the job ticket is not frozen (e.g., released), and the process proceeds to step S818a. In step S818a, the number of printable copies of the job ticket is incremented by ‘1’. After the series of steps are completed, the process returns to the initial step.

In this case, steps S800a to S818a correspond to the output data utilization managing units according to the sixty-eighth, seventy-fourth, eightieth, and eighty-ninth aspects or the output data utilization managing steps according to the ninety-fifth, one-hundred fourth, one-hundred tenth, and one-hundred sixteenth aspects.

Further, in the third and fourth embodiments described above, the number of printable copies is specified in the job ticket to limit the number of printable copies. However, the invention is not limited thereto. For example, the number of printable pages may be specified in the job ticket and the number of printed pages may be restricted.

Further, in the third and fourth embodiments described above, the host terminal 100a is used, but the invention is not limited thereto. For example, instead of the host terminal 100a, a printer server may be used.

Further, in the third and fourth embodiments described above, the authentication information is read from the authentication card by the card reader 23a or 34a, but the invention is not limited thereto. For example, the authentication information may be inputted from the operation panel 80a or 81a. In this case, the card reader 23a or 34a does not need to be provided.

Further, in the third and fourth embodiments described above, the card reader 23a or 34a is integrally provided in the network printer 200a or 300a, but the invention is not limited thereto. For example, the card reader 23a or 34a may be separately provided from the network printer 200a or 300a. Specifically, a user authenticating device having the card reader 23a or 34a is communicably connected to the network printer 200a or 300a, and the network printer 200a or 300a inputs the authentication information by receiving the authentication information from the user authenticating device.

Further, in the third and fourth embodiments described above, in order to execute each of the processes shown in the flowcharts of FIGS. 21, 23, 24, 26 to 29, 31, 33 to 35, and 38, the control program stored in the ROM 52a, 72a, or 92a in advance is executed, but the invention is not limited thereto. For example, programs indicating these procedures may be stored in a storage medium. Then, each program may be read in the RAM 54a, 74a, or 94a to be executed.

Here, as the storage medium, a semiconductor storage medium, such as the RAM, the ROM, or the like, a magnetic recordable storage medium, such as the FD, the HD, or the like, an optical readable storage medium, such as the CD, the CDV, the LD, the DVD, or the like, and a magnetic recordable/optical readable storage medium, such as the MO or the like may be used. Specifically, any storage medium may be used as long as it is a computer readable storage medium, regardless of reading methods such as electronic, magnetic, or optical.

Further, in the third and fourth embodiments described above, the authentication output system, the device utilizing apparatus, the network device, the output data management program, the output control program, and the authentication output method according to the invention are applied to the case in which printing is performed by the network printer 200a or 300a by using the authentication card. However, the invention is not limited thereto, and, for example, the application to other cases can be made without departing from the subject matter of the invention. Instead of the network printer 200a or 300a, for example, the invention can be applied to a projector, a home gateway, a personal computer, a PDA, a network storage, an audio apparatus, a mobile phone, PHS, a watch-type PDA, a STB, a POS terminal, a facsimile machine, a phone (including an IP phone or the like), and other output devices.

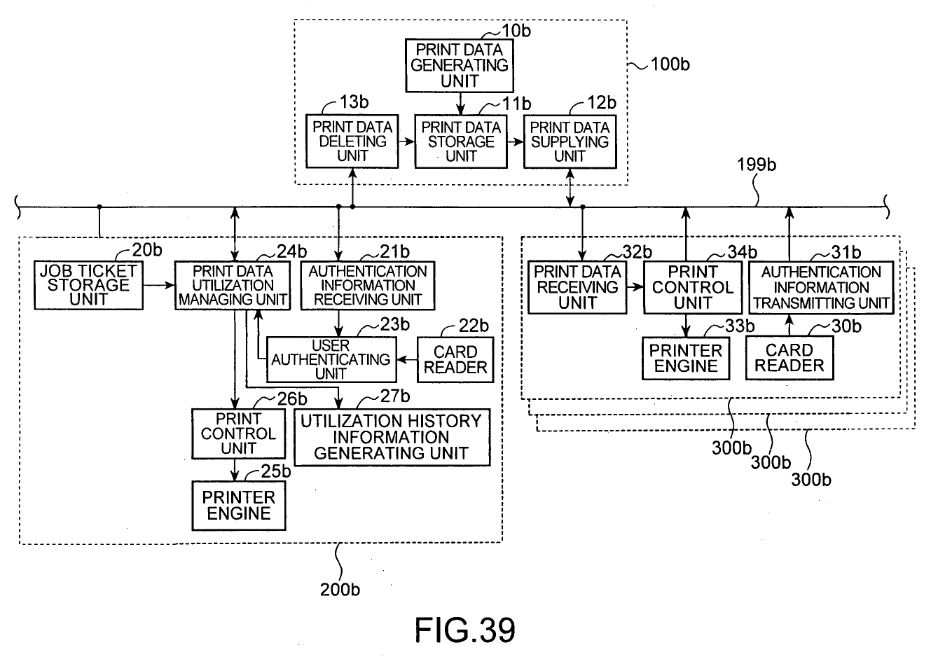

Next, a fifth embodiment of the invention will be described with reference to the accompanying drawings. FIGS. 39 to 53 are views illustrating a fifth embodiment of an output system, a network device, and an output method according to the invention.

In the present embodiment, as shown in FIG. 39, the output system, the network device, and the output method according to the invention are applied to a case in which printing is performed by a network printer 200b or 300b by using an authentication card.

First, a functional outline of a network system to which the invention is applied will be described with reference to FIG. 39.

FIG. 39 is a block diagram illustrating the functional outline of the network system.

As shown in FIG. 39, a host terminal 100b, a network printer 200b for controlling a job ticket specifying the number of printable copies, and a plurality of network printers 300b are connected to a network 199b.

The host terminal 100b includes a print data generating unit 10b for generating print data, a print data holding unit 11b for storing the print data generated by the print data generating unit 10b, a print data supplying unit 12b for supplying the print data of the print data holding unit 11b to the network printer 200b according to the request from the network printer 200b, and a data deleting unit 13b for deleting the print data of the print data holding unit 11b according to a data deletion notice from the network printer 200b.

The network printer 200b includes a job ticket holding unit 20b for storing the job ticket, an authentication information receiving unit 21b for receiving the authentication information, a card reader 22b for reading out the authentication information from an inserted authentication card, a user authenticating unit 23b for performing a user authentication on the basis of the authentication information received from the authentication information receiving unit 21b and the authentication information read from the card reader 22b.

Also, the network printer 200b further includes a print data utilization managing unit 24b for managing the use of the print data, a printer engine 25b composed of a print head, a head driving unit, and other mechanism necessary for printing, and a print control unit 26b for controlling the printing of the print engine 25b on the basis of the print data.

When the print data utilization managing unit 24b determines that the user authentication from the user authenticating unit 23b is accomplished on the basis of the authentication information received from the authentication information receiving unit 21b and the job ticket of the job ticket holding unit 20b is not frozen, the print data utilization managing unit 24b acquires the print data from the host terminal 100b to transmit the acquired print data to one of the plurality of network printers 300b, the one being a source from which the authentication information has been transmitted, and does not freeze the job ticket until it receives a print interruption notice or a print completion notice. Further, when the print data utilization managing unit 24b determines that the user authentication from the user authenticating unit 23b is accomplished on the basis of the authentication information read from the card reader 22b and the job ticket of the job ticket holding unit 20b is not frozen, the print data utilization managing unit 24b acquires the print data from the host terminal 100b to transmit the acquired print data to the print control unit 26b, and does not freeze the job ticket until printing performed by the printer engine 25b is interrupted or completed. Furthermore, the print data utilization managing unit 24b decrements the number of printable copies of the job ticket when the print completion notice is received or the printing by the printer engine 25b is completed, and the print data utilization managing unit 24b transmits the data deletion notice to the host terminal 100b and deletes the job ticket when it is determined that the number of printable copies is ‘0’.

The print control unit 26b performs printing on the basis of the print data received from the print data utilization managing unit 24b.

Also, the network printer 200b further includes a utilization history information generating unit 27b which generates utilization history information indicating the use history of the print data on the basis of data on a utilization result received from the print data utilization managing unit 24b.

The network printer 300b includes a card reader 30b for reading out authentication information from an inserted authentication card, an authentication information transmitting unit 31b for transmitting the authentication information read from the card reader 30b to the network printer 200b, a print data receiving unit 32b for receiving the print data, a printer engine 33b composed of a print head, a head driving unit, and other mechanism necessary for printing, and a print control unit 34b for controlling the printing of the print engine 33b on the basis of the print data received from the print data receiving unit 32b.

When printing performed by the printer engine 33b is interrupted, the print control unit 34b removes the print data being printed and transmits a print interruption notice to the network printer 200b, and when the printing performed by the printer engine 33b is completed, the print control unit 34b transmits a print completion notice to the network printer 200b.

Next, a configuration of the host terminal 100b will be described.

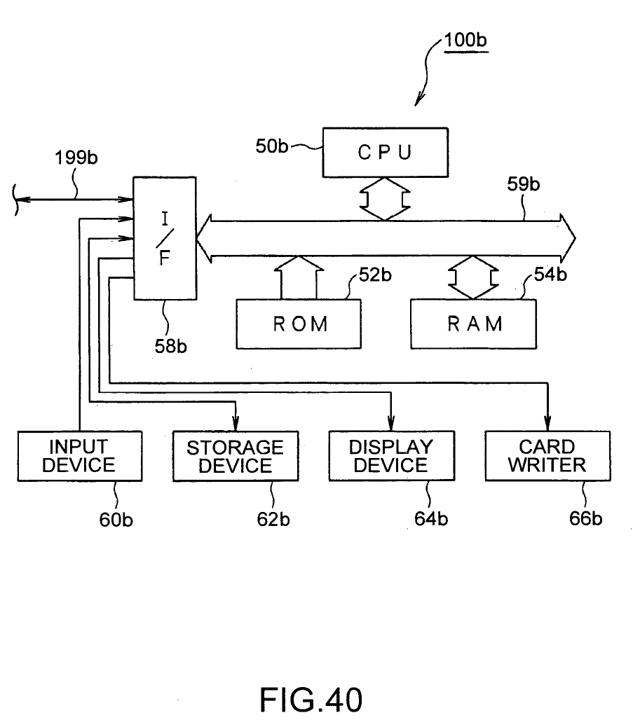

FIG. 40 is a block diagram illustrating the hardware configuration of the host terminal 100b.

As shown in FIG. 40, the host terminal 100b includes a CPU 50b for controlling overall system and operations on the basis of a control program, a ROM 52b for storing the control program of the CPU 50b and the like in a predetermined area in advance, a RAM 54b for storing data read from the ROM 52b or an operation result necessary for an operation process of the CPU 50b, and an I/F 58b for intermediating an input/output of data to/from peripheral devices, and those are communicably connected to one another through a bus 59b, which serves as a signal line for transmitting-data.

To the IF 58b, an input device 60b, serving as a human interface, such as a keyboard or a mouse through which data can be input, a storage device 62b for storing data or tables as a file, a display device 64b for displaying images on the basis of image signals, a card writer 66b for writing authentication information into an inserted authentication card, all of which are peripheral devices, and signal lines for connection with the network 199b are connected.

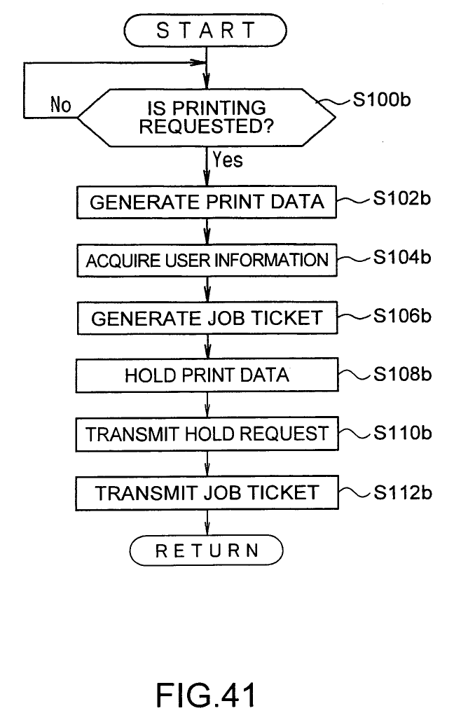

The CPU 50b includes a micro processing unit. The CPU 50b runs a predetermined program stored in the predetermined area of the ROM 52b, and then according to the program, executes a print data generating process, a print data supplying process, and a print data deleting process shown in flowcharts of FIGS. 41, 43, and 44 in a time-division manner.

FIG. 41 is a flowchart illustrating the print data generating process.

If the print data generating process is executed by the CPU 50b, first, the process proceeds to step S100b, as shown in FIG. 41.

In step S100b, it is determined whether or not printing has been requested by a documentation application or the like, and when it is determined that the printing has been requested (Yes), the process proceeds to step S102b, but when it is determined that the printing has not been requested (No), the process is on standby at step S100b until the printing is requested.

In step S102b, a job ID for unique identification on print data is issued, and print data including the issued job ID is generated on the basis of document data edited by the documentation application or the like. Then, the process proceeds to step S104b.

In step S104b, information on a user who uses the host terminal 100b at present is acquired, and then in step S106b, a job ticket is generated on the basis of the issued job ID and the acquired user information.

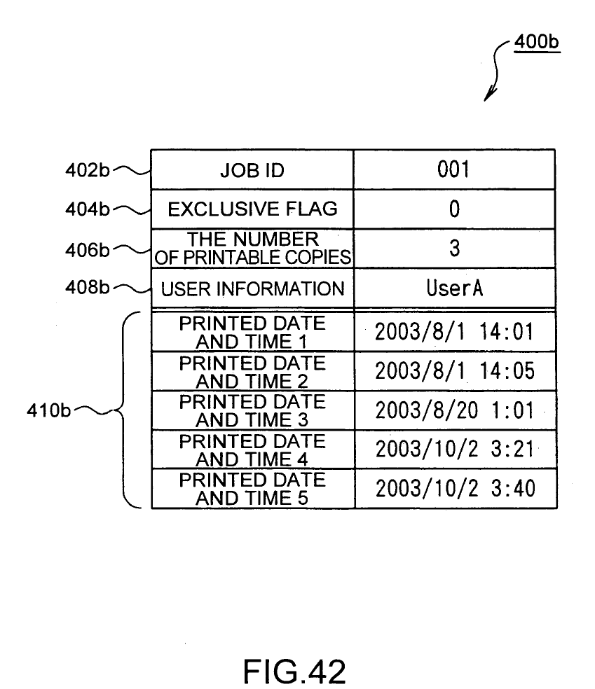

FIG. 42 is a view illustrating a data structure of the job ticket 400b.

As shown in FIG. 42, the job ticket 400b includes a field 402b for storing a job ID, a field 404b for storing an exclusive flag indicating whether the job ticket 400b is frozen or not, a field 406b for storing the number of printable copies, and a field 408b for storing the user information. The job ticket 400b is added with a field 410b for storing utilization history information whenever the print data is used.

In an example shown in FIG. 42, ‘001’ is stored as the Job ID, ‘0’ is stored as the exclusive flag, ‘3’ is stored as the number of printable copies, and ‘UserA’ is stored as the user information. This indicates that the print data of the job ID of ‘001’ can be printed only by the user information ‘UserA’ and the number of printable copies is three. In addition, the exclusive flag is reset, which indicates that a current job ticket is not frozen. Here, the number of printable copies may be optionally set by the user or may be set to a predetermined value.

Further, five records are stored as the utilization history information. This indicates that the print data of the job ID of ‘001’ has been already printed by five copies, and the five records show printing dates and times as the use history.

Thereafter, in step S108b, the generated print data is stored in the storage device 62b, then in step S110b, a request for storing the generated print data is transmitted to the network printer 200b, and then in step S112b, the generated job ticket is transmitted to the network printer 200b. After the series of steps are completed, the process returns to the initial step.

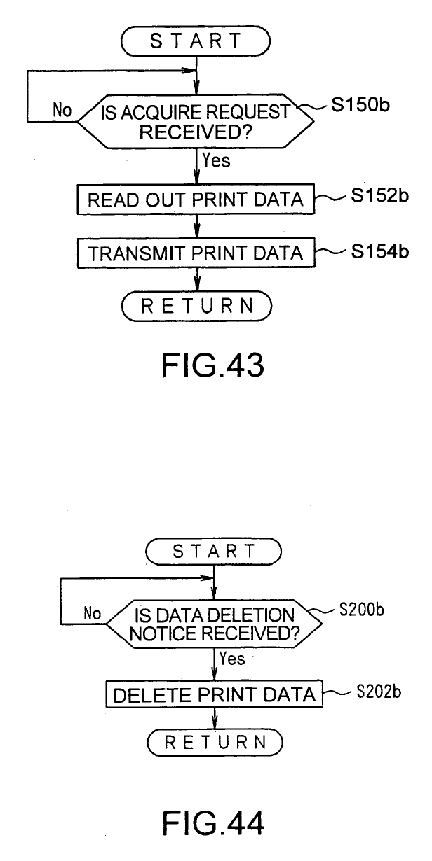

Next, a print data supplying process will be described in detail with reference to FIG. 43.

FIG. 43 is a flowchart illustrating the print data supplying process.

The print data supplying process is a process of supplying the print data in response to the acquisition request from the network printer 200b, and if the print data supplying process is executed by the CPU 50b, the process proceeds to step S150b, as shown in FIG. 43.

In step S150b, it is determined whether or not the acquisition request has been received, and when it is determined that the acquisition request has been received (Yes), the process proceeds to step S152b, but when it is determined that the acquisition request has not been requested (No), the process is on standby at step S150b until the acquisition request is received.

In step S152b, the print data corresponding to the job ID included in the received acquisition request is read from the storage device 62b, and then in step S154b, the read print data is transmitted to the network printer 200b. After the series of steps are completed, the process returns to the initial step.

Next, a print data deleting process will be described in detail with reference to FIG. 44.

First, if the print data deleting process is executed by the CPU 50b, the process proceeds to step S200b, as shown in FIG. 44.

In step S200b, it is determined whether or not the data deletion notice has been received, and when it is determined that the data deletion notice has been received (Yes), the process proceeds to step S202b, but when it is determined that the acquisition request has not been requested (No), the process is on standby at step S200b until the acquisition request is received.

In step S202b, the print data corresponding to the job ID included in the received data deletion notice is deleted from the storage device 62b. After the series of steps are completed, the process returns to the initial step.

Next, a configuration of the network printer 200b will be described.

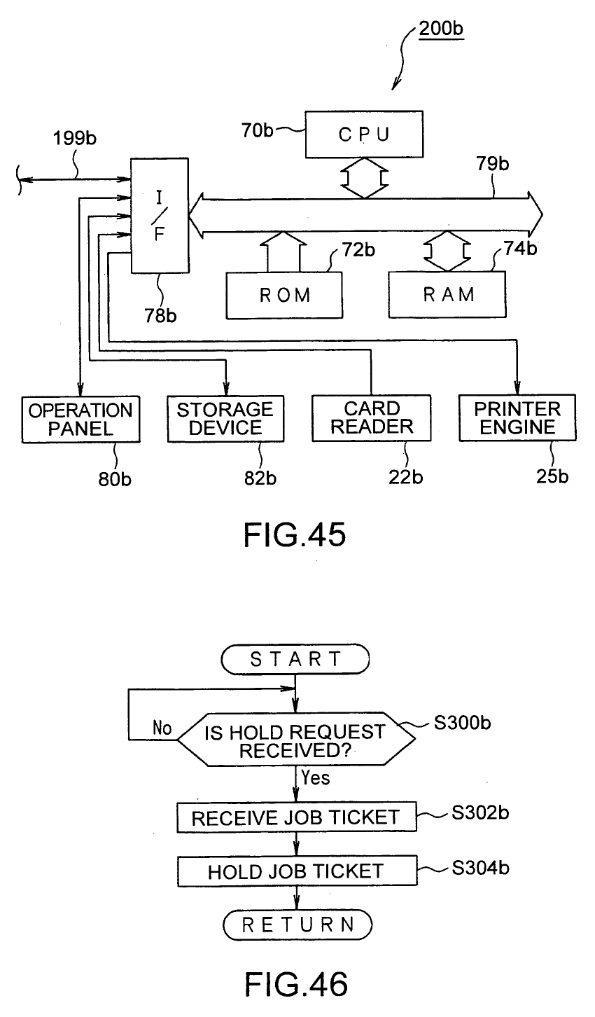

FIG. 45 is a block diagram illustrating a hardware configuration of the network printer 200b.

As shown in FIG. 45, the network printer 200b includes a CPU 70b for controlling overall system and operations on the basis of a control program, a ROM 72b for storing the control program of the CPU 70b or the like in a predetermined area in advance, a RAM 74b for storing data read from the ROM 72b or an operation result required for an operation process of the CPU 70b, and an I/F 78b for intermediating an input/output of data to/from peripheral devices, and those are communicably connected to one another through a bus 79b, which serves as a signal line for transmitting data.

To the IF 78b, an operation panel 80b, serving as a human interface, such as a touch panel through which data can be input and displayed, a storage device 82b for storing data or tables as a file, a card reader 22b, a printer engine 25b, all of which are peripheral devices, and signal lines for connection with the network 199b are connected.

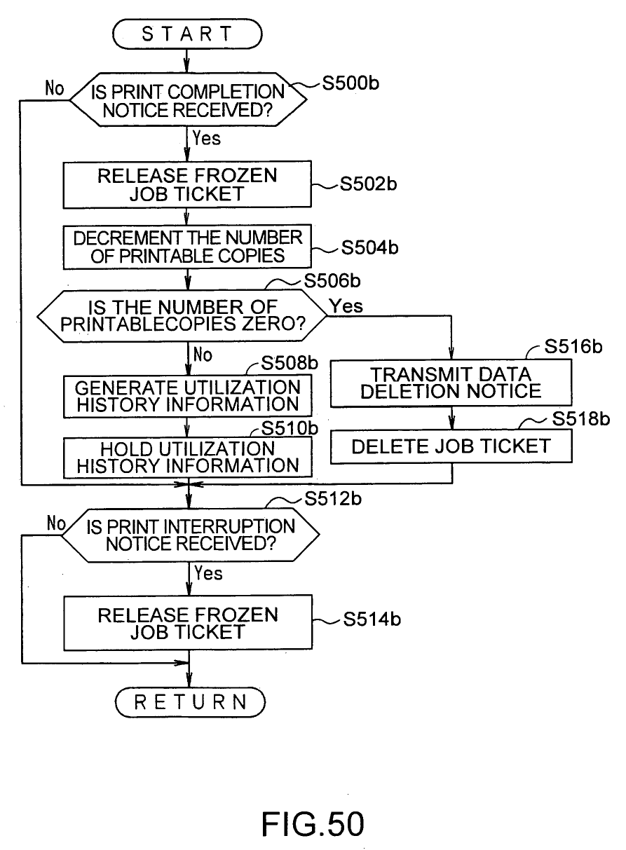

The CPU 70b includes a micro processing unit. The CPU 70b runs a predetermined program stored in the predetermined area of the ROM 72b, and then according to the program, executes a job ticket storing process, a print control process, a print state monitoring process, a print request accepting process, and a print result receiving process shown in a flowchart of FIG. 46 or 50, in a time-division manner.

First, the job ticket storing process will be described in detail with reference to FIG. 46.

FIG. 46 is a flowchart illustrating the job ticket storing process.

The job ticket storing process is a process of storing the job ticket from the host terminal 100b, and if the job ticket storing process is executed by the CPU 70b, the process proceeds to step S300b, as shown in FIG. 46.

In step S300b, it is determined whether or not the storing request has been received, and when it is determined that the storing request has been requested (Yes), the process proceeds to step S302b, but when it is determined that the storing request has not been requested (No), the process is on standby at step S300b until the storing request is received.

In step S302b, the job ticket is received, and then in step S304b, the received job ticket is stored in the storage device 82b. After the series of steps are completed, the process returns to the initial step.

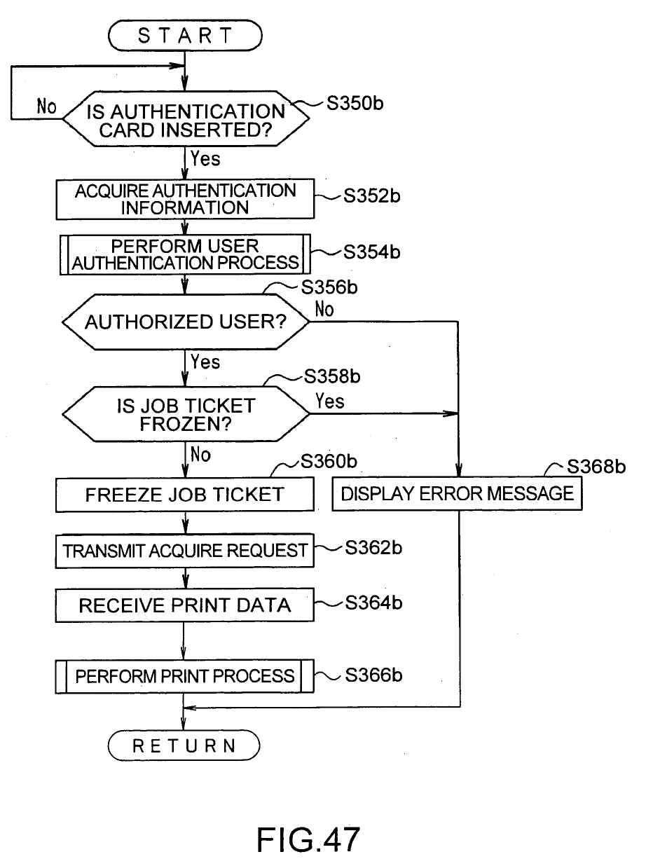

Next, the print control process will be described in detail with reference to FIG. 47.

FIG. 47 is a flowchart illustrating the print control process.

The print control process is a process of performing the print control of the printer engine 25b, and if the print control process is executed by the CPU 70b, the process proceeds to step S350b, as shown in FIG. 47.

In step S350b, it is determined whether or not the authentication card has been inserted into the card reader 22b, and when it is determined that the authentication card has been inserted into the card reader 22b (Yes), the process proceeds to step S352b, but when it is determined that the authentication card is not inserted into the card reader 22b (No), the process is on standby at step S350b until the authentication card is inserted.

In step S352b, the authentication information including the job ID and the user information is read from the authentication card by the card reader 22b, and then in step S354b, a user authenticating process is performed on the basis of the read authentication information. In the user authenticating process, the job ticket corresponding to the job ID included in the read authentication information is retrieved from the storage device 82b. As a result, when the corresponding job ticket has been retrieved, it is determined whether or not the user information of the retrieved job ticket matches the user information included in the read authentication information and then they match each other, it is determined that the user is eligible to use the print data. On the other hand, when it is determined that the corresponding job ticket has not been retrieved or the user information of the retrieved job ticket does not match the user information included in the read authentication information, it is determined that the user is not eligible to use the print data. Step S352b is the same as step S452b to be described below.

Subsequently, in step S356b, a result of the user authenticating process is determined, and when it is determined that the user is eligible to use the print data (Yes), the process proceeds to step S358b in which it is determined whether or not an exclusive flag of the retrieved job ticket is set. When it is determined that the exclusive flag is not set (No), it is determined that the job ticket is not frozen, and the process proceeds to step S360b.

In step S360, the exclusive flag of the retrieved job ticket is set, and then in step S362b, the acquisition request including the job ID included in the read authentication information is transmitted to the host terminal 100b. In step S364b, the print data is received, and then in step S366b, a printing process of performing the print control of the printer engine 25b is carried out on the basis of the received print data. After the series of steps are completed, the process returns to the initial step.

Further, in step S358b, when it is determined that the exclusive flag of the retrieved job ticket is set (Yes), it is determined that the job ticket is frozen, and the process proceeds to step S368b in which an error message is displayed on the operation panel 80b. After the series of steps are completed, the process returns to the initial step.

Meanwhile, in step S356b, when it is determined that the user is not eligible to use the print data (No), the process proceeds to step S368b.

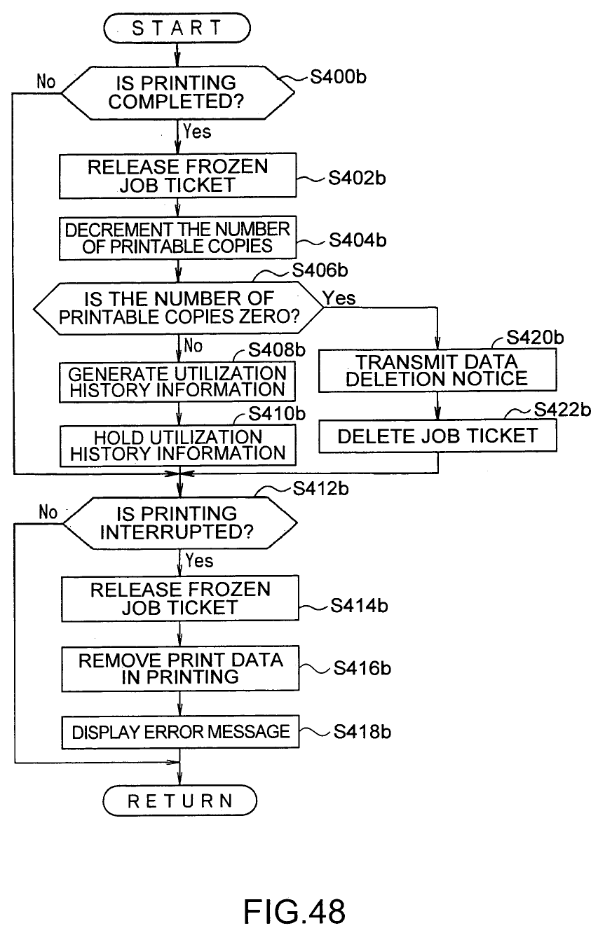

Next, the print state monitoring process will be described in detail with reference to FIG. 48.

FIG. 48 is a flowchart illustrating the print state monitoring process.

The print state monitoring process is a process of monitoring the print state of the printer engine 25b, and if the print state monitoring process is executed by the CPU 70b, the process proceeds to step S400b, as shown in FIG. 48.

In step S400b, it is determined whether the printing has been completed in the printer engine 25b, and when it is determined that the printing has been completed (Yes), the process proceeds to step S402b in which the job ticket corresponding to the job ID of the print-completed print data is retrieved from the storage device 82b and the exclusive flag of the retrieved job ticket is reset. Then, in step S404b, the number of printable copies of the retrieved job ticket is decremented by Ill to proceed to step S406b.

In step S406b, it is determined whether or not the number of printable copies is ‘0’, and when it is determined that the number of printable copies is not ‘0’ (No), the process proceeds to step S408b in which the utilization history information including the print dates and times is generated. In step S410b, the generated utilization history information and the retrieved job ticket are stored in the storage device 82b to proceed to step S412b.

In step S412b, it is determined whether or not the printer engine 25b has stopped printing, and when it is determined that the printing has been interrupted (Yes), the process proceeds to step S414b in which the job ticket corresponding to the job ID of the print-interrupted print data is retrieved from the storage device 82b and the exclusive flag of the retrieved job ticket is reset. Then, in step S416b, the print data being printed is removed to proceed to step S418b in which an error message is displayed on the operation panel 80b. After the series of steps are completed, the process returns to the initial step.

On the other hand, in step S412b, when it is determined that the printing has not been interrupted (No) in the printer engine 25b, the series of processes are completed to return to the first step.

Further, in step S406b, when it is determined that the number of printable copies is ‘0’ (Yes), step S406b proceeds to step S420b in which the data deletion notice including the job ID of the print-completed print data is transmitted to the host terminal 100b. In step S422b, the job ticket corresponding to the job ID of the print-completed print data is deleted from the storage device 82b to proceed to step S412b.

Further, in step S400b, when it is determined that the printer engine 25b has not completed the printing (No), the process proceeds to step S412b.

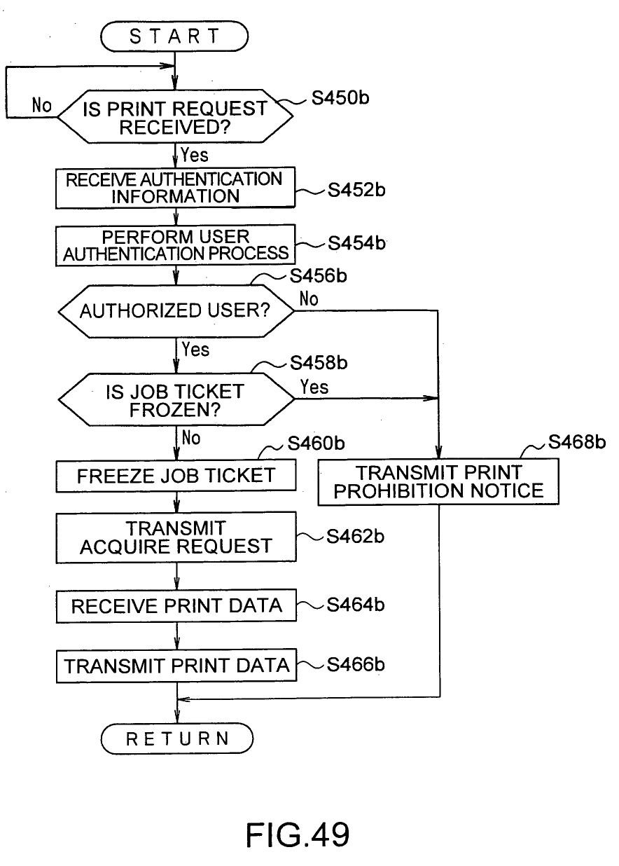

Next, the print request receiving process will be described in detail with reference to FIG. 49.

FIG. 49 is a flowchart illustrating the print request receiving process.

The print request receiving process is a process of receiving a printer request from the network printer 300b, and if the print request receiving process is executed by the CPU 70b, the process proceeds to step S450b, as shown in FIG. 49.

In step S450b, it is determined whether or not the printer request has been received, and when it is determined that the printer request has been received (Yes), the process proceeds to step S452b, but when it is determined that the printer request has not been received (No), the process is on standby at step S450b until the printer request is received.

In step S452b, the authentication information is received, and then in step S454b, a user authenticating process is performed on the basis of the received authentication information to proceed to step S456b.

In step S456b, a result of the user authenticating process is determined, and then when it is determined that the user is eligible to use the print data (Yes), the process proceeds to step S458b in which it is determined whether or not an exclusive flag of the retrieved job ticket is set. When it is determined that the exclusive flag is not set (No), it is determined that the job ticket is not frozen, and the process proceeds to step S460b.

In step S460b, the exclusive flag of the retrieved job ticket is set, and then in step S462b, the acquisition request including the job ID included in the received authentication information is transmitted to the host terminal 100b. In step S464b, the print data is received, and then in step S466b, the received print data is transmitted to the network printer 300b which is a source of the request. After the series of steps are completed, the process returns to the initial step.

Further, in step S458b, when it is determined that the exclusive flag of the retrieved job ticket is set (Yes), it is determined that the job ticket is frozen to proceed to step S468b in which a print prohibition notice is transmitted to the network printer 300b which is a source of the request. After the series of steps are completed, the process returns to the initial step.

Meanwhile, in step S456b, when it is determined that the user is not eligible to use the print data (No), the process proceeds to step S468b.

Next, the print result receiving process will be described in detail with reference to FIG. 50.

FIG. 50 is a flowchart illustrating the print result receiving process.

The print result receiving process is a process of receiving the print result from the network printer 300b, and if the print result receiving process is executed by the CPU 70b, the process proceeds to step S500b, as shown in FIG. 50.

In step S500b, it is determined whether or not a print completion notice including the job ID has been received, and when it is determined that the print completion notice has been received (Yes), the process proceeds to step S502b in which the job ticket corresponding to the job ID included in the received print completion notice is retrieved from the storage device 82b to reset the exclusive flag of the retrieved job ticket, and then in step S504b, the number of printable copies of the retrieved job ticket is decremented by ‘1’ to proceed to step S506b.

In step S506b, it is determined that the number of printable copies is ‘0’, and when it is determined that the number of printable copies is not ‘0’ (No), the process proceeds to step S508b in which the utilization history information including print dates and times is generated, and then in step S510b, the generated utilization history information and the retrieved job ticket are stored in the storage device 82b to proceed to step S512b.

In step S512b, it is determined whether or not the print interruption notice has been received, and when it is determined that the print interruption notice has been received (Yes), the process proceeds to step S514b in which the job ticket corresponding to the job ID included in the received print completion notice is retrieved from the storage device 82b and the exclusive flag of the retrieved job ticket is reset. After the series of steps are completed, the process returns to the initial step.

On the other hand, in step S512b, when it is determined that the print interruption notice has not been received (No), the series of processes are completed to return to the initial step.

Further, in step S506b, when it is determined that the number of printable copies is ‘0’ (Yes), the process proceeds to step S516b in which the data deletion notice including the job ID included in the received print completion notice is transmitted to the host terminal 100b. Then, in step S518b, the job ticket corresponding to the job ID included in the received print completion notice is deleted from the storage device 82b to proceed to step S512b.

On the other hand, in step S500b, when it is determined that the print completion notice has not been received (No), the process proceeds to step S512b.

Next, a configuration of the network printer 300b will be described.

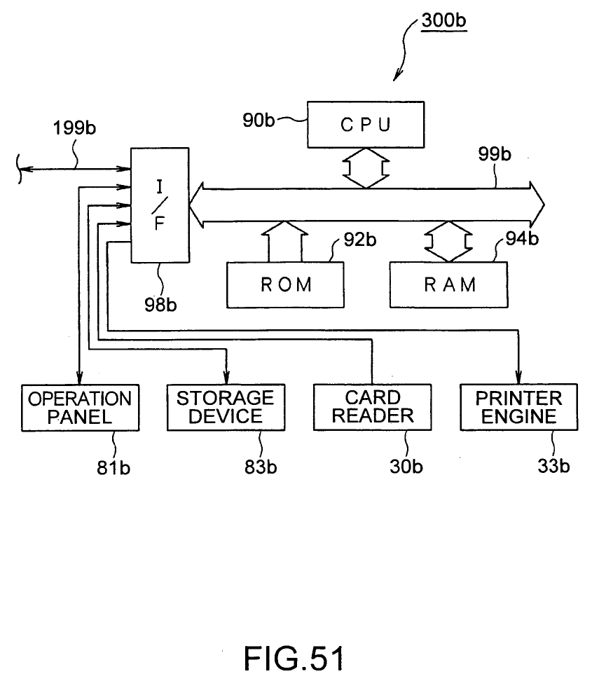

FIG. 51 is a block diagram illustrating a hardware configuration of the network printer 300b.

As shown in FIG. 51, the network printer 300b includes a CPU 90b for controlling overall system and operations on the basis of a control program, a ROM 92b for storing the control program of the CPU 90b or the like in a predetermined area in advance, a RAM 94b for storing data read from the ROM 92b or an operation result necessary for an operation process of the CPU 90b, and an I/F 98b for intermediating an input/output of data to/from peripheral devices, and those are communicably connected to one another through a bus 99b, which serves as a signal line for transmitting data.

To the IF 98b, an operation panel 81b, serving as a human interface, such as a touch panel through which data can be input and displayed, a storage device 83b for storing data or tables as a file, a card reader 30b, a printer engine 33b, all of which are peripheral devices, and signal lines for connection with the network 199b are connected.

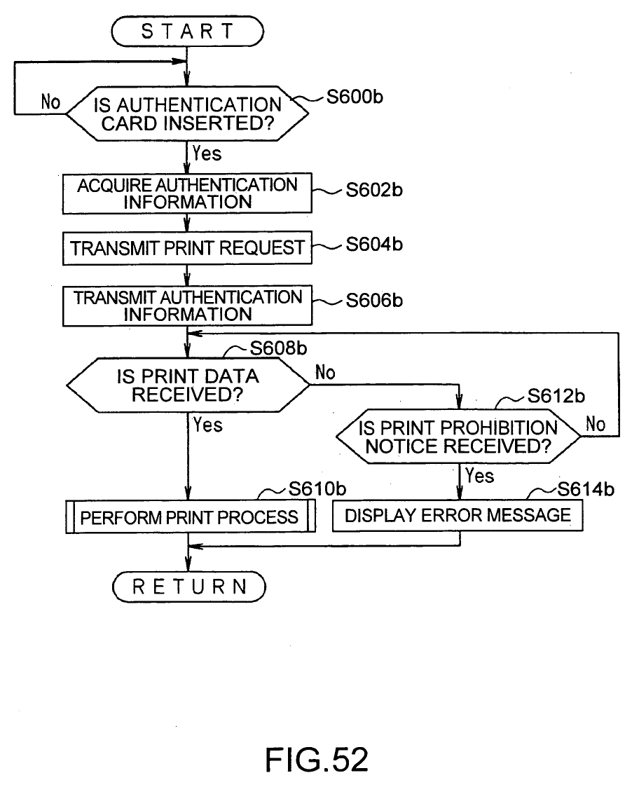

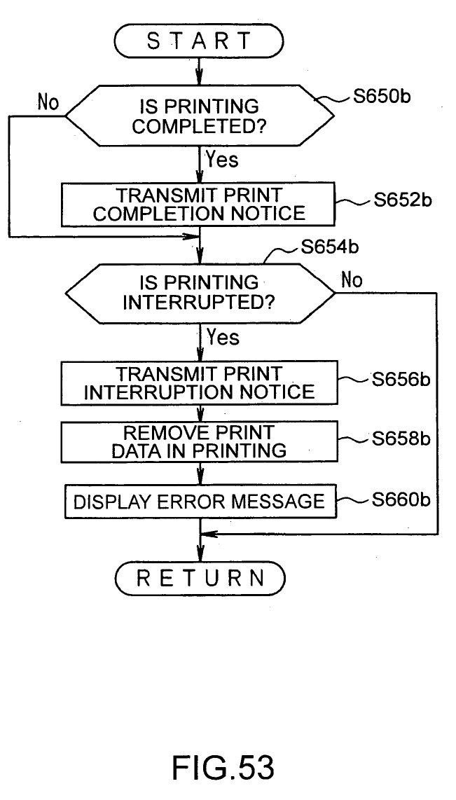

The CPU 90b includes a micro processing unit. The CPU 90b runs a predetermined program stored in the predetermined area of the ROM 92b, and then according to the program, executes a print control process and a print state monitoring process shown in flowcharts of FIGS. 52 and 53, in a time-division manner.

First, the print control process will be described in detail with reference to FIG. 52.

FIG. 52 is a flowchart illustrating the print control process.

The print control process is a process of performing the print control of the printer engine 33b, and if the print control process is executed by the CPU 90b, the process proceeds to step S600b, as shown in FIG. 52.

In step S600b, it is determined whether or not the authentication card has been inserted into the card reader 30b, and when it is determined that the authentication card has been inserted into the card reader 30b (Yes), the process proceeds to step S602b, but when it is determined that the authentication card has not been inserted into the card reader 30b (No), the process is on standby at step S600b until the authentication card is inserted.

In step S602b, the card reader 30b reads the authentication information from the authentication card to proceed to step S604b in which the network printer 200b transmits a print request. Then, in step S606b, the read authentication information is transmitted to the network printer 200b to proceed to step S608b.

In step S608b, it is determined whether or not the print data has been received, and when it is determined that the print data has been received (Yes), the process proceeds to step S610b in which a printing process of performing the printing control of the printer engine 33b on the basis of the received print data is carried out. After the series of steps are completed, the process returns to the initial step.

On the other hand, in step S608b, when it is determined that the print data has not been received (No), the process proceeds to step S612b in which it is determined whether or not a print prohibition notice has been received, and when it is determined that the print prohibition notice has been received (Yes), the process proceeds to step S614b in which an error message is displayed on the operation panel 81b. After the series of steps are completed, the process returns to the initial step.

Meanwhile, in step S612b, when it is determined that the print prohibition notice has not been received (No), the process proceeds to step S608b.

Next, the print state monitoring process will be described in detail with reference to FIG. 53.

FIG. 53 is a flowchart illustrating the print state monitoring process.

The print state monitoring process is a process of monitoring the printing state of the printer engine 33b, and if the print state monitoring process is executed by the CPU 90b, the process proceeds to step S650b, as shown in FIG. 53.

In step S650b, it is determined whether or not the printer engine 33b has completed printing, and when it is determined that the printing has been completed (Yes), the process proceeds to step S652b in which the print completion notice including the job ID of the print-completed print data is transmitted to the network printer 200b, and then the process proceeds to step S654b.

In step S654b, it is determined whether or not the printer engine 33b has stopped printing, and when it is determined that the printing has been interrupted (Yes), the process proceeds to step S656b in which the print interruption notice including the job ID of the print-completed print data is transmitted to the network printer 200b, and then the process proceeds to step S658b. In step S658b, the print data being printed is removed to proceed to step S660b in which an error message is displayed on the operation panel 81b. After the series of steps are completed, the process returns to the initial step.

On the other hand, in step S654b, when it is determined that the printer engine 33b has not stopped the printing (No), the series of processes are completed to return to the initial step.

Further, in step S650b, when it is determined that the printer engine 33b has not stopped the printing (No), the process proceeds to Step S654b.

Next, an operation of the present embodiment will be described.

A user requests the host terminal 100b to edit document data by using a documentation application and to print it.

In the host terminal 100b, when the printing is requested, print data and a job ticket are generated, the generated print data is stored in the storage device 62b, and the generated job ticket and a storage request are transmitted to the network printer 200b, in steps S102b through S112b.

In the network printer 200b, when the job ticket and the storage request are received, the received job ticket is stored in the storage device 82b in step 304b.

First, a case in which printing is performed in the network printer 200b will be described.

The user inserts an authentication card into the card reader 66b, and the card reader 66b records the job ID and user information in an authentication card, in the host terminal 100b. Further, the user goes to the network printer 200b to insert the authentication card into the card reader 22b.

In the network printer 200b, when the authentication card is inserted, the authentication information is read from the authentication card by the card reader 22b and a user authentication operation is performed on the basis of the read authentication information in steps S352b and S354b. As a result, when the user authentication is accomplished, the job ticket is frozen and then an acquisition request is transmitted to the host terminal 100b in steps S360b and S362b.

In the host terminal 100b, when the acquisition request is received, the print data is read from the storage device 62b and then the read print data is transmitted to the network printer 200b in steps S152b and S154b.

In the network printer 200b, when the print data is received, the print control is performed on the basis of the received print data in step S366b. Then, when the printing is completed, the job ticket is not frozen and the number of printable copies of the job ticket is decremented in steps S402b and S404b. As a result, if the number of printable copies is not ‘0’, utilization history information is generated and then the generated utilization history information is added to the job ticket to be stored in the storage device 82b in steps S408 and S410b.

Next, a case in which printing is performed in the network printer 300b will be described.

A user goes to one of the network printers 300b to insert an authentication card into the card reader 30b.

In the network printer 300b, when the authentication card is inserted, the authentication information is read from the authentication card by the card reader 30b, and then the read authentication information and a printing request are transmitted to the network printer 200b in steps S602b through S606b.

In the network printer 200b, when the printing request and the authentication information are received, a user authentication operation is performed on the basis of the received authentication information in step S454b. As a result, the user authentication is accomplished, the job ticket is frozen and an acquisition request is transmitted to the host terminal 100b in steps S460b and S462b.

In the host terminal 100b, when the acquisition request is received, the print data is read from the storage device 62b and the read print data is transmitted to the network printer 200b.

In the network printer 200b, when the print data is received, the received print data is transmitted to the network printer 300b which is a requestor in step S466b.

In the network printer 300b, when the print data is received, the print control is performed on the basis of the received print data in step S610b. Then, when the printing is completed, a print completion notice is transmitted to the network printer 200b in step S652b.

In the network printer 200b, when the print completion notice is received, the job ticket is not frozen and the number of printable copies of the job ticket is decremented in steps S502b and S504b. As a result, if the number of printable copies is not ‘0’, utilization history information is generated and then the generated utilization history information is added to the job ticket to be stored in the storage device 82b in steps S508 and S510b.

Next, a case in which printing is interrupted in the network printer 200b will be described.

In the network printer 200b, the printing is interrupted due to a trouble such as a paper jam, the job ticket is not frozen and then the print data being printed is removed to display an error message in steps S414b through S418b.

Next, the user removes the authentication card from the card reader 22b in the network printer 200b. Also, the user goes to another network printer 300b to insert the authentication card into the card reader 30b. Hereinafter, the same operations as described above are performed in the network printer 200b and another network printer 300b, and the printing is performed by the network printer 300b. The number of printable copies is not decremented even though the printing is interrupted until the printing is completed by another network printer 300b.

Next, a case in which printing is interrupted in the network printer 300b will be described.

In the network printer 300b, the printing is interrupted due to a trouble such as a paper jam, a printing interruption notice is transmitted to the network printer 200b, and the print data being printed is removed to display an error message in steps S656b through S660b.

In the network printer 200b, when the printing interruption notice is received, the job ticket is not frozen in step S514b.

Next, a user removes the authentication card from the card reader 30b in the network printer 300b in which the printing has been interrupted. Also, the user goes to another network printer 300b to insert the authentication card into the card reader 30b. Hereinafter, the same operations as described above are performed in the network printer 200b and another network printer 300b, and the printing is performed by the network printer 300b. The number of printable copies is not decremented even though the printing is interrupted until the printing is completed by another network printer 300b.

Next, a case in which an authentication card is removed while the network printer 200b or one of the network printers 300b performs printing and the authentication card is inserted into the card reader 30b will be described.

In the network printer 300b, when the authentication card is inserted, the authentication information is read out from the authentication card by the card reader 30b, and then the read authentication information and a printing request are transmitted to the network printer 200b.

In the network printer 200b, when the printing request and the authentication information are received, a user authentication operation is performed on the basis of the received authentication information. As a result, even though the user authentication is accomplished, since the job ticket is frozen, a print prohibition notice is transmitted to the network printer 300b, which is a source of the request, in step S468b.

In the network printer 300b, when the print prohibition notice is received, an error message is displayed in step S614b and printing is not performed.

Next, a case in which an authentication card is removed while one of the network printers 300b performs printing and the authentication card is inserted into the card reader 22b in the network printer 200b will be described.

In the network printer 200b, when the authentication card is inserted, the authentication information is read from the authentication card by the card reader 22b, and then a user authentication operation is performed on the basis of the read authentication information. As a result, even though the user authentication is accomplished, since the job ticket is frozen, an error message is displayed in step S368b and printing is not performed.

Further, in a case in which an authentication card having unauthorized authentication information is used, since the user authentication can not be accomplished, a print prohibition notice is transmitted to the network printer 300b, which is a source of the request, or an error message is displayed in the network printer 200b.

Furthermore, when the number of printable copies becomes ‘0’, in the network printer 200b, a data deletion notice is transmitted to the host terminal 100b to delete the job ticket in steps S420b and S422b or S516b and S518b.

In the host terminal 100b, when the data deletion notice is received, the print data is deleted in step S202b.

As such, in the present embodiment, the host terminal 100b supplies the print data to the network printer 200b in response to the acquisition request and deletes the print data in response to the data deletion notice. Further, in the network printer 200b, when the user authentication is accomplished and it is determined that the job ticket is not frozen, the print data is acquired from the host terminal 100b, the acquired print data is transmitted to one of the plurality of network printers 300b, the job ticket is frozen until the print interruption notice or the print completion notice is received, or the print control is performed on the basis of the acquired print data to make the job ticket frozen until the printing is interrupted or completed, and when the print completion notice is received or the printing has been completed, the number of printable copies of the job ticket is decremented, and as a result, when it is determined that the number of printable copies is ‘0’, the data deletion notice is transmitted to the host terminal 100b and the job ticket is deleted. Furthermore, in the network printer 300b, the print data is received and the print control is performed on the basis of the received print data, and when the printing operation has been interrupted, the print data being printed is removed and the print interruption notice is transmitted to the network printer 200b and when the printing operation has been completed, the print completion notice is transmitted to the network printer 200b.

Accordingly, since the number of printable copies is decremented only when printing has been completed, even though the printing is interrupted due to a trouble, such as a paper jam, at one of the network printers 200b and 300b, the printing can be performed by other network printers 200b and 300b. Therefore, only an authorized user can acquire the printed matter.

Further, since either the print data is supplied to the network printer 300b or the print data is used in the network printer 200b, it is possible to reduce a possibility that the same printed contents will be printed simultaneously at the network printers 200b and 300b. Furthermore, even though the print-interrupted network printers 200b and 300b are fixed, the print data being printed is removed, so that it is possible to reduce a possibility that the print data being printed will be printed by the print-interrupted network printers 200b and 300b. As a result, since a possibility that the printing will be performed exceeding the number of printable copies can be reduced, it is possible to protect the secrecy of printed contents and to protect a literary work when the print data is the literary work, as compared with the related art.

Furthermore, in the network printer 200b of the present embodiment, when the user authentication is accomplished on the basis of the received authentication information and it is determined that the job ticket is not frozen, the print data is transmitted to one of the plurality of network printers 300b, the one having transmitted the authentication information, and the user authentication is accomplished on the basis of the read authentication information and when it is determined that the job ticket is frozen, the print control is performed on the basis of the acquired print data.

As such, a user can perform printing at one of the network printers 200b and 300b by presenting an authentication card recorded with the authentication information to one of the network printers 200b and 300b that the user wants to use.

In addition, in the present embodiment, the network printer 200b generates utilization history information whenever the print data is used.

Accordingly, it is possible to see how the print data has been used by referring to the utilization history information.

Further, in the present embodiment, the network printer 200b transmits a data deletion notice to the host terminal 100b and deletes the job ticket when the number of printable copies is ‘0’, and the host terminal 100b deletes the print data when the data deletion notice is received.

Accordingly, a possibility that the print data and the job ticket will be used by an unauthorized user is reduced, so that the secrecy of the printed contents and the literary work can be reliably protected.

In the fifth embodiment, the host terminal 100b corresponds to the data managing units according to the one-hundred twenty-first, one-hundred twenty-sixth, one-hundred twenty-seventh, one-hundred thirty-second, one-hundred thirty-third, one-hundred thirty-eighth, one-hundred thirty-ninth, and one-hundred forty-fourth aspects, and the print data holding unit 11b and the storage device 62b correspond to the output data holding unit according to the one-hundred twenty-first or one-hundred thirty-ninth aspect. Also, the print data supplying unit 12b, the I/F 58b, and step S150b to S154b correspond to the output data supplying unit according to the one-hundred twenty-first aspect, steps S150b to S154b correspond to the output data supplying steps according to the one-hundred thirty-ninth aspect, and the print data deletion unit 13b, the I/F 58b, and step S200b or S202b correspond to the output data deletion unit according to the one-hundred twenty-sixth aspect.

Further, in the fifth embodiment, step S200b or S202b correspond to the output data deletion step according to the one-hundred forty-fourth aspect, the network printer 200b corresponds to the first network devices according to the one-hundred twenty-first, one-hundred twenty-third to one-hundred twenty-fifth, one-hundred thirty-ninth, and one-hundred forty-first to one-hundred forty-third aspects, and the job ticket holding unit 20b and the storage device 82b correspond to the job ticket holding units according to the one-hundred twenty-first, one-hundred twenty-seventh, one-hundred thirty-third, and one-hundred thirty-ninth aspects. Moreover, the authentication information receiving unit 21b, the I/F 78b, and step S452b correspond to the authentication information receiving units according to the one-hundred twenty-third, one-hundred twenty-fourth, one-hundred twenty-ninth, and one-hundred thirtieth aspects, and step S452b corresponds to the authentication information receiving steps according to the one-hundred thirty-fifth, one-hundred thirty-sixth, one-hundred forty-first, or one-hundred forty-second aspects.

Furthermore, in the fifth embodiment, the card reader 22b and step S352b correspond to the first authentication information acquiring unit according to the one-hundred twenty-third or the one-hundred twenty-fourth aspect, or correspond to the authentication information acquiring unit according to the one-hundred twenty-ninth or one-hundred thirtieth aspect. Also, step S352b corresponds to the first authentication information acquiring step according to the one-hundred forty-first or one-hundred forty-second aspect, or corresponds to the authentication information acquiring step according to the one-hundred thirty-fifth or one-hundred thirty-sixth aspect. Also, the user authentication unit 23b and step S354b or S454b correspond to the authentication units according to the one-hundred twenty-third, one-hundred twenty-fourth, one-hundred twenty-ninth, and one-hundred thirtieth aspects, and step S354b or S454b correspond to the authentication steps according to the one-hundred thirty-fifth, one-hundred thirty-sixth, one-hundred forty-first, and one-hundred forty-second aspects. Also, the print data utilization managing unit 24b, the I/F 78b, and steps S356b to S364b, S400b to S406b, S412b to S422b, S456b to S466b, S500b to S506b, and S512b to S518b correspond to the output data use managing units according to the one-hundred twenty-first, one-hundred twenty-third to one-hundred twenty-seventh, and one-hundred twenty-ninth to one-hundred thirty-second aspects.

In addition, in the fifth embodiment, steps S356b to S364b, S400b to S406b, S412b to S422b, S456b to S466b, S500b to S506b, and S512b to S518b correspond to the output data use managing steps according to the one-hundred thirty-third, one-hundred thirty-fifth to one-hundred thirty-ninth, one-hundred forty-first to one-hundred forty-fourth aspects. Also, the print control unit 26b and step S366b correspond to the first output control units according to the one-hundred twenty-first, one-hundred twenty-third, and one-hundred twenty-fourth aspects, or correspond to the output control units according to the one-hundred twenty-seventh, one-hundred twenty-ninth, and one-hundred thirtieth aspects. Also, step S366b corresponds to the first output control steps according to the one-hundred thirty-ninth, one-hundred forty-first, and one-hundred forty-second aspects, or corresponds to the output control steps according to the one-hundred thirty-third, one-hundred thirty-fifth, and one-hundred thirty-sixth aspects.

Moreover, in the fifth embodiment, the utilization history information generating unit 27b and step S408b correspond to the utilization history information generating unit according to the one-hundred twenty-fifth or the one-hundred thirty-first aspect, step S408b corresponds to the utilization history information generating unit according to the one-hundred thirty-seventh or the one-hundred forty-third aspect, and the network printer 300b corresponds to the second network devices according to the one-hundred twenty-first, one-hundred twenty-third, one-hundred twenty-fourth, one-hundred thirty-ninth, one-hundred forty-first, and the one-hundred forty-seconds. Also, the card reader 30b and step S602b correspond to the second authentication information acquiring unit according to the one-hundred twenty-third aspect, step S602b corresponds to the second authentication information acquiring unit according to the one-hundred forty-first aspect, and the authentication information transmitting unit 31b, the I/F 98b, and step S606b correspond to the authentication information transmitting unit according to the one-hundred twenty-third aspect.

Further, in the fifth embodiment, step S606b corresponds to the authentication information transmitting step according to the one-hundred forty-first aspect, the print data receiving unit 32b, the I/F 98b, and step S608b correspond to the output data receiving unit according to the one-hundred twenty-first aspect, and step S608b corresponds to the output data receiving step according to the one-hundred thirty-ninth aspect. Also, the print control unit 34b, the I/F 98b, and step S610b correspond to the second output control unit according to the one-hundred twenty-first aspect, step S610b corresponds to the second output control step according to the one-hundred thirty-ninth aspect, and the print data corresponds to the output data according to the one-hundred twenty-first, one-hundred twenty-third to one-hundred twenty-seventh, one-hundred twenty-ninth to one-hundred thirty-first, one-hundred thirty-third, one-hundred thirty-fifth to one-hundred thirty-seventh, one-hundred thirty-ninth, and one-hundred forty-first to one-hundred forty-fourth aspects.

Furthermore, in the fifth embodiment, the print interruption notice corresponds to the output interruption notice according to the one-hundred twenty-first, one-hundred twenty-fourth, one-hundred twenty-seventh, one-hundred thirtieth, one-hundred thirty-third, one-hundred thirty-sixth, one-hundred thirty-ninth, and one-hundred forty-second aspects, and the print completion notice corresponds to the output completion notice according to the one-hundred twenty-first, one-hundred twenty-fourth, one-hundred twenty-seventh, one-hundred thirtieth, one-hundred thirty-third, one-hundred thirty-sixth, one-hundred thirty-ninth, and one-hundred forty-second aspects. Also, the data deletion notice corresponds to use prohibition notice according to the one-hundred twenty-sixth, one-hundred thirty-second, one-hundred thirty-eighth, and one-hundred forty-fourth aspects.

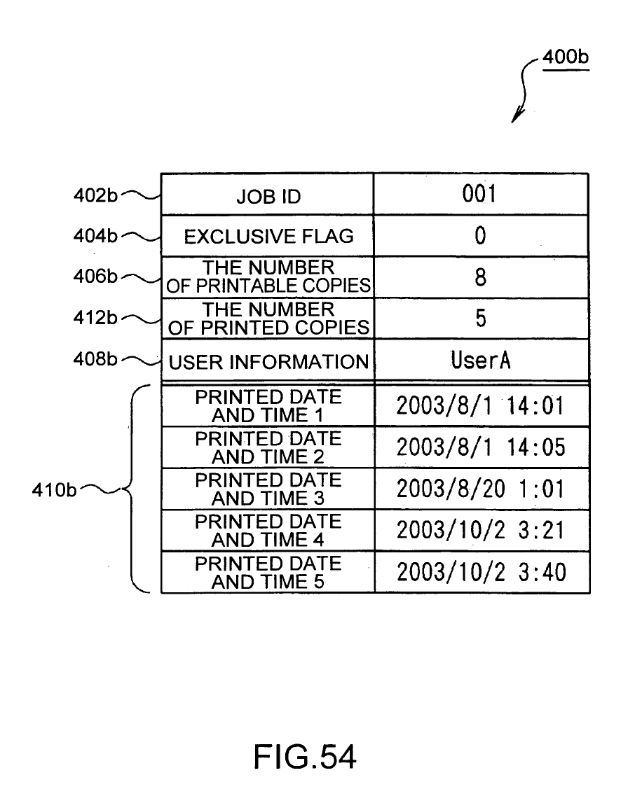

In addition, in the fifth embodiment described above, the number of printable copies is decremented and the print data and the job ticket are deleted when the number of printable copies becomes ‘0’. However, the invention is not limited thereto. For example, the number of print-completed copies is incremented with the number of printable copies and the number of print-completed copies specified in the job ticket, and when the number of print-completed copies reaches the number of printable copies, the print data and the job ticket may be deleted. Specifically, the job ticket is configured as shown in FIG. 54.

FIG. 54 is a view illustrating a data structure of the job ticket 400b.

As shown in FIG. 54, the job ticket 400b includes a field 402b for storing a job ID, a field 404b for storing an exclusive flag, a field 406b for storing the number of printable copies, a field 412b for storing the number of print-completed copies, and a field 408b for storing the user information.

In an example shown in FIG. 54, ‘8’ is stored as the number of printable copies, and ‘5’ is stored as the number of print-completed copies. This indicates that the number of printable copies with respect to the print data of the job ID of ‘001’ is eight and five of them have been already printed.

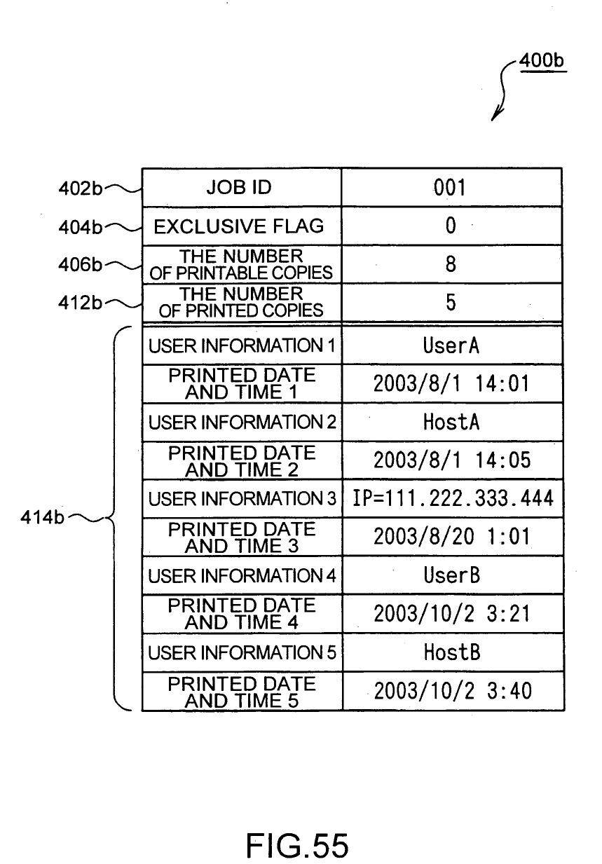

Further, in the fifth embodiment described above, the user authentication operation is carried out on the basis of the authentication information and the job ticket with the user information specified in the job ticket. However, the invention is not limited thereto. For example, any user may perform printing by omitting the user authentication. In this case, it is preferable that the user information and the print dates and times be recorded as the utilization history information. Specifically, the job ticket is configured as shown in FIG. 55.

FIG. 55 is a view illustrating a data structure of the job ticket 400b.

As shown in FIG. 55, the job ticket 400b includes a field 402b for storing a job ID, a field 404b for storing an exclusive flag, a field 406b for storing the number of printable copies, and a field 412b for storing the number of print-completed copies. Further, a field 414b for storing the utilization history information whenever the print data is used is added thereto.

In an example shown in FIG. 55, five records are stored as the utilization history information. This indicates that the print data of the job ID of ‘001’ has been already printed by five copies, and the five records show, as the use history, the user information and the print dates and times when the respective printing operations are performed. Here, as the user information, for example, an IP address and a host ID of the host terminal 100b other than the user ID may be set.

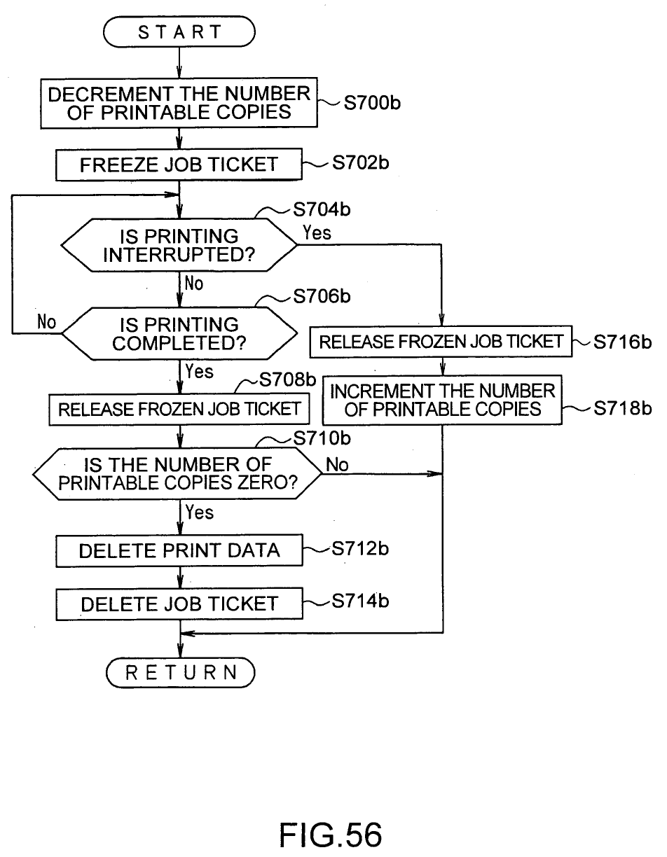

Furthermore, in the fifth embodiment described above, the number of printable copies is decremented when the printing has been interrupted or after the printing has been completed. However, the invention is not limited thereto. For example, the number of printable copies may be decremented before the job ticket is frozen. Specifically, a job ticket updating process shown in a flowchart of FIG. 56 is performed.

FIG. 56 is a flowchart illustrating the job ticket updating process.

First, if the job ticket updating process is executed by the CPU 70b, the process proceeds to step S700b, as shown in FIG. 56.

In step S700b, the number of printable copies of the job ticket is decremented by ‘1’ to proceed to step S702b in which the job ticket is frozen. Then, in step S704b, it is determined whether printing has been interrupted, and when it is determined that the printing has not been interrupted (No), the process proceeds to step S706b.

In step S706b, it is determined whether or not the printing has been completed, and when it is determined that the printing has been completed (Yes), the process proceeds to step S708b in which the job ticket is not frozen (e.g., released). Then, in step S710b, it is determined whether the number of printable copies is ‘0’, and when it is determined that the number of printable copies is not ‘0’ (No), the series of processes are completed to return to the initial step.

On the other hand, in step S710b, when it is determined that the number of printable copies is ‘0’ (Yes), the process proceeds to step S712b in which the print data is deleted. Then, in step S714b, the job ticket is deleted and the series of processes are completed to return to the initial step.

On the other hand, in step S706b, when it is determined that the printing has not been completed (No), the process proceeds to step S704b.

In step S704b, when it is determined that the printing has been interrupted (Yes), the process proceeds to step S716b, and the job ticket is not frozen (e.g., released). Then, in step S718b, the number of printable copies is incremented by ‘1’ and the series of processes are completed to return to the initial step.

In this case, steps S700b to S718b correspond to the output data use managing unit according to the one-hundred twenty-second or one-hundred twenty-eighth aspect, or correspond to the output data use managing step according to the one-hundred thirty-fourth or one-hundred fortieth aspect.

Further, in the fifth embodiment described above, the host terminal 100b generates the job ticket and the print data simultaneously. However, the invention is not limited thereto. For example, when literary works, such as documents or images which can be obtained on network 199b, are printed, a job ticket issuing device which issues a job ticket may be connected to the network 199b so that the job ticket issuing device can issue the job ticket at the time of payment of an expense. In this case, for example, the issued job ticket is recorded in the authentication card to be written into the network printer 200b through the card reader 22b. Also, in this case, since unspecified persons print literary works, the user authentication is not required. Accordingly, it does not need to prepare the user authenticating process at step S354b or S454b.

Furthermore, in the fifth embodiment described above, the number of printable copies is specified in the job ticket so as to limit the number of printable copies. However, the invention is not limited thereto. For example, the number of printable pages may be specified in the job ticket to restrict the number of printed pages.

Further, in the fifth embodiment described above, the host terminal 100b is used, but the invention is not limited thereto. For example, a printer server, a file server, or other data servers may be used instead of the host terminal 100b.

Further, in the fifth embodiment described above, the authentication information is read from the authentication card by the card reader 22b or 30b, but the invention is not limited thereto. For example, the authentication information may be input from the operating panel 80b or 81b. In this case, the card reader 22b or 30b is not required.

Further, in the fifth embodiment described above, the card reader 22b or 30b is integrally provided in the network printer 200b or 300b, but the invention is not limited thereto. For example, the card reader 22b or 30b may be provided separately from the network printer 200b or 300b. Specifically, a user authenticating device having the card reader 22b or 30b is communicably connected to the network printer 200b or 300b, and the network printer 200b or 300b inputs the authentication information by receiving the authentication information from the user authenticating device.

Further, in the fifth embodiment described above, in order to execute the processes shown in the flowcharts of FIGS. 41, 43, 44, 46 to 50, 52, 53, and 56, the control program stored in the ROM 52b, 72b, or 92b in advance is executed, but the invention is not limited thereto. For example, a program instructing these procedures may be read out from storage media which store the program, and then the program may be read in the RAM 54b, 74b, or 94b to be executed.

Here, the storage media include a semiconductor storage medium, such as a RAM, a ROM, or the like, a magnetic recordable storage medium, such as an FD, an HD, or the like, an optical readable storage medium, such as a CD, a CDV, an LD, a DVD, or the like, and a magnetic recordable/optical readable storage medium, such as an MO or the like. Specifically, the storage medium includes all storage media as long as it is a computer readable storage medium, regardless of reading methods such as electronic, magnetic, or optical.

Further, in the fifth embodiment described above, the output system, the network device, and the output method according to the invention are applied to the case in which printing is performed by the network printer 200b or 300b by using the authentication card, however, the invention is not limited thereto. For example, the invention can be applied to other cases without departing from the subject matter of the invention. Instead of the network printer 200b or 300b, for example, the invention can be applied to a projector, a home gateway, a personal computer, a personal digital assistant (PDA), a network storage, an audio apparatus, a mobile phone, PHS (Personal Handyphone System), a watch-type PDA, a set top box (STB), a POS terminal, a facsimile machine, a phone (including an IP phone or the like), and other output devices.

What is claimed is:

1. An authentication output system comprising:
a plurality of network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes:
an output data storage unit that stores the output data;
a job ticket storage unit that stores job tickets specifying contents related to whether to permit or restrict the use of the output data; and
an output data utilization managing unit that manages the use of the output data,
when the authentication succeeds, the output data utilization managing unit supplies the output data stored in the output data storage unit to any one of the plurality of network devices, and prohibits the supply of the output data until a print completion notice is received,
when the print completion notice is received, the output data utilization managing unit updates the job tickets stored in the job ticket storage unit, and when it is determined that the contents of the job tickets satisfy predetermined conditions, the output data utilization managing unit prohibits the supply of the output data,
each of the network devices includes:
an output data receiving unit that receives the output data; and
an output control unit that performs output control based on the output data received by the output data receiving unit, and
the output control unit transmits the print completion notice to the device using apparatus when the network device completely outputs the output data.

2. The authentication output system according to claim 1,
wherein the output data utilization managing unit prohibits the supply of the output data until the print completion notice or a print interruption notice is received, and
when the output of the output data from the network devices is interrupted, the output control unit prohibits the use of the output data and transmits the print interruption notice to the device using apparatus.

3. An authentication output system comprising:
a plurality of network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes:
an output data storage unit that stores the output data;
a job ticket storage unit that stores job tickets specifying contents related to whether to permit or restrict the use of the output data; and
an output data utilization managing unit that manages the use of the output data,
when the authentication succeeds, the output data utilization managing unit supplies the output data stored in the output data storage unit to any one of the plurality of network devices, updates the job tickets stored in the job ticket storage unit, and prohibits the supply of the output data unit a print completion notice is received,
when it is determined that the contents of the job tickets satisfy predetermined conditions, the output data utilization managing unit prohibits the supply of the output data,
each of the network devices includes:
an output data receiving unit that receives the output data; and
an output control unit that performs output control based on the output data received by the output data receiving unit, and
the output control unit transmits the print completion notice to the device using apparatus when the network device completely outputs the output data.

4. The authentication output system according to claim 3,
wherein the output data utilization managing unit prohibits the supply of the output data until the print completion notice or a print interruption notice is received,
when the print interruption notice is received, the output data utilization managing unit restores the contents of the job tickets to the original states before the update, and
when the output of the output data from the network devices is interrupted, the output control unit prohibits the use of the output data and transmits the print interruption notice to the device using apparatus.

5. The authentication output system according to claim 2,
wherein the device using apparatus further includes:
an authentication information receiving unit that receives authentication information used for the authentication; and
an authenticating unit, each of the network devices further includes:
an authentication information acquiring unit that acquires the authentication information; and
an authentication information transmitting unit that transmits the authentication information acquired by the authentication information acquiring unit to the device using apparatus,
the authenticating unit authenticates the use of the output data based on the authentication information received by the authentication information receiving unit, and
when it is determined that the use of the output data is authenticated by the authenticating unit, the output data utilization managing unit supplies the output data to one of the plurality of network device, which is a source of the authentication information.

6. The authentication output system according to claim 5,
wherein, when it is determined that the use of the output data is authenticated by the authenticating unit and that the job tickets can be updated, the output data utilization managing unit supplies the output data, and prohibits the update of the job tickets until the print interruption notice or the print completion notice is received.

7. The authentication output system according to claim 2,
wherein the device using apparatus further includes:
a utilization history information generating unit that creates utilization history information indicating a utilization history of the output data, based on the result supplied by the output data utilization managing unit.

8. An authentication output system comprising:
first and second network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes an output data transmitting unit that transmits the output data to the first network device,
the first network device includes:
an output data storage unit;
a first output data receiving unit that receives the output data;
an output data holding unit that stores the output data received by the first output data receiving unit in the output data storage unit;
a job ticket storage unit that stores job tickets specifying contents related to whether to permit or restrict the use of the output data;
an output data utilization managing unit that manages the use of the output data; and
a first output control unit that performs output control based on the output data stored in the output data storage unit,
when the authentication succeeds, the output data utilization managing unit supplies the output data stored in the output data storage unit to the second network device, and prohibits the supply and use of the output data until a print completion notice is received; or the output data utilization managing unit requires the first output control unit to output the output data, prohibits the supply of the output data until the output of the output data from the first network device is completed, updates the job tickets stored in the job ticket storage unit when the print completion notice is received or when the output of the output data from the first network device is completed, and prohibits the supply and use of the output data when it is determined that the contents of the job tickets satisfy predetermined conditions,
the first output control unit performs the output process based on the output data, according to the output request,
the second network device includes:
a second output data receiving unit that receives the output data; and
a second output control unit that performs output control based on the output data received by the second output data receiving unit, and
when the output of the output data from the second network device is completed, the second output control unit transmits the print completion notice to the first network device.

9. The authentication output system according to claim 8,
wherein the output data utilization managing unit prohibits the supply and use of the output data until the print completion notice or a print interruption notice is received, or the output data utilization managing unit prohibits the supply of the output data until the output of the output data from the first network device is interrupted or completed, and
when the output of the output data from the second network device is interrupted, the second output control unit prohibits the use of the output data and transmits the print interruption notice to the first network device.

10. An authentication output system comprising:
first and second network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes an output data transmitting unit that transmits the output data to the first network device,
the first network device includes:
an output data storage unit;
a first output data receiving unit that receives the output data;
an output data holding unit that stores the output data received by the first output data receiving unit in the output data storage unit;
a job ticket storage unit that stores job tickets specifying contents related to whether to permit or restrict the use of the output data;
an output data utilization managing unit that manages the use of the output data; and
a first output control unit that performs output control based on the output data stored in the output data storage unit,
when the authentication succeeds, the output data utilization managing unit supplies the output data stored in the output data storage unit to the second network device, updates the job tickets stored in the job ticket storage unit, and prohibits the supply and use of the output data until a print completion notice is received; or the output data utilization managing unit requires the first output control unit to output the output data, updates the job tickets stored in the job ticket storage unit, prohibits the supply of the output data until the output of the output data from the first network device is completed, and prohibits the supply and use of the output data when it is determined that the contents of the job tickets satisfy predetermined conditions,
the first output control unit performs the output process based on the output data, according to the output request,
the second network device includes:
a second output data receiving unit that receives the output data; and
a second output control unit that performs output control based on the output data received by the second output data receiving unit, and
when the output of the output data from the second network device is completed, the second output control unit transmits the print completion notice to the first network device.

11. The authentication output system according to claim 10,
wherein the output data utilization managing unit prohibits the supply and use of the output data until the print completion notice or a print interruption notice is received; or the output data utilization managing unit prohibits the supply of the output data until the output of the output data from the first network device is interrupted or completed, and restores the contents of the job tickets to the original states before the update when the print interruption notice is received or when the output of the output data from the first network device is interrupted, and
when the output of the output data from the second network device is interrupted, the second output control unit prohibits the use of the output data and transmits the print interruption notice to the first network device.

12. The authentication output system according to claim 9,
wherein the first network device further includes:
an authentication information receiving unit that receives authentication information used for the authentication;
a first authentication information acquiring unit that acquires the authentication information; and
an authenticating unit,
the second network device further includes:
a second authentication information acquiring unit that acquires the authentication information; and
an authentication information transmitting unit that transmits the authentication information acquired by the second authentication information acquiring unit to the first network device,
the authenticating unit authenticates the use of the output data based on the authentication information received by the authentication information receiving unit and the authentication information acquired by the first authentication information acquiring unit,
when it is determined that the use of the output data is authenticated by the authenticating unit, based on the authentication information received by the authentication information receiving unit, the output data utilization managing unit supplies the output data to the second network device, and
when it is determined that the use of the output data is authenticated by the authenticating unit based on the authentication information acquired by the first authentication information acquiring unit, the output data utilization managing unit requires the first output control unit to output the output data.

13. The authentication output system according to claim 12,
wherein, when it is determined that the use of the output data is authenticated by the authenticating unit based on the authentication information received by the authentication information receiving unit and that the job tickets can be updated, the output data utilization managing unit supplies the output data, and prohibits the update of the job tickets until the print interruption notice or the print completion notice is received, and
when it is determined that the use of the output data is authenticated by the authenticating unit, based on the authentication information acquired by the first authentication information acquiring unit and that the job tickets can be updated, the output data utilization managing unit performs an output request and prohibits the update of the job tickets until the output of the output data from the first network device is interrupted or completed.

14. The authentication output system according to claim 9,
wherein the first network device further includes:
a utilization history information generating unit that creates utilization history information indicating a utilization history of the output data, based on a utilization result and a supply result of the output data utilization managing unit.

15. The authentication output system according to claim 2,
wherein, when it is determined that the contents of the job tickets satisfy the predetermined conditions, the output data utilization managing unit removes the output data and the job tickets.

16. A device using apparatus that uses a plurality of network devices, comprising:
an output data storage unit that stores output data;
a job ticket storage unit that stores job tickets specifying contents related to whether to permit or restrict the use of the output data; and
an output data utilization managing unit that manages the use of the output data,
wherein, when authentication succeeds, the output data utilization managing unit supplies the output data stored in the output data storage unit to any one of the plurality of network devices, and prohibits the supply of the output data until a print completion notice is received,
when the print completion notice is received, the output data utilization managing unit updates the job tickets stored in the job ticket storage unit, and
when it is determined that the contents of the job tickets satisfy predetermined conditions, the output data utilization managing unit prohibits the supply of the output data.

17. A device using apparatus that uses a plurality of network devices, comprising:
an output data storage unit that stores output data;
a job ticket storage unit that stores job tickets specifying contents related to whether to permit or restrict the use of the output data; and
an output data utilization managing unit that manages the use of the output data,
wherein, when authentication succeeds, the output data utilization managing unit supplies the output data stored in the output data storage unit to any one of the plurality of network devices, updates the job tickets stored in the job ticket storage unit, and prohibits the supply of the output data until a print completion notice is received, and
when it is determined that the contents of the job tickets satisfy predetermined conditions, the output data utilization managing unit prohibits the supply of the output data.

18. A network device that performs an output process based on output data, comprising:
an output data receiving unit that receives the output data; and
an output control unit that performs output control based on the output data received by the output data receiving unit,
wherein, when the network device completely outputs the output data, the output control unit transmits a print completion notice to a device using apparatus.

19. A network device that performs an output process based on output data, comprising:
an output data storage unit;
an output data receiving unit that receives the output data;
an output data holding unit that stores the output data received by the output data receiving unit in the output data storage unit;
a job ticket storage unit that stores job tickets specifying contents related to whether to permit or restrict the use of the output data;
an output data utilization managing unit that manages the use of the output data; and
an output control unit that performs output control based on the output data stored in the output data storage unit,
wherein, when the authentication succeeds, the output data utilization managing unit supplies the output data stored in the output data storage unit to another network device, and prohibits the supply and use of the output data until a print completion notice is received; or the output data utilization managing unit requires the output control unit to output the output data, prohibits the supply of the output data until the output of the output data from the network device is completed, updates the job tickets stored in the job ticket storage unit when the print completion notice is received or when the output of the output data from the network device is completed, and prohibits the supply and use of the output data when it is determined that the contents of the job tickets satisfy predetermined conditions, and
the output control unit performs the output process based on the output data, according to the output request.

20. A network device that performs an output process based on output data, comprising:
an output data storage unit;
an output data receiving unit that receives the output data;
an output data holding unit that stores the output data received by the output data receiving unit in the output data storage unit;
a job ticket storage unit that stores job tickets specifying contents related to whether to permit or restrict the use of the output data;
an output data utilization managing unit that manages the use of the output data; and
an output control unit that performs output control based on the output data stored in the output data storage unit,
when authentication succeeds, the output data utilization managing unit supplies the output data stored in the output data storage unit to another network device, updates the job tickets stored in the job ticket storage unit, and prohibits the supply and use of the output data until a print completion notice is received; or the output data utilization managing unit requires the output control unit to output the output data, updates the job tickets stored in the job ticket storage unit, prohibits the supply of the output data until the output of the output data from the first network device is completed, and prohibits the supply and use of the output data when it is determined that the contents of the job tickets satisfy predetermined conditions, and
the output control unit performs the output process based on the output data, according to the output request.

21. An output data managing program that manages output data used for a plurality of network devices, comprising:
a program that allows a computer to execute a process including an output data utilization managing step of managing the use of the output data,
wherein, in the output data utilization managing step, when authentication succeeds in an authenticating step, the output data stored in an output data storage unit that stores the output data is supplied to any one of the plurality of network devices, and the supply of the output data is prohibited until a print completion notice is received,
when the print completion notice is received, job tickets stored in a job ticket storage unit that stores the job tickets specifying contents related to whether to permit or restrict the use of the output data are updated, and
when it is determined that the contents of the job tickets satisfy predetermined conditions, the supply of the output data is prohibited.

22. An output data managing program that manages output data used for a plurality of network devices, comprising:
a program that allows a computer to execute a process including an output data utilization managing step of managing the use of the output data,
wherein, in the output data utilization managing step, when authentication succeeds in an authenticating step, the output data stored in an output data storage unit that stores the output data is supplied to any one of the plurality of network devices, job tickets stored in a job ticket storage unit that stores the job tickets specifying contents related to whether to permit or restrict the use of the output data are updated, and the supply of the output data is prohibited until a print completion notice is received, and
when it is determined that the contents of the job tickets satisfy predetermined conditions, the supply of the output data is prohibited.

23. An output control program that performs an output process based on output data, comprising:
a program that allows a computer to execute a process including an output data receiving step of receiving the output data and an output control step of performing output control based on the output data received in the output data receiving step,
wherein, in the output control step, when the output of the output data is completed, a print completion notice is transmitted to a device using apparatus.

24. An output control program that performs an output process based on output data, comprising:
a program that allows a computer to execute a process,
the process including:
an output data receiving step of receiving the output data;
an output data storing step of storing the output data received in the output data receiving step in an output data storage unit;
an output data utilization managing step of managing the use of the output data; and
an output control step of performing output control based on the output data stored in the output data storage unit,
wherein, in the output data utilization managing step, when authentication succeeds in an authenticating step, the output data stored in the output data storage unit is supplied to another network device, and the supply and use of the output data are prohibited until a print completion notice is received; or the output of the output data is requested in the output control step, the supply of the output data is prohibited until the output data is completely output, job tickets stored in a job ticket storage unit that stores the job tickets specifying contents related to whether to permit or restrict the use of the output data are updated when the print completion notice is received or when the output data is completely output, and the supply and use of the output data are prohibited when it is determined that the contents of the job tickets satisfy predetermined conditions, and
in the output control step, the output process is performed based on the output data, according to the output request.

25. An output control program that performs an output process based on output data, comprising:
a program that allows a computer to execute a process,
the process including:
an output data receiving step of receiving the output data;
an output data storing step of storing the output data received in the output data receiving step in an output data storage unit;
an output data utilization managing step of managing the use of the output data; and
an output control step of performing output control based on the output data stored in the output data storage unit,
wherein, in the output data utilization managing step, when authentication succeeds in an authenticating step, the output data stored in the output data storage unit is supplied to another network device, job tickets stored in a job ticket storage unit that stores the job tickets specifying contents related to whether to permit or restrict the use of the output data are updated, and the supply and use of the output data are prohibited until a print completion notice is received; or the output of the output data is requested in the output control step, the job tickets stored in the job ticket storage unit are updated, the supply of the output data is prohibited until the output of the output data is completely, and the supply and use of the output data are prohibited when it is determined that the contents of the job tickets satisfy predetermined conditions, and
in the output control step, the output process is performed based on the output data, according to the output request.

26. An authentication output method that performs an output process through authentication in a plurality of network devices each of which performs the output process based on output data, the network devices being connected to a device using apparatus that uses the network devices so as to communicate therewith,
the method comprising:
for the device using apparatus,
an output data utilization managing step of supplying, when the authentication succeeds in an authenticating step, the output data stored in an output data storage unit that stores the output data to any one of the plurality of network devices,
of prohibiting the supply of the output data until a print completion notice is received,
of updating, when the print completion notice is received, job tickets stored in a job ticket storage unit that stores the job tickets specifying contents related to whether to permit or restrict the use of the output data, and
of prohibiting the supply of the output data when it is determined that the contents of the job tickets satisfy predetermined conditions, and
for the network devices,
an output control step of receiving the output data, and of transmitting the print completion notice to the device using apparatus when the output of the output data from the network devices is completed.

27. An authentication output method that performs an output process through authentication in a plurality of network devices each of which performs the output process based on output data, the network devices being connected to a device using apparatus that uses the network devices so as to communicate therewith,
the method comprising:
for the device using apparatus,
an output data utilization managing step of supplying, when the authentication succeeds in an authenticating step, the output data stored in an output data storage unit that stores the output data to any one of the plurality of network devices,
of updating job tickets stored in a job ticket storage unit that stores the job tickets specifying contents related to whether to permit or restrict the use of the output data,
of prohibiting the supply of the output data until a print completion notice is received, and
of prohibiting the supply of the output data when it is determined that the contents of the job tickets satisfy predetermined conditions, and
for the network devices,
an output data receiving step of receiving the output data; and
an output control step of transmitting the print completion notice to the device using apparatus when the output of the output data from the network devices is completed.

28. An authentication output method that performs an output process through authentication in first and second network devices each of which performs the output process based on output data, the first and second network devices being connected to a device using apparatus that uses the network devices so as to communicate therewith,
the method comprising:
for the device using apparatus,
an output data transmitting step of transmitting the output data to the first network device,
for the first network device,
a first output data receiving step of receiving the output data;
an output data storing step of storing the output data received in the first output data receiving step in an output data storage unit;
an output data utilization managing step of managing the use of the output data; and
a first output control step of performing output control based on the output data stored in the output data storage unit,
wherein, in the output data utilization managing step, when the authentication succeeds in an authenticating step, the output data stored in the output data storage unit is supplied to the second network device, and the supply and use of the output data are prohibited until a print completion notice is received; or the output of the output data is requested in the first output control step, the supply of the output data is prohibited until the output of the output data from the first network device is completed, job tickets stored in a job ticket storage unit that stores the job tickets specifying contents related to whether to permit or restrict the use of the output data are updated when the print completion notice is received or when the output of the output data from the first network device is completed, and the supply and use of the output data are prohibited when it is determined that the contents of the job tickets satisfy predetermined conditions, and
the output process is performed in the first output control step based on the output data, according to the output request, and
the method comprising:
for the second network device,
a second output data receiving step of receiving the output data; and
a second output control step of transmitting the print completion notice to the first network device when the output of the output data from the second network device is completed.

29. An authentication output method that performs an output process through authentication in first and second network devices each of which performs the output process based on output data, the first and second network devices being connected to a device using apparatus that uses the network devices so as to communicate therewith,
the method comprising:
for the device using apparatus,
an output data transmitting step of transmitting the output data to the first network device,
for the first network device,
a first output data receiving step of receiving the output data;
an output data storing step of storing the output data received in the first output data receiving step in an output data storage unit;
an output data utilization managing step of managing the use of the output data; and
a first output control step of performing output control based on the output data stored in the output data storage unit,
wherein, in the output data utilization managing step, when the authentication succeeds in an authenticating step, the output data stored in the output data storage unit is supplied to the second network device, job tickets stored in a job ticket storage unit that stores the job tickets specifying contents related to whether to permit or restrict the use of the output data are updated, and the supply and use of the output data are prohibited until a print completion notice is received; or the output of the output data is requested in the first output control step, the job tickets stored in the job ticket storage unit are updated, the supply of the output data is prohibited until the output of the output data from the first network device is completed, and the supply and use of the output data are prohibited when it is determined that the contents of the job tickets satisfy predetermined conditions,
the output process is performed in the first output control step based on the output data, according to the output request, and
the method comprising:
for the second network device,
a second output data receiving step of receiving the output data; and
a second output control step of transmitting the print completion notice to the first network device when the output of the output data from the second network device is completed.

30. An authentication output system comprising:
a plurality of network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes:
an output data transmitting unit that transmits the output data to the plurality of network devices;
a job ticket storage unit that stores job tickets specifying contents related to whether to permit or restrict the use of the output data; and
an output data utilization managing unit that manages the use of the output data,
when the authentication succeeds, the output data utilization managing unit transmits an output permission notice to any one of the plurality of network devices, and prohibits the transmission of the output permission notice until a print interruption notice or a print completion notice is received,
when the print completion notice is received, the output data utilization managing unit updates the job tickets stored in the job ticket storage unit, and when it is determined that the contents of the job tickets satisfy predetermined conditions, the output data utilization managing unit transmits a utilization prohibition notice to the plurality of network devices,
each of the network devices includes:
an output data storage unit;
an output data receiving unit that receives the output data;
an output data holding unit that stores the output data received by the output data receiving unit in the output data storage unit; and
an output control unit that performs output control based on the output data stored in the output data storage unit,
when the output permission notice is received, the output control unit performs the output process based on the output data,
when the output of the output data from the network devices is interrupted, the output control unit prohibits the use of the output data and transmits the print interruption notice to the device using apparatus,
when the output of the output data from the network devices is completed, the output control unit transmits the print completion notice to the device using apparatus, and
when the utilization prohibition notice is received, the output control unit prohibits the use of the output data.

31. An authentication output system comprising:
a plurality of network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes:
an output data transmitting unit that transmits the output data to the plurality of network devices;
a job ticket storage unit that stores job tickets specifying contents related to whether to permit or restrict the use of the output data; and
an output data utilization managing unit that manages the use of the output data,
when the authentication succeeds, the output data utilization managing unit transmits an output permission notice to any one of the plurality of network devices, updates the job tickets stored in the job ticket storage unit, and prohibits the transmission of the output permission notice until a print interruption notice or a print completion notice is received,
when the print interruption notice is received, the output data utilization managing unit restores the contents of the job tickets to the original states before the update,
when it is determined that the contents of the job tickets satisfy predetermined conditions, the output data utilization managing unit transmits a utilization prohibition notice to the plurality of network devices,
each of the network devices includes:
an output data storage unit;
an output data receiving unit that receives the output data;
an output data holding unit that stores the output data received by the output data receiving unit in the output data storage unit; and
an output control unit that performs output control based on the output data stored in the output data storage unit,
when the output permission notice is received, the output control unit performs the output process based on the output data,
when the output of the output data from the network devices is interrupted, the output control unit prohibits the use of the output data and transmits the print interruption notice to the device using apparatus,
when the output of the output data from the network devices is completed, the output control unit transmits the print completion notice to the device using apparatus, and
when the utilization prohibition notice is received, the output control unit prohibits the use of the output data.

32. An authentication output system comprising:
first and second network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes an output data transmitting unit that transmits the output data to the first and second network devices,
the first network device includes:
a first output data storage unit;
a first output data receiving unit that receives the output data;
a first output data holding unit that stores the output data received by the first output data receiving unit in the first output data storage unit;
a job ticket storage unit that stores job tickets specifying contents related to whether to permit or restrict the use of the output data;
an output data utilization managing unit that manages the use of the output data; and
a first output control unit that performs output control based on the output data stored in the first output data storage unit,
when the authentication succeeds, the output data utilization managing unit transmits an output permission notice to the second network device, and prohibits the transmission of the output permission notice and the use of the output data until a print interruption notice or a print completion notice is received; or the output data utilization managing unit requires the first output control unit to output the output data, prohibits the transmission of the output permission notice until the output of the output data from the first network device is interrupted or completed, updates the job tickets stored in the job ticket storage unit when the print completion notice is received or when the output of the output data from the first network device is completed, and transmits a utilization prohibition notice to the second network device and prohibits the use of the output data when it is determined that the contents of the job tickets satisfy predetermined conditions,
the first output control unit performs the output process based on the output data, according to the output request,
the second network device includes:
a second output data storage unit;
a second output data receiving unit that receives the output data;
a second output data holding unit that stores the output data received by the second output data receiving unit in the second output data storage unit; and
a second output control unit that performs output control based on the output data stored in the second output data storage unit,
when the output permission notice is received, the second output control unit performs the output process based on the output data,
when the output of the output data from the second network device is interrupted, the second output control unit prohibits the use of the output data and transmits the print interruption notice to the first network device,
when the output of the output data from the second network device is completed, the second output control unit transmits the print completion notice to the first network device, and
when the utilization prohibition notice is received, the second output control unit prohibits the use of the output data.

33. An authentication output system comprising:
first and second network devices each of which performs an output process based on output data; and
a device using apparatus that uses the network devices, the device using apparatus being connected to the network devices so as to communicate therewith,
wherein, when authentication succeeds, the network devices perform the output process,
the device using apparatus includes an output data transmitting unit that transmits the output data to the first and second network devices,
the first network device includes:
a first output data storage unit;
a first output data receiving unit that receives the output data;
a first output data holding unit that stores the output data received by the first output data receiving unit in the first output data storage unit;
a job ticket storage unit that stores job tickets specifying contents related to whether to permit or restrict the use of the output data;
an output data utilization managing unit that manages the use of the output data; and
a first output control unit that performs output control based on the output data stored in the first output data storage unit,
when the authentication succeeds, the output data utilization managing unit transmits an output permission notice to the second network device, updates the job tickets stored in the job ticket storage unit, and prohibits the transmission of the output permission notice and the use of the output data until a print interruption notice or a print completion notice is received; or the output data utilization managing unit requires the first output control unit to output the output data, updates the job tickets stored in the job ticket storage unit, prohibits the transmission of the output permission notice until the output of the output data from the first network device is interrupted or completed, restores the contents of the job tickets to the original states before the update when the print interruption notice is received or when the output of the output data from the first network device is interrupted, and transmits a utilization prohibition notice to the second network device and prohibits the use of the output data when it is determined that the contents of the job tickets satisfy predetermined conditions,
the first output control unit performs the output process based on the output data, according to the output request,
the second network device includes:
a second output data storage unit;
a second output data receiving unit that receives the output data;
a second output data holding unit that stores the output data received by the second output data receiving unit in the second output data storage unit; and
a second output control unit that performs output control based on the output data stored in the second output data storage unit,
when the output permission notice is received, the second output control unit performs the output process based on the output data,
when the output of the output data from the second network device is interrupted, the second output control unit prohibits the use of the output data and transmits the print interruption notice to the first network device,
when the output of the output data from the second network device is completed, the second output control unit transmits the print completion notice to the first network device, and
when the utilization prohibition notice is received, the second output control unit prohibits the use of the output data.

34. A device using apparatus that uses a plurality of network devices, comprising:
an output data transmitting unit that transmits the output data to the plurality of network devices;
a job ticket storage unit that stores job tickets specifying contents related to whether to permit or restrict the use of the output data; and
an output data utilization managing unit that manages the use of the output data,
when authentication succeeds, the output data utilization managing unit transmits an output permission notice to any one of the plurality of network devices, and prohibits the transmission of the output permission notice until a print interruption notice or a print completion notice is received,
when the print completion notice is received, the output data utilization managing unit updates the job tickets stored in the job ticket storage unit, and
when it is determined that the contents of the job tickets satisfy predetermined conditions, the output data utilization managing unit transmits a utilization prohibition notice to the plurality of network devices.

35. A device using apparatus that uses a plurality of network devices, comprising:
an output data transmitting unit that transmits the output data to the plurality of network devices;
a job ticket storage unit that stores job tickets specifying contents related to whether to permit or restrict the use of the output data; and
an output data utilization managing unit that manages the use of the output data,
wherein, when authentication succeeds, the output data utilization managing unit transmits an output permission notice to any one of the plurality of network devices, updates the job tickets stored in the job ticket storage unit, and prohibits the transmission of the output permission notice until a print interruption notice or a print completion notice is received,
when the print interruption notice is received, the output data utilization managing unit updates the job tickets stored in the job ticket storage unit, and
when it is determined that the contents of the job tickets satisfy predetermined conditions, the output data utilization managing unit transmits a utilization prohibition notice to the plurality of network devices.

36. A network device that performs an output process based on output data, comprising:
an output data storage unit;
an output data receiving unit that receives the output data;
an output data holding unit that stores the output data received by the output data receiving unit in the output data storage unit; and
an output control unit that performs output control based on the output data stored in the output data storage unit,
wherein, when an output permission notice is received, the output control unit performs the output process based on the output data,
when the output of the output data from the network device is interrupted, the output control unit prohibits the use of the output data and transmits a print interruption notice to a device using apparatus,
when the output of the output data from the network device is completed, the output control unit transmits a print completion notice to the device using apparatus, and
when a utilization prohibition notice is received, the output control unit prohibits the use of the output data.

37. A network device that performs an output process based on output data, comprising:
an output data storage unit;
an output data receiving unit that receives the output data;
an output data holding unit that stores the output data received by the output data receiving unit in the output data storage unit;
a job ticket storage unit that stores job tickets specifying contents related to whether to permit or restrict the use of the output data;
an output data utilization managing unit that manages the use of the output data; and
an output control unit that performs output control based on the output data stored in the output data storage unit,
wherein, when authentication succeeds, the output data utilization managing unit transmits an output permission notice to another network device, and prohibits the transmission of the output permission notice and the use of the output data until a print interruption notice or a print completion notice is received; or the output data utilization managing unit requires the output control unit to output the output data, prohibits the transmission of the output permission notice until the output of the output data from the network device is interrupted or completed, updates the job tickets stored in the job ticket storage unit when the print completion notice is received or when the output of the output data from the network device is completed, and transmits a utilization prohibition notice to another network device and prohibits the use of the output data when it is determined that the contents of the job tickets satisfy predetermined conditions, and
the output control unit performs the output process based on the output data, according to the output request.

38. A network device that performs an output process based on output data, comprising:
an output data storage unit;
an output data receiving unit that receives the output data;
an output data holding unit that stores the output data received by the output data receiving unit in the output data storage unit;
a job ticket storage unit that stores job tickets specifying contents related to whether to permit or restrict the use of the output data;
an output data utilization managing unit that manages the use of the output data; and
an output control unit that performs output control based on the output data stored in the output data storage unit,
wherein, when authentication succeeds, the output data utilization managing unit transmits an output permission notice to another network device, updates the job tickets stored in the job ticket storage unit, and prohibits the transmission of the output permission notice and the use of the output data until a print interruption notice or a print completion notice is received; or the output data utilization managing unit requires the output control unit to output the output data, updates the job tickets stored in the job ticket storage unit, prohibits the transmission of the output permission notice until the output of the output data from the network device is interrupted or completed, restores the contents of the job tickets to the original states before the update when the print interruption notice is received or when the output of the output data from the first network device is interrupted, and transmits a utilization prohibition notice to another network device and prohibits the use of the output data when it is determined that the contents of the job tickets satisfy predetermined conditions, and
the output control unit performs the output process based on the output data, according to the output request.

39. An authentication output method that performs an output process through authentication in a plurality of network devices each of which performs the output process based on output data, the network devices being connected to a device using apparatus that uses the network devices so as to communicate therewith,
the method comprising:
for the device using apparatus,
an output data transmitting step of transmitting the output data to the plurality of network devices; and
an output data utilization managing step of, when authentication succeeds in an authenticating step, transmitting an output permission notice to any one of the plurality of network devices, of prohibits the transmission of the output permission notice until a print interruption notice or a print completion notice is received, of updating job tickets stored in a job ticket storage unit that stores the job tickets specifying contents related to whether to permit or restrict the use of the output data when the print completion notice is received, and of transmitting a utilization prohibition notice to the plurality of network devices when it is determined that the contents of the job tickets satisfy predetermined conditions, and
for the network devices,
an output data receiving step of receiving the output data;
an output data storing step of storing the output data received in the output data receiving step in an output data storage unit; and
an output control step of performing the output process based on the output data stored in the output data storage unit when the output permission notice is received, of prohibiting the use of the output data and transmitting the print interruption notice to the device using apparatus when the output of the output data from the network devices is interrupted, of transmitting the print completion notice to the device using apparatus when the output of the output data from the network devices is completed, and of prohibiting the use of the output data when the utilization prohibition notice is received.

40. An authentication output method that performs an output process through authentication in a plurality of network devices each of which performs the output process based on output data, the network devices being connected to a device using apparatus that uses the network devices so as to communicate therewith,
the method comprising:
for the device using apparatus,
an output data transmitting step of transmitting the output data to the plurality of network devices; and
an output data utilization managing step of, when authentication succeeds in an authenticating step, transmitting an output permission notice to any one of the plurality of network devices, of updating job tickets stored in a job ticket storage unit that stores the job tickets specifying contents related to whether to permit or restrict the use of the output data, of prohibits the transmission of the output permission notice until a print interruption notice or a print completion notice is received, of restoring the contents of the job tickets to the original states before the update when the print interruption notice is received, and of transmitting a utilization prohibition notice to the plurality of network devices when it is determined that the contents of the job tickets satisfy predetermined conditions, and
for the network devices,
an output data receiving step of receiving the output data;
an output data storing step of storing the output data received in the output data receiving step in an output data storage unit; and
an output control step of performing the output process based on the output data stored in the output data storage unit when the output permission notice is received, of prohibiting the use of the output data and transmitting the print interruption notice to the device using apparatus when the output of the output data from the network devices is interrupted, of transmitting the print completion notice to the device using apparatus when the output of the output data from the network devices is completed, and of prohibiting the use of the output data when the utilization prohibition notice is received.

41. An authentication output method that performs an output process through authentication in first and second network devices each of which performs the output process based on output data, the first and second network devices being connected to a device using apparatus that uses the network devices so as to communicate therewith,
the method comprising:
for the device using apparatus,
an output data transmitting step of transmitting the output data to the first and second network devices,
for the first network device,
a first output data receiving step of receiving the output data;
a first output data storing step of storing the output data received in the first output data receiving step in a first output data storage unit;
an output data utilization managing step of managing the use of the output data; and
a first output control step of performing output control based on the output data stored in the first output data storage unit,
wherein, in the output data utilization managing step, when the authentication succeeds in an authenticating step, an output permission notice is transmitted to the second network device, and the transmission of the output permission notice and the use of the output data are prohibited until a print interruption notice or a print completion notice is received; or the output of the output data is requested in the first output control step, the transmission of the output permission notice is prohibited until the output of the output data from the first network device is interrupted or completed, job tickets stored in a job ticket storage unit that stores the job tickets specifying contents related to whether to permit or restrict the use of the output data are updated when the print completion notice is received or when the output of the output data from the first network device is completed, and a utilization prohibition notice is transmitted to the second network device and the use of the output data is prohibited when it is determined that the contents of the job tickets satisfy predetermined conditions, and
in the first output control step, the output process is performed based on the output data, according to the output request, and
for the second network device,
a second output data receiving step of receiving the output data;
a second output data storing step of storing the output data received in the second output data receiving step in a second output data storage unit; and
a second output control step of, when the output permission notice is received, performing the output process based on the output data stored in the second output data storage unit, of prohibiting the use of the output data and transmitting the print interruption notice to the first network device when the output of the output data from the second network device is interrupted, of transmitting the print completion notice to the first network device when the output of the output data from the second network device is completed, and of prohibiting the use of the output data when the utilization prohibition notice is received.

42. An authentication output method that performs an output process through authentication in first and second network devices each of which performs the output process based on output data, the first and second network devices being connected to a device using apparatus that uses the network devices so as to communicate therewith,
the method comprising:
for the device using apparatus,
an output data transmitting step of transmitting the output data to the first and second network devices,
for the first network device,
a first output data receiving step of receiving the output data;
a first output data storing step of storing the output data received in the first output data receiving step in a first output data storage unit;
an output data utilization managing step of managing the use of the output data; and
a first output control step of performing output control based on the output data stored in the first output data storage unit,
wherein, in the output data utilization managing step, when the authentication succeeds in an authenticating step, an output permission notice is transmitted to the second network device, job tickets stored in a job ticket storage unit that stores the job tickets specifying contents related to whether to permit or restrict the use of the output data are updated, and the transmission of the output permission notice and the use of the output data are prohibited until a print interruption notice or a print completion notice is received; or the output of the output data is requested in the first output control step, the job tickets stored in the job ticket storage unit are updated, the transmission of the output permission notice is prohibited until the output of the output data from the first network device is interrupted or completed, the contents of the job tickets are restored to the original states before the update when the print interruption notice is received or when the output of the output data from the first network device is interrupted, and a utilization prohibition notice is transmitted to the second network device and the use of the output data is prohibited when it is determined that the contents of the job tickets satisfy predetermined conditions, and
in the first output control step, the output process is performed based on the output data, according to the output request, and
for the second network device,
a second output data receiving step of receiving the output data;
a second output data storing step of storing the output data received in the second output data receiving step in a second output data storage unit; and
a second output control step of, when the output permission notice is received, performing the output process based on the output data stored in the second output data storage unit, of prohibiting the use of the output data and transmitting the print interruption notice to the first network device when the output of the output data from the second network device is interrupted, of transmitting the print completion notice to the first network device when the output of the output data from the second network device is completed, and of prohibiting the use of the output data when the utilization prohibition notice is received.

43. An output system comprising:
first and second network devices each of which performs an output process based on output data; and
a data managing apparatus that manages the output data, the data managing apparatus being connected to the network devices so as to communicate therewith,
wherein the data managing apparatus includes:
an output data storage unit that stores the output data; and
an output data supplying unit that supplies the output data stored in the output data storage unit to the first network device in response to an acquiring request of the first network device,
the first network device includes:
a job ticket storage unit that stores job tickets specifying contents related to whether to permit or restrict the use of the output data;
an output data utilization managing unit that manages the use of the output data; and
a first output control unit that performs output control based on the output data,
the output data utilization managing unit acquires the output data from the data managing apparatus, supplies the acquired output data to the second network device, and prohibits the supply and use of the output data until a print interruption notice or a print completion notice is received; or the output data utilization managing unit outputs the acquired output data to the first output control unit, prohibits the supply of the output data until the output of the output data from the first network device is interrupted or completed, updates the job tickets stored in the job ticket storage unit when the print completion notice is received or when the output of the output data from the first network device is completed, and prohibits the supply and use of the output data when it is determined that the contents of the job tickets satisfy predetermined conditions,
the first output control unit performs the output process based on the output data from the output data utilization managing unit,
the second network device includes:
an output data receiving unit that receives the output data; and
a second output control unit that performs output control based on the output data received by the output data receiving unit,
when the output of the output data from the second network device is interrupted, the second output control unit prohibits the use of the output data and transmits the print interruption notice to the first network device, and
when the output of the output data from the second network device is completed, the second output control unit transmits the print completion notice to the first network device.

44. An output system comprising:
first and second network devices each of which performs an output process based on output data; and
a data managing apparatus that manages the output data, the data managing apparatus being connected to the network devices so as to communicate therewith,
wherein the data managing apparatus includes:
an output data storage unit that stores the output data; and
an output data supplying unit that supplies the output data stored in the output data storage unit to the first network device in response to an acquiring request of the first network device,
the first network device includes:
a job ticket storage unit that stores job tickets specifying contents related to whether to permit or restrict the use of the output data;
an output data utilization managing unit that manages the use of the output data; and
a first output control unit that performs output control based on the output data,
the output data utilization managing unit acquires the output data from the data managing apparatus, supplies the acquired output data to the second network device, updates the job tickets stored in the job ticket storage unit, and prohibits the supply and use of the output data until a print interruption notice or a print completion notice is received; or the output data utilization managing unit outputs the acquired output data to the first output control unit, updates the job tickets stored in the job ticket storage unit, prohibits the supply of the output data until the output of the output data from the first network device is interrupted or completed, restores the contents of the job tickets to the original states before the update when the print interruption notice is received or when the output of the output data from the first network device is interrupted, and prohibits the supply and use of the output data when it is determined that the contents of the job tickets satisfy predetermined conditions,
the first output control unit performs the output process based on the output data from the output data utilization managing unit,
the second network device includes:
an output data receiving unit that receives the output data; and
a second output control unit that performs output control based on the output data received by the output data receiving unit,
when the output of the output data from the second network device is interrupted, the second output control unit prohibits the use of the output data and transmits the print interruption notice to the first network device, and
when the output of the output data from the second network device is completed, the second output control unit transmits the print completion notice to the first network device.

45. A network device that performs an output process based on output data, comprising:
a job ticket storage unit that stores job tickets specifying contents related to whether to permit or restrict the use of the output data;
an output data utilization managing unit that manages the use of the output data; and
an output control unit that performs output control based on the output data,
wherein the output data utilization managing unit acquires the output data from a data managing apparatus, supplies the acquired output data to another network device, and prohibits the supply and use of the output data until a print interruption notice or a print completion notice is received; or the output data utilization managing unit outputs the acquired output data to the output control unit, prohibits the supply of the output data until the output of the output data from the first network device is interrupted or completed, updates the job tickets stored in the job ticket storage unit when the print completion notice is received or when the output of the output data from the network device is completed, and prohibits the supply and use of the output data when it is determined that the contents of the job tickets satisfy predetermined conditions, and
the output control unit performs the output process based on the output data from the output data utilization managing unit.

46. A network device that performs an output process based on output data, comprising:
a job ticket storage unit that stores job tickets specifying contents related to whether to permit or restrict the use of the output data;
an output data utilization managing unit that manages the use of the output data; and
an output control unit that performs output control based on the output data,
wherein the output data utilization managing unit acquires the output data from a data managing apparatus, supplies the acquired output data to another network device, updates the job tickets stored in the job ticket storage unit, and prohibits the supply and use of the output data until a print interruption notice or a print completion notice is received; or the output data utilization managing unit outputs the acquired output data to the output control unit, updates the job tickets stored in the job ticket storage unit, prohibits the supply of the output data until the output of the output data from the network device is interrupted or completed, restores the contents of the job tickets to the original states before the update when the print interruption notice is received or when the output of the output data from the network device is interrupted, and prohibits the supply and use of the output data when it is determined that the contents of the job tickets satisfy predetermined conditions, and
the output control unit performs the output process based on the output data from the output data utilization managing unit.

47. An output method used for an output system including first and second network devices each of which performs an output process based on output data, and a data managing apparatus that manages the output data, the data managing apparatus being connected to the network devices so as to communicate therewith,
the method comprising:
for the first network device,
an output data utilization managing step of managing the use of the output data; and
a first output control step of performing output control based on the output data,
wherein, in the output data utilization managing step, the output data is acquired from the data managing apparatus, the acquired output data is supplied to the second network device, and the supply and use of the output data are prohibited until a print interruption notice or a print completion notice is received; or the acquired output data is output to the first output control unit, the supply of the output data is prohibited until the output of the output data from the first network device is interrupted or completed, job tickets stored in a job ticket storage unit that stores job tickets specifying contents related to whether to permit or restrict the use of the output data are updated when the print completion notice is received or when the output of the output data from the first network device is completed, and the supply and use of the output data are prohibited when it is determined that the contents of the job tickets satisfy predetermined conditions, and
in the first output control step, the output process is performed based on the output data from the output data utilization managing step,
for the data managing apparatus,
an output data supplying step of supplying the output data stored in an output data storage unit to the first network device in response to an acquiring request of the first network device, and
for the second network device,
an output data receiving step of receiving the output data; and
a second output control step of, when the output of the output data from the second network device is interrupted, prohibiting the use of the output data received in the output data receiving step and transmitting the print interruption notice to the first network device, and of transmitting the print completion notice to the first network device when the output of the output data from the second network device is completed.

48. An output method used for an output system including first and second network devices each of which performs an output process based on output data, and a data managing apparatus that manages the output data, the data managing apparatus being connected to the network devices so as to communicate therewith,
the method comprising:
for the first network device,
an output data utilization managing step of managing the use of the output data; and
a first output control step of performing output control based on the output data,
wherein, in the output data utilization managing step, the output data is acquired from the data managing apparatus, the acquired output data is supplied to the second network device, job tickets stored in a job ticket storage unit that stores the job tickets specifying contents related to whether to permit or restrict the use of the output data are updated, and the supply and use of the output data are prohibited until a print interruption notice or a print completion notice is received; or the acquired output data is output to the first output control unit, the job tickets stored in the job ticket storage unit are updated, the supply of the output data is prohibited until the output of the output data from the first network device is interrupted or completed, the contents of the job tickets are restored to the original states before the update when the print interruption notice is received or when the output of the output data from the first network device is interrupted, and the supply and use of the output data are prohibited when it is determined that the contents of the job tickets satisfy predetermined conditions, and
in the first output control step, the output process is performed based on the output data from the output data utilization managing step,
for the data managing apparatus,
an output data supplying step of supplying the output data stored in an output data storage unit to the first network device in response to an acquiring request of the first network device, and
for the data managing apparatus,
an output data receiving step of receiving the output data; and
a second output control step of, when the output of the output data from the second network device is interrupted, prohibiting the use of the output data received in the output data receiving step and transmitting the print interruption notice to the first network device, and of transmitting the print completion notice to the first network device when the output of the output data from the second network device is completed.
